(19) United States
(12) Patent Application Publication
(10) Pub. No.: US 2026/0228168 A1
(43) Pub. Date: Aug. 6, 2026

(54) CXL Memory Tier for NVLink, Enabling Heterogeneous AI Computing Architectures and GPU Memory Disaggregation

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/632,301

(22) Filed: Mar. 29, 2026

Related U.S. Application Data
(63) Continuation-in-part of application No. 19/371,779, filed on Oct. 28, 2025, now Pat. No. 12,657,153.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

As AI clusters scale to hundreds or thousands of GPUs and accelerators, memory capacity and bandwidth increasingly become the bottleneck limiting model size, inference throughput, and training speed. A computer, coupled between a first NVLink-based interface and a second CXL interface, receives an NVLink-based request comprising a first physical address. The computer translates the first physical address to a second physical address, generates a CXL.mem M2S request comprising a read-class memory opcode and the second physical address, and sends the CXL.mem M2S request to a second entity. The computer receives a CXL.mem S2M DRS comprising data and returns an NVLink-based response comprising the data. The computer may further translate CXL.mem M2S requests to NVLink-based requests, enabling bidirectional memory access across NVLink and CXL protocol domains. This translation may facilitate GPU memory disaggregation, AI workloads utilizing CXL memory pools, and unified memory access between NVLink-coupled accelerators and CXL-attached memory resources.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

NVLink is a high-speed interconnect technology that enables communication among GPUs, accelerators, switches, and other processing elements in high-performance computing environments. NVLink provides high-bandwidth, low-latency data transfer between entities, supporting memory access operations across interconnected devices. NVLink utilizes a physical layer that incorporates electrical signaling characteristics designed for rack-level and longer-reach deployments, and supports data transfer in protocol data units that carry commands, addresses, and data between entities on an NVLink fabric. NVLink traffic may carry read requests, write requests, and associated responses, with routing facilitated by source and destination identifiers within the NVLink fabric.

Compute Express Link (CXL) is an interconnect technology that enables cache-coherent memory access and high-bandwidth communication between hosts and devices. CXL builds upon the physical and electrical interface defined by PCI Express (PCIe) while adding protocols that support memory semantics and cache coherency operations. The CXL specification defines sub-protocols, including CXL.io for input/output operations, CXL.mem for memory access, and CXL.cache for cache coherency. CXL.mem enables memory access between CXL hosts and CXL devices through Master-to-Subordinate (M2S) and Subordinate-to-Master (S2M) message channels. M2S messages carry requests and data from a master, such as a host, toward a subordinate, such as a memory device, while S2M messages carry responses and data in the opposite direction.

### SUMMARY

Artificial intelligence (AI) workloads, including large language model (LLM) training and inference, demand massive parallelization across accelerators while maintaining low-latency access to large memory pools. Modern datacenter architectures increasingly deploy clusters of accelerators interconnected by high-speed fabrics, alongside host processors and memory expansion devices, to deliver computational throughput. In some implementations, heterogeneous computing architectures may incorporate entities that communicate according to different interconnect protocols, such as NVLink-based protocols and CXL, wherein translation between messages of different protocols may facilitate memory access operations across protocol domain boundaries. Some implementations address these challenges by providing translation between NVLink-based messages and CXL.mem messages, enabling memory operations, address translations, and data transfers across different protocol domains.

In various implementations, a method comprises receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem M2S request comprising a read-class memory opcode and the second physical address, wherein CXL denotes Compute Express Link; sending, by the computer via a second interface, the CXL.mem M2S request to a second entity; receiving, by the computer from the second entity, a CXL.mem S2M DRS comprising data; and sending, by the computer to the first entity, an NVLink-based response comprising the data.

In other implementations, a system comprises a first interface configured to communicate according to an NVLink-based protocol with a first entity; a second interface configured to communicate according to CXL with a second entity; and a computer coupled between the first and second interfaces, configured to translate physical addresses associated with the NVLink-based protocol to physical addresses associated with CXL, and translate between NVLink-based requests received via the first interface and CXL.mem M2S requests transmitted via the second interface.

In yet other implementations, a method comprises receiving, by a computer from a first entity via a first interface that communicates according to CXL, a CXL.mem M2S request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem S2M DRS comprising the data, and sending the CXL.mem S2M DRS to the first entity.

In still other implementations, a system comprises a first interface configured to communicate according to CXL with a first entity; a second interface configured to communicate according to an NVLink-based protocol with a second entity; and a computer coupled between the first and second interfaces, configured to translate physical addresses associated with CXL to physical addresses associated with the NVLink-based protocol, and translate between CXL.mem M2S requests received via the first interface and NVLink-based requests transmitted via the second interface.

### BRIEF DESCRIPTION OF THE DRAWINGS

FIG. 1A illustrates an example of a system comprising an apparatus that translates between NVLink-based traffic and CXL.mem traffic;

FIG. 1B illustrates an example of a TFD demonstrating translations between NVLink-based traffic and CXL.mem traffic;

FIG. 2A illustrates an example of a system, comprising an RPU having an NVLink interface, which enables a GPU to access resources coupled to the RPU over CXL.mem;

FIG. 2B illustrates an example of a TFD demonstrating translations between an NVLink-based protocol and CXL.mem utilized for communicating with a CXL device or CXL memory;

FIG. 2C illustrates an example of a TFD demonstrating translations between NVLink-based requests and CXL.mem requests;

FIG. 3A illustrates an example of a system that translates between an NVLink-based protocol and a CXL protocol;

FIG. 3B illustrates an example of a system comprising an RPU in an NVLink switch or NVSwitch, coupled to NVLink and CXL.mem entities;

FIG. 3C illustrates an example of a system comprising an xPU with an NVLink Fusion chiplet;

FIG. 4A illustrates an example of a system comprising a processor including a coherent interconnect and an NVLink interface;

FIG. 4B illustrates an example of a TFD demonstrating two NVLink read requests forwarded to different memories via a coherent interconnect;

FIG. 5A illustrates an example of a system comprising a processor comprising an NVLink interface and a CXL RP;

FIG. 5B illustrates an example of a TFD demonstrating translating a first NVLink request to a coherent interconnect protocol, and translating a second NVLink read request to a CXL.mem M2S MemRd request;

FIG. 6A illustrates an example of a system that may function as an NVLink memory switch appliance or an NVLink memory pool;

FIG. 6B illustrates an example of a TFD depicting a multi-entity memory access scenario wherein GPUs access memory mapped to physical address spaces through NVLink to ARM CHI translations;

FIG. 7A illustrates an example of GPU/CPU coupled to an xPU comprising dies coupled by chip-to-chip interfaces;

FIG. 7B illustrates an example of a custom accelerator comprising an NVLink Fusion chiplet;

FIG. 8A illustrates an example of a system that translates between NVLink-based traffic and CHI-based coherent interconnect traffic;

FIG. 8B illustrates an example of a TFD showing the translation of NVLink read request to CHI ReadOnce request;

FIG. 9A illustrates an example of a system that translates between NVLink-based traffic and ARM CHI traffic;

FIG. 9B illustrates an example of an RPU that translates between NVLink traffic and CHI traffic, utilizing an intermediate protocol based on ARM AMBA ACE-Lite;

FIG. 10A illustrates an example of a system that translates between NVLink traffic and CHI-based traffic;

FIG. 10B illustrates an example of an RPU that translates between NVLink traffic and CHI traffic;

FIG. 11A illustrates an example of a TFD showing translating an NVLink read request to a PCIe UIO read request to an ARM CHI ReadOnce request;

FIG. 11B illustrates an example of a TFD showing translating an NVLink read request to a CXL.cache RdCurr request to an ARM CHI ReadOnce request;

FIG. 12A illustrates an example of a system comprising an external entity coupled to an optional NVLink switch coupled to a processor comprising an RPU comprising an NVLink interface, a Request Agent (RA) Proxy, and a Home Agent (HA) Proxy;

FIG. 12B illustrates an example of a system comprising a processor comprising NVLink chiplets (such as NVLink Fusion) to translate between NVLink and CHI;

FIG. 13A illustrates an example of a system comprising an xPU comprising an RPU that translates between NVLink traffic and CHI traffic;

FIG. 13B illustrates an example of a system comprising an entity including NVLink and CXL ports coupled to CHI interfaces that enable memory access via a processor's coherent interconnect;

FIG. 14A illustrates an example of a system comprising a processor comprising an NVLink chiplet coupled via NVLink-C2C to the processor's coherent interconnect;

FIG. 14B illustrates an example of a system comprising an xPU coupled to a GPU utilizing an RPU that translates between NVLink traffic and CHI-based traffic;

FIG. 15A illustrates an example of a system functioning as a multi-protocol memory switch appliance or a multi-protocol memory pool comprising NVLink-based interfaces;

FIG. 15B illustrates an example of a TFD depicting a multi-entity memory access scenario wherein separate NVLink and UALink transactions utilize the same coherent interconnect infrastructure for memory access;

FIG. 16 illustrates an example of a heterogeneous computing system comprising an NVLink chiplet coupled to an accelerator based on ARM mesh architecture;

FIG. 17A illustrates an example of a system comprising a processor comprising an NVLink interface, processing cores, LLC, a CXL RP, and memory controllers coupled via memory channels to memory;

FIG. 17B illustrates an example of a transaction flow diagram (TFD) demonstrating translations from NVLink traffic to traffic conforming to a protocol utilized by a processor's coherent interconnect, utilizing CXL.cache as an intermediate protocol;

FIG. 18A illustrates an example of a system comprising a computer coupled between a first interface communicating according to an NVLink-based protocol and a second interface communicating according to CXL.cache;

FIG. 18B illustrates an example of a cable comprising an NVLink port and a CXL port, with an RPU integrated into the cable;

FIG. 18C illustrates an example of a TFD demonstrating translations between NVLink-based requests and CXL.cache requests;

FIG. 19A illustrates an example of a system comprising an xPU with an RPU that translates between CXL.cache and NVLink;

FIG. 19B illustrates an example of a TFD demonstrating translation of a CXL.cache D2H request to an NVLink read request and translation of the NVLink response to a CXL.cache H2D Data message;

FIG. 20A illustrates an example of a system comprising an xPU with an RPU, a cache, and a local memory, showing two access paths for CXL.cache D2H requests;

FIG. 20B illustrates an example of a TFD demonstrating two CXL.cache D2H request flows: a first flow served from local memory with cache state transition, and a second flow translated to an NVLink read request;

FIG. 21A illustrates an example of a system comprising a computer coupled between an NVLink-based interface and a CXL.cache interface;

FIG. 21B illustrates an example of a TFD demonstrating translation of an NVLink read request to a CXL.cache H2D request comprising SnpCur;

FIG. 21C illustrates an example of a TFD demonstrating translation of an NVLink read request to a CXL.cache H2D request comprising SnpData;

FIG. 22A illustrates an example of a system that translates between NVLink-based traffic and CXL-based traffic;

FIG. 22B illustrates an example of a TFD demonstrating translations between an NVLink request and a CXL.io request;

FIG. 23A illustrates an example of a system that translates between NVLink-based traffic and CXL-based traffic;

FIG. 23B illustrates an example of a TFD demonstrating translations between NVLink-based read requests and CXL.io UIO TLPs;

FIG. 23C illustrates an example of a TFD demonstrating translations between NVLink-based read requests and CXL.io MRd TLPs;

FIG. 24A illustrates an example of a system comprising a computer configured to translate between CXL.io traffic and NVLink-based traffic;

FIG. 24B illustrates an example of a TFD demonstrating translations between CXL.io read requests and NVLink-based read requests;

FIG. 25A illustrates an example of a system that translates between NVLink-based traffic and PCIe-based traffic;

FIG. 25B illustrates an example of a TFD demonstrating translations between an NVLink read request and a PCIe UIOMRd;

FIG. 25C illustrates an example of a TFD demonstrating translations between an NVLink read request and a PCIe MRd;

FIG. 26A illustrates an example of a cable comprising an RPU that translates between PCIe-based traffic and NVLink-based traffic;

FIG. 26B illustrates an example of a TFD demonstrating translations between PCIe-based requests and NVLink-based requests;

FIG. 27A illustrates an example of a system comprising a CXL host coupled to a CXL device over two bridges that utilize an NVLink PHY;

FIG. 27B illustrates an example of a TFD depicting tunneling of CXL.io transactions between a host and a device through two bridges that utilize IEEE 802.3 and NVLink flits;

FIG. 28A illustrates an example of a system configured to enable CXL over NVLink, such as via CXL tunneling over NVLink;

FIG. 28B illustrates an example of a TFD demonstrating CXL communications over NVLink, such as CXL over NVLink, or CXL tunneling over NVLink;

FIG. 29A illustrates an example of a system configured to enable PCIe over NVLink, such as via PCIe tunneling over NVLink;

FIG. 29B illustrates an example of a TFD demonstrating PCIe UIO communications over NVLink, such as PCIe UIO over NVLink, or PCIe UIO tunneling over NVLink;

FIG. 30A illustrates an example of a processor comprising an NVLink interface, processing cores, LLCs, and a coherent interconnect;

FIG. 30B illustrates an example of a processor comprising NVLink interfaces and DDR channels;

FIG. 31A illustrates an example of a processor comprising an NVLink interface, processing cores, caches, and a coherent interconnect;

FIG. 31B illustrates an example of a TFD demonstrating translating an NVLink read request to a read transactions of a protocol utilized by a processor's coherent interconnect to access memory;

FIG. 32A illustrates an example of a system comprising a processor that includes an NVLink interface;

FIG. 32B illustrates an example of a TFD demonstrating two translations from NVLink-based traffic to traffic conforming to a protocol utilized by a processor's coherent interconnect;

FIG. 33A illustrates an example of a system that translates between NVLink-based traffic and ISoL traffic;

FIG. 33B illustrates an example of a TFD demonstrating translations between NVLink-based traffic and Intel UPI traffic;

FIG. 34A illustrates an example of a system comprising a cable configured to translate between CXL and NVLink;

FIG. 34B illustrates an example of a TFD demonstrating translating between CXL.mem M2S MemRd request and NVLink read request;

FIG. 35A illustrates an example of a memory switch configured to provide memory to its coupled entities;

FIG. 35B illustrates an example of a TFD demonstrating NVLink requests from entities to access memory;

FIG. 36A illustrates an example of a system that implements an NVLink-based switch, or an NVLink Memory Switch, utilizing a CHI-based interconnect;

FIG. 36B illustrates an example of a TFD demonstrating NVLink switching operation between entities through a switch interconnect;

FIG. 37A illustrates an example of a system comprising a processor comprising an NVLink-C2C interface;

FIG. 37B illustrates an example of a system comprising a CPU comprising an NVLink-C2C chiplet, such as NVLink Fusion;

FIG. 38A illustrates an example of a processing pipeline for extracting passenger protocol messages from carrier protocol communications received over a PHY based on IEEE 802.3 PMA;

FIG. 38B illustrates an example of a packet structure that may be suitable for L3 switching operations;

FIG. 38C illustrates an example of a packet structure that may be suitable for L2 switching operations;

FIG. 39A, FIG. 39B, and FIG. 39C illustrate three examples of variations for the Passenger Protocol PDU that may be encapsulated within the Carrier Protocol PDU illustrated in FIG. 38B;

FIG. 40A illustrates an example of a system comprising a memory switch, a memory pool, or a Global Fabric-Attached Memory Device;

FIG. 40B illustrates an example of a system comprising a memory pool coupled to hosts and to a memory expander;

FIG. 41A illustrates an example of a system comprising a memory pool comprising two or more MxPUs;

FIG. 41B illustrates an example of a system comprising a memory pool comprising at least one MxPU and at least one xPU or CPU;

FIG. 42A illustrates an example of a system comprising a memory pool comprising a processor, DRAM, and an RPU performing host-to-host physical address translations;

FIG. 42B illustrates an example of a system comprising a memory pool comprising a CXL Multi Headed Device (MHD) comprising a processor coupled to DRAM;

FIG. 43 illustrates an example of a system comprising an AI memory switch or a memory pool, comprising a CXL Multi Headed Device (MHD);

FIG. 44A illustrates an example of a system enabling an entity to access DRAM and other resources via a CXL device port and a coherent interconnect interface;

FIG. 44B illustrates an example of a TFD showing address translations between CXL.mem M2S Req MemRd and ARM CHI REQ ReadOnce;

FIG. 45A illustrates an example of a system comprising a CXL memory switch appliance comprising a CPU having processing cores and memory controllers;

FIG. 45B illustrates an example of a TFD depicting a multi-host memory access scenario wherein two entities access memory through a shared coherent interconnect infrastructure;

FIG. 46A illustrates an example of a system comprising a processor comprising multiple interfaces; and

FIG. 46B illustrates an example of a system comprising a processor capable of servicing external requests through CCGs optimized for handling CXL.mem traffic.

### DETAILED DESCRIPTION

In some implementations, a computer, such as an RPU, may be coupled between an NVLink interface and a CXL interface, and may translate between NVLink-based traffic and CXL.mem traffic. The computer may receive NVLink-based requests from a first entity, such as a GPU or an accelerator, and may translate the NVLink-based requests to CXL.mem M2S requests for transmission to a second entity, such as a CXL device, a CXL memory expander, or a CXL memory pool. The translation may include address translation between physical address spaces, opcode translation between NVLink commands and CXL.mem memory opcodes, and Tag translation between NVLink transaction identifiers and CXL.mem Tags. The computer may be implemented as a discrete component, as a chiplet within an IC package, as an IP block within a processor, or may be integrated into an active cable or an NVLink switch. The translation may enable NVLink-coupled accelerators to access CXL memory resources for GPU memory disaggregation, capacity expansion, AI model parameter storage, key-value (KV) cache offloading, and other memory-intensive AI workloads.

In various implementations, a method comprising: receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem Master-to-Subordinate (M2S) request comprising a read-class memory opcode and the second physical address, wherein CXL denotes Compute Express Link; sending, by the computer via a second interface, the CXL.mem M2S request to a second entity; receiving, by the computer from the second entity, a CXL.mem Subordinate-to-Master Data Response with Status (S2M DRS) comprising data; and sending, by the computer to the first entity, an NVLink-based response comprising the data. The computer may translate the NVLink-based request by terminating the NVLink transaction and initiating a corresponding CXL.mem transaction. For example, the read-class memory opcode may include MemRd, MemRdData, or other read-class opcodes defined by CXL.mem. The address translation may be implemented utilizing lookup tables, page tables, base-and-offset calculations, or programmable translation functions. The computer may translate requests initiated from the NVLink-based domain to the CXL domain, may translate requests initiated from the CXL domain to the NVLink-based domain, or may translate requests initiated from both domains.

In some implementations of the method, the NVLink-based request is associated with a data payload size exceeding a maximum CXL.mem data payload size, and wherein generating the CXL.mem M2S request comprises generating CXL.mem M2S requests corresponding to the NVLink-based request. For example, an NVLink-based read request for 256 Bytes of data may be translated to four CXL.mem M2S requests, each targeting a 64-Byte cacheline. The computer may generate the CXL.mem M2S requests with sequential or non-sequential addresses derived from the first physical address.

In some implementations, the method further comprises accumulating data from CXL.mem S2M DRS responses corresponding to the CXL.mem M2S requests before sending the NVLink-based response to the first entity. The computer may buffer partial data from individual S2M DRS responses and assemble the complete data payload before generating the NVLink-based response. The S2M DRS responses may arrive out of order, and the computer may utilize Tag mappings to associate each response with the corresponding CXL.mem M2S request.

In some implementations, the method further comprises maintaining, by the computer, a mapping between a first Tag associated with the NVLink-based request and a second Tag associated with the CXL.mem M2S request, and utilizing the mapping to associate the CXL.mem S2M DRS with the NVLink-based request. The mapping may be stored in a tracker entry, a translation table, or a content-addressable memory. The first Tag may include an NVLink Tag or TransactionID, and the second Tag may be a CXL.mem Tag allocated from a Tag space utilized by the computer toward the second entity.

In some implementations, the method further comprises generating, by the computer, a second CXL.mem M2S request comprising a MemSpecRd opcode and a third physical address; and sending the second CXL.mem M2S request to the second entity. The computer may generate speculative read requests to prefetch data from the second entity before, or without, the first entity explicitly requesting it. The speculative reads may reduce read latency when the second entity exhibits long access times, such as when accessing slow memory media or remote memory resources over a fabric.

In some implementations of the method, the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool. The NVLink-based network address space may be utilized for routing NVLink requests across the NVLink fabric. The HPA space may be utilized by a CXL host or CXL device for memory access operations. The address translation may accommodate differences in size, base addresses, or memory layouts between the address spaces.

In some implementations of the method, the CXL.mem S2M DRS further comprises a Poison indication, and the NVLink-based response further comprises an error indication translated from the Poison indication. The Poison indication in CXL.mem S2M DRS may signal that the data contains an error. The computer may translate the Poison indication to an equivalent error indication in the NVLink-based response to propagate the error status to the first entity.

In some implementations, the method further comprises receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface; receiving, from the second entity, a CXL.mem Subordinate-to-Master No Data Response (S2M NDR); and sending an NVLink-based write response to the first entity. For example, MemWr* may include MemWr, MemWrPtl, or other memory write opcode variants defined by CXL.mem. The write data may be transferred from the NVLink domain to the CXL.mem domain with optional byte enable manipulation when the write is partial. The S2M NDR may include a Cmp opcode indicating completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to an NVLink-based protocol and a second interface configured to communicate according to CXL, with a computer coupled between the interfaces. The computer may be implemented in various form factors, such as an IC package conforming to a retimer BGA specification, an NVLink Fusion chiplet within a processor IC package, a discrete bridge device, or a component integrated into an active cable or an NVLink switch. The system may include optional NVLink switches and CXL switches to support multi-entity topologies. The computer may translate between physical address spaces and between NVLink-based requests and CXL.mem M2S requests, enabling NVLink-coupled entities to access CXL memory resources.

In various implementations, a system comprising: a first interface configured to communicate according to an NVLink-based protocol with a first entity; a second interface configured to communicate according to Compute Express Link (CXL) with a second entity; and a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface. The computer may further translate CXL.mem S2M responses received via the second interface to NVLink-based responses transmitted via the first interface. The computer may include logic for address translation, Tag management, protocol conversion, and transaction tracking. The system may be deployed in datacenters, HPC environments, or AI training and inference clusters to enable NVLink-coupled accelerators to access CXL-attached memory resources such as CXL memory expanders or CXL memory pools.

In some implementations of the system, the computer is packaged in an integrated circuit (IC) package comprising input/output (I/O) connection points arranged according to a retimer ball grid array (BGA) specification. The retimer BGA form factor may enable the computer to be deployed in existing retimer sockets within server platforms, optionally facilitating adoption without requiring board-level redesign.

In some implementations, the system further comprises at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools. The NVLink switch may be an NVSwitch that aggregates traffic from accelerators/GPUs toward the computer. The CXL switch may enable the computer to access multiple CXL memory devices or memory pools via a CXL interface, expanding the addressable memory capacity.

In some implementations of the system, the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY. The NVLink Fusion chiplet may enable integration of NVLink connectivity into processors that may not have native NVLink support. The D2D interface may couple the chiplet to a coherent interconnect within the processor, such as an on-chip ring or mesh interconnect.

In some implementations of the system, the NVLink-based protocol and CXL are associated with a same physical address space, the same physical address space comprising a global address space, a pod address space, or a fabric address space. When both protocols are associated with the same physical address space, the computer may perform address translations between addresses within the same space, such as range adjustments or offset calculations, rather than translations between fundamentally different address spaces.

In some implementations, a computer may translate CXL.mem requests to NVLink-based requests, enabling CXL hosts or CPUs to access memory residing on an NVLink fabric via NVLink-coupled entities such as accelerators/GPUs. NVLink provides a distributed memory model where GPUs may access memory via other GPUs. This translation may provide a CXL.mem bridge or gateway for non-NVLink compute elements, such as CPUs, to access memory on the NVLink fabric. The computer may be implemented as a discrete component, integrated into an active cable, or included in an NVLink switch.

In various implementations, a method comprising: receiving, by a computer from a first entity via a first interface that communicates according to Compute Express Link (CXL), a CXL.mem Master-to-Subordinate (M2S) request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem Subordinate-to-Master Data Response with Status (S2M DRS) comprising the data, and sending the CXL.mem S2M DRS to the first entity. The computer may translate the CXL.mem M2S request by terminating the CXL.mem transaction and initiating a corresponding NVLink transaction. The read-class memory opcode in the CXL.mem M2S request may include opcodes such as MemRd, MemRdData, or MemSpecRd. The computer may translate the HPA from the CXL.mem M2S request to an NVLink network address utilized for routing the NVLink request to its destination on the NVLink fabric. The CXL.mem S2M DRS may carry a MemData opcode and the data retrieved from the second entity.

In some implementations, the method further comprises maintaining, by the computer, a mapping between a first Tag associated with the CXL.mem M2S request and a second Tag associated with the NVLink-based request, and utilizing the mapping to associate the NVLink-based response with the CXL.mem M2S request. Upon receiving the NVLink-based response, the computer may utilize the second Tag to retrieve the first Tag from the mapping and include the first Tag in the CXL.mem S2M DRS for transaction completion at the first entity.

In some implementations of the method, the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface. The computer may derive the DestinationID from the translated address, from a routing table, or from address-range-to-destination mappings. The DestinationID may be utilized for routing the NVLink request through NVLink switches to the target entity on the NVLink fabric.

In some implementations of the method, the first entity comprises a CXL host or a CPU, and the second entity comprises a GPU, an NVLink switch, or an accelerator; and wherein the NVLink-based response comprises data retrieved from a memory accessible via the second entity on an NVLink fabric. The translation may enable CPUs to access GPU-attached memory, such as HBM and/or High-Bandwidth Flash (HBF), via the CXL.mem-to-NVLink bridge, facilitating scenarios where CPUs participate alongside NVLink GPUs in AI inference or training workloads.

In some implementations, the method further comprises receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity. The S2M NDR may carry a Cmp opcode to indicate completion of a write or invalidation operation. The computer may translate NVLink completion indications to the corresponding CXL.mem S2M NDR opcode.

In some implementations, the method further comprises receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and generating a CXL.mem Subordinate-to-Master No Data Response (S2M NDR), and sending the CXL.mem S2M NDR to the first entity. MemWr* may include MemWr, MemWrPtl, or other memory write opcode variants. The computer may translate the CXL.mem write data and byte enables to corresponding NVLink write request formats. The S2M NDR may be sent after the NVLink-based write response is received, or may be sent before the NVLink write completes as an early completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to CXL and a second interface configured to communicate according to an NVLink-based protocol, with a computer coupled between the interfaces to translate CXL.mem M2S requests to NVLink-based requests. The computer may be integrated into an active cable, included in an NVLink switch, or implemented as a discrete bridge device. The system may position the computer closer to the CXL interface for signal integrity, since CXL runs over PCIe electricals designed for shorter-reach connectivity, while NVLink may incorporate signaling compatible with longer-reach deployments.

In various implementations, a system comprising: a first interface configured to communicate according to Compute Express Link (CXL) with a first entity; a second interface configured to communicate according to an NVLink-based protocol with a second entity; and a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface. The computer may further translate NVLink-based responses received via the second interface to CXL.mem S2M responses transmitted via the first interface. The system may enable CXL hosts or CPUs to access memory on an NVLink fabric, such as GPU-attached HBM and/or HBF, via the NVLink-based protocol. The computer may maintain transaction tracking structures for matching NVLink responses to pending CXL.mem requests.

In some implementations, the system further comprises an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface. The physical medium may include twinaxial cable, multimode fiber, or single-mode fiber. The active cable may be implemented as an Active Optical Cable (AOC) or an Active Copper Cable (ACC). The signaling conversion within the cable may simplify system integration by presenting standard CXL and NVLink interfaces at each end.

In some implementations of the system, the second interface utilizes fewer lanes than the first interface, and wherein the NVLink-based protocol operates at a higher per-lane signaling rate than CXL, such that the second interface achieves a bandwidth comparable to the first interface utilizing the fewer lanes. The lane reduction may simplify cable design by reducing the number of copper wires or optical fibers, which may reduce cost and complexity of the interconnect while maintaining bandwidth parity between the two interfaces.

In some implementations of the system, the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments. Positioning the computer closer to the CXL interface may improve signal integrity for the shorter-reach CXL signaling, while the longer-reach NVLink signaling may tolerate the additional distance to the second entity.

In some implementations of the system, the computer is included in an NVLink switch, the NVLink switch coupled to NVLink entities via the second interface; and wherein the computer translates CXL.mem M2S requests from the first entity to NVLink-based requests directed to at least one of the NVLink entities. The NVLink switch may route the translated NVLink-based requests to the appropriate NVLink entity based on destination identifiers or address-based routing. Integrating the computer into the NVLink switch may enable a CXL host to access memory across multiple NVLink-coupled accelerators/GPUs.

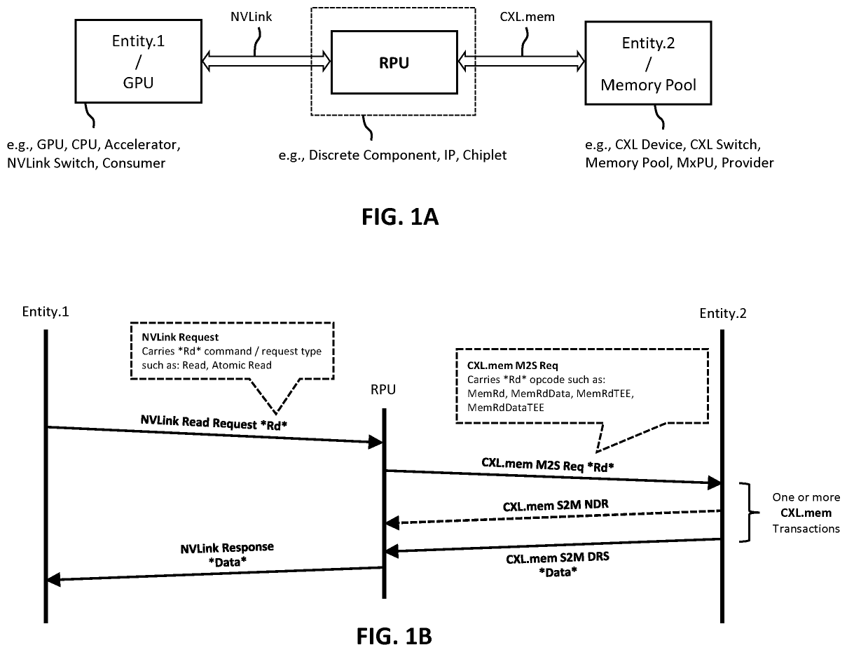

FIG. 1A illustrates an example of a system comprising an apparatus, such as an RPU, coupled between a first entity (Entity.1) and a second entity (Entity.2). The RPU may translate between NVLink-based traffic and CXL-based traffic, such as CXL.mem traffic. Entity.1, shown as a GPU, may communicate with the RPU according to an NVLink-based protocol, and may include a GPU, CPU, Accelerator, NVLink Switch (NVSwitch), or other resource consumer. Entity.2, shown as a Memory Pool, may communicate with the RPU according to CXL.mem, and may include a CXL Device, CXL Switch, Memory Pool, MxPU, or other resource provider. The RPU may be implemented as a discrete component, an IP block within a processor, or a chiplet within an IC package. Additionally or alternatively, the RPU may translate between the NVLink-based traffic and CXL.io traffic, and/or between the NVLink-based traffic and CXL.cache traffic.

FIG. 1B illustrates an example of a Transaction Flow Diagram (TFD) demonstrating an apparatus, such as an RPU, that may translate between NVLink-based traffic and CXL-based traffic, such as CXL.mem traffic. The TFD shows three entities: Entity.1 (a GPU or Consumer) on the left, the RPU in the center, and Entity.2 (a CXL Device or Provider) on the right. The first entity may send an NVLink Read Request carrying a *Rd* command or request type, such as Read or Atomic Read, to the RPU. The RPU may translate the NVLink Read Request to a CXL.mem M2S Req carrying a *Rd* opcode, such as MemRd, MemRdData, MemRdTEE, or MemRdDataTEE, and may send the CXL.mem M2S Req to the second entity. The second entity may respond with one or more CXL.mem transactions, including a CXL.mem S2M NDR and/or a CXL.mem S2M DRS carrying *Data*. The RPU may translate the CXL.mem S2M DRS to an NVLink Response carrying *Data* and send the NVLink Response to the first entity. In some examples, the RPU may translate an NVLink-based request to multiple CXL.mem request, such as when splitting an NVLink request for a data payload of 256 Bytes to CXL.mem M2S requests each carrying 64 Bytes. The RPU may accumulate data from one or more CXL.mem S2M DRS messages before sending the data via an NVLink-based response.

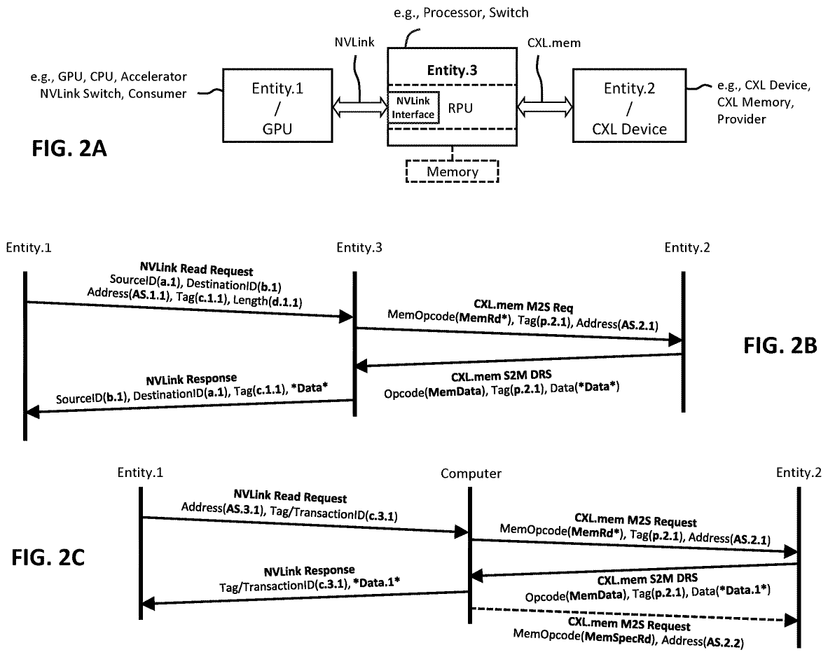

FIG. 2A illustrates an example of a system comprising a third entity (Entity.3), such as a processor or a switch. Entity.3 includes an NVLink Interface and an RPU, and includes or is coupled to an optional Memory. Entity.3 is coupled to a first entity (Entity.1), which may be a GPU, CPU, Accelerator, NVLink Switch (NVSwitch), or resource consumer, via an NVLink-based protocol. Entity.3 is further coupled to a second entity (Entity.2), which may be a CXL Device, CXL Memory, or resource provider, via CXL.mem. In some examples, messages conforming to the NVLink-based protocol may be associated with a first physical address (PA) space, such as a GPU physical address space or an NVLink-based network address space, and messages conforming to CXL.mem may be associated with a second PA space, such as HPA space. The RPU may perform address translations between addresses within the first PA space and addresses within the second PA space. In other examples, messages conforming to the NVLink-based protocol and messages conforming to CXL.mem may be associated with the same PA space, such as a global address space. Optionally, the RPU may perform further translations between the NVLink-based domain and CXL.mem domain, such as protocol translations, opcode translations, command translations, and field translations.

FIG. 2B illustrates an example of a TFD demonstrating translations performed by a third entity (Entity.3), such as a processor, a switch, or an RPU, between messages conforming to an NVLink-based protocol utilized for communicating with a first entity (Entity.1), such as a GPU, a CPU, or an accelerator, and messages conforming to CXL.mem utilized for communicating with a second entity (Entity.2), such as a CXL device or CXL memory. The first entity may initiate an NVLink Read Request comprising SourceID(a.1), DestinationID(b.1), Address(AS.1.1), Tag(c.1.1), and Length(d.1.1), wherein SourceID(a.1) may denote the NVLink interconnect address utilized by the requesting entity, and DestinationID(b.1) may denote the NVLink interconnect address utilized by the target of the NVLink request. The third entity may translate the NVLink request to a CXL.mem M2S Req comprising MemOpcode(MemRd*), Tag(p.2.1), and Address(AS.2.1), and may send the CXL.mem M2S Req to the second entity. Upon receiving a response from the second entity, which may include a CXL.mem S2M DRS comprising Opcode(MemData), Tag(p.2.1), and Data(*Data*), the third entity may translate the CXL.mem S2M DRS to an NVLink Response comprising SourceID(b.1), DestinationID(a.1), Tag(c.1.1), and *Data*. The third entity may perform further translations, such as protocol translations, opcode translations, command translations, or translations between PDUs conforming to the NVLink-based protocol and messages conforming to CXL.mem, such as translations of Tags and translations of error indications, such as poison.

FIG. 2C illustrates an example of a TFD demonstrating translations, such as address translations, optionally performed by a computer, between NVLink-based requests received from a first entity (Entity.1), which may be a CPU or a GPU, and CXL.mem requests sent to a second entity (Entity.2), which may be a CXL device. The first entity may initiate an NVLink Read Request comprising Address(AS.3.1) and Tag/TransactionID(c.3.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.mem M2S Request comprising MemOpcode(MemRd*), Tag(p.2.1), and Address(AS.2.1), and may send the CXL.mem M2S Request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to an NVLink response comprising Tag/TransactionID(c.3.1) and *Data.1*, and send the NVLink response to the first entity. The computer may further initiate speculative memory reads targeting the second entity, such as a CXL.mem M2S request comprising MemOpcode(MemSpecRd) and Address(AS.2.2), to facilitate data prefetches and potentially reduce read latency from the second entity. Optionally, the computer may utilize the speculative memory reads on behalf of the first entity. When utilizing MemSpecRd, some of the CXL.mem M2S Req fields, such as Tag, MetaField, MetaValue, and SnpType, may be reserved. In some examples, the computer may issue multiple CXL.mem reads in response to receiving an NVLink request from the first entity, such as when splitting an NVLink request for a large block of data (e.g., 256 B) to smaller CXL.mem reads (e.g., 64 B each), or when prefetching data from the second entity utilizing CXL.mem reads. The computer may translate requests or transactions initiated from the NVLink-based domain to the CXL domain, and/or may translate requests or transactions initiated from the CXL domain to the NVLink-based domain.

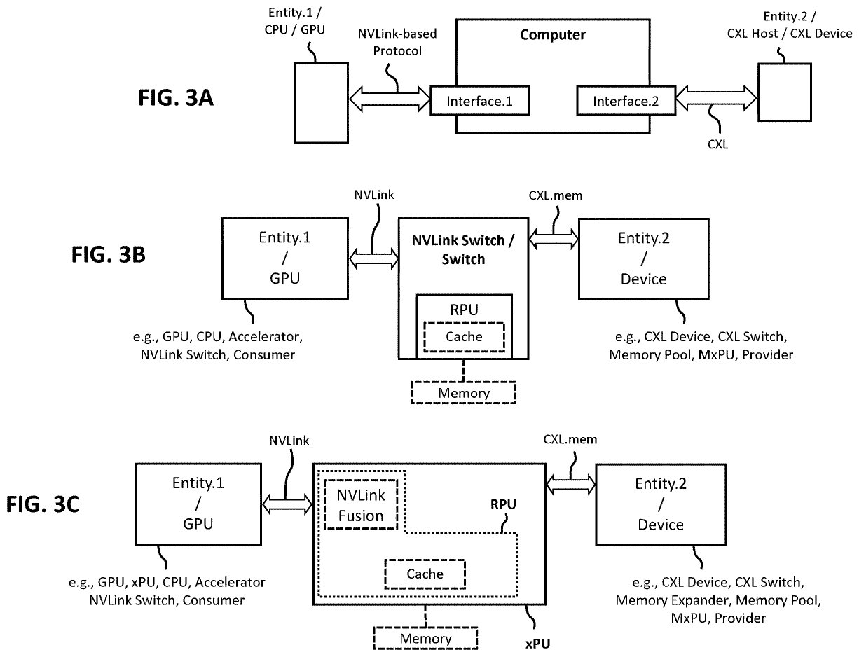

FIG. 3A illustrates an example of a system comprising a computer coupled between a first interface (Interface.1) and a second interface (Interface.2). Interface.1 may communicate according to an NVLink-based Protocol with a first entity (Entity.1), which may be a CPU or a GPU. Interface.2 may communicate according to CXL with a second entity (Entity.2), which may be a CXL host or a CXL device. The computer may extract addresses from requests received via the first interface, wherein these addresses may refer to a first address space, such as an NVLink-based address space, an NVLink-based network address space, or a GPU address space utilized by the first entity. The computer may further translate these addresses and generate requests carrying the translated addresses for transmission via the second interface, wherein the translated addresses may refer to a second address space utilized by the second entity. In other examples, the first address space and the second address space may be associated with the same address space, such as a common address space, a global address space, a pod address space, or a fabric address space. The computer may be implemented in an IC package having high-speed differential I/O balls positioned according to a ball grid array layout defined by a retimer specification. Optional switch(es), such as NVLink switches, may be positioned between the first interface and the first entity. Similarly, optional switch(es), such as CXL switches, may be positioned between the second interface and the second entity.

FIG. 3B illustrates an example of a system comprising an NVLink Switch, or Switch that includes an RPU and a Cache. The switch is coupled to a first entity (Entity.1), shown as a GPU, via an NVLink-based protocol, and to a second entity (Entity.2), shown as a Device, via CXL.mem. Entity.1 may be a GPU, CPU, Accelerator, NVLink Switch, or Consumer. Entity.2 may be a CXL Device, CXL Switch, Memory Pool, MxPU, or Provider. The switch may further be coupled to a Memory. The RPU within the switch may translate between NVLink-based requests received from the first entity and CXL.mem M2S requests transmitted to the second entity. The Cache within the switch may store data for reducing latency or accumulating data from multiple CXL.mem responses.

FIG. 3C illustrates an example of a system comprising a processor, such as an xPU, that includes an RPU that may include an NVLink Fusion chiplet or IP block. The RPU may further include a Cache, and may be coupled to a Memory. The RPU may be coupled, via the NVLink Fusion component, to a first entity (Entity.1) that may be a GPU, xPU, CPU, Accelerator, NVLink Switch, or Consumer. The RPU is coupled via CXL.mem to a second entity (Entity.2), shown as a Device. Entity.2 may be a CXL Device, CXL Switch, Memory Expander, Memory Pool, MxPU, or Provider. The NVLink Fusion chiplet may include the NVLink interface and may be part of the RPU, such that protocol translation between NVLink-based traffic and CXL.mem traffic may be performed within the NVLink Fusion chiplet. The NVLink Fusion chiplet may also include an NVLink PHY. In other examples, the NVLink interface and the RPU may be implemented as functional blocks on the same die with the xPU, or split between silicon dies or chiplets inside the IC package of the xPU.

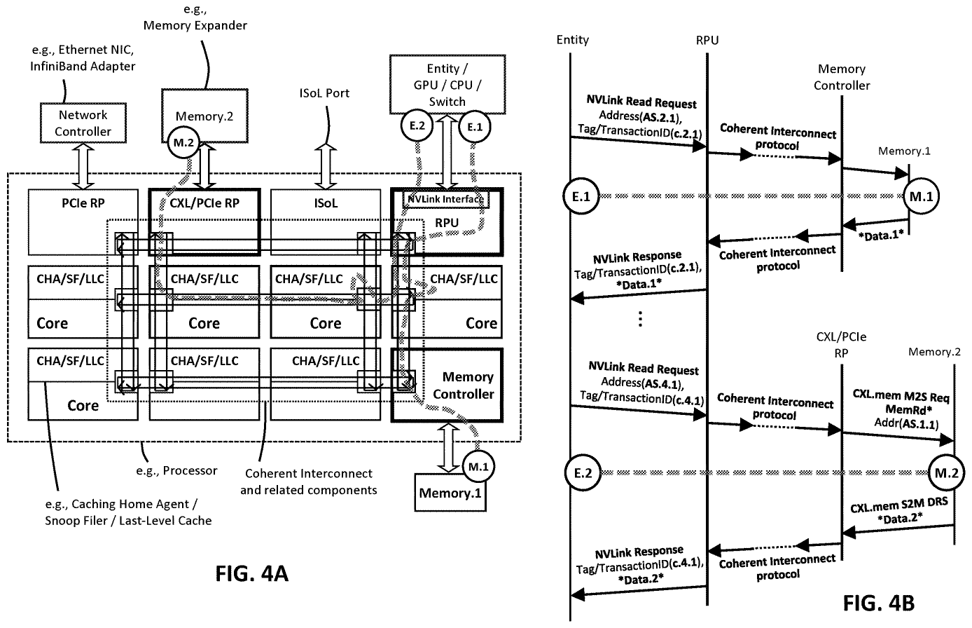

FIG. 4A illustrates an example of a system comprising a processor including a coherent interconnect, which may enable an external entity, such as a GPU, CPU, or Switch, to access memory resources mapped to an address space utilized by the coherent interconnect, such as via one or more of the two illustrated paths denoted as (E.1)-(M.1) and (E.2)-(M.2). The processor may include processing cores, and coherent interconnect, and related components, such as Caching Home Agent/Snoop Filter/Last-Level Cache (CHA/SF/LLC) slices. The processor may further include a PCIe RP coupled to a Network Controller (e.g., Ethernet NIC, InfiniBand Adapter), a CXL/PCIe RP coupled to a second memory (Memory.2, such as a Memory Expander), a memory controller coupled to a first memory (Memory.1), such as DRAM, and an ISoL port (e.g., utilizing NVIDIA NVLink-C2C, ARM CHI C2C, or Intel Coherent Processor Interconnect Protocol (ICPIP)). The processor includes an RPU coupled to an NVLink interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL/PCIe RP, such as over path (E.2)-(M.2). The illustrated RPU may be coupled to the coherent interconnect, and may translate between the NVLink-based protocol and a protocol utilized by the coherent interconnect. The processor may be implemented as a monolithic die, as chiplets within an IC package, or as components on a board, and may utilize a mesh-based coherent interconnect, or other types of coherent interconnects such as a ring, a crossbar, or a Network on Chip (NoC).

FIG. 4B illustrates an example of a TFD demonstrating two NVLink requests, such as NVLink read requests, received from an entity, such as a GPU or a CPU, processed by an RPU and forwarded, possibly using a protocol utilized by a coherent interconnect of a processor, to different memories that may be mapped to an address space utilized by the coherent interconnect. The paths from the RPU to the different memories may traverse other components, such as CHA/SF/LLC slices, memory controllers, or in other examples a home agent or a home node, optionally for resolving coherency. The RPU may perform physical address translations between first physical addresses, such as from GPU physical addresses or NVLink-based network addresses that may be carried in the NVLink requests, and second physical addresses, such as Host Physical Addresses (HPAs), which may refer to an address space utilized by the coherent interconnect, wherein the physical address translations may enable the entity to access the processor's memories. The processor may have multiple memory resources, such as first memory (Memory.1), which may be DRAM coupled to a memory controller of the processor, and/or second memory (Memory.2), which may be a CXL memory expander coupled to a CXL/PCIe RP of the processor. The RPU may further translate between NVLink-based requests and requests based on a protocol utilized by the coherent interconnect, and send the translated requests to the coherent interconnect, requesting read from memory. In some examples, the requested data may be provided by a processor cache, such as by an LLC, instead of by the memory. The data may then return over the coherent interconnect to the RPU, wherein the RPU may provide the data to the requesting entity via an NVLink response.

The TFD illustrates two exemplary transactions between the entity and the RPU, (Entity/GPU/CPU/Switch), processed by an RPU and forwarded via the coherent interconnect protocol to different memories. The TFD illustrates two exemplary transactions corresponding to two distinct memory read paths denoted as (E.1)-(M.1) and (E.2)-(M.2), each associated with a different physical address mapped to different memory resources. The first exemplary transaction (E.1) includes a first NVLink Read Request comprising Address(AS.2.1) and Tag/TransactionID(c.2.1). The RPU may translate the first NVLink request and forward the translated request via the Coherent Interconnect protocol, resulting in the retrieval of *Data.1* from the first memory (Memory.1) via the Memory Controller, wherein *Data.1* may be sent to the entity via the Coherent Interconnect protocol and via the RPU with the first NVLink Response comprising Tag/TransactionID(c.2.1) and *Data.1*.

The second exemplary transaction (E.2) includes a second NVLink Read Request comprising Address(AS.4.1) and Tag/TransactionID(c.4.1). The RPU may translate the second NVLink read request and may further translate the physical address (AS.4.1) carried in the second NVLink read request to a translated physical address (AS.1.1) which may refer to an address space utilized by the coherent interconnect. The RPU may forward the translated request, that may include the translated physical address (AS.1.1), via the coherent interconnect protocol, resulting in the retrieval of *Data.2* from the second memory (Memory.2) via the CXL/PCIe RP, utilizing a CXL.mem M2S request comprising MemRd* and Address(AS.1.1). The second memory (Memory.2) may respond with a CXL.mem S2M DRS comprising *Data.2*, which may be sent to the RPU via the coherent interconnect protocol. The RPU may then send *Data.2* to the entity via the second NVLink response. It is noted that the physical addresses (AS.2.1) and (AS.4.1) may refer to different memory regions within an address space, such as a GPU physical address space or an NVLink-based network address space, which may be exposed via an NVLink interface, enabling the entity to access memory resources based on the translation capabilities of the RPU.

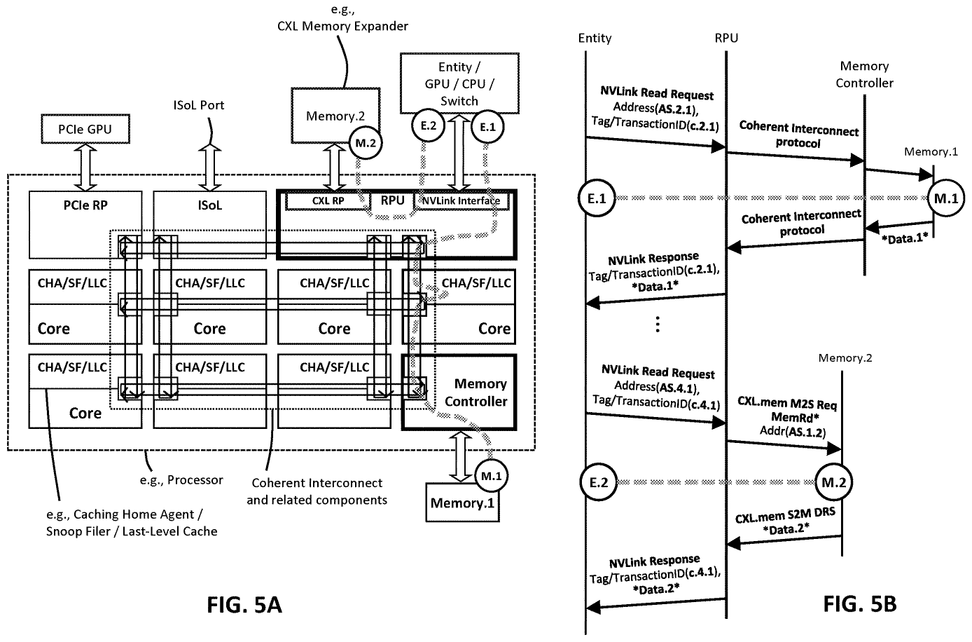

FIG. 5A illustrates an example of a system comprising a processor, including a coherent interconnect, capable of enabling an external entity, such as a GPU, CPU, or accelerator, to access memory resources mapped to an address space utilized by the coherent interconnect, such as via one or more of the two illustrated paths denoted as (E.1)-(M.1) and (E.2)-(M.2). The processor may include processing cores and CHA/SF/LLC, optionally implemented as distributed slices coupled to the coherent interconnect. The processor may further include a PCIe RP that may be coupled to a PCIe GPU, an ISoL port (e.g., utilizing NVLink-C2C, CHI C2C, or Intel Coherent Processor Interconnect Protocol (ICPIP), e.g., Intel UPI), and a Memory Controller coupled to a first memory (Memory.1). The processor includes an RPU that comprises a CXL RP, wherein the CXL RP is coupled to a second memory (Memory.2), such as a CXL Memory Expander. The RPU further includes an NVLink Interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL RP within the RPU, such as over path (E.2)-(M.2). The illustrated RPU and NVLink Interface are coupled to the coherent interconnect, and may translate between the NVLink-based protocol and a protocol utilized by the coherent interconnect. The processor may utilize a mesh-based coherent interconnect, or other types of coherent interconnects such as a ring, a crossbar, or a Network on Chip (NoC).

FIG. 5B illustrates an example of a TFD demonstrating two NVLink requests, such as NVLink read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations between first physical addresses, such as NVLink-based physical addresses, NVLink-based network addresses, or GPU physical addresses, and second physical addresses, such as Host Physical Addresses (HPAs) or System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between an NVLink-based protocol, such as a protocol utilizing an NVLink interconnect, and a protocol utilized by the coherent interconnect, wherein the RPU may send the optionally translated NVLink requests to the coherent interconnect, requesting reads from memory, such as from the first memory or from the second memory. Additionally or alternatively, the RPU may translate NVLink-based traffic to CXL-based traffic (e.g., CXL.mem), and send the translated NVLink traffic to the second memory via the CXL RP. In some examples, the requested data may be provided by a cache of the processor, such as by an LLC, instead of by the memory. The data may then return over the coherent interconnect to the RPU, wherein the RPU may provide an NVLink response to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first NVLink request comprising Address(AS.2.1) and Tag/TransactionID(c.2.1). The Tag/TransactionID may denote a Tag, a transaction Tag, a transaction identifier, or another field or set of fields carried in NVLink requests and/or NVLink responses, which may serve to associate the NVLink responses with the NVLink requests. The RPU may translate the first NVLink request and forward the translated request via the coherent interconnect protocol, resulting in the retrieval of *Data.1* from the first memory (Memory.1) via the memory controller, wherein *Data.1* may be sent to the entity via the coherent interconnect protocol and via the RPU with the first NVLink response. The second exemplary transaction corresponds to the memory read path denoted as (E.2)-(M.2), and may include a second NVLink request comprising Address(AS.4.1) and Tag/TransactionID(c.4.1). The RPU may translate the second NVLink request to a CXL.mem M2S request comprising MemRd* and translated Address(AS.1.2), wherein the RPU may send the translated request to the second memory (Memory.2) via the CXL RP. *Data.2* is retrieved from the second memory utilizing a CXL.mem S2M DRS, and sent to the RPU via the CXL RP, wherein the RPU may send *Data.2* to the entity via the second NVLink response.

In various implementations, an apparatus comprising: an integrated circuit comprising processing cores comprising memory management units (MMUs) and coherent caches; wherein the processing cores are configured to respond to snoop requests that utilize physical addresses within a physical address space (PAS), and wherein the MMUs are configured to translate virtual addresses to physical addresses within the PAS; a coherent interconnect coupling the processing cores to memory controllers coupled to memory channels capable of supporting memory having a capacity of at least 64GB, and wherein the processing cores are configured to execute an operating system (OS) that accesses the memory utilizing the physical addresses within the PAS; a resource provisioning unit (RPU) comprising an NVLink-based interface configured to communicate, according to an NVLink-based protocol, with an entity coupled to the apparatus; and wherein the RPU is further coupled to the coherent interconnect and configured to translate physical addresses associated with the NVLink-based protocol to physical addresses within the PAS; whereby the translate of the physical addresses enables the entity to access the memory via the NVLink-based interface and the memory controllers.

In some implementations of the apparatus, the NVLink-based interface comprises at least one differential pair and is configured to support reliable communication by utilizing at least one of: a replay buffer configured to enable retransmissions of packets that were not positively acknowledged by a receiver, or a Forward Error Correction (FEC) code configured to enable correction of symbol errors.

In some implementations of the apparatus, The apparatus of claim 1, wherein, in addition to the physical address translations, the RPU is further configured to translate between first fields conforming to the NVLink-based protocol message formats, and second fields conforming to message formats of a protocol utilized by the coherent interconnect.

In some implementations of the apparatus, the protocol utilized by the coherent interconnect is based on Coherent Hub Interface (CHI-based protocol), and the RPU is further configured to translate read requests corresponding to the NVLink-based protocol to requests corresponding to the CHI-based protocol carrying ReadOnce or ReadShared. The RPU may further translate CHI responses to NVLink responses, such as CHI responses carrying CompData to NVLink responses. Additionally, the RPU may maintain transaction context to properly correlate requests and responses across the protocol domains. The translation to CHI ReadOnce may be utilized for non-cacheable data accesses, while ReadShared may be utilized for cacheable shared data. The RPU may handle protocol-specific differences in flow control, credit management, and response ordering between the NVLink and CHI domains. The CompData responses from CHI may carry the requested data along with completion status, which the RPU translates into appropriate NVLink response formats.

In some implementations of the apparatus, the protocol utilized by the coherent interconnect is based on an Intel Coherent Processor Interconnect Protocol (ICPIP-based protocol) for scalable multiprocessors with a shared physical address space, and wherein the RPU is further configured to translate memory access requests corresponding to the NVLink-based protocol to requests corresponding to the ICPIP-based protocol, while maintaining coherency state tracking for physical addresses within the PAS that are associated with the coherent caches. Examples of ICPIP include Intel's Ultra Path Interconnect (UPI) and future Intel's Coherent Processor Interconnect Protocols. Optionally, the coherency state tracking between NVLink and ICPIP domains may include monitoring cacheline states and ensuring consistency across protocol boundaries. The RPU may include state machines to track outstanding transactions and their coherency implications. The translation may accommodate differences in data transfer granularity and response timing between NVLink and ICPIP protocols.

In some implementations of the apparatus, the protocol utilized by the coherent interconnect is based on Infinity Fabric (IF-based), and wherein the RPU is further configured to translate NVLink-based traffic to IF-based traffic, while preserving memory ordering required by the entity. The preservation of memory ordering may include tracking command dependencies and enforcing completion ordering as required by both NVLink and Infinity Fabric specifications. The RPU may include ordering enforcement logic that respect producer-consumer relationships and memory barrier semantics across the protocol boundary. The RPU may translate NVLink commands that include partial write indicators to appropriate Infinity Fabric write command types while maintaining data integrity.

In some implementations of the apparatus, the RPU is further configured to translate commands or encodings associated with the NVLink-based protocol to commands or opcodes associated with a protocol utilized by the coherent interconnect, based on a mapping between request types of the NVLink-based protocol and corresponding request types of the protocol utilized by the coherent interconnect. The mapping may be implemented utilizing lookup tables, state machines, or programmable translation logic. The RPU may handle various NVLink categories including memory reads, memory writes, and atomic operations, translating them to appropriate coherent interconnect opcodes while preserving transaction semantics.

In some implementations of the apparatus, the RPU is further configured to translate a request corresponding to the NVLink-based protocol to at least one message corresponding to the protocol utilized by the coherent interconnect; wherein the at least one message causes prefetch to a cache of a processor comprising the processing cores. The RPU may translate NVLink requests, such as requests carrying explicit or implicit prefetch hints, to messages of a protocol utilized by the coherent interconnect that effectively prefetch data into a cache of the processor, enabling reduced memory access latency for anticipated future accesses. An example of a prefetch hint may include a case wherein the RPU detects a pattern of reading pairs of addresses that are adjacent to each other or separated by a distinguishable stride.

In some implementations of the apparatus, the RPU is further configured to utilize an intermediate protocol selected from Peripheral Component Interconnect Express (PCIe) or Compute Express Link (CXL) when translating between the NVLink-based protocol and a protocol utilized by the coherent interconnect. The use of an intermediate protocol may facilitate translation by leveraging existing protocol conversion logic. When utilizing PCIe as an intermediate protocol, the RPU may translate NVLink traffic to PCIe Transaction Layer Packets (TLPs) and subsequently to coherent interconnect transactions. When utilizing CXL as an intermediate protocol, the RPU may leverage CXL.cache or CXL.mem as appropriate for the transaction type. The intermediate protocol stage may enable reuse of existing protocol bridges and translation logic.

In some implementations of the apparatus, the RPU is further configured to maintain mappings between transaction identifiers utilized by the NVLink-based protocol and transaction identifiers utilized by the coherent interconnect, enabling correlation of requests and responses across domains. The transaction identifier mappings may accommodate different identifier formats, sizes, and allocation schemes between NVLink and the coherent interconnect. Transaction identifiers may be used to identify a transaction, such as when supporting outstanding requests in-flight through the RPU, or may be used to convey properties associated with messages or transactions, such as trace identifiers used for debugging and performance measurements, or authorization identifiers used for security. The RPU may include identifier pools and allocation mechanisms to prevent identifier exhaustion and may support identifier recycling upon transaction completion. The mapping structures may be optimized for fast lookup during high-frequency transaction processing and may utilize on-silicon SRAM, content-addressable memory (CAM) or Ternary Content-Addressable Memory (TCAM) structures.

In some implementations of the apparatus, the RPU is further configured to: maintain a transaction tracking structure to monitor outstanding transactions from the entity, allocate coherent interconnect transaction identifiers for transactions initiated by the RPU, and release identifiers upon transaction completion. The transaction tracking structure may be implemented using content-addressable memories, linked lists, or circular buffers optimized for the expected transaction rates. The RPU may include timeout logic to handle lost or excessively delayed transactions and may support error recovery procedures. The tracking structure may maintain additional transaction attributes such as timestamps, retry counts, or quality-of-service parameters.

In some implementations of the apparatus, the RPU is further configured to enable bidirectional access by translating requests between messages conforming to the NVLink-based protocol and messages conforming to the protocol utilized by the coherent interconnect; whereby the entity accesses the memory according to the NVLink-based protocol, and the processing cores access resources attached to the entity via the coherent interconnect. The bidirectional access capability may enable memory pooling and memory sharing architectures wherein system memory and entity-attached memory form a memory space accessible from both domains via translations. The RPU may maintain separate translation contexts for each direction and may apply different translation policies based on the initiator and target of each transaction. The bidirectional capability may support various computing paradigms including GPU-direct operations and peer-to-peer transfers. When processing cores access entity-attached resources, such as High-Bandwidth Memory (HBM) resources, the RPU may handle different memory attributes between the two domains.

In some implementations of the apparatus, the entity comprises at least one of: high-bandwidth memory (HBM), High-Bandwidth Flash (HBF), Low-Power Double Data Rate (LPDDR) memory, or Graphics Double Data Rate (GDDR) memory; and wherein the RPU is further configured to map a portion of the entity memory into the PAS, enabling the processing cores to access the entity memory based on memory-mapped operations. The mapping of entity memory such as HBM, HBF, LPDDR, or GDDR memory into PAS may include establishing memory windows with specific attributes optimized for the memory type. The RPU may handle differences in memory access granularity, bandwidth characteristics, and latency profiles between system memory and entity memory. The memory-mapped operations may be subject to caching policies and coherency protocols appropriate for cross-domain memory access.

In some implementations of the apparatus, the RPU is further configured to provide access control by validating the physical addresses associated with the NVLink-based protocol against permitted address ranges for the entity, and blocking NVLink-based traffic targeting prohibited address ranges. The permitted address ranges may be configured utilizing secure configuration registers or loaded from trusted firmware during system initialization. The RPU may support different access control contexts for different operational modes or security domains. The blocking of prohibited traffic may generate error responses conforming to NVLink error reporting logic and may trigger security event logging.

In some implementations of the apparatus, the RPU is further configured to evaluate transaction attributes associated with the NVLink-based protocol, including source identifiers and access types, and to apply security policies to allow or deny traffic based on preconfigured security rules. The security policies may consider combinations of transaction attributes including source device identification, vendor-defined commands or fields, transaction type, address range, and temporal factors. The RPU may provide role-based access control wherein different entities have different access privileges. The security rules may be updateable utilizing authenticated channels and may support both static and dynamic security policy enforcement.

In some implementations of the apparatus, the RPU is further configured to detect access patterns in NVLink-based traffic from the entity, and generates prefetch requests based on predicted future accesses; and wherein the prefetch requests are routed via the coherent interconnect and the memory controllers. The access pattern detection may utilize algorithms such as stride detection, stream buffers, or correlation-based prediction algorithms. The RPU may maintain pattern history tables to track access behaviors and may adapt prefetching aggressiveness based on prefetch accuracy metrics. The prefetch requests may be tagged with lower priority to avoid interfering with demand requests and may be cancelled if subsequent access patterns diverge from predictions.

In some implementations of the apparatus, the RPU is further configured to coalesce coherent interconnect transactions targeting contiguous or nearby addresses into fewer NVLink-based transactions; whereby the coalescing improves memory bandwidth utilization. The request coalescing may consider factors including address proximity, request types, and timing windows when determining which transactions to combine. The RPU may include write combining buffers for write transactions and may support read coalescing for sequential read patterns. In one example, coherent interconnects may use up to 64-byte transfers, that may reflect a nominal cacheline size utilized by the coherent interconnect, whereas NVLink may use larger transfers up to 256 bytes, making coalescing beneficial for bandwidth efficiency.

In some implementations of the apparatus, the NVLink-based interface is configured to support virtual channels, and the RPU is further configured to map the virtual channels to quality-of-service (QoS) attributes in a protocol utilized by the coherent interconnect. The virtual channel to QoS mapping may enable differentiated service levels for different traffic classes, such as bulk data transfers versus latency-sensitive communications. The RPU may include programmable mapping tables to allow flexible QoS policy configuration. The mapping may consider both NVLink virtual channel priorities and coherent interconnect QoS mechanisms to maintain end-to-end service level objectives.

In some implementations of the apparatus, the memory comprises dynamic random-access memory (DRAM), and the entity comprises a graphics processing unit (GPU) or an accelerator coupled to the apparatus via the NVLink-based interface; and wherein the RPU enables the entity to access the DRAM with cache-line granularity. An entity, such as a GPU or an accelerator, may utilize the NVLink interface for memory access to memory resources attached to the processor. Optionally, when the entity is coupled through an NVLink switch, the RPU may handle switch-specific routing information and may support entities sharing the NVLink interface through switch-based connectivity. The GPU or accelerator entity may utilize the NVLink interface for high-bandwidth memory access patterns characteristic of parallel computing workloads. The RPU may optimize translations for the specific access patterns and bandwidth requirements of GPU or accelerator workloads.

In various implementations, a method for enabling an entity to access memory via an NVLink-based interface, comprising: operating a processor comprising processing cores, memory management units (MMUs), and coherent caches; wherein the processing cores respond to snoop requests that utilize physical addresses within a physical address space (PAS), and the MMUs translate virtual addresses to physical addresses within the PAS; communicating, via a coherent interconnect, between the processing cores and memory controllers that communicate with memory channels coupled to memory having a capacity of at least 64 GB; executing, by the processing cores, an operating system (OS) that accesses the memory utilizing the physical addresses within the PAS; communicating according to an NVLink-based protocol with the entity via an NVLink-based interface; and translating physical addresses associated with the NVLink-based protocol to physical addresses within the PAS.

In some implementations, the method further comprises translating from non-address fields conforming to the NVLink-based protocol message formats to corresponding fields conforming to message formats of a protocol utilized by the coherent interconnect; and wherein the translating of the physical addresses is performed by a resource provisioning unit (RPU) coupled between the NVLink-based interface and the coherent interconnect.

In some implementations of the method, the protocol utilized by the coherent interconnect is based on Coherent Hub Interface (CHI-based protocol); and wherein the translating between non-address fields comprises translating NVLink-based protocol read commands to CHI-based protocol opcodes or commands comprising ReadOnce or ReadShared. The method may further include translating CHI response opcodes to NVLink response opcodes, such as translating CHI responses carrying CompData to NVLink responses.

In some implementations of the method, the protocol utilized by the coherent interconnect is based on an Intel Coherent Processor Interconnect Protocol (ICPIP-based protocol) for scalable multiprocessors with a shared physical address space; and wherein the translating between non-address fields comprises translating NVLink-based protocol memory access commands to ICPIP-based protocol requests while maintaining coherency state tracking between domain of the NVLink-based protocol and domain of the ICPIP-based protocol.

In some implementations of the method, the protocol utilized by the coherent interconnect is based on Infinity Fabric (IF-based); and wherein the translating between non-address fields comprises translating NVLink-based commands to IF-based commands while preserving memory ordering required by the entity.

In some implementations, the method further comprises translating NVLink-based commands to commands associated with a protocol utilized by the coherent interconnect, based on a mapping between NVLink-based transaction types and corresponding transaction types of the protocol utilized by the coherent interconnect. It is noted that in the context of such implementations, NVLink-based commands and NVLink-based encodings may be used interchangeably.

In some implementations of the method, the translating of the physical addresses comprises utilizing an intermediate protocol selected from Peripheral Component Interconnect Express (PCIe) or Compute Express Link (CXL) as an intermediate stage between the NVLink-based protocol and a protocol utilized by the coherent interconnect.

In some implementations, the method further comprises translating transaction identifiers utilized by the NVLink-based protocol to transaction identifiers utilized by the coherent interconnect, maintaining a transaction tracking structure to monitor outstanding transactions from the entity, allocating coherent interconnect transaction identifiers for RPU-initiated transactions, and releasing identifiers upon transaction completion.

In some implementations, the method further comprises validating the physical addresses associated with the NVLink-based protocol against permitted address ranges for the entity, and blocking NVLink-based traffic targeting prohibited address ranges; and further comprising evaluating NVLink-based traffic attributes including source identifiers and access types, and applying security policies to allow or deny traffic based on preconfigured security rules.

In some implementations, the method further comprises detecting access patterns in NVLink-based traffic from the entity, and generating prefetch requests based on predicted future accesses, wherein the prefetch requests are routed via the coherent interconnect and the memory controllers.

In various implementations, a system comprising: a host processor; a memory having a capacity of at least 64GB; a coherent interconnect architecture coupling processing elements to the memory, wherein the processing elements utilize a local physical address space to access the memory; and a resource provisioning unit (RPU) configured to translate physical addresses associated with an NVLink-based protocol, utilized by an entity coupled to the RPU via an NVLink-based interface, to physical addresses within the local physical address space; whereby the translate of the physical addresses enables the entity to utilize the memory as disaggregated memory accessed via the NVLink-based interface and the memory controllers.

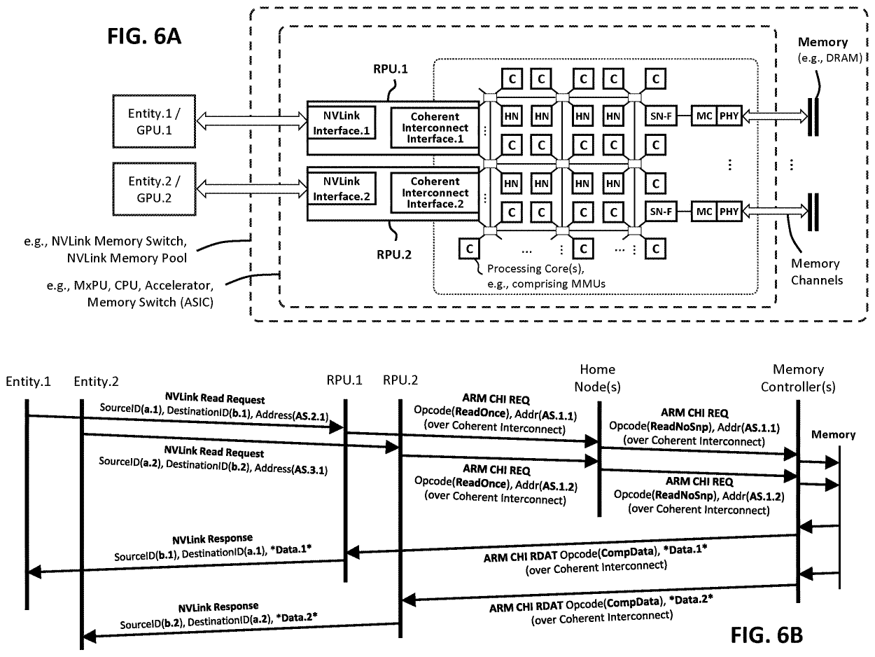

FIG. 6A illustrates an example of a system that may function as an NVLink memory switch appliance or an NVLink memory pool, and may include an MxPU, CPU, accelerator, or a memory switch ASIC, that is coupled to two entities denoted as Entity.1/GPU.1 and Entity.2/GPU.2. The MxPU includes processing cores and memory controllers coupled to a coherent interconnect that may be based on CHI. The MxPU utilizes translations, performed by the RPUs, between NVLink-based interfaces and an MxPU's coherent interconnect. The first RPU (RPU.1) may enable Entity.1/GPU.1 to access resources mapped to a physical address space utilized by the MxPU's coherent interconnect, wherein the access is via the first NVLink interface and the MxPU's coherent interconnect. Examples of resources mapped to the physical address space utilized by the MxPU's coherent interconnect include DRAM or other memory resources of the MxPU. Correspondingly, the second RPU (RPU.2) may enable Entity.2/GPU.2 to access, via the second NVLink interface and the MxPU's coherent interconnect, resources mapped to a physical address space utilized by the MxPU's coherent interconnect, such as memory resources of the MxPU.

FIG. 6B illustrates an example of a TFD depicting a multi-entity memory access scenario wherein first and second entities/GPUs access memory mapped to one or more physical address spaces utilized by the coherent interconnect (CohInterMappedMemory), through NVLink to ARM CHI translations. Entity.1/GPU.1 initiates a first NVLink request: Read with SourceID(a.1) to identify the source GPU, DestinationID(b.1) to identify the destination GPU, and Address(AS.2.1) representing an NVLink network address from a second physical address space. RPU.1 translates the first NVLink request to ARM CHI REQ carrying Opcode(ReadOnce), and Addr(AS.1.1) from a first physical address space utilized by the coherent interconnect. Concurrently or sequentially, Entity.2/GPU.2 may initiate a second NVLink request: Read with SourceID(a.2), DestinationID(b.2), and Address(AS.3.1) representing an NVLink network address optionally from a third physical address space or from the second physical address space. RPU.2 translates the second NVLink request to ARM CHI REQ carrying Opcode(ReadOnce) and Addr(AS.1.2) from the first physical address space utilized by the coherent interconnect.

Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and Data.1* for Entity.1/GPU.1. RPU.2 translates the second ARM CHI RDAT message to NVLink response with SourceID(b.2), DestinationID(a.2), and *Data.2* for Entity.2/GPU.2. The illustrated example demonstrates how entities/GPUs may share access to the same CohInterMappedMemory through different RPUs that translate between NVLink and ARM CHI, including physical address translations. Alternatively, the illustrated example may be viewed as two separate NVLink transactions that utilize the same coherent interconnect infrastructure to access CohInterMappedMemory, wherein the GPU entities may access the CohInterMappedMemory via a shared or separate address spaces that are translated to the shared coherent interconnect physical address space. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other implementations may co-locate the home node function with a specific memory controller, utilizing a unified mapping scheme that selects both a home node and a memory controller.

In various implementations, an apparatus comprising: a coherent interconnect that utilizes a protocol based on Coherent Hub Interface (CHI-based protocol), comprising an interconnect component configured to receive CHI-based messages; processing cores coupled via the coherent interconnect to memory controllers coupled to memory channels capable of supporting memory having a capacity of at least 64 GB; a resource provisioning unit (RPU) comprising an NVLink interface and a CHI interface; wherein the NVLink interface utilizes differential pairs and is capable of communicating according to an NVLink-based protocol with an entity external to the apparatus; wherein the CHI interface is coupled to the interconnect component; and wherein the RPU is configured to translate between messages conforming to the NVLink-based protocol and messages conforming to the CHI-based protocol to enable the entity to access resources via the NVLink interface and the coherent interconnect.

In some implementations of the apparatus, the RPU is further configured to: translate first physical addresses associated with the NVLink-based protocol to second physical addresses associated with the CHI-based protocol, and translate NVLink command encodings to corresponding CHI opcodes. The RPU may perform address translation from the NVLink domain to the CHI domain. The address translation may support different memory mapping schemes between the NVLink and CHI domains, while the command translation may preserve the intent of the transaction. For example, when translating an NVLink read request transaction, received from a GPU, to a CHI request transaction, targeting an xPU coherent interconnect, wherein the CHI transaction carries ReadOnce for obtaining a non-cacheable snapshot of the data, satisfying the intent of the I/O-coherent NVLink read request. The RPU may preserve the ordering requirements of the original NVLink traffic within the CHI-based protocol framework.

In some implementations of the apparatus, the resources are selected from at least one of: registers within the apparatus, SRAM, HBF, or HBM within the apparatus, at least some of the 64 GB of memory, network devices coupled to the apparatus, or storage devices coupled to the apparatus.

In some implementations of the apparatus, the RPU further comprises a request node which does not include a hardware-coherent cache, and wherein the request node is configured to communicate with the interconnect component according to the CHI-based protocol.

In some implementations of the apparatus, the request node is coupled to the interconnect component and is further configured to expose registers accessible utilizing memory-mapped I/O (MMIO) operations, to enable the entity to detect at least one of: node type, node configuration, or connection topology based on register inspection.

In some implementations of the apparatus, the request node is configured to expose the registers via Advanced Microcontroller Bus Architecture (AMBA) Advanced Peripheral Bus (APB) interface, to enable the entity to read the registers via the NVLink interface.

In some implementations of the apparatus, the request node comprises an I/O-Coherent Request Node (RN-I) or an I/O-Coherent Request Node with Distributed Virtual Memory (DVM) support (RN-D); and the RPU is configured to translate NVLink read requests to CHI read requests. The integration with ARM mesh architecture may allow the NVLink-coupled entity to participate in the broader system interconnect fabric, with interconnect components, such as crosspoints, providing routing decisions based on transaction addresses and types. The MMIO-accessible registers enable system firmware or diagnostic software to discover the structure of the coherent interconnect, the presence of request nodes and home nodes included in the RPU, verify correct node connections, detect NVLink translation capabilities in the RPU via additional register inspections, and configure operational parameters for the translation path.

In some implementations of the apparatus, the RPU further comprises a home node which does not include a Point of Coherence (PoC) and is not capable of processing snoopable requests, and wherein the home node is configured to communicate with the interconnect component according to the CHI-based protocol.

In some implementations of the apparatus, the home node comprises a I/O-coherent Home Node (HN-I), enabling the processing cores to access resources via the NVLink interface.

In some implementations of the apparatus, the RPU further comprises a request node and a home node, the request node couples the NVLink interface to the interconnect component, and the home node couples the NVLink interface to a second interconnect component. The RPU may implement routing decisions based on transaction types, directing memory access transactions from the NVLink domain through a request node, such as an RN-I node, while receiving, from a home node, such as an HN-I node, transactions targeting the NVLink domain. The apparatus may enable entities communicating according to NVLink-based protocol to perform I/O-coherent accesses to resources within a CHI-based system through appropriate non-coherent or I/O-coherent nodes. A request node, such as an RN-D node, may receive DVM transactions and generate a subset of CHI transactions without maintaining a hardware-coherent cache. The home node, such as an HN-I node, may process a limited subset of request types and manage ordering between I/O requests targeting the I/O subsystem without maintaining coherency utilizing snooping. The RPU may perform protocol-specific translations including command mapping, address formatting, address translations, orchestration and tracking of transaction IDs, and transaction sequencing between the NVLink and CHI domains.

In some implementations of the apparatus, the RPU further comprises an interconnect gateway configured to communicate with the interconnect component according to the CHI-based protocol, wherein the RPU is further configured to utilize a streaming interface protocol to enable connectivity between the NVLink interface and the coherent interconnect via the interconnect gateway.

In some implementations of the apparatus, the streaming interface protocol transports packets of an intermediate protocol; and wherein the RPU is further configured to translate between messages conforming to the intermediate protocol and messages conforming to the CHI-based protocol.

In some implementations of the apparatus, the intermedia protocol conforms to PCIe, and the RPU is further configured to translate a PCIe UIO memory read request utilizing a UIOMRd TLP type to a CHI REQ comprising ReadOnce.

In some implementations of the apparatus, the streaming interface protocol is based on Advanced Microcontroller Bus Architecture (AMBA) Credited eXtensible Stream (CXS); and wherein the interconnect gateway provides credit-based flow-control and supports bi-directional connectivity between the NVLink interface and the coherent interconnect.

In some implementations of the apparatus, the interconnect gateway comprises CXL/CCIX Gateway (CCG) comprising a link agent that supports the streaming interface protocol, providing flit packing and unpacking, end-to-end data integrity, and a flit-retry mechanism for reliability, availability and serviceability (RAS) containment when data corruption is detected.

In some implementations of the apparatus, the interconnect gateway comprises at least one of Coherent Multichip Link (CML) or Cache Coherent Interconnect for Accelerators (CCIX) Gateway (CXG); and wherein the gateway is configured to utilize a 32-bit cyclic-redundancy check (CRC-32) to protect transactions conforming to the streaming interface protocol.

In some implementations of the apparatus, the RPU comprises a request agent (RA) proxy configured to communicate with the interconnect component according to the CHI-based protocol, enabling the entity to access, via the NVLink interface, resources coupled to the coherent interconnect.

In some implementations of the apparatus, the RPU comprises a home agent (HA) proxy configured to communicate with the interconnect component according to the CHI-based protocol, enabling the processing cores to access resources via the NVLink interface.

In some implementations of the apparatus, the interconnect component comprises a crosspoint comprising at least four mesh ports and at least two device ports; and wherein the RPU is coupled to a device port of the at least two device ports.

In some implementations of the apparatus, the coherent interconnect comprises a scalable coherent fabric (SCF), the interconnect component comprises a Cache Switch Node (CSN), and the RPU is coupled to the CSN via the CHI interface. In some implementations, the xPU may be based on an NVIDIA SCF coherent interconnect that includes CSNs as a crosspoint, and an NVLink-C2C for connecting to an external entity, such as a GPU, via an NVLink interface.

In some implementations of the apparatus, the SCF comprises an SCF Cache partition (SCC); and wherein the RPU and the SCC are coupled to the CSN, providing the entity, via the NVLink interface, with low-latency access to caching resources of the apparatus.

In some implementations of the apparatus, the memory comprises dynamic random-access memory (DRAM), and the entity comprises an NVLink Switch, a GPU, or an accelerator.

In various implementations, a method comprising: operating a coherent interconnect that utilizes a protocol based on Coherent Hub Interface (CHI-based protocol), comprising an interconnect component that receives CHI-based messages; communicating, via the coherent interconnect, between processing cores and memory controllers that communicate with memory channels coupled to memory having a capacity of at least 64 GB; operating a resource provisioning unit (RPU) comprising an NVLink interface and a CHI interface, wherein the NVLink interface utilizes differential pairs and communicates according to an NVLink-based protocol with an entity external to the RPU, and wherein the CHI interface communicates with the interconnect component; and translating, by the RPU, between messages conforming to the NVLink-based protocol and messages conforming to the CHI-based protocol to enable the entity to access resources via the NVLink interface and the coherent interconnect.

In some implementations, the method further comprises translating, by the RPU, first physical addresses associated with the NVLink-based protocol to second physical addresses associated with the CHI-based protocol, and translating NVLink command encodings to corresponding CHI opcodes.

In some implementations of the method, the RPU comprises a request agent (RA) proxy, and further comprising communicating, by the RA proxy, with the interconnect component according to the CHI-based protocol, enabling the entity to access, via the NVLink interface, resources coupled to the coherent interconnect.

In some implementations of the method, the RPU comprises a home agent (HA) proxy, and further comprising communicating, by the HA proxy, with the interconnect component according to the CHI-based protocol, enabling the processing cores to access resources via the NVLink interface.

In various implementations, a system comprising: a coherent interconnect that utilizes a protocol based on Coherent Hub Interface (CHI-based protocol), comprising interconnect components configured to route CHI-based messages; processing cores coupled via the coherent interconnect to memory controllers coupled to memory channels coupled to memory having a capacity of at least 64GB; resource provisioning units (RPUs) comprising external interfaces and CHI interfaces, wherein at least one of the external interfaces comprises an NVLink interface utilizing differential pairs for communication according to an NVLink-based protocol with one or more external entities; wherein the CHI interfaces are coupled to the interconnect components; and wherein the RPUs are configured to translate between protocols utilized by the external interfaces and the CHI-based protocol; whereby the translate enables the external entities to access system resources via the external interfaces and the coherent interconnect.

In some implementations of the system, the RPUs are configured to translate physical addresses from physical address spaces associated with their external interface protocol to addresses from physical address spaces associated with the CHI-based protocol, and to translate command encodings from the external interface protocol to command encodings from corresponding CHI opcodes.

In some implementations of the system, the RPUs comprise at least one of request agent (RA) proxies or home agent (HA) proxies configured to communicate with the interconnect components according to the CHI-based protocol; wherein the RA proxies enable external entities to access memory and I/O resources coupled to the coherent interconnect, and the HA proxies enable the processing cores to access external memory resources via the external interfaces, thereby implementing a distributed shared memory architecture.

In some implementations of the system, at least one of the RPUs comprises an interconnect gateway configured to communicate with a corresponding interconnect component according to the CHI-based protocol; wherein the interconnect gateway utilizes a streaming interface protocol to enable connectivity between the external interface associated with the at least one of the RPUs and the coherent interconnect via the at least one of the RPUs. The external interfaces associated with the RPUs may implement various protocol bridging architectures to enable communication between external entities and the coherent interconnect. In one example, an RPU may utilize proxy-based mechanisms such as Request Agent (RA) proxy and Home Agent (HA) proxy for NVLink translations. In alternative implementations, the RPUs may employ direct translation engines that perform stateless or stateful conversion between external protocols and CHI-based messages, transaction queuing and reordering mechanisms that handle protocol-specific ordering requirements, or address remapping units that maintain translation tables for converting between addresses from different physical address spaces. The RPUs may implement credit-based flow control, transaction tracking structures, or protocol-specific state machines that manage the lifecycle of transactions as they traverse between domains. These various implementation approaches may enable external entities to access system memory while system components access resources attached to the external entities.

Optionally, the architectural flexibility of the RPUs may enable multiple protocols to co-exist within the system utilizing various mechanisms. Different RPUs in the system may support UALink through UPLI message processing engines, CXL protocol through CXL.mem and/or CXL.cache transaction handlers, PCIe protocol through TLP processing units, or proprietary interconnect protocols through custom translation logic. The system may include RPUs configured for multi-protocol operation, such as multi-protocol RPUs embedded in a Fabric Processing Unit (FPU) or in a software-defined fabric processor, wherein an RPU implements protocol detection and routing logic, shared transaction buffers with protocol-specific handling, unified address translation units that support multiple addressing schemes, or configurable state machines that adapt to different protocol requirements. The streaming interface protocol utilized by the interconnect gateway may provide a common transport mechanism with protocol-agnostic packetization and framing, enabling these diverse protocols to efficiently communicate with the CHI-based coherent interconnect. The RPUs may implement protocol-specific optimizations such as transaction coalescing, speculative prefetching, or latency hiding techniques while maintaining protocol semantics and coherency requirements utilizing appropriate translation and synchronization mechanisms.

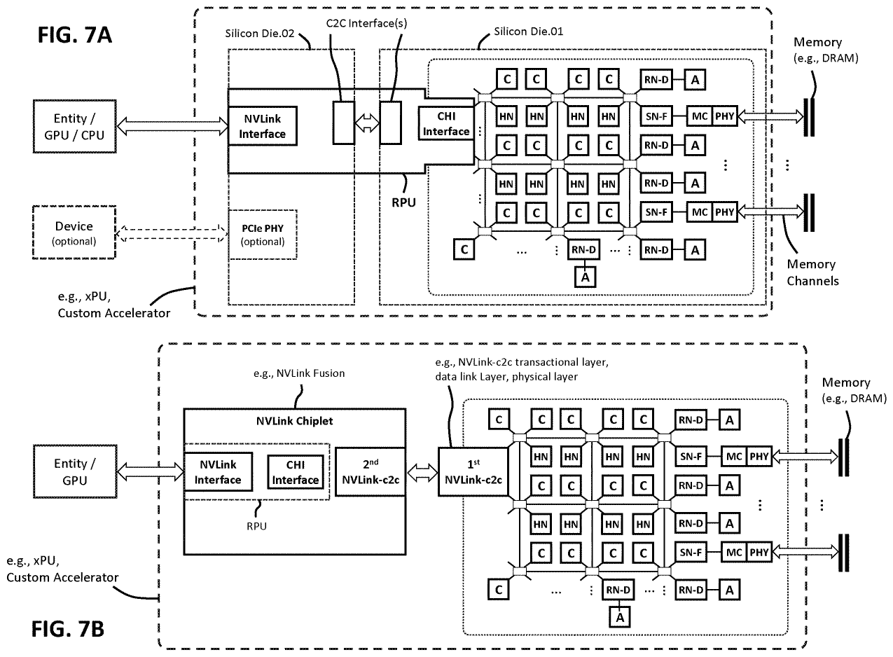

FIG. 7A illustrates an example of an xPU coupled to an entity such as a CPU or a GPU. The xPU includes an RPU which translates between NVLink traffic protocol and CHI-based traffic. The xPU further includes at least two silicon dies, wherein the first die includes a CHI interface of the RPU, and the second die includes an NVLink interface of the RPU. The second die may further include an optional PCIe PHY to communicate according to PCIe with a device external to the xPU. The first die and the second die are coupled by at least one C2C interface, utilizing chip-to-chip or die-to-die protocols such as CHI C2C or NVLink-C2C. The RPU may enable coherent memory access from the entity to the xPU, and optionally, from the device to the xPU.

FIG. 7B illustrates an example of an xPU coupled to an entity such as an NVIDIA Blackwell GPU. The xPU includes processing cores, acceleration cores, memory controllers, a coherent interconnect, and an NVLink chiplet, such as NVLink Fusion, that is coupled to the coherent interconnect via a first NVLink-C2C. The NVLink chiplet includes a second NVLink-C2C, and an RPU that translates between NVLink traffic and CHI-based traffic. The RPU includes an NVLink interface for coupling to the entity, and a CHI interface for coupling to the second NVLink-C2C. The NVLink-C2C interfaces are optionally integrated into NVLink-C2C controllers that includes transactional layers, data link layers and physical layers. The RPU may enable the GPU to access, via the NVLink interface, resources mapped to the physical address space utilized by the xPU coherent interconnect. Correspondingly, the RPU may enable the processing cores of the xPU to access, via the NVLink interface, resources of the GPU, such as HBM, High-Bandwidth Flash (HBF), or GDDR memory.

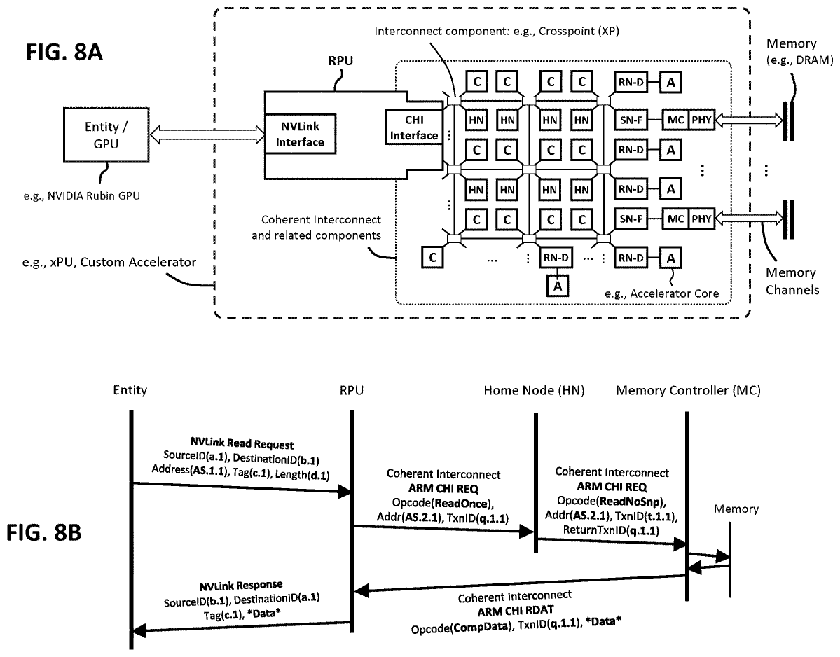

FIG. 8A illustrates an example of a system that translates between NVLink-based traffic and coherent interconnect CHI-based traffic. The NVLink connections are coupled via an RPU to an interconnect component such as a crosspoint (e.g., XP), which may serve as a fundamental building block of a coherent interconnect, providing switching or routing of CHI messages between participating elements such as request nodes, home nodes, gateways, protocol bridges, or other elements that connect to the coherent interconnect. The RPU may translate between NVLink traffic utilized by an entity, such as a GPU or a CPU, to CHI-based traffic utilized by the interconnect component, possibly eliminating intermediate protocol translations. Alternatively, the RPU may translate between an NVLink traffic and CHI traffic by utilizing intermediate protocols such as Advance Extensible Interface (AXI), or AXI Coherency Extensions Lite (ACE-Lite), or by utilizing streaming interface protocols such as Credited eXtensible Stream (CXS). Direct translation from NVLink to CHI may provide high-performance connectivity between a GPU coupled to the NVLink interface and memory coupled to the coherent interconnect, a performance gain that may be reflected via lower-latency accesses to memory and higher-bandwidth of reads and writes.

FIG. 8B illustrates an example of a transaction flow diagram (TFD) showing the translation of NVLink traffic to CHI traffic. An entity, such as a GPU or a CPU, initiates an NVLink read request, that is received by the RPU via the NVLink interface. The RPU translates the NVLink request to a CHI request carrying ReadOnce, optionally translating the physical address (AS.1.1) associated with NVLink to a physical address (AS.2.1) associated with CHI. The RPU may capture identification information associated with the NVLink request, such as source identifier of the requesting entity, and transaction Tag identifier, and may record the information together with identification information associated with the CHI request generated, such as the transaction ID (TxnID), in order to support the generation of an NVLink response for the NVLink request received from the entity. The RPU sends the CHI request, via the CHI interface, to an interconnect component, such as a crosspoint (e.g., an XP on a CHI coherent interconnect), that forwards the request to a home node. The home node processes the request and issues a CHI request carrying ReadNoSnp to a memory controller coupled to the coherent interconnect. The memory controller may read the requested data from memory, and may send the data to the RPU, or alternatively the memory controller may send the data to the home node, wherein the home node is responsible for sending the data to the RPU. When the RPU receives the data via the CHI interface, the RPU may issue an NVLink response with the data to the requesting entity, utilizing the identification information the RPU captured when processing and translating the NVLink request.

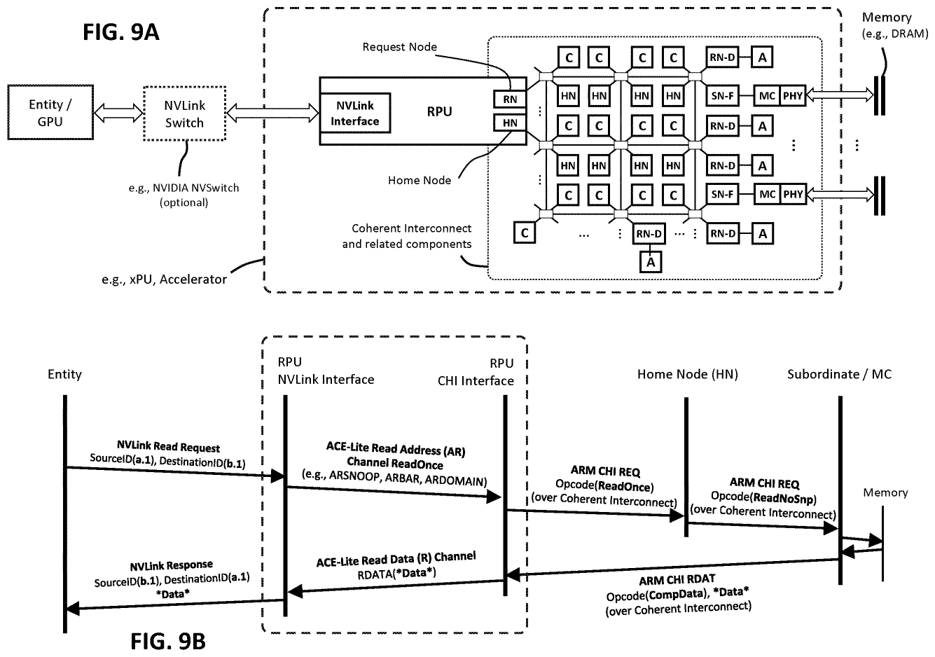

FIG. 9A illustrates an example of a system that translates between NVLink-based traffic and CHI-based traffic. The NVLink connections are coupled via an RPU to crosspoint (e.g., XP) interconnect components of the CHI coherent interconnect. The RPU may include request nodes (e.g., RNs), such as I/O-coherent RN-I nodes and/or RN-D, and/or home nodes (e.g., HNs), such as non-coherent HN-I nodes. This example enables external entities, such as GPUs, CPUs, or accelerators, which communicate utilizing NVLink traffic, to access resources within the ARM-based processor's coherent domain utilizing appropriate translations and routing, such as by an RPU translating from NVLink traffic utilized by a GPU entity, to CHI traffic, utilized by a crosspoint (XP) component of the CHI interconnect, wherein a request node or a home node provides the CHI interface for connecting to the XP.

FIG. 9B illustrates an example of an RPU that translates between NVLink traffic and CHI traffic, utilizing an intermediate protocol based on ARM Advanced Microcontroller Bus Architecture (AMBA) Advance Extensible Interface (AXI) Coherency Extensions Lite (ACE-Lite). The RPU may further translate physical addresses associated with NVLink to physical addresses associated with CHI. The RPU may process and translate the NVLink traffic, received from an NVLink interface, to ACE-Lite traffic for further processing, and send the ACE-Lite traffic to a request node (e.g., RN). The request node translates the ACE-Lite traffic to CHI traffic and provides a CHI interface for connecting to the coherent interconnect. In this example, the RPU receives from an entity, such as a GPU or a CPU, NVLink traffic that includes a read request. The RPU translates the NVLink traffic to an intermediate ACE-Lite ReadOnce, that is further translated by a request node to a CHI ReadOnce destined to a home node (e.g., HN). The home node processes the CHI ReadOnce and may issue a ReadNoSnp to a memory controller, for servicing the original read request received from the entity via the NVLink interface. The memory controller reads the requested data from memory, and may send the data via the coherent interconnect to the CHI interface of the RPU for delivery to the entity over the NVLink interface.

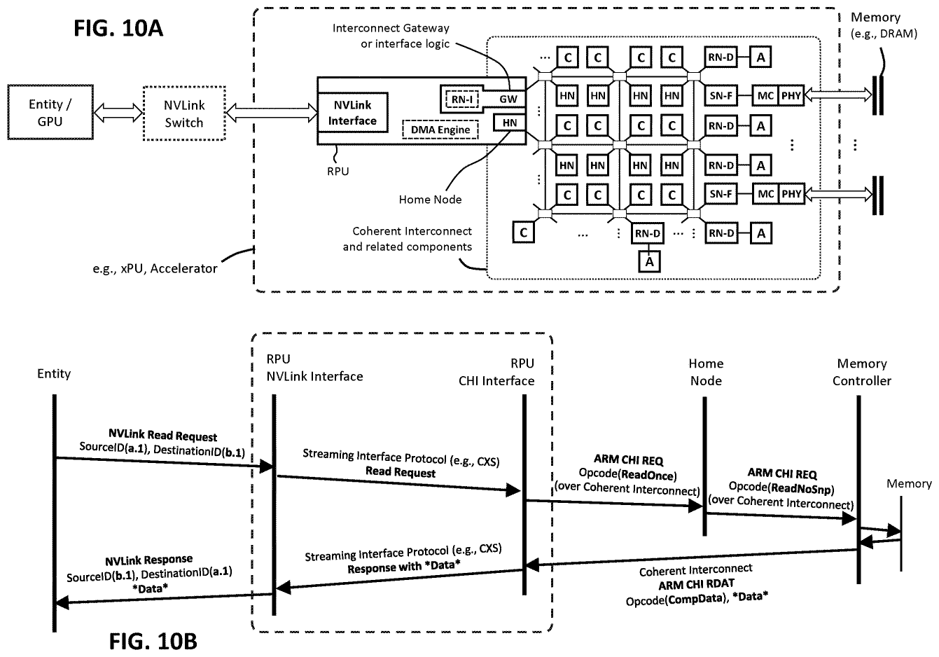

FIG. 10A illustrates an example of a system that translates between an interface based on NVLink, and interconnect components that communicate according to a protocol based on ARM CHI. The system enables entities, such as GPUs or CPUs, to access, via an optional NVLink switch, and an NVLink interface, resources coupled to the coherent interconnect. The NVLink connections are coupled, via an RPU, to crosspoint (e.g., XP) interconnect components of the coherent interconnect. The RPU may include a gateway or interface logic (marked GW in the figure), such as CXL/CCIX Gateway (CCG), Coherent Multichip Link (CML), Cache Coherent Interconnect for Accelerators (CCIX) Gateway (CXG), CHI C2C, or NVLink-C2C, that may include a CHI interface coupled to the coherent interconnect, enabling connectivity between the NVLink interface and the coherent interconnect, via the RPU. The gateway or interface logic may utilize a streaming interface protocol, such as Credited eXtensible Stream (CXS), to provide packing and un-packing of CHI C2C or an intermediate protocol over the streaming interface. The RPU may further include one or more request nodes (e.g., RN-I), home nodes (e.g., HN-I), optionally placed in the GW, that may enable DMA engines in the RPU to move blocks of data between the NVLink interface and the CHI interface. Examples of the gateway or interface logic include CCG, CML, CXG, CHI C2C, or NVLink-C2C.

FIG. 10B illustrates an example of an RPU that translates between NVLink traffic and CHI traffic. The RPU may further translate NVLink physical addresses to CHI physical addresses. The RPU utilizes a streaming interface protocol that may be based on ARM Advanced Microcontroller Bus Architecture (AMBA) Credited eXtensible Stream (CXS). Optionally, the RPU may utilize an intermediate protocol, such as CCIX, PCIe, or CXL, over the streaming interface protocol, and may translate from NVLink to intermediate protocol, and/or from the intermediate protocol to CHI. Optionally or alternatively, the RPU may include interfacing logic such as CHI C2C or NVLink-C2C, that may utilize a streaming interface protocol based on CXS.

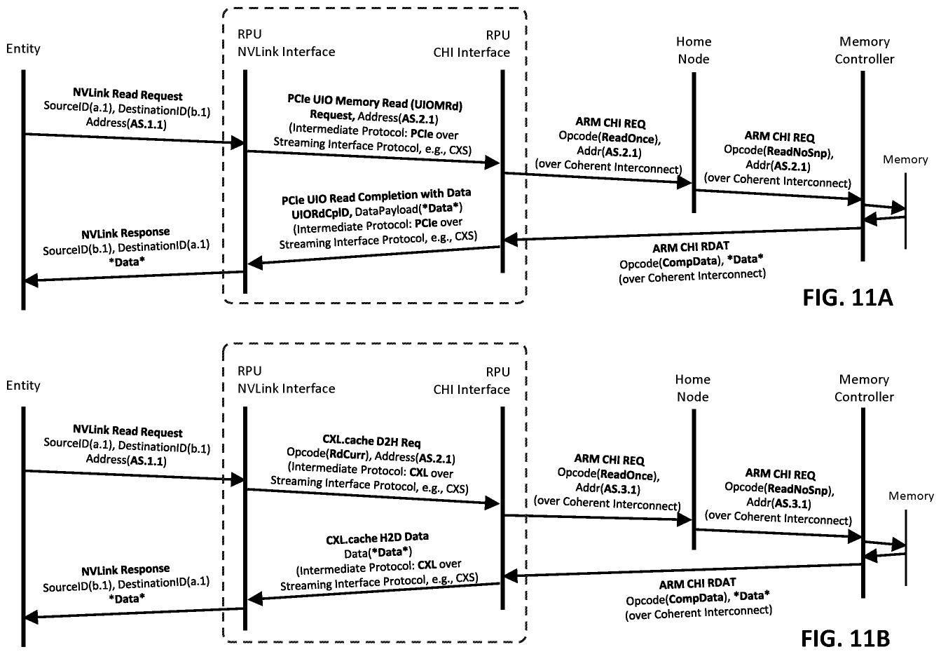

FIG. 11A illustrates an example of a TFD showing a read transaction from an entity such as a GPU to memory resources of an xPU or a memory pool, wherein an RPU provides translations between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.2.1), optionally utilizing one stage of address translation. The RPU may utilize a streaming interface protocol, such as CXS, and may utilize PCIe as an intermediate protocol over the CXS streaming interface protocol, translating from NVLink to the PCIe intermediate protocol, and/or from the PCIe intermediate protocol to CHI.

The entity/GPU initiates the transaction by sending an NVLink read request carrying a physical address (AS.1.1) to the RPU, which translates the NVLink read request to a PCIe UIO Memory Read request utilizing a UIOMRd TLP type, optionally translating the physical address (AS.1.1) carried in the NVLink read request to a different physical address (AS.2.1) carried in the UIOMRd TLP. The RPU further translates the PCIe UIO Memory Read request to an ARM CHI REQ carrying ReadOnce and a physical address (AS.2.1 in the illustrated example), which is sent via the coherent interconnect to the Home Node (HN). The Home Node processes the request and sends a subsequent ARM CHI REQ with ReadNoSnp and the physical address (AS.2.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to PCIe UIO Read Completion with Data, utilizing a UIORdCplD TLP type, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other TLP types such as MRd for a PCIe or CXL request, CplD for PCIe or CXL response, and other intermediate protocols such as CXL.mem or CXL.io.

FIG. 11B illustrates an example of a TFD showing a read transaction from an entity such as a GPU to memory resources of an xPU or a memory pool, wherein an RPU translates between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.3.1), optionally utilizing two stages of address translation with an intermediate address (AS.2.1) that may be associated with an intermediate protocol. The RPU utilizes a streaming interface protocol, such as CXS, and may utilize CXL as an intermediate protocol over the CXS streaming interface protocol, translating from NVLink to the CXL intermediate protocol, and/or from the CXL intermediate protocol to CHI.

The entity/GPU initiates the transaction by sending an NVLink read request carrying a physical address (AS.1.1) to the RPU, which translates the NVLink read request to a CXL.cache D2H request comprising RdCurr, optionally translating the physical address (AS.1.1) carried in the NVLink read request to a different physical address (AS.2.1) carried in the CXL.cache D2H request, wherein (AS.2.1) may be an intermediate address associated with the intermediate protocol. The RPU further translates the CXL.cache D2H request to an ARM CHI REQ carrying ReadOnce, optionally translating the physical address (AS.2.1) carried in the CXL.cache D2H request to a different physical address (AS.3.1), carried in the ARM CHI REQ, which is sent via the coherent interconnect to the Home Node (HN). The Home Node processes the request and sends a subsequent ARM CHI REQ with ReadNoSnp and the physical address (AS.3.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to CXL.cache H2D Data, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other opcodes, such as CXL.cache RdShared or CXL.cache RdAny, other TLP types such as MRd for a PCIe or CXL request, CplD for PCIe or CXL response, and other intermediate protocols such as CXL.mem or CXL.io.

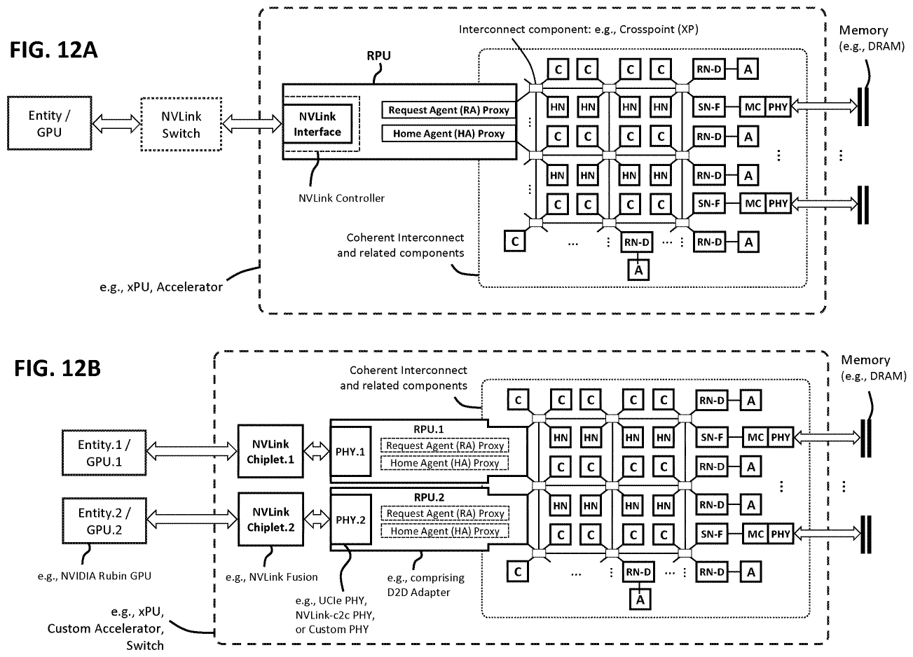

FIG. 12A illustrates an example of a system comprising an external entity coupled to an optional NVLink switch coupled to a processor comprising (such as an xPU) comprising an RPU comprising an NVLink interface, a Request Agent (RA) Proxy, and a Home Agent (HA) Proxy. The RPU may further comprise an NVLink controller, wherein the NVLink controller may include the NVLink interface. The RPU may be coupled to an interconnect component, such as a crosspoint (e.g., XP), optionally via the RA Proxy and/or the HA Proxy, wherein the RPU may communicate with the interconnect component according to a CHI-based protocol. The RPU may be further coupled, via the NVLink interface, and optionally via an NVLink switch, to an external entity, such as a GPU, wherein the RPU may communicate with the external entity according to an NVLink-based protocol. The RPU may translate between messages conforming to the NVLink-based protocol and messages conforming to the CHI-based protocol, possibly enabling the external entity to access resources of the xPU, such as xPU local memory (e.g., DRAM), and/or enabling the xPU to access resources of the external entity, such as remote memory coupled to the entity. The Request Agent (RA) proxy may receive requests that originate outside of the coherent interconnect, such as from remote agents, from the NVLink interface, from the NVLink controller, from an attached accelerator die, or from a remote chip, wherein the RA proxy may represent such remote initiators as a proxy when communicating with the coherent interconnect, e.g., by utilizing a Source ID (SrcID) namespace and a Transaction ID (TxnID) namespace associated with the coherent interconnect. The Home Agent (HA) proxy may own an address window backed by memory that may be placed on another chip or silicon die, such as on the external entity, wherein the HA proxy may enable processing cores of the xPU to access resources coupled to the external entity, such as memory (e.g., HBM and/or HBF).

FIG. 12B illustrates an example of a system comprising an xPU, such as a custom accelerator, that may utilize translations between NVLink and CHI, wherein the xPU may utilize NVLink for communicating with a first entity and with a second entity, which may each be a GPU external to the xPU, and wherein the xPU may further utilize CHI for intra-xPU communications between xPU resources coupled to a coherent interconnect of the xPU. The xPU may include first and second NVLink chiplets, or silicon dies, such as NVLink Fusion, coupled to the first and second entities, respectively. The first and second NVLink chiplets may be further coupled to first and second RPUs, respectively, via first and second physical layers (PHYs), respectively. The first and second RPUs may each include a Die-to-Die (D2D) adapter, a Request Agent (RA) Proxy, and/or a Home Agent (HA) proxy, wherein each RPU may communicate with the coherent interconnect, via the RA Proxy and/or the HA Proxy. The first and second PHYs may each include a UCIe PHY, an NVLink-C1C PHY, or a custom PHY.

The translations between NVLink and CHI may enable the first and/or the second entity to access resources coupled to the coherent interconnect of the xPU; and may further enable processing cores of the xPU to access resources coupled to the first and/or second entity. The translations between NVLink and CHI may further enable the xPU to perform as a switch, such as an NVLink switch, that may utilize NVLink to enable communication between the first entity and the second entity. The first entity may communicate with the second entity via the xPU, such as via the first NVLink chiplet, the first RPU, the coherent interconnect, the second RPU, and the second NVLink chiplet. Similarly, the second entity may communicate with the first entity via the xPU, such as via the second NVLink chiplet, the second RPU, the coherent interconnect, the first RPU, and the first NVLink chiplet.

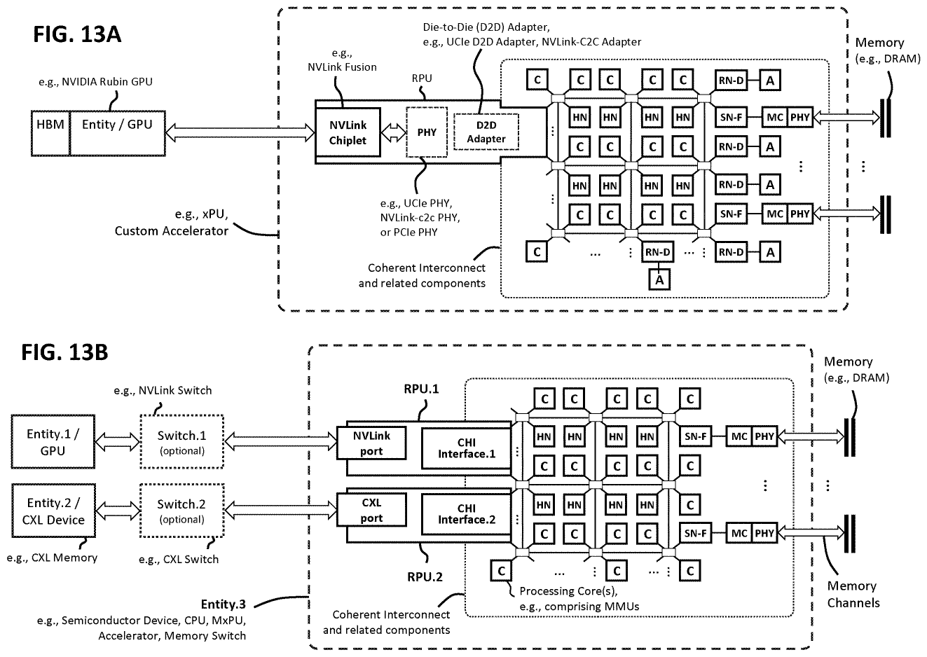

FIG. 13A illustrates an example of a system comprising an xPU comprising an RPU that translates between NVLink traffic and CHI traffic. The RPU may include a die-to-die (D2D) adapter, such as UCIe D2D adapter or NVLink-C1C adapter, which may perform at least one of: (1) Serve as an interfacing logic coupling the coherent interconnect and a die-to-die link; (2) Packetize CHI C2C into flits that can be streamed out to another chip or die, and correspondingly, handle de-packetization in the reverse direction; (3) Provide a CHI interface for connecting to an interconnect component such as a crosspoint (e.g., XP); or (4) Couple to a PHY such as a UCIe PHY, an NVLink-C1C PHY, or a PCIe PHY, for connecting to an NVLink chiplet, such as NVLink Fusion.

FIG. 13B illustrates an example of a system comprising a third entity (Entity.3), such as a semiconductor device, a CPU, an MxPU, an accelerator, or a memory switch, wherein the third entity may be coupled to a memory, such as DRAM, optionally via memory channels. The third entity may include a coherent interconnect, a first RPU (RPU.1) comprising an NVLink port and a first CHI interface (CHI Interface.1), and a second RPU (RPU.2) comprising a CXL port and a second CHI interface (CHI Interface.2). The third entity may be coupled, via the NVLink port and optionally via a first switch (Switch.1), such as an NVLink switch or an NVSwitch, to a first entity (Entity.1), such as a GPU, wherein the third entity may be further coupled, via the CXL port and optionally via a second switch (Switch.2), which may be a CXL switch, to a second entity (Entity.2), such as a CXL device (e.g., CXL memory). The third entity may utilize translations between NVLink and CHI that may enable the first entity to access the memory of the third entity, wherein the third entity may further utilize translations between CXL and CHI that may enable the second entity to access the memory of the third entity.

In some examples, the translations between NVLink and CHI, and the translations between CXL and CHI, may enable the third entity to perform as a switch, such as a multi-protocol switch or a hybrid switch, enabling communication between the first entity and the second entity, which may enable the GPU to utilize the CXL memory. For example, the first entity may communicate with the second entity via the third entity, such as via the first RPU comprising the NVLink port and the first CHI interface (CHI Interface.1), via the coherent interconnect, and via the second RPU that includes the CXL port and the second CHI interface (CHI Inetrface.2). In another example, the second entity may communicate with the first entity via the third entity, such as via the second RPU, the coherent interconnect, and the first RPU.

In some examples, the third entity may enable communication between the NVLink domain and the CXL domain, such as communication between NVLink ports and CXL ports, or communication between NVLink interfaces and CXL ports, whereas in other examples the communication between the NVLink domain and the CXL domain may be restricted, optionally by an access control list (ACL), such as to a subset of the NVLink ports and/or to a subset of the CXL ports. Additionally or alternatively, communication between the NVLink domain and the CXL domain may be restricted to a subset of allowed address regions associated with one or more address spaces, or may be restricted to a subset of allowed protocols, such as CXL.mem (e.g., not allowing CXL.cache transactions).

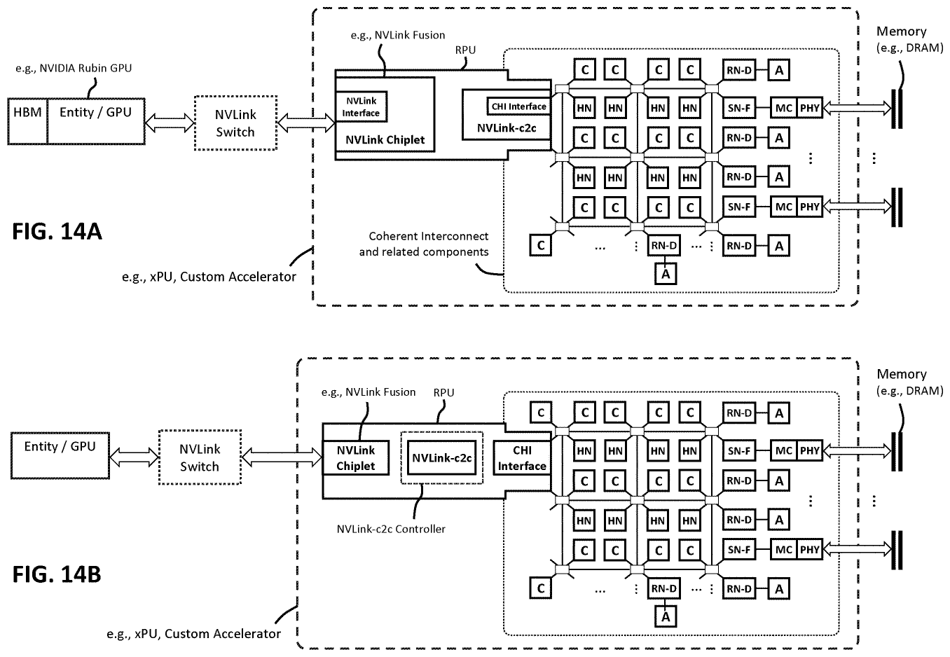

FIG. 14A illustrates an example of a system comprising an xPU or a custom accelerator, coupled to an entity such as a GPU, optionally via an NVLink switch. The xPU includes an RPU which translates between an NVLink traffic and CHI traffic. The RPU includes an NVLink chiplet, such as NVLink Fusion, that provides an NVLink interface for coupling to the external entity. The RPU further includes an NVLink-C1C for coupling the NVLink chiplet to the coherent interconnect, wherein the NVLink-C1C utilizes a CHI interface for connecting to at least one crosspoint of the coherent interconnect. The RPU may provide bi-directional memory access between the xPU and the GPU, enabling the xPU to read from the GPU's HBM, and enabling the GPU to read from DRAM coupled to the xPU. Alternatively, the RPU may provide unidirectional memory access, enabling the GPU to access xPU memory but not vice-versa, such as by exposing at least some of the xPU resources as a memory expander or a memory pool for use by the GPU.

FIG. 14B illustrates an example of a system comprising an xPU coupled to an entity such as a GPU. The xPU includes an RPU which translates between NVLink traffic and CHI-based traffic, wherein the RPU includes a CHI interface for coupling to a coherent interconnect, an NVLink-C1C logic, optionally integrated into an NVLink-C1C controller that includes a transactional layer, a data link layer and a physical layer. The RPU further includes an NVLink chiplet, such as NVLink Fusion, for coupling to the GPU, wherein the NVLink chiplet is further coupled to the coherent interconnect via the NVLink-C1C logic, optionally communicating with at least one crosspoint interconnect component according to a protocol based on ARM CHI.

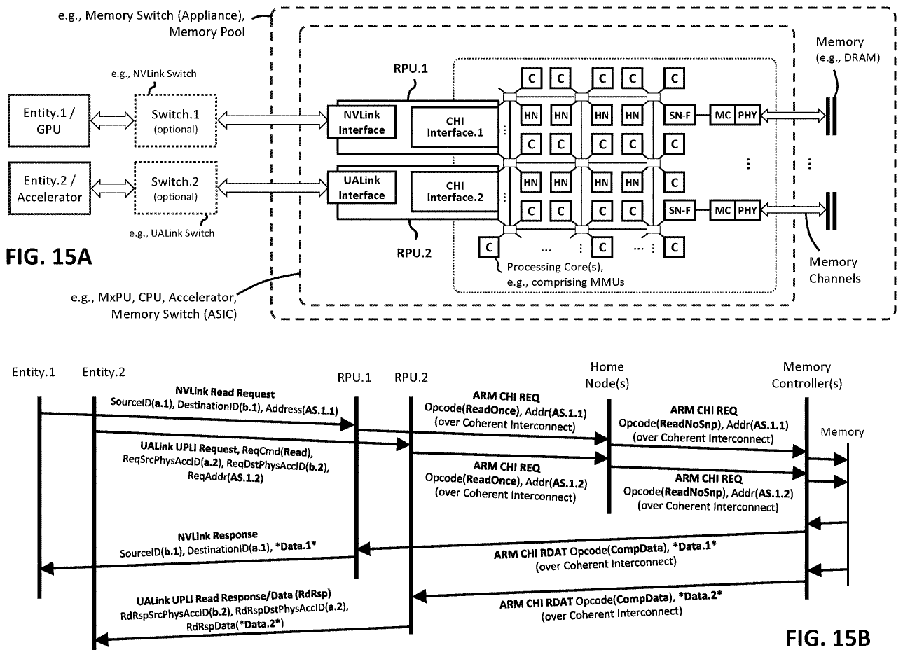

FIG. 15A illustrates an example of a system that may function as a multi-protocol memory switch appliance or a multi-protocol memory pool, and may include an MxPU, CPU, accelerator, or a memory switch ASIC, that may be coupled to two entities, optionally via switches: (1) Entity.1/GPU via an optional first switch (Switch.1), such as an NVLink switch or NVSwitch, and (2) Entity.2/Accelerator via an optional second switch (Switch.2), such as a UALink switch. The MxPU includes processing cores and memory controllers coupled to a coherent interconnect that may be based on CHI. The MxPU may utilize different translations for the external interfaces, performed by different RPUs, such as between NVLink-based interfaces and the MxPU coherent interconnect, or between UALink-based interfaces and the MxPU coherent interconnect. The first RPU (RPU.1) may enable Entity.1/GPU to access resources mapped to a physical address space utilized by the MxPU coherent interconnect, wherein the access is via the optional first switch, the NVLink interface and the MxPU coherent interconnect. Examples of resources mapped to the physical address space utilized by the MxPU coherent interconnect include DRAM or other memory resources of the MxPU. Correspondingly, the second RPU (RPU.2) may enable Entity.2/Accelerator to access, via the optional second switch, the UALink interface and the MxPU's coherent interconnect, resources mapped to a physical address space utilized by the MxPU's coherent interconnect, such as DRAM or other memory resources of the MxPU.

FIG. 15B illustrates an example of a TFD depicting a multi-entity memory access scenario wherein a GPU/first entity and an accelerator/second entity access memory mapped to one or more address spaces utilized by the coherent interconnect (CohInterMappedMemory) utilizing heterogeneous protocol message translations. Entity.1/GPU.1 initiates an NVLink request: Read with SourceID(a.1) to identify the source GPU, DestinationID(b.1) to identify the destination, and Address(AS.1.1) representing a physical address, such as an NVLink network address. RPU.1 translates the NVLink request to ARM CHI REQ carrying Opcode(ReadOnce) while preserving Addr(AS.1.1) unchanged. Concurrently or sequentially, Entity.2/Accelerator may initiate a UALink UPLI request (Req) with ReqCmd(Read), ReqSrcPhysAccID(a.2) to identify the source accelerator, ReqDstPhysAccID(b.2) to identify the destination, and ReqAddr(AS.1.2) representing a request address, such as a network physical address (NPA). RPU.2 translates the UALink UPLI request to ARM CHI REQ carrying Opcode(ReadOnce) while preserving Addr(AS.1.2) unchanged. Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and Data.1* for Entity.1/GPU. RPU.2 translates the second ARM CHI RDAT message to UALink UPLI read response/data (RdRsp) with RdRspSrcPhysAccID(b.2), RdRspDstPhysAccID(a.2), and RdRspData(*Data.2*) for Entity.2/Accelerator.

The illustrated example demonstrates how heterogeneous entities utilizing different protocols may share access to the same CohInterMappedMemory through different RPUs that translate messages between different protocols while preserving the physical addresses. Alternatively, the illustrated example may be viewed as separate NVLink and UALink transactions that utilize the same coherent interconnect infrastructure to access the CohInterMappedMemory. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

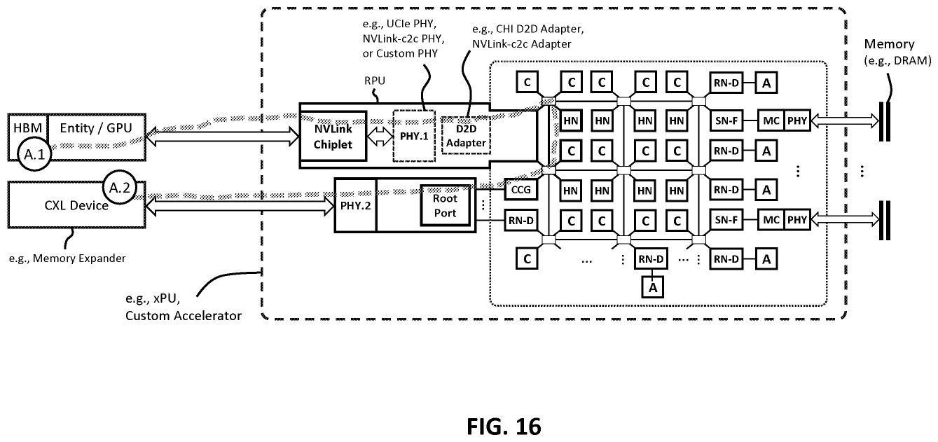

FIG. 16 illustrates an example of a heterogeneous computing system comprising an xPU or custom accelerator that utilizes an ARM-based mesh architecture with protocol interconnections. The xPU comprises a coherent interconnect implemented as a mesh topology with crosspoints (XP) that route transactions between various system components. Processing cores (C) are distributed throughout the mesh architecture and coupled to the coherent interconnect via the crosspoints. Home nodes are positioned within the mesh, optionally including HN-I nodes that may handle I/O-coherent transactions and HN-F nodes that may manage fully coherent transactions. System Node Fully coherent (SN-F) nodes are coupled to memory controllers (MC) which interface with external memory via physical layers (PHYs). The memory may be DRAM accessible through the memory channels. An entity comprising an NVIDIA Rubin GPU with integrated HBM is coupled to the xPU coherent interconnect via an NVLink chiplet. The NVLink chiplet, which may be an NVLink Fusion chiplet or custom PHY, is coupled utilizing a first physical layer (PHY.1, such as a UCIe PHY) to a die-to-die (D2D) adapter, which may be a CHI D2D Adapter or an NVLink-C1C Adapter, that enables communication between the NVLink chiplet and the coherent interconnect. The NVLink chiplet may provide the NVLink physical layer interface and may additionally provide higher protocol layers including the NVLink data link layer and transaction layer functionality.

Moreover, a CXL device, which may be a memory expander, may be coupled to the xPU coherent interconnect via a second physical layer (PHY.2) and a root port. The root port provides the interface between the CXL device and the coherent interconnect, enabling the CXL device to be discovered and configured by the system. The xPU architecture may enable the GPU to access memory resources of the CXL memory expander utilizing translations performed by the RPU and the coherent interconnect. The transaction path denoted as A.1 to A.2 in the figure illustrates a memory access flow that may represent an NVLink read transaction initiated by the GPU. The transaction may traverse from the GPU through the NVLink chiplet to the ARM mesh interconnect, wherein the RPU may translate the NVLink read request to a CHI transaction compatible with the ARM mesh interconnect. The CHI transaction may then be routed through the coherent interconnect to the appropriate home node and subsequently to the root port, wherein it may be further translated to a CXL.mem MemRd transaction for delivery to the CXL memory expander (A.2). The xPU may additionally comprise accelerator cores that may perform specialized computation tasks and may access both the GPU-attached HBM and the CXL-attached memory through the coherent interconnect.

In computing systems where NVLink-attached entities, such as accelerators/GPUs, require access to memory resources managed by a processor, an RPU may translate between NVLink-based traffic and CXL.cache traffic. The RPU may utilize CXL.cache as an intermediate protocol for reaching the processor's coherent interconnect, by presenting itself to a CXL host as a CXL endpoint and issuing CXL.cache D2H requests. The CXL host, which may be a CXL root port or another CXL-capable entity, may process the D2H requests and return data via CXL.cache H2D responses. The RPU may perform address translations between NVLink address spaces (such as GPU physical addresses or NVLink network addresses) and address spaces utilized by the CXL host (such as Host Physical Addresses), as well as Tag translations between NVLink Tags and CXL.cache CQIDs. In some examples, the RPU may split an NVLink-based request to multiple CXL.cache D2H requests when the requested data payload exceeds a cacheline size.

In various implementations, a method comprising: receiving, by a resource provisioning unit (RPU) from a first entity via an NVLink interface that communicates according to an NVLink-based protocol, an NVLink-based request comprising a first physical address; translating, by the RPU, the NVLink-based request to a CXL.cache Device-to-Host (D2H) request comprising an opcode and a second physical address, wherein CXL denotes Compute Express Link; sending, by the RPU, the CXL.cache D2H request to a second entity; receiving, by the RPU from the second entity, a CXL.cache Host-to-Device (H2D) response comprising data accessed via the second physical address; and sending, by the RPU, an NVLink-based response comprising the data to the first entity. The RPU may receive NVLink-based requests from various types of NVLink-attached entities, such as GPUs, accelerators, or NVLink switches, and may translate these requests to CXL.cache D2H requests directed at a CXL host. The second entity may include a CXL root port of a processor, a CXL switch, or another entity that processes CXL.cache D2H requests and returns CXL.cache H2D responses. The opcode in the CXL.cache D2H request may be selected based on the type of NVLink-based request, the caching policy of the RPU, and the coherency requirements of the access. The CXL.cache H2D response may include a Global Observation (GO) indication along with data, or may include data delivered via an H2D Data message. The RPU may aggregate data from one or more H2D responses or H2D Data messages before sending the NVLink-based response to the first entity.

In some implementations of the method, the second entity comprises a CXL root port (RP) coupled to a coherent interconnect of a processor, and the data is retrieved via the coherent interconnect from at least one of: a cache of the processor, a memory controller coupled to memory, or a CXL memory expander. The cache may include an LLC. The memory may include DRAM coupled to the memory controller via memory channels. The CXL memory expander may be coupled to a separate CXL port of the processor. The coherent interconnect may route the request to the appropriate resource based on address decoding.

In some implementations of the method, the CXL RP is coupled to the coherent interconnect via an interconnect interface, and the coherent interconnect utilizes a protocol selected from at least one of: ARM CHI, Intel UPI, or AMD Infinity Fabric. The interconnect interface may be a Ring-to-CXL (R2CXL) interface or a mesh-to-CXL interface that translates between the CXL protocol domain and the coherent interconnect protocol domain.

In some implementations of the method, the translating comprises translating an NVLink Tag carried in the NVLink-based request to a command queue identifier (CQID) carried in the CXL.cache D2H request, and maintaining a mapping between the NVLink Tag and the CQID for correlating the CXL.cache H2D response with the NVLink-based response. The mapping may be maintained in a translation table or tracker. The CQID may identify the RPU's tracker entry for the transaction. Upon receiving an H2D response carrying the CQID, the RPU may look up the corresponding NVLink Tag to route the response to the originating entity.

In some implementations of the method, the translating comprises translating the NVLink-based request to CXL.cache D2H requests when the NVLink-based request specifies a data payload larger than a cacheline, and wherein each of the CXL.cache D2H requests comprises an opcode selected from RdOwn or RdShared. NVLink-based requests may specify data payloads of up to 256 bytes, while CXL.cache D2H requests may operate on cacheline granularity, such as 64 bytes. The RPU may split an NVLink-based request to multiple D2H requests with consecutive addresses. RdOwn or RdShared may be selected based on the caching policy of the RPU.

In some implementations of the method, the translating comprises translating the first physical address from a GPU physical address or an NVLink network address to a Host Physical Address (HPA) carried as the second physical address in the CXL.cache D2H request. The address translation may be implemented utilizing address range registers, translation tables, page tables, or algorithmic mappings. The GPU physical address or NVLink network address may be utilized by the NVLink-attached entity for routing within the NVLink domain, while the HPA may be utilized by the CXL host for accessing memory resources.

In some implementations of the method, the RPU, the NVLink interface, and a CXL device are implemented in a chiplet within an integrated circuit (IC) package of a processor, and the second entity comprises a CXL root port (RP) of the processor. The chiplet may be an NVLink chiplet, or NVLink Fusion, coupled to other dies within the IC package via a chip-to-chip (C2C) interface, such as UCIe or NVLink-C2C. The CXL device may present as a CXL EP to the CXL RP of the processor.

In some implementations of the method, the RPU presents as a CXL endpoint (CXL EP) to the second entity, the CXL EP comprising a Type-1 CXL device or a Type-2 CXL device, and wherein the opcode of the CXL.cache D2H request comprises RdCurr. A Type-1 CXL device may support CXL.io and CXL.cache, enabling the RPU to issue D2H requests and receive H2D responses from the second entity. A Type-2 CXL device may additionally support CXL.mem, enabling the second entity to also access memory resources of the RPU via M2S requests in addition to cache coherency operations. The selection between Type-1 and Type-2 may depend on whether the RPU exposes memory resources to the second entity beyond cache coherency functionality.

In some implementations of the method, the opcode of the CXL.cache D2H request comprises RdCurr, and the data received via the CXL.cache H2D response is forwarded to the first entity without being cached by the RPU, whereby the RPU provides I/O-coherent access to resources accessible via the second entity. I/O-coherent access may be suitable for streaming or peer data transfers where cacheline residency at the RPU is not required and snoop filter overhead at the second entity is to be avoided. The RPU may forward data directly to the first entity upon receipt, without allocating cache entries, maintaining coherency state, or participating in snoop exchanges beyond those inherent to the RdCurr transaction.

In some implementations of the method, the RPU comprises a cache, the opcode of the CXL.cache D2H request is selected from RdOwn, RdShared, or RdAny, and the data received via the CXL.cache H2D response is stored in the cache of the RPU; and further comprising receiving, by the RPU from the second entity, a CXL.cache H2D request comprising a snoop opcode targeting a cacheline stored in the cache, and sending, by the RPU, a CXL.cache D2H response to the second entity. The RPU cache may reduce cross-protocol round trips by serving subsequent requests from cached data. RdOwn may request exclusive ownership, RdShared may request shared state, and RdAny may allow the host to determine the state. The snoop opcode may include SnpData, SnpInv, or SnpCur. The D2H response may include RspIHitI, RspIHitSE, RspSHitSE, RspVHitV, RspSFwdM, RspIFwdM, or RspVFwdV based on the cache state and the snoop type. When the D2H response includes a data-forwarding opcode such as RspSFwdM, RspIFwdM, or RspVFwdV, the RPU may also send a CXL.cache D2H Data comprising the cached data.

In some implementations of the method, a non-transitory computer-readable medium comprising instructions which, when executed by a processor, cause the processor to perform the method. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

The following system may include a processor with a CXL root port coupled to a coherent interconnect, and an RPU comprising an NVLink interface and a CXL EP. The RPU may translate between NVLink-based requests and CXL.cache D2H requests, enabling NVLink-attached entities to access processor memory resources via the coherent interconnect. The CXL EP may present the RPU to the CXL RP as a CXL device, such as a Type-1 or Type-2 CXL device. The processor may include processing cores, caches, and memory controllers coupled to the coherent interconnect. In some examples, the RPU and NVLink interface may reside on a separate silicon die or chiplet within the processor's IC package.

In various implementations, a system comprising: a processor comprising a Compute Express Link (CXL) root port (RP), a coherent interconnect, and memory controllers; wherein the memory controllers are coupled to the coherent interconnect and coupled to memory; a resource provisioning unit (RPU) comprising: an NVLink interface configured to communicate with an entity according to an NVLink-based protocol, and a CXL endpoint (CXL EP) coupled to the CXL RP; and wherein the RPU is configured to translate between NVLink-based requests received via the NVLink interface and CXL.cache Device-to-Host (D2H) requests sent to the CXL RP, to enable the entity to access memory resources via the coherent interconnect. The system may be implemented as a monolithic processor die, as chiplets within an IC package, or as components on a board. The CXL RP may process the CXL.cache D2H requests and access memory resources via the coherent interconnect, such as from DRAM coupled to the memory controllers, from a cache of the processor, or from a CXL memory expander coupled to a separate CXL port. The RPU may perform address translations between NVLink address spaces and Host Physical Addresses, Tag translations between NVLink Tags and CXL.cache CQIDs, and opcode translations between NVLink request types and CXL.cache D2H opcodes. The entity may include a GPU, an accelerator, or an NVLink switch.

In some implementations of the system, the CXL EP comprises a Type-1 CXL device or a Type-2 CXL device, and the coherent interconnect utilizes a protocol selected from at least one of: ARM CHI, Intel UPI, or AMD Infinity Fabric. A Type-1 CXL device may support CXL.io and CXL.cache. A Type-2 CXL device may additionally support CXL.mem. The coherent interconnect protocol may determine how the CXL RP communicates with processing cores, caches, and memory controllers within the processor.

In some implementations, the system further comprises processing cores and a last level cache (LLC) coupled to the coherent interconnect, and wherein the CXL RP is coupled to the coherent interconnect via an interconnect interface. The interconnect interface may be a Ring-to-CXL (R2CXL) interface or a mesh-to-CXL interface. The processing cores and LLC may be implemented as distributed slices coupled to the coherent interconnect. The CXL.cache D2H requests from the RPU may be served by the LLC on a cache hit, avoiding access to DRAM.

In some implementations of the system, the RPU, the NVLink interface, and the CXL EP are on a first silicon die, and the CXL RP and the coherent interconnect are on a second silicon die, the first and second silicon dies within an IC package. The first silicon die may be an NVLink chiplet, such as NVLink Fusion, coupled to the second silicon die via a chip-to-chip (C2C) interface, such as UCIe or NVLink-C2C.

In some implementations of the system, the RPU is further configured to translate CXL.cache Host-to-Device (H2D) requests received from the CXL RP to NVLink-based requests sent to the entity via the NVLink interface, enabling the processor to access resources of the entity. The translation may enable the processor's cores to access memory or resources coupled to the NVLink-attached entity, such as GPU memory. The RPU may maintain separate translation contexts for inbound (NVLink-to-CXL.cache) and outbound (CXL.cache-to-NVLink) traffic.

In some implementations, a computer may translate CXL.cache H2D requests, such as snoops, to NVLink-based requests targeting NVLink-attached entities. This translation may enable a CXL host, such as a processor, to access resources coupled to NVLink-attached entities, such as GPU memory or accelerator memory, by issuing CXL.cache H2D requests that the computer translates to NVLink-based requests. The computer may translate UQIDs carried in H2D requests to NVLink Tags, perform address translations between Host Physical Addresses and NVLink or GPU physical addresses, and generate CXL.cache D2H response and D2H Data messages from NVLink-based responses. The computer may be implemented in a switch, a bridge, a semiconductor device, a chiplet, or an active cable.

In various implementations, a method comprising: receiving, by a computer from a first entity, a CXL.cache Host-to-Device (H2D) request comprising an opcode and a first address, wherein CXL denotes Compute Express Link; translating, by the computer, the CXL.cache H2D request to an NVLink-based request comprising a second physical address; sending, by the computer via an NVLink interface that communicates according to an NVLink-based protocol, the NVLink-based request to a second entity; receiving, by the computer from the second entity, an NVLink-based response; and translating, by the computer, the NVLink-based response to one or more CXL.cache Device-to-Host (D2H) messages, and sending the one or more CXL.cache D2H messages to the first entity. The first entity may be a CXL host, such as a processor comprising a CXL root port, or another entity that issues CXL.cache H2D requests. The second entity may be a GPU, an accelerator, or an NVLink switch that processes NVLink-based requests and returns NVLink-based responses. The opcode in the H2D request may include a snoop opcode, such as SnpData, SnpInv, or SnpCur, and the computer may generate an appropriate NVLink-based request type based on the snoop intent. The one or more CXL.cache D2H messages may include a CXL.cache D2H response, a CXL.cache D2H Data, or both, depending on whether data return is indicated by the snoop type and the NVLink-based response.

In some implementations of the method, the translating of the CXL.cache H2D request comprises translating a Unique Queue ID (UQID) carried in the CXL.cache H2D request to an NVLink Tag carried in the NVLink-based request, and maintaining a mapping between the UQID and the NVLink Tag for correlating the NVLink-based response with the one or more CXL.cache D2H messages. The UQID may identify the host entry that originated the H2D request. Upon receiving the NVLink-based response, the computer may look up the mapping to recover the UQID for inclusion in the D2H response and D2H Data messages.

In some implementations of the method, the opcode of the CXL.cache H2D request comprises a snoop opcode selected from SnpData, SnpInv, or SnpCur, the NVLink-based request comprises a read or invalidation request type corresponding to the snoop opcode, the first entity comprises a CXL host, and the second entity comprises a GPU, an NVLink switch, or an accelerator. SnpData may be translated to an NVLink read with data return. SnpInv may be translated to an NVLink invalidation or read for exclusive ownership. SnpCur may be translated to an NVLink read without cache state change. The NVLink request type may be selected based on the snoop intent.

In some implementations of the method, the NVLink-based response comprises data, and the one or more CXL.cache D2H messages comprise a CXL.cache D2H response comprising a snoop response opcode and a Unique Queue ID (UQID), and a CXL.cache D2H Data comprising the data and the UQID. The snoop response opcode may include RspSFwdM, RspIFwdM, or RspVFwdV, indicating data forwarding with the corresponding cache state transition. The UQID in both the D2H response and D2H Data may be reflected from the H2D request to enable the first entity to correlate the response with the originating snoop.

In some implementations, the method further comprises issuing, by the computer via the NVLink interface, additional NVLink-based requests to the second entity as prefetch requests based on a detected access pattern of CXL.cache H2D requests received from the first entity. The computer may detect sequential, strided, or other access patterns from the addresses in the H2D requests and may issue speculative NVLink-based requests to reduce latency for subsequent H2D requests. Prefetched data may be stored in a local buffer or cache of the computer.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface communicating according to CXL.cache with a first entity and a second interface communicating according to an NVLink-based protocol with a second entity, with a computer coupled between the two interfaces. The computer may translate CXL.cache H2D requests to NVLink-based requests and NVLink-based responses to CXL.cache D2H messages, enabling the first entity to access resources of the second entity across the protocol boundary. The computer may be included in a switch, a bridge, or a standalone semiconductor device, and may further support bidirectional translation.

In various implementations, a system comprising: a first interface configured to communicate according to CXL.cache with a first entity, wherein CXL denotes Compute Express Link; a second interface configured to communicate according to an NVLink-based protocol with a second entity; and a computer coupled between the first and second interfaces, configured to translate CXL.cache Host-to-Device (H2D) requests received via the first interface to NVLink-based requests transmitted via the second interface, and to translate NVLink-based responses received via the second interface to CXL.cache Device-to-Host (D2H) messages transmitted via the first interface. The first entity may be a CXL host, such as a processor, and the second entity may be a GPU, an accelerator, or an NVLink switch. The computer may perform address translations, transaction identifier translations, and opcode translations between the CXL.cache and NVLink protocol domains. The CXL.cache D2H messages may include D2H responses, D2H Data, or both. The system may be implemented in an IC package, on a PCB, or integrated into a cable form factor.

In some implementations of the system, the CXL.cache D2H messages comprise a CXL.cache D2H response comprising an opcode selected from RspSFwdM, RspIFwdM, or RspVFwdV, and a CXL.cache D2H Data comprising data sourced from a memory or a cache of the second entity. The selection of the D2H response opcode may depend on the snoop type in the H2D request and the data returned by the second entity. The memory of the second entity may include HBM, HBF, or DRAM. The cache of the second entity may include an L2 cache or an LLC of a GPU or accelerator.

In some implementations of the system, the computer is configured to translate Host Physical Addresses (HPAs) carried in the CXL.cache H2D requests to NVLink network addresses or GPU physical addresses carried in the NVLink-based requests. The address translation may be implemented utilizing address range registers, translation tables, or algorithmic mappings. HPAs may be utilized by the first entity, such as a processor, and NVLink network addresses or GPU physical addresses may be utilized for routing within the NVLink domain.

In some implementations of the system, the computer is included in a switch or a bridge, and the computer is further configured to translate NVLink-based requests received via the second interface to CXL.cache D2H requests transmitted via the first interface, enabling the second entity to access resources coupled to the first entity. The translation may enable both the first entity to access resources of the second entity and the second entity to access resources of the first entity through the same switch or bridge. The switch may be an NVLink switch or a CXL switch.

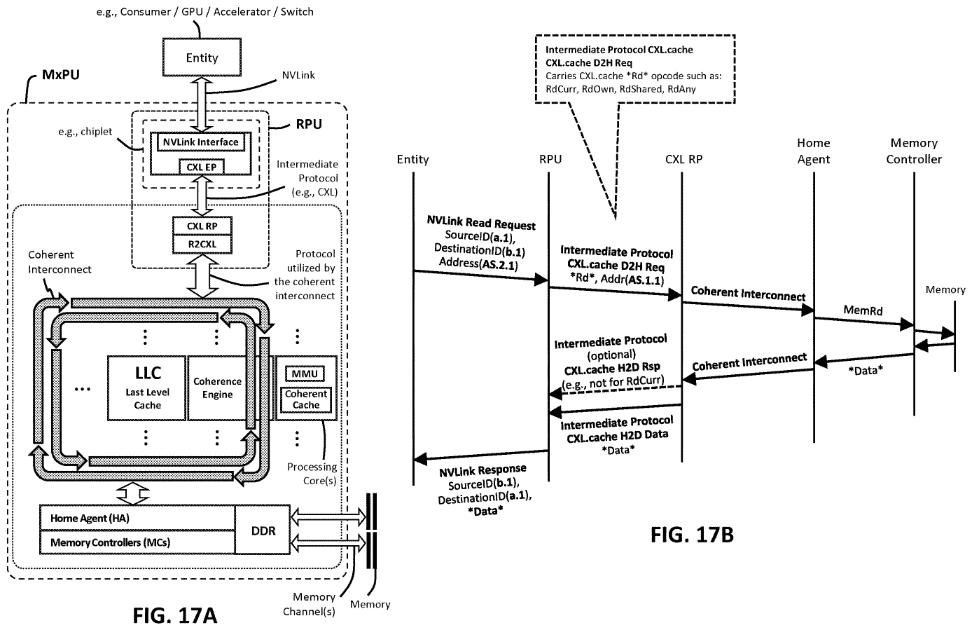

FIG. 17A illustrates an example of a system comprising a processor (such as an MxPU) comprising processing cores, LLC, a CXL RP, and memory controllers coupled via memory channels to memory, such as DRAM. The processor may include a coherent interconnect, such as a ring or mesh interconnect. The coherent interconnect may couple the processing cores, the LLC, and the memory controllers, and may further couple a coherence engine. The processing cores may each include an MMU and a coherent cache. The CXL RP may be coupled to the coherent interconnect via a Ring-to-CXL (R2CXL) interconnect interface that may communicate with the coherent interconnect according to a protocol utilized by the coherent interconnect, such as ARM CHI, Intel UPI, or AMD Infinity Fabric. A Home Agent (HA) may be coupled to the memory controllers, and the memory controllers may communicate with the memory via DDR memory channels.

An RPU, which may be included in the processor, may perform physical address translations that may enable an entity, such as a GPU, an accelerator, or a switch, to access the memory. The processor may expose to the entity, optionally via the RPU, an NVLink interface that may communicate with the entity according to an NVLink-based protocol. The RPU may further perform translations, such as from NVLink to a protocol utilized by the coherent interconnect, wherein the RPU may utilize an intermediate protocol, such as CXL (e.g., CXL.cache), to provide the translations. The RPU may expose to the processor, via the CXL RP, a CXL device utilizing a CXL endpoint (CXL EP), such as a Type-1 CXL device or a Type-2 CXL device. The R2CXL interconnect interface, that may reside in the RPU or between the RPU and the coherent interconnect, may couple the CXL RP to the coherent interconnect and complete the translation path from NVLink, via the intermediate protocol, to traffic based on the protocol utilized by the coherent interconnect. In some examples, the RPU, the NVLink interface, and the CXL device (e.g., CXL EP) may be implemented in a chiplet, such as an NVLink chiplet or NVLink Fusion, inside an IC package of the processor. In other examples, the RPU, the NVLink interface, and the CXL device may be implemented as functional blocks on the same die with the CXL RP of the processor, or split between silicon dies or chiplets inside the IC package of the processor.

FIG. 17B illustrates an example of a TFD demonstrating an NVLink read request received from an entity (such as a consumer, GPU, accelerator, or a switch), wherein the RPU may translate the NVLink read request to traffic conforming to a protocol utilized by the processor's coherent interconnect, utilizing CXL.cache as an intermediate protocol. The entity may send an NVLink request, such as an NVLink read request, comprising SourceID(a.1), DestinationID(b.1), and Address(AS.2.1), to the RPU. The RPU may translate the physical address (AS.2.1) carried in the NVLink request to a physical address (AS.1.1) utilized for accessing the memory. The RPU may perform further translations, such as opcode translations and Tag translations, e.g., translating from NVLink Tags to CXL.cache CQIDs. The RPU may generate a CXL.cache D2H request carrying the translated address (AS.1.1) and a CXL.cache read opcode (*Rd*) which indicates that the CXL.cache D2H request may carry an opcode such as RdCurr, RdOwn, RdShared, or RdAny. The CXL.cache D2H request is sent to the CXL RP for further processing. The CXL RP may communicate with a Home Agent via the coherent interconnect, and the Home Agent may issue a MemRd to a memory controller to retrieve data (*Data*) from the memory. The data may return over the coherent interconnect to the CXL RP, which may send an optional CXL.cache H2D response (when the opcode is not RdCurr) and a CXL.cache H2D Data comprising *Data* to the RPU. The RPU may then send an NVLink response comprising SourceID(b.1), DestinationID(a.1), and *Data* to the requesting entity. In some examples, the data may be provided by an LLC of the processor over the coherent interconnect, instead of by the memory via the memory controller.

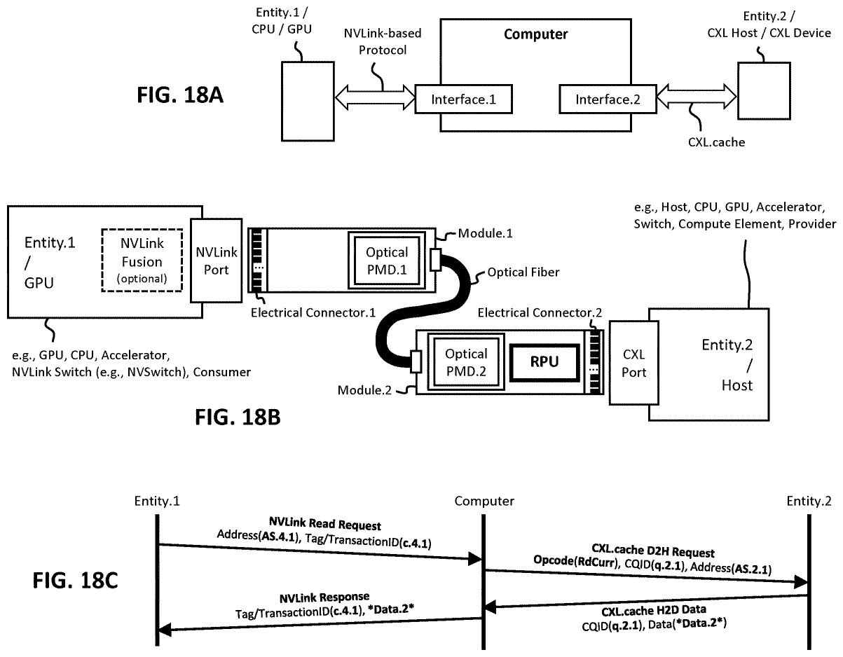

FIG. 18A illustrates an example of a system comprising a computer coupled between a first interface (Interface.1) communicating according to an NVLink-based protocol with a first entity (Entity.1), and a second interface (Interface.2) communicating according to CXL.cache with a second entity (Entity.2). The first entity may be a CPU or a GPU. The second entity may be a CXL host or a CXL device. The computer may extract addresses from requests received via either the first interface or the second interface, translate the addresses, and generate requests carrying the translated addresses for transmission via the other interface. In one direction, the computer may translate NVLink-based requests from the first entity to CXL.cache requests sent to the second entity. In the other direction, the computer may translate CXL.cache requests from the second entity to NVLink-based requests sent to the first entity. The addresses carried in NVLink-based requests may refer to a first address space, such as an NVLink-based address space, an NVLink-based network address space, or a GPU address space utilized by the first entity. The translated addresses carried in CXL.cache requests may refer to a second address space utilized by the second entity, such as a Host Physical Address (HPA) space.

FIG. 18B illustrates an example of a cable comprising an NVLink port and a CXL port, with an RPU integrated into the cable. The cable couples a first entity (Entity.1), such as a GPU, CPU, accelerator, NVLink switch (e.g., NVSwitch), or consumer, to a second entity (Entity.2), such as a host, CPU, GPU, accelerator, switch, compute element, or provider. The first entity may include an NVLink Fusion chiplet or IP block (optional) coupled to an NVLink port. The second entity may include a CXL port. The cable may include a first module (Module.1) including an optical physical medium dependent (Optical PMD.1) sublayer, and a second module (Module.2) including an optical physical medium dependent (Optical PMD.2) sublayer and an RPU. The first module may be coupled to the first entity via a first electrical connector (Electrical Connector.1) and the second module may be coupled to the second entity via a second electrical connector (Electrical Connector.2). An optical fiber may couple the first module to the second module. The RPU may translate between messages conforming to the NVLink-based protocol utilized by the first entity and messages conforming to CXL.cache utilized by the second entity. In the illustrated example, the RPU is placed in Module.2 closer to the CXL port. CXL, which runs over PCIe electricals, is designed as a shorter-reach interface, while some versions of NVLink incorporate electrical signaling characteristics designed for longer-reach interconnects. Placing the RPU closer to the CXL port may improve signal integrity and may allow for reducing the number of optical fibers or copper wires between the modules, since NVLink may utilize a higher signaling rate than CXL and therefore may require fewer lanes for the same bandwidth.

FIG. 18C illustrates an example of a TFD demonstrating translations performed by a computer between NVLink-based requests and CXL.cache requests. A first entity (Entity.1), which may be a CPU or a GPU, may initiate an NVLink request, such as an NVLink read request, comprising Address(AS.4.1) and Tag/TransactionID(c.4.1). The, wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.cache D2H request comprising Opcode(RdCurr), CQID(q.2.1), and Address(AS.2.1), and may send the CXL.cache D2H request to a second entity (Entity.2), which may be a CXL host. The computer may translate the physical address (AS.4.1) carried in the NVLink request to a physical address (AS.2.1) carried in the CXL.cache D2H request, and may translate the NVLink Tag/TransactionID(c.4.1) to a CXL.cache CQID(q.2.1). Upon receiving one or more responses from the second entity, which may include a CXL.cache H2D Data comprising CQID(q.2.1) and Data(*Data.2*), the computer may translate the one or more responses to an NVLink response comprising Tag/TransactionID(c.4.1) and *Data.2*, and send the NVLink response to the first entity. In some examples, the computer may issue multiple CXL.cache D2H requests in response to receiving an NVLink request from the first entity, such as when splitting an NVLink request for a large block of data (e.g., 256 bytes) to smaller CXL.cache D2H requests (e.g., 64 bytes each), or when prefetching data from the second entity utilizing CXL.cache reads.

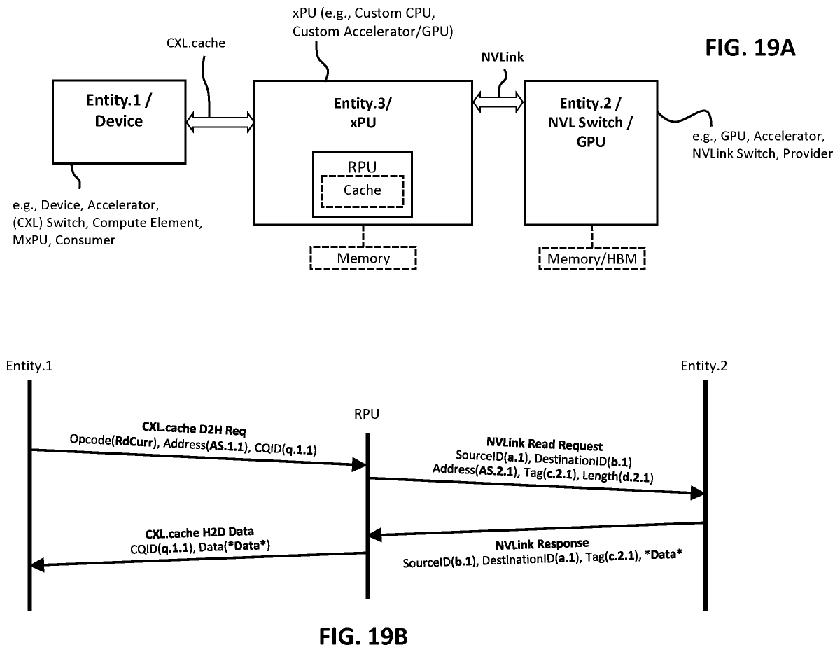

FIG. 19A illustrates an example of a system comprising an xPU (Entity.3), such as a custom CPU or a custom accelerator/GPU, coupled between a first entity (Entity.1) via CXL.cache and a second entity (Entity.2) via NVLink. Entity.1 may be a device, an accelerator, a CXL switch, a compute element, an MxPU, or a consumer. Entity.2 may be a GPU, an accelerator, an NVLink switch, or a provider. The xPU may include an RPU with an optional cache and an optional memory coupled to the RPU. The RPU may translate CXL.cache D2H requests received from Entity.1 to NVLink read requests sent to Entity.2, and may translate NVLink responses to CXL.cache H2D messages returned to Entity.1. Entity.2 may include Memory/HBM accessible via NVLink.

FIG. 19B illustrates an example of a TFD demonstrating translation of a CXL.cache D2H request to an NVLink read request. Entity.1 sends a CXL.cache D2H Req comprising Opcode(RdCurr), Address(AS.1.1), and CQID(q.1.1) to the RPU. The RPU translates the D2H request to an NVLink Read Request comprising SourceID(a.1), DestinationID(b.1), Address(AS.2.1), Tag(c.2.1), and Length(d.2.1), and sends the NVLink Read Request to Entity.2. Entity.2 returns an NVLink Response comprising SourceID(b.1), DestinationID(a.1), Tag(c.2.1), and *Data*. The RPU translates the NVLink Response to a CXL.cache H2D Data comprising CQID(q.1.1) and Data(*Data*), and sends the H2D Data to Entity.1. Because the opcode is RdCurr, no CXL.cache H2D Response (GO) is sent.

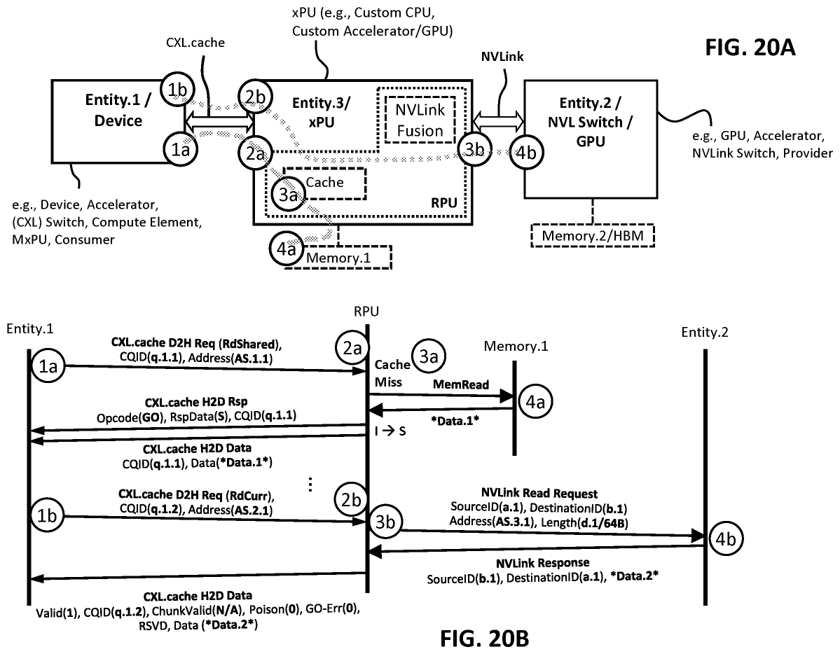

FIG. 20A illustrates an example of a system comprising an xPU (Entity.3), such as a custom CPU or a custom accelerator/GPU, coupled between Entity.1 via CXL.cache and Entity.2 via NVLink. The xPU may include an optional NVLink Fusion chiplet, an RPU with a cache, and a local memory (Memory.1). Entity.1 may be a device, an accelerator, a CXL switch, a compute element, an MxPU, or a consumer. Entity.2 may be a GPU, an accelerator, an NVLink switch, or a provider. Entity.2 may include Memory.2/HBM. The figure illustrates two access paths for CXL.cache D2H requests from Entity.1. A first path (1a, 2a, 3a, 4a) routes a D2H request from Entity.1 to the RPU, through the cache, and to Memory.1 of the xPU. A second path (1b, 2b, 3b, 4b) routes a D2H request from Entity.1 to the RPU, through NVLink, to Entity.2 and its Memory.2/HBM.

FIG. 20B illustrates an example of a TFD demonstrating two CXL.cache D2H request flows processed by an RPU with a cache. In a first flow, Entity.1 sends a CXL.cache D2H Req comprising Opcode(RdShared), CQID(q.1.1), and Address(AS.1.1) to the RPU (step 1a). The RPU performs a cache lookup (step 2a), which results in a cache miss. The RPU issues a MemRead to Memory.1 (step 3a), and Memory.1 returns *Data.1* (step 4a). The RPU stores *Data.1* in the cache and transitions the cache state from Invalid (I) to Shared(S). The RPU sends to Entity.1 a CXL.cache H2D Rsp comprising Opcode(GO) with RspData indicating Shared state and CQID(q.1.1), followed by a CXL.cache H2D Data comprising CQID(q.1.1) and Data(*Data.1*). In a second flow, Entity.1 sends a CXL.cache D2H Req comprising Opcode(RdCurr), CQID(q.1.2), and Address(AS.2.1) to the RPU (step 1b). The RPU translates the D2H request to an NVLink Read Request comprising SourceID(a.1), DestinationID(b.1), Address(AS.3.1), and Length(d.1/64B), and sends the NVLink Read Request to Entity.2 (steps 2b, 3b). Entity.2 returns an NVLink Response comprising SourceID(b.1), DestinationID(a.1), and *Data.2* (step 4b). The RPU translates the NVLink Response to a CXL.cache H2D Data comprising Valid(1), CQID(q.1.2), ChunkValid(N/A), Poison(0), GO-Err(0), RSVD, and Data(*Data.2*), and sends the H2D Data to Entity.1. Because the opcode is RdCurr, no CXL.cache H2D Response (GO) is sent, and the data is not cached by the RPU.

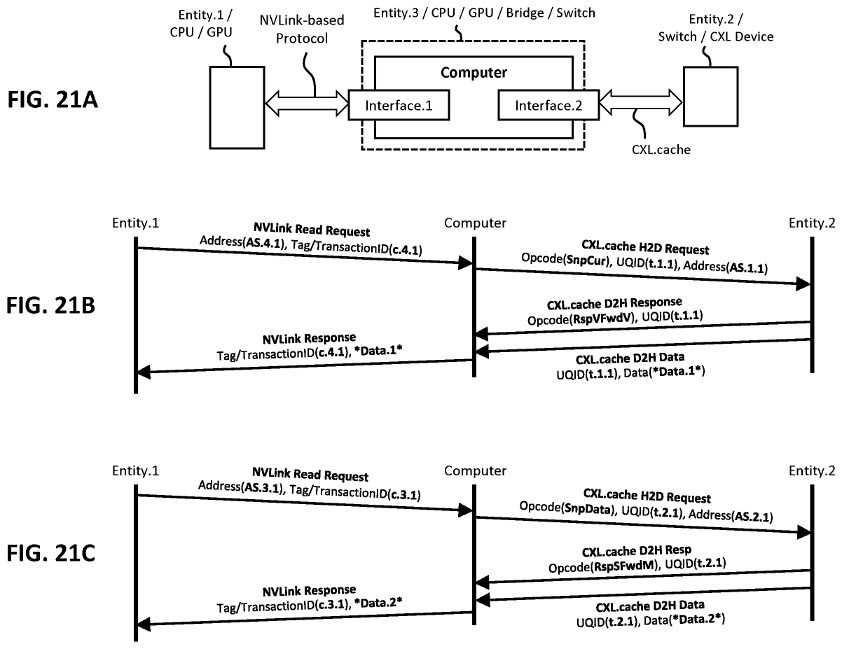

FIG. 21A illustrates an example of a system comprising a computer (Entity.3), such as a CPU, GPU, bridge, or switch, coupled between a first entity (Entity.1) via an NVLink-based protocol and a second entity (Entity.2) via CXL.cache. Entity.1 may be a CPU or a GPU. Entity.2 may be a switch or a CXL device. The computer may include a first interface (Interface.1) communicating according to the NVLink-based protocol and a second interface (Interface.2) communicating according to CXL.cache. The computer may translate NVLink read requests received from Entity.1 to CXL.cache H2D requests sent to Entity.2, and may translate CXL.cache D2H messages received from Entity.2 to NVLink responses sent to Entity.1.

FIG. 21B illustrates an example of a TFD demonstrating translation of an NVLink read request to a CXL.cache H2D request comprising SnpCur. Entity.1 sends an NVLink Read Request comprising Address(AS.4.1) and Tag/TransactionID(c.4.1) to the computer. The computer translates the NVLink Read Request to a CXL.cache H2D request comprising Opcode(SnpCur), UQID(t.1.1), and Address(AS.1.1), and sends the H2D request to Entity.2. Entity.2 returns a CXL.cache D2H Response comprising Opcode(RspVFwdV) and UQID(t.1.1), and a CXL.cache D2H Data comprising UQID(t.1.1) and Data(*Data.1*). The computer translates the D2H messages to an NVLink Response comprising Tag/TransactionID(c.4.1) and *Data.1*, and sends the NVLink Response to Entity.1. RspVFwdV indicates that the data is returned without changing cache state at Entity.2.

FIG. 21C illustrates an example of a TFD demonstrating translation of an NVLink read request to a CXL.cache H2D request comprising SnpData. Entity.1 sends an NVLink Read Request comprising Address(AS.3.1) and Tag/TransactionID(c.3.1) to the computer. The computer translates the NVLink Read Request to a CXL.cache H2D request comprising Opcode(SnpData), UQID(t.2.1), and Address(AS.2.1), and sends the H2D request to Entity.2. Entity.2 returns a CXL.cache D2H Resp comprising Opcode(RspSFwdM) and UQID(t.2.1), and a CXL.cache D2H Data comprising UQID(t.2.1) and Data(*Data.2*). The computer translates the D2H messages to an NVLink Response comprising Tag/TransactionID(c.3.1) and *Data.2*, and sends the NVLink Response to Entity.1. RspSFwdM indicates that the cacheline was in Modified state at Entity.2 and has been downgraded to Shared state, with the data forwarded.

In heterogeneous computing architectures, NVLink-based entities such as GPUs, accelerators, and NVLink switches may need to access resources coupled to CXL-based entities such as CXL hosts, CXL devices, CXL switches, or CXL-attached memory pools. NVLink-based protocols and CXL.io utilize different message formats, addressing schemes, and transaction semantics. NVLink-based requests may carry NVLink-based network addresses or GPU physical addresses within a first address space, while CXL.io requests may carry Host Physical Addresses (HPAs) within a second address space. A computer, which may be implemented as a processor, a switch, an RPU, a semiconductor device, a chiplet, an active cable, or other suitable device, may be positioned between an NVLink-based interface and a CXL.io interface to translate between these incompatible protocol domains. The computer may translate addresses, Tags, opcodes, and other fields, and may propagate QoS telemetry information carried in CDL fields of CXL.io UIO completions. The translation may be performed in one direction from NVLink to CXL.io, in the reverse direction from CXL.io to NVLink, or bidirectionally. In the reverse direction, the computer may generate CDL values in CXL.io UIO completions based on load or congestion information observed at the NVLink domain, even when the NVLink-based protocol does not natively carry CDL. Such CDL generation by a host-side entity may extend QoS telemetry capabilities beyond what CXL specifications define for CXL devices alone.

In various implementations, a method comprising: receiving, by a computer from a first entity via a first interface, an NVLink-based request comprising a first physical address; translating, by the computer, the NVLink-based request to a CXL.io request comprising a read-class Transaction Layer Packet (TLP) type and a second physical address, wherein CXL denotes Compute Express Link; sending, by the computer via a second interface, the CXL.io request to a second entity; receiving, by the computer from the second entity, a CXL.io completion comprising data and a Tag; translating, by the computer, the CXL.io completion to an NVLink-based response; and sending the NVLink-based response comprising the data to the first entity. The method may enable an NVLink-based entity, such as a GPU, an accelerator, or an NVLink switch, to access resources coupled to a CXL-based entity, such as a CXL host, a CXL device, a CXL switch, or a CXL-attached memory pool, by translating NVLink-based requests to CXL.io requests and translating CXL.io completions to NVLink-based responses. The computer may be a processor, a switch, an RPU, an active cable, or a semiconductor device positioned between the first entity and the second entity. The first interface may communicate according to an NVLink-based protocol, and the second interface may communicate according to CXL.io. The NVLink-based request may be an NVLink read request comprising fields such as SourceID, DestinationID, Address, Tag, and Length. The computer may translate the NVLink-based request to a CXL.io request comprising a read-class TLP type, which may be either a standard Memory Read (MRd) or a UIO Memory Read (UIOMRd). The CXL.io completion may be a CplD or a UIORdCplD, and may carry a CDL field when the UIO path is utilized. The computer may translate the data and Tag from the CXL.io completion into the NVLink-based response, reconstructing the NVLink response fields such as SourceID, DestinationID, and Tag for delivery to the first entity. In some examples, the computer may issue one or more CXL.io requests in response to an NVLink-based request, such as when splitting a large NVLink read into smaller CXL.io reads, or when prefetching data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). UIO may be utilized when the path between the computer and the second entity supports Flit Mode and has UIO enabled. The UIOMRd may provide multi-path routing and out-of-order completion delivery capabilities. The UIORdCplD may include a CDL that carries QoS telemetry populated by the second entity or intermediate components.

In some implementations of the method, the CXL.io UIORdCplD comprises a CXL DevLoad (CDL) field, and wherein the computer performs at least one of: (i) translating information carried in the CDL to one or more fields of the NVLink-based response, or (ii) utilizing information carried in the CDL for at least one of throttling subsequent requests to the second entity or collecting Quality-of-Service (QoS) telemetry. The CDL may carry device load indicators such as light load, optimal load, moderate overload, or severe overload encodings. The computer may translate CDL information to reserved fields, vendor-defined fields, or custom fields of the NVLink-based response, or may collect CDL values over time to build a telemetry profile of the second entity. When utilizing CDL for throttling, the computer may reduce or modulate the rate of subsequent CXL.io requests based on the observed loading state.

In some implementations of the method, the CXL.io request comprises a CXL.io Memory Read (MRd) request, and the CXL.io completion comprises a CXL.io Completion with Data (CplD). The standard MRd and CplD types may be utilized when the second entity does not support UIO, when UIO is not enabled along the path, or when the path between the computer and the second entity does not utilize Flit Mode. The CplD does not include a CDL, and the computer may populate any QoS-related fields in the NVLink-based response with locally generated information or default values.

In some implementations of the method, the first physical address refers to an NVLink-based network address or a GPU physical address belonging to a first address space, the second physical address refers to a Host Physical Address (HPA) belonging to a second address space, wherein the NVLink-based request further comprises a first Tag, the computer assigns a second Tag to the CXL.io request, and the computer maintains a mapping between the first Tag and the second Tag to correlate the CXL.io completion with the NVLink-based request. The address translation may be implemented utilizing lookup tables, page tables, base-and-offset calculations, or programmable translation functions. The Tag mapping may be maintained in tracker entries, content-addressable memory, or translation tables. Upon receiving the CXL.io completion comprising the Tag, the computer may look up the corresponding first Tag and include it in the NVLink-based response for proper correlation at the first entity.

In some implementations of the method, the computer translates an NVLink-based request to CXL.io requests, the computer prefetches data from the second entity into a cache coupled to the computer, the first entity comprises at least one of a GPU, an accelerator, or an NVLink switch, and the second entity comprises at least one of a CXL host, a CXL device, or a CXL switch. The computer may split a large NVLink read request, such as a 256-byte read, to smaller CXL.io read requests, such as 64-byte or 128-byte reads, to accommodate differences in maximum payload sizes between the NVLink-based protocol and CXL.io. The computer may additionally prefetch data from addresses adjacent to or following the requested address, storing the prefetched data in the cache for servicing anticipated subsequent requests from the first entity with reduced latency.

In some implementations of the method, the computer translates error indications between the CXL.io completion and the NVLink-based response, comprising translating at least one of a poison indication or a data corruption indication. The poison indication in CXL.io may indicate that the data payload has been corrupted or is otherwise invalid. The computer may translate this indication to a corresponding error indication in the NVLink-based response, enabling the first entity to handle the error accordingly.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system, which may be configured for translation from NVLink-based traffic to CXL.io traffic, may include a semiconductor device, a bridge, a switch, or another apparatus that includes a first interface configured to communicate according to an NVLink-based protocol and a second interface configured to communicate according to CXL.io. A computer coupled between the interfaces may translate physical addresses between a first address space, such as an NVLink-based network address space or a GPU physical address space, and a second address space, such as an HPA space, associated with CXL.io. The computer may additionally translate between NVLink-based requests and other CXL sub-protocols such as CXL.mem or CXL.cache. The system may include optional switches on one or both sides of the computer, and the computer may be implemented in various form factors including a retimer BGA package. Such systems may serve heterogeneous AI computing architectures where NVLink-based accelerators need to access CXL-attached resources including memory expansion devices, coherent memory pools, or host-managed device memory.

In various implementations, a system comprising: a first interface configured to communicate according to an NVLink-based protocol with a first entity; a second interface configured to communicate according to CXL.io with a second entity, wherein CXL denotes Compute Express Link; and a computer coupled between the first and second interfaces, configured to translate between NVLink-based requests received via the first interface and CXL.io requests transmitted via the second interface; wherein the computer is further configured to translate physical addresses between a first address space associated with the NVLink-based protocol and a second address space associated with CXL.io. The system may enable an NVLink-based entity, such as a GPU or an accelerator, to access resources coupled to a CXL-based entity, such as a CXL host, a CXL device, or a CXL-attached memory device, through the translating computer. The first interface may be coupled to the first entity directly or through one or more NVLink switches, and the second interface may be coupled to the second entity directly or through one or more CXL switches. The computer may be implemented as a processor, a switch, an RPU, a semiconductor device, or an active cable. The first address space may include an NVLink-based network address space or a GPU physical address space, and the second address space may include an HPA space. The computer may translate addresses utilizing lookup tables, page tables, base-and-offset calculations, or programmable translation functions. In some examples, the computer may additionally translate between NVLink-based requests and CXL.mem requests or CXL.cache requests, enabling access to different types of CXL-attached resources through the same system.

In some implementations of the system, the computer is further configured to translate between NVLink-based requests and at least one of CXL.mem requests or CXL.cache requests via the second interface; and wherein the NVLink-based requests comprise requests associated with an artificial intelligence (AI) model, comprising at least one of: requests for AI model parameters stored in a CXL-attached memory device accessible via CXL.mem, or requests for AI model data maintained in a cache coherency domain accessible via CXL.cache. The multi-channel CXL translation may enable AI accelerators to access model parameters from CXL-attached memory expansion devices via CXL.mem, while simultaneously accessing coherent data structures via CXL.cache. The computer may select the appropriate CXL sub-protocol based on the address range, transaction type, or memory attributes of each NVLink-based request.

In some implementations of the system, the computer is implemented in an integrated circuit (IC) package having high-speed differential I/O balls positioned according to a ball grid array (BGA) layout defined by a retimer specification. The retimer BGA form factor may enable the computer to be deployed in existing retimer sockets within server platforms, utilizing a standardized physical footprint such as the PCIe 5.0, 6.0, or 7.0 Retimer Supplemental Features and Standard BGA Footprint Specification.

In some implementations of the system, the computer comprises a cache configured to store prefetched data received via the second interface, the prefetched data comprising data associated with an artificial intelligence (AI) model comprising at least one of model weights, activation tensors, or embedding tables, and the computer comprises at least one of a processor, a switch, or a Request Processing Unit (RPU). The cache may store prefetched AI model data to reduce latency for subsequent NVLink-based requests from the first entity. AI model weights, activation tensors, and embedding tables may exhibit predictable sequential access patterns that benefit from prefetching. The RPU, processor, or switch may manage the prefetch scheduling and cache allocation policies.

In some implementations of the system, one or more NVLink switches are positioned between the first interface and the first entity, one or more CXL switches are positioned between the second interface and the second entity, and the first entity comprises an AI accelerator that processes an artificial intelligence (AI) model distributed across AI accelerators coupled via the one or more NVLink switches. The NVLink switches may couple AI accelerators that collectively process a distributed AI model, such as when model parameters or activations are partitioned across accelerators using model parallelism, tensor parallelism, or pipeline parallelism. The CXL switches may couple the second interface to one or more CXL-attached memory devices, memory pools, or hosts that store portions of the AI model data.

In some implementations, translation may be performed from CXL.io traffic to NVLink-based traffic. A first entity, such as a CXL host, may initiate CXL.io read requests targeting resources coupled to a second entity, such as a GPU, that communicates according to an NVLink-based protocol. The computer may translate CXL.io requests to NVLink-based requests and translate NVLink-based responses to CXL.io completions. The computer may determine NVLink routing fields such as SourceID and DestinationID based on routing information, since CXL.io requests do not natively carry NVLink routing fields. Additionally, when translating to CXL.io UIO completions such as UIORdCplD, the computer may populate a CDL field with QoS telemetry information derived from the NVLink domain, from locally observed load or congestion conditions, or from information carried in the NVLink-based response. This CDL generation by a host-side or bridge-side entity extends the telemetry model beyond the CXL specification, which defines CDL population for CXL devices under specific conditions. Such translation may enable CXL hosts to access GPU memory storing AI model data, intermediate computations, or inference results.

In various implementations, a method comprising: receiving, by a computer from a first entity via a first interface, a CXL.io request comprising a read-class Transaction Layer Packet (TLP) type and a first physical address, wherein CXL denotes Compute Express Link; translating, by the computer, the CXL.io request to an NVLink-based request comprising a second physical address; sending, by the computer via a second interface that communicates according to an NVLink-based protocol, the NVLink-based request to a second entity; receiving, by the computer from the second entity, an NVLink-based response comprising data; translating, by the computer, the NVLink-based response to a CXL.io completion comprising the data; and sending the CXL.io completion to the first entity. The method may enable a CXL-based entity, such as a CXL host or a CXL device, to access resources coupled to an NVLink-based entity, such as a GPU, by translating CXL.io requests to NVLink-based requests and translating NVLink-based responses to CXL.io completions. The computer may be a processor, a switch, an RPU, a bridge, an active cable, or a semiconductor device positioned between the first entity and the second entity. The first interface may communicate according to CXL.io, and the second interface may communicate according to an NVLink-based protocol. The CXL.io request may be a CXL.io MRd or a CXL.io UIOMRd, and the CXL.io completion may be a CplD or a UIORdCplD, respectively. The computer may translate the first physical address, which may be an HPA or an address within a CXL address space, to the second physical address, which may be an NVLink-based network address or a GPU physical address. The computer may additionally determine NVLink routing fields such as SourceID and DestinationID for the outgoing NVLink-based request based on routing information, address mapping tables, or configuration maintained by the computer. The NVLink-based response may include fields such as SourceID, DestinationID, Tag, and data, and the computer may translate these to the corresponding CXL.io completion fields. In some examples, the computer may aggregate CXL.io requests into an NVLink-based request, or may prefetch additional data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). The UIO path may be utilized when the first entity supports UIO capabilities and the path between the first entity and the computer has UIO enabled. The UIORdCplD may include a CDL that the computer may populate with telemetry information derived from the NVLink domain.

In some implementations of the method, the computer populates a CXL DevLoad (CDL) field in the CXL.io UIORdCplD with information based on at least one of: load information observed by the computer, congestion information associated with the second entity, or Quality-of-Service (QoS) telemetry derived from the NVLink-based response. The CDL generation by the computer may extend the CXL DevLoad telemetry model to the NVLink domain, where the NVLink-based protocol does not natively carry CDL. The computer may derive load or congestion information from the response latency, queue depth, or other observable characteristics of the second entity. The computer may populate the CDL utilizing the same encoding as defined for CXL devices, such as light load, optimal load, moderate overload, or severe overload, enabling the first entity to make informed scheduling or resource allocation decisions based on conditions at the second entity.

In some implementations of the method, the CXL.io request comprises a CXL.io Memory Read (MRd) request, and the CXL.io completion comprises a CXL.io Completion with Data (CplD). The standard MRd and CplD types may be utilized when the first entity does not support UIO or when UIO is not enabled along the path. The CplD does not include a CDL, and the computer may utilize any QoS or load information internally for traffic management or monitoring rather than propagating it to the first entity.

In some implementations of the method, the CXL.io request further comprises a first Tag, the NVLink-based request further comprises a second Tag assigned by the computer, the computer maintains a mapping between the first Tag and the second Tag, and translating the CXL.io request to the NVLink-based request comprises determining a SourceID and a DestinationID for the NVLink-based request based on routing information maintained by the computer. The computer may assign the second Tag from a pool of available NVLink Tags and store the mapping in a tracker entry. The SourceID and DestinationID may be determined based on routing tables, address range configurations, or forwarding information maintained by the computer, since CXL.io requests do not natively carry NVLink routing fields. Upon receiving the NVLink-based response comprising the second Tag, the computer may retrieve the corresponding first Tag for inclusion in the CXL.io completion.

In some implementations of the method, the computer aggregates CXL.io requests received from the first entity, and translates the aggregated CXL.io requests to an NVLink-based request. The computer may aggregate smaller CXL.io read requests targeting adjacent or contiguous addresses into a larger NVLink-based read request, leveraging the NVLink-based protocol's support for larger payload sizes to improve bandwidth utilization and reduce the number of transactions on the NVLink-based interface.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system may be configured to translate from CXL.io traffic to NVLink-based traffic. The system may include a computer coupled between a first interface configured to communicate according to CXL.io and a second interface configured to communicate according to an NVLink-based protocol. The computer may translate CXL.io requests received from a first entity, such as a CXL host, to NVLink-based requests transmitted to a second entity, such as a GPU. The computer may include an RPU with a cache, and may be implemented as a bridge, a switch, a standalone translation device, or a chiplet. The system may include optional NVLink switches or CXL switches on either side of the computer. Such systems may enable CXL hosts to access GPU memory resources, such as memory storing AI model data, intermediate computation results, or inference outputs, through the CXL.io interface.

In various implementations, a system comprising: a first interface configured to communicate according to CXL.io with a first entity, wherein CXL denotes Compute Express Link; a second interface configured to communicate according to an NVLink-based protocol with a second entity; and a computer coupled between the first and second interfaces, configured to translate between CXL.io requests received via the first interface and NVLink-based requests transmitted via the second interface. The system may enable a CXL-based entity, such as a CXL host, a CXL device, or a CXL switch, to access resources coupled to an NVLink-based entity, such as a GPU, an accelerator, or an NVLink switch, through the computer that performs translation between the CXL.io and NVLink-based protocol domains. The computer may translate addresses, Tags, routing fields, error indications, and other protocol-specific fields. The computer may additionally determine NVLink routing fields such as SourceID and DestinationID for outgoing NVLink-based requests, since CXL.io requests do not carry NVLink routing information. In some examples, the computer may include an RPU coupled to a cache, and may be coupled to a memory. The first interface may be coupled to the first entity directly or through one or more CXL switches, and the second interface may be coupled to the second entity directly or through one or more NVLink switches. The computer may be implemented as a bridge, a switch, a standalone translation device, a semiconductor device, or a chiplet.

In some implementations of the system, the computer is configured to determine a SourceID and a DestinationID for NVLink-based requests transmitted via the second interface based on routing information maintained by the computer. The routing information may include routing tables, address-to-destination mappings, forwarding information, or configuration data programmed by a management entity. The SourceID and DestinationID may be utilized by NVLink switches or the second entity to route and deliver the NVLink-based requests.

In some implementations of the system, the computer is further configured to translate at least one of poison indications or data corruption indications between messages communicated via the first interface and messages communicated via the second interface. The poison indication in CXL.io may be propagated to or from corresponding error fields in NVLink-based messages, enabling end-to-end error visibility across the protocol boundary.

In some implementations of the system, the computer comprises a Request Processing Unit (RPU) coupled to a cache configured to store data associated with translations between the CXL.io requests and the NVLink-based requests, and wherein the computer is further configured to translate between fields of the CXL.io requests and fields of the NVLink-based requests, comprising at least one of: Traffic Class (TC) to QoS priority, Tag to Tag, or length to length translations. The RPU may manage the translation state and orchestrate the protocol conversions. The cache may store data retrieved from the second entity to reduce latency for repeated or adjacent accesses. The cross-field translations may include mapping CXL.io Traffic Class values to NVLink QoS priority levels, mapping CXL.io Tags to NVLink Tags, and translating length fields to accommodate differences in granularity or maximum transfer sizes between the protocols.

In some implementations of the system, the computer is included in at least one of a bridge, a switch, or a standalone translation device, which enables the first entity to access, via CXL.io, GPU memory of the second entity storing data associated with an artificial intelligence (AI) model. The bridge, switch, or standalone translation device may be deployed in AI inference or training systems where CXL hosts need to read intermediate results, model outputs, or gradient data from GPU memory. The translation device may enable such access without requiring the GPU to natively support CXL.io.

In some implementations of the system, the computer comprises an NVLink Fusion chiplet coupled to a processing die via an NVLink Chip-to-Chip (NVLink-C1C) coherent interface; and wherein at least one of: one or more NVLink switches are positioned between the second interface and the second entity, or one or more CXL switches are positioned between the first interface and the first entity. The NVLink Fusion chiplet may implement the translation logic as a separate die within a multi-die package, communicating with the processing die via the NVLink-C1C coherent interface. The NVLink switches or CXL switches may extend the system topology to include multiple NVLink-based entities or multiple CXL-based entities, respectively.

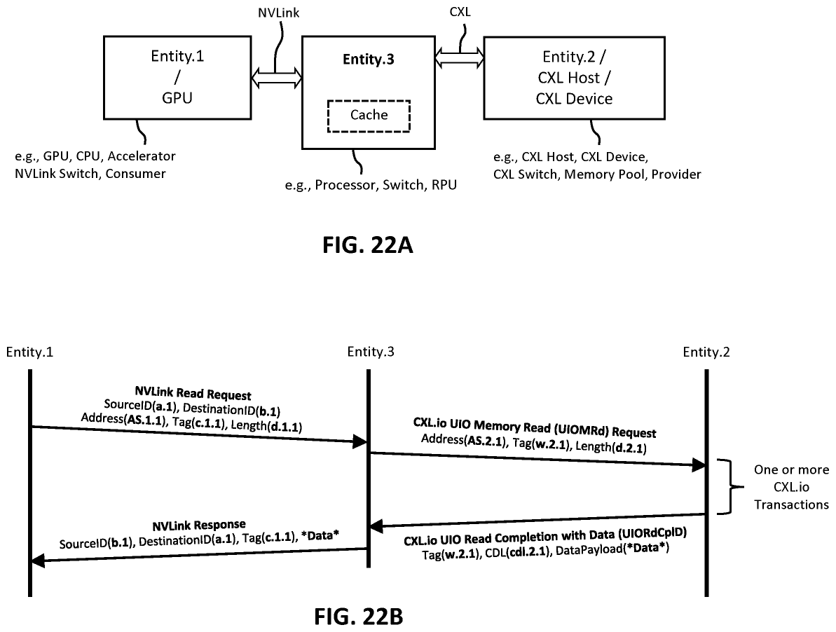

FIG. 22A illustrates an example of a system comprising a third entity (Entity.3), such as a processor, a switch, or an RPU, optionally comprising a cache, that may enable NVLink-based resource consumers to access resources coupled to CXL-based entities. The third entity is coupled to a first entity (Entity.1), which may be a GPU, a CPU, an accelerator, an NVLink switch, or a consumer, wherein the third entity may communicate with the first entity according to an NVLink-based protocol. The third entity is further coupled to a second entity (Entity.2), which may be a CXL host, a CXL device, a CXL switch, a CXL-based memory pool, or a resource provider, wherein the third entity may communicate with the second entity according to a CXL-based protocol, such as at least one of CXL.io, CXL.mem, or CXL.cache. In some examples, messages conforming to the NVLink-based protocol may be associated with a first address space, such as an NVLink-based address space, an NVLink-based network address space, or a GPU address space; and messages conforming to the CXL-based protocol, such as CXL.io, may be associated with a second address space, such as a System Physical Address (SPA) space or a Host Physical Address (HPA) space; wherein the third entity may perform address translations between addresses within the first and second address spaces, respectively. In other examples, messages conforming to the NVLink-based protocol and messages conforming to the CXL-based protocol may be associated with the same physical address space, such as a global address space, a pod address space, or a fabric address space; wherein the third entity may perform address translations between addresses within the same address space. The third entity may perform further translations, such as protocol translations, opcode translations, command translations, request translations, or TLP translations, such as when translating between NVLink requests and CXL.io requests. The third entity may further translate between PDUs of the NVLink-based protocol and PDUs of the CXL protocol, translate Tags, and/or translate error indications, such as data corruption indications or poison. The optional cache within the third entity, shown in dashed outline, may store prefetched data or data retrieved from the second entity to reduce latency for subsequent requests from the first entity. Optionally, the first entity may be a GPU, CPU, accelerator, NVLink switch, or consumer; the third entity may be a processor, switch, or RPU; and the second entity may be a CXL host, CXL device, CXL switch, memory pool, or provider.

FIG. 22B illustrates an example of a transaction flow diagram (TFD) demonstrating a third entity (Entity.3), such as a processor, a switch, or an RPU, that may translate between NVLink-based traffic and CXL-based traffic, such as CXL.io traffic. The third entity may receive from a first entity (Entity.1), which may be a GPU, an NVLink read request that may include SourceID(a.1), DestinationID(b.1), Address(AS.1.1), Tag(c.1.1), and Length(d.1.1), wherein SourceID(a.1) may denote the NVLink interconnect address utilized by the requesting entity, such as a source GPU, and wherein DestinationID(b.1) may denote the NVLink interconnect address utilized by the target of the NVLink request, and may be utilized for routing or forwarding the NVLink request to its destination. The third entity may translate the NVLink request to a CXL.io request that may include a CXL.io UIO Memory Read (UIOMRd) request comprising Address(AS.2.1), Tag(w.2.1), and Length(d.2.1), and may send the CXL.io UIOMRd to a second entity (Entity.2), which may be a CXL host or a CXL device. The third entity may further translate between other values of the NVLink request and the CXL.io request, such as between addresses, Tags, QoS-related values, or identifications (IDs), which may serve to route or forward the NVLink request to its destination. In some examples, the third entity may translate an NVLink request to multiple CXL.io request, such as in order to split a large data read request (e.g., splitting a large 256B NVLink read request to smaller 64B CXL.io read requests), or in order to prefetch data, optionally into a cache that may be included in or coupled to the third entity. Upon receiving a response from the second entity (Entity.2), which may include a CXL.io UIORdCplD comprising Tag(w.2.1), CDL(cdl.2.1), and DataPayload(*Data*), the third entity may translate the CXL.io UIORdCplD to an NVLink response comprising SourceID(b.1), DestinationID(a.1), Tag(c.1.1), and *Data*. The CDL that may be included in the CXL.io UIORdCplD may be populated with information related to QoS, such as QoS telemetry value or values. The third entity may translate information carried in the CDL and send it via one or more fields of the NVLink response, such as via reserved fields, vendor-defined fields, or custom fields. Alternatively or additionally, the third entity may collect QoS information, telemetry, or statistics from UIORdCplD completions.

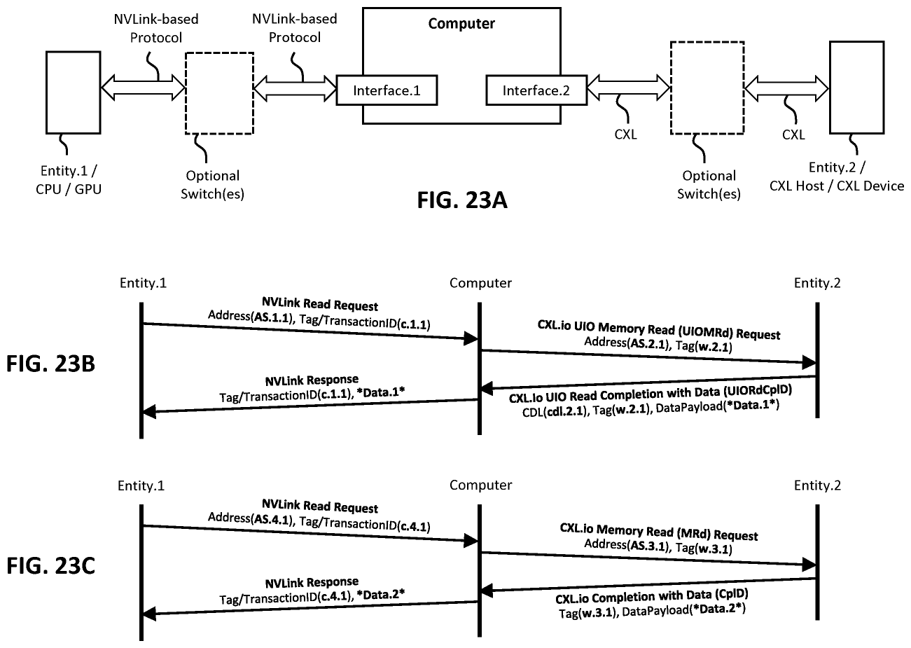

FIG. 23A illustrates an example of a system comprising a computer coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a CXL-based protocol, such as CXL.io, with a second entity (Entity.2), which may be a CXL host or a CXL device. Optionally, the computer may be implemented in a semiconductor device package. The computer may extract physical addresses from requests received via the first interface, wherein these addresses may refer to an NVLink-based address space, an NVLink-based network address space, or a GPU address space utilized by the first entity. The computer may further translate these addresses, and generate requests carrying the translated physical addresses for transmission via the second interface; wherein these translated addresses may correspond to an HPA space utilized by the second entity. Optional switch(es), such as NVLink switches, may be positioned between the first interface and the first entity, as shown in dashed outline on the left side of the figure. Similarly, optional switch(es), such as CXL switches, may be positioned between the second interface and the second entity, as shown in dashed outline on the right side of the figure. The NVLink-based protocol labels on the connections between the first entity, the optional switches, and the first interface indicate that NVLink-based traffic traverses the left side of the illustrated system. The CXL labels on the connections between the second interface, the optional switches, and the second entity indicate that CXL-based traffic traverses the right side of the illustrated system. Optionally, the computer may be included in a switch or a bridge. In some examples, the computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification.

FIG. 23B illustrates an example of a TFD demonstrating translations between NVLink-based requests, such as NVLink read requests, received from a first entity (Entity.1), which may be a CPU or a GPU, and CXL.io UIO TLPs sent to a second entity (Entity.2), which may be a CXL host or a CXL device, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.1.1), and Tag/TransactionID(c.1.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io UIO Memory Read (UIOMRd) request comprising a physical address, such as HPAs Address(AS.2.1), and Tag(w.2.1), and may send the CXL.io UIOMRd to the second entity. Upon receiving the CXL.io UIOMRd, the second entity may respond with a completion, which may include a CXL.io UIO Read Completion with Data (UIORdCplD) comprising CDL(cdl.2.1), Tag(w.2.1), and DataPayload(*Data.1*), wherein the CDL may be populated by the CXL device (or alternatively by the CXL host) with information related to QoS, such as QoS telemetry value or values. The computer may translate the CXL.io UIORdCplD to an NVLink response comprising Tag/TransactionID(c.1.1) and *Data.1*, and may send the NVLink response to the first entity. In some examples, the computer may issue multiple CXL.io UIO memory read requests in response to receiving an NVLink request from the first entity, such as when splitting an NVLink request for a large block of data to smaller CXL.io UIO memory read requests, or when prefetching data from the second entity. The computer may translate requests or transactions initiated from the NVLink-based domain to the CXL domain, or may translate requests or transactions initiated from the CXL domain to the NVLink-based domain.

FIG. 23C illustrates an example of a TFD demonstrating translations between NVLink-based requests, such as NVLink read requests, received from a first entity (Entity.1), which may be a CPU or a GPU, and CXL.io TLPs sent to a second entity (Entity.2), which may be a CXL host or a CXL device. The translation is performed by a computer, which may be a semiconductor device. The first entity may initiate an NVLink request, which may be an NVLink read request, comprising physical address Address(AS.4.1), and Tag/TransactionID(c.4.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io Memory Read (MRd) request comprising physical address Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to an NVLink response comprising Tag/TransactionID(c.4.1) and *Data.2*, and may send the NVLink response to the first entity. In some examples, the computer may issue multiple CXL.io memory read requests in response to receiving an NVLink request from the first entity, such as when splitting an NVLink request for a large block of data to smaller CXL.io memory read requests, or when prefetching data from the second entity.

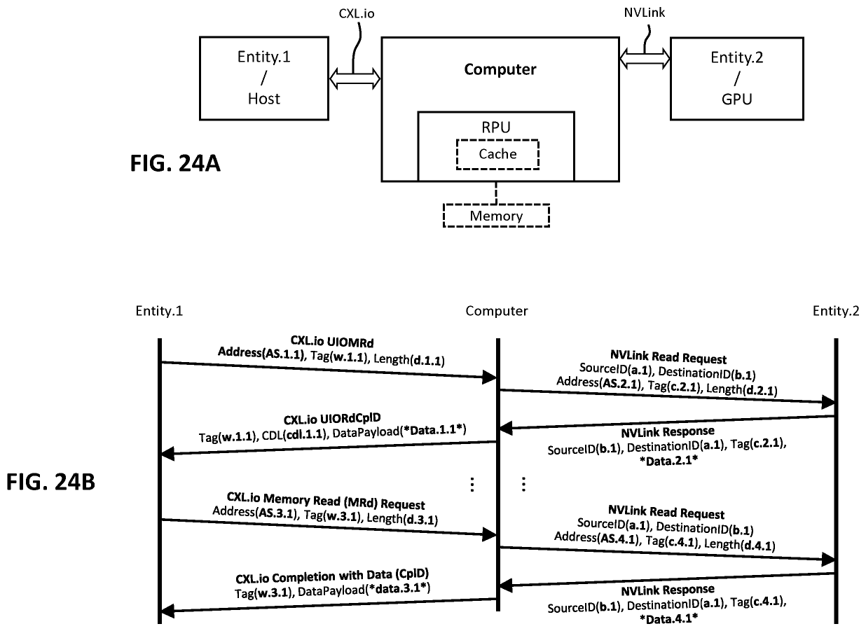

FIG. 24A illustrates an example of a system comprising a computer configured to translate between CXL.io traffic and NVLink-based traffic. A first entity (Entity.1), which may be a host, is coupled to the computer via a CXL.io interface. A second entity (Entity.2), which may be a GPU, is coupled to the computer via an NVLink interface. The computer includes an RPU that may orchestrate the protocol translation logic. The RPU may include an optional cache, which may store data associated with translations between CXL.io requests and NVLink-based requests, such as prefetched data, cached responses, or translation state. The computer is further coupled to an optional memory, shown in dashed outline below the computer, that may store routing tables, address translation tables, Tag mapping entries, or other state information utilized by the RPU during translation. The system enables the first entity (Host) to access resources coupled to the second entity (GPU) through the computer by translating CXL.io requests to NVLink-based requests and translating NVLink-based responses to CXL.io completions. The computer may determine NVLink routing fields such as SourceID and DestinationID for outgoing NVLink-based requests, since CXL.io requests do not natively carry NVLink routing fields. When translating NVLink-based responses to CXL.io UIO completions, the computer may populate a CDL field with QoS telemetry information derived from the NVLink domain, from load or congestion information observed by the computer, or from information carried in the NVLink-based response.

FIG. 24B illustrates an example of a TFD demonstrating translations between CXL.io read requests received from a first entity (Entity.1) and NVLink-based read requests sent to a second entity (Entity.2), with the translation performed by a computer positioned between the first and second entities. The figure shows two separate transaction flows separated by a vertical ellipsis, representing two alternative translation paths: an upper UIO path and a lower non-UIO path. In the upper UIO path, the first entity sends a CXL.io UIOMRd comprising Address(AS.1.1), Tag(w.1.1), and Length(d.1.1) to the computer. The computer translates the CXL.io UIOMRd to an NVLink read request comprising SourceID(a.1), DestinationID(b.1), Address(AS.2.1), Tag(c.2.1), and Length(d.2.1), and sends the NVLink read request to the second entity. The computer determines the SourceID(a.1) and DestinationID(b.1) based on routing information maintained by the computer, since the CXL.io UIOMRd does not carry NVLink routing fields. Upon receiving an NVLink Response from the second entity comprising SourceID(b.1), DestinationID(a.1), Tag(c.2.1), and *Data.2.1*, the computer translates the NVLink Response to a CXL.io UIORdCplD comprising Tag(w.1.1), CDL(cdl.1.1), and DataPayload(*Data.1.1*), and sends the CXL.io UIORdCplD to the first entity. The CDL(cdl.1.1) may be populated by the computer with QoS telemetry information based on load information observed by the computer, congestion information associated with the second entity, or information derived from the NVLink Response, since the NVLink-based protocol does not natively carry a CDL field.

In the lower non-UIO path, the first entity sends a CXL.io Memory Read (MRd) request comprising Address(AS.3.1), Tag(w.3.1), and Length(d.3.1) to the computer. The computer translates the CXL.io MRd to an NVLink read request comprising SourceID(a.1), DestinationID(b.1), Address(AS.4.1), Tag(c.4.1), and Length(d.4.1), and sends the NVLink read request to the second entity. Upon receiving an NVLink Response from the second entity comprising SourceID(b.1), DestinationID(a.1), Tag(c.4.1), and *Data.4.1*, the computer translates the NVLink Response to a CXL.io Completion with Data (CplD) comprising Tag(w.3.1) and DataPayload(*Data.3.1*), and sends the CXL.io CplD to the first entity. Unlike the upper UIO path, the CplD in the lower non-UIO path does not include a CDL. In both paths, the computer translates addresses between the CXL.io domain (Address AS.1.1 and AS.3.1) and the NVLink domain (Address AS.2.1 and AS.4.1), translates Tags between the CXL.io domain (Tag w.1.1 and w.3.1) and the NVLink domain (Tag c.2.1 and c.4.1), and determines NVLink SourceID and DestinationID routing fields for the outgoing NVLink read requests.

In heterogeneous computing architectures, entities may communicate using different interconnect protocols while requiring coordinated access to shared resources. NVLink is a high-bandwidth interconnect technology utilized for communication among GPUs, accelerators, and switches, while PCIe is an interconnect technology utilized for communication between hosts and devices. NVLink-based PDUs utilize an NVLink-based address space, whereas PCIe TLPs utilize a PCIe address space, such as a Host Physical Address (HPA) space. In environments where a first entity communicating via NVLink needs to access resources coupled to a second entity communicating via PCIe, or vice versa, translations between NVLink-based PDUs and PCIe TLPs may facilitate memory operations and data transfers across the different protocol domains. Such translations may be performed by a computer, an apparatus, a cable, or other suitable devices positioned between the first entity and the second entity. The translations may include translating physical addresses between the NVLink-based address space and the PCIe address space, translating between NVLink-based request types and PCIe TLP types, and translating identifier fields such as Tags, SourceIDs, DestinationIDs, and RequesterIDs. The translations may support AI workloads, such as training and inference of large language models (LLMs), mixture-of-experts (MoE) models, multi-modal models, and diffusion models, which may involve transferring model weights, key-value (KV) cache entries, activation tensors, and embedding tables between NVLink-connected entities and PCIe-connected resources.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe Transaction Layer Packets (TLPs) communicated via the second interface, wherein the translating comprises: translating physical addresses between a first address space associated with the NVLink-based protocol and a second address space associated with the PCIe protocol; and translating between NVLink-based request types and PCIe TLP types. The computer may be implemented as a semiconductor device, an integrated circuit (IC), a chiplet, an active cable, a switch, or another suitable device positioned between the first entity and the second entity. The first address space may include an NVLink-based network address space or a GPU physical address space, and the second address space may include an HPA space or another PCIe memory address space. The computer may maintain address translation tables, such as Link TLBs or address mapping tables, to translate between addresses in the first and second address spaces. The translating may be bidirectional: in one direction, the computer may translate NVLink-based PDUs received from the first entity to PCIe TLPs sent to the second entity; in the opposite direction, the computer may translate PCIe TLPs received from the second entity to NVLink-based PDUs sent to the first entity. The NVLink-based request types may include NVLink read requests and NVLink write requests, and the PCIe TLP types may include Memory Read (MRd) requests, Memory Write (MWr) requests, and Completions. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity, the NVLink-based request comprising a first address in the first address space; wherein the PCIe TLPs comprise a PCIe Memory Read (MRd) request comprising a second address in the second address space; and wherein the translating further comprises translating the NVLink-based request to the PCIe MRd and sending the PCIe MRd to the second entity via the second interface. The NVLink-based request may be an NVLink read request carrying a GPU physical address or an NVLink-based network address. The computer may translate this address to an HPA or another address within the PCIe memory address space. The computer may further translate NVLink Tags or transaction identifiers to PCIe Tags for tracking the transaction.

In some implementations of the method, the PCIe TLPs further comprise a PCIe Completion with Data (CplD) from the second entity, the PCIe CplD comprising a data payload corresponding to the PCIe MRd; and wherein the translating further comprises translating the PCIe CplD to an NVLink-based response comprising the data payload. The computer may correlate the PCIe CplD with the previously sent PCIe MRd using the PCIe Tag, and may translate the PCIe Tag back to the corresponding NVLink Tag or transaction identifier. The data payload may be forwarded from the PCIe CplD into the NVLink-based response without modification.

In some implementations of the method, the PCIe TLPs comprise a PCIe Memory Read (MRd) request from the second entity, the PCIe MRd comprising a first address in the second address space; wherein the NVLink-based PDUs comprise an NVLink-based request comprising a second address in the first address space; and wherein the translating further comprises translating the PCIe MRd to the NVLink-based request and sending the NVLink-based request to the first entity via the first interface. In the opposite direction, the second entity may initiate a PCIe MRd targeting a resource accessible via the NVLink fabric. The computer may translate the PCIe address, such as an HPA, to an NVLink-based address, and may generate NVLink identifier fields such as SourceID and DestinationID that are not present in the PCIe domain. The computer may further translate the PCIe Tag to an NVLink Tag for transaction tracking.

In some implementations of the method, the NVLink-based PDUs further comprise an NVLink-based response from the first entity, the NVLink-based response comprising a data payload; and wherein the translating further comprises translating the NVLink-based response to a PCIe Completion with Data (CplD) comprising the data payload. The computer may translate the NVLink Tag back to the PCIe Tag of the original MRd and may generate PCIe completion header fields such as CompleterID and RequesterID. The data payload may be forwarded from the NVLink response into the PCIe CplD.

In some implementations of the method, the PCIe MRd further comprises a RequesterID, and wherein the PCIe CplD further comprises a CompleterID and the RequesterID, and wherein the computer generates the CompleterID for the PCIe CplD. The CompleterID may identify the computer as the PCIe Completer for the transaction. The RequesterID may be reflected from the original PCIe MRd to enable correct routing of the CplD back to the originating entity. These identifiers may be set during enumeration or initialization phases.

In some implementations of the method, the PCIe MRd further comprises a RequesterID and a first Tag, and wherein the NVLink-based request further comprises a SourceID, a DestinationID, and a second Tag; and wherein translating the PCIe MRd to the NVLink-based request comprises generating the SourceID and the DestinationID, and translating the first Tag to the second Tag. The PCIe domain utilizes RequesterID (Bus/Device/Function) for identifying the requester, whereas the NVLink domain utilizes separate SourceID and DestinationID fields for routing. The computer may generate the SourceID based on its own NVLink identity, and the DestinationID based on the target entity in the NVLink fabric. The computer may maintain a Tag mapping table to translate between PCIe Tags and NVLink Tags and to correlate responses with their corresponding requests.

In some implementations of the method, the PCIe TLPs communicated via the second interface utilize a Flit Mode (FM) format, and wherein the first entity comprises a GPU or an accelerator, and the second entity comprises a PCIe host or a PCIe device. Flit Mode may be supported by PCIe Revision 6.0 and above, and may provide increased bandwidth efficiency and support for 14-bit Tags. The second entity may be a PCIe host, such as a CPU or a Root Complex, or a PCIe device, such as an NVMe SSD, a network interface card (NIC), or a memory controller.

In some implementations of the method, the computer translates between Flit Mode (FM) and Non-Flit Mode (NFM) TLP formats for the PCIe TLPs communicated via the second interface, and wherein the NVLink-based PDUs carry data associated with an artificial intelligence (AI) model comprising at least one of: a large language model (LLM), a mixture-of-experts (MoE) model, a multi-modal model, or a diffusion model. When the second interface operates in a different data stream mode than an adjacent PCIe link segment, the computer may translate between FM and NFM TLP formats, including adapting header formats, Tag widths, and encoding mechanisms. LLMs may include transformer-based architectures, MoE models may route inputs to subsets of expert sub-networks, multi-modal models may process inputs across text, image, and video modalities, and diffusion models may generate content through iterative denoising.

In some implementations of the method, the PCIe TLPs carry a data payload not exceeding 64 Double Words (DWs), and wherein the computer translates an NVLink-based PDU to multiple PCIe TLPs. The 64 DW ceiling (256 bytes) may correspond to a maximum payload size supported by the NVLink-based protocol, which may be imposed on the PCIe domain. When an NVLink request targets a data block that exceeds the PCIe Maximum Payload Size or requires multiple completions, the computer may split the request into smaller PCIe TLPs and may reassemble the returned data before translating it back to the NVLink domain.

In some implementations of the method, at least one physical address within the second address space, which is a PCIe memory address space, is not mapped to an NVLink address in the first address space, and wherein the NVLink-based PDUs and the PCIe TLPs carry data associated with an artificial intelligence (AI) workload, the data comprising at least one of: model weights, key-value (KV) cache entries, activation tensors, or embedding tables. The computer may expose only a subset of the PCIe memory address space to the NVLink domain. Unmapped PCIe addresses may correspond to configuration registers, management interfaces, or memory regions reserved for local use by the second entity. KV cache entries may be utilized during autoregressive inference, activation tensors may represent intermediate computation results, and embedding tables may map discrete tokens to continuous vector representations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system translates between NVLink-based traffic and PCIe traffic. The system may support various form factors, including semiconductor devices packaged in retimer-compatible BGA layouts, active cables with optical or copper physical media, and chiplet-based implementations. The system may further include NVLink switches or PCIe switches positioned between the interfaces and the respective entities, enabling multi-entity topologies. The system may be deployed in datacenters, high-performance computing (HPC) environments, or AI/ML training and inference clusters, where NVLink-connected accelerators/GPUs need to access PCIe-attached resources such as host memory, NVMe storage, or network interface cards.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe traffic communicated via the second interface, comprising translating physical addresses between a first address space associated with the NVLink-based protocol and a second address space associated with the PCIe protocol. The system may be deployed in environments where NVLink-connected entities, such as GPUs, accelerators, or NVLink switches, need to access resources coupled to PCIe-connected entities, such as PCIe hosts, NVMe SSDs, or network interface cards. The computer may be implemented as a semiconductor device comprising translation logic, address mapping tables, and pending transaction trackers. The first and second interfaces may support different link speeds, lane widths, and signaling technologies. The system may support bidirectional translation, wherein in one direction the computer translates NVLink-based traffic to PCIe traffic, and in the opposite direction the computer translates PCIe traffic to NVLink-based traffic. Optional switches may be positioned between the first interface and the first entity, and between the second interface and the second entity, to support multi-entity topologies.

In some implementations of the system, the computer is implemented in an IC package having differential input/output (I/O) balls positioned according to a ball grid array (BGA) layout, and wherein the system further comprises a cable including a first module and a second module coupled by a physical medium, the computer residing within the first module or the second module. The BGA layout may conform to a retimer specification, such as the PCIe 5.0, 6.0, or 7.0 Retimer Supplemental Features and Standard BGA Footprint Specification. The physical medium may include a copper wire, a twinaxial cable, a multimode fiber (MMF), or a single-mode fiber (SMF). The cable may be implemented as an Active Optical Cable (AOC) or an Active Copper Cable (ACC).

In some implementations of the system, the computer comprises an NVLink Fusion chiplet, and wherein an NVLink switch is coupled between the first interface and the first entity. The NVLink Fusion chiplet may integrate the translation logic, address mapping functionality, and NVLink interface within a chiplet package. The NVLink switch may enable multi-entity connectivity, allowing multiple accelerators (e.g., GPUs) to access PCIe resources through the same computer. The NVLink Fusion chiplet may be a component of an RPU within an active cable or a discrete semiconductor device.

In some implementations of the system, the second interface operates in Flit Mode (FM), and wherein the NVLink-based traffic and the PCIe traffic carry data associated with an artificial intelligence (AI) workload comprising at least one of: model training, model inference, or model fine-tuning. Flit Mode operation on the second interface may provide increased bandwidth efficiency and support for 14-bit Tags and UIO capabilities. Model training may involve distributing gradient computations and model parameters across NVLink-connected GPUs while accessing datasets stored on PCIe-attached storage. Model inference may involve transferring model weights and KV cache entries between memory tiers. Model fine-tuning may involve adapting pre-trained model parameters using task-specific data.

In some implementations, the translations between NVLink-based traffic and PCIe traffic may involve PCIe Unordered I/O (UIO) TLPs. UIO is an optional capability defined in PCIe that introduces TLP types associated with UIO Virtual Channels, including UIO Memory Read (UIOMRd) and UIO Read Completion with Data (UIORdCplD). UIO enables multi-path routing and may provide improved performance in fabric environments. In environments where a first entity communicating via NVLink needs to access resources coupled to a second entity via PCIe UIO, or vice versa, translations between NVLink-based PDUs and PCIe UIO TLPs may facilitate memory operations and data transfers. UIO TLPs are defined for Flit Mode and are associated with dedicated UIO Virtual Channels. The translations between NVLink-based PDUs and PCIe UIO TLPs may involve translating between NVLink identifier fields, such as SourceID and DestinationID, and PCIe UIO identifier fields, such as RequesterID and DestinationBDF/BF. The translations may support AI workloads such as training and inference of LLMs, MoE models, and multi-modal models.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe UIO Transaction Layer Packets (TLPs) communicated via the second interface. The computer may be implemented as a semiconductor device, an IC, a chiplet, an active cable, a switch, or another suitable device positioned between the first entity and the second entity. PCIe UIO TLPs are distinct from standard PCIe TLPs and are associated with UIO Virtual Channels. The method may be bidirectional: in one direction, the computer may translate NVLink-based PDUs received from the first entity to PCIe UIO TLPs sent to the second entity; in the opposite direction, the computer may translate PCIe UIO TLPs received from the second entity to NVLink-based PDUs sent to the first entity. The translating may include opcode translations, Tag translations, address translations, and identifier translations between the NVLink-based domain and the PCIe UIO domain. The PCIe UIO TLPs may include UIOMRd, UIOMWr, UIORdCplD, UIORdCpl, and UIOWrCpl. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity; wherein the PCIe UIO TLPs comprise a PCIe UIO Memory Read (UIOMRd) request; and wherein the translating further comprises translating the NVLink-based request to the PCIe UIOMRd and sending the PCIe UIOMRd to the second entity via the second interface. The NVLink-based request may be an NVLink read request comprising a physical address and a Tag or transaction identifier. The computer may translate the NVLink-based request to a PCIe UIOMRd carrying a translated address and a PCIe Tag. The UIOMRd may utilize a UIO Virtual Channel for transmission to the second entity.

In some implementations of the method, the PCIe UIO TLPs further comprise a PCIe UIO Read Completion with Data (UIORdCplD) from the second entity, the UIORdCplD comprising a data payload; and wherein the translating further comprises translating the UIORdCplD to an NVLink-based response comprising the data payload. The computer may correlate the UIORdCplD with the previously sent UIOMRd using the PCIe Tag, and may translate the response back to the NVLink domain. UIO completions may be received in any order by the requester, and the computer may handle out-of-order completions when reassembling data for the NVLink response.

In some implementations of the method, the PCIe UIO TLPs comprise a PCIe UIO Memory Read (UIOMRd) request from the second entity; wherein the NVLink-based PDUs comprise an NVLink-based request; and wherein the translating further comprises translating the UIOMRd to the NVLink-based request and sending the NVLink-based request to the first entity via the first interface. In the opposite direction, the second entity may initiate a PCIe UIOMRd targeting a resource accessible via the NVLink fabric. The computer may translate the UIOMRd to an NVLink-based request, generating NVLink SourceID and DestinationID fields and translating the PCIe Tag to an NVLink Tag. The UIOMRd may carry a RequesterID that the computer may store for generating the corresponding UIORdCplD.

In some implementations of the method, the NVLink-based PDUs further comprise an NVLink-based response from the first entity, the NVLink-based response comprising a data payload; and wherein the translating further comprises translating the NVLink-based response to a PCIe UIO Read Completion with Data (UIORdCplD) comprising the data payload. The computer may generate PCIe UIO completion header fields, such as CompleterID and DestinationBDF/BF, when constructing the UIORdCplD. The DestinationBDF/BF may correspond to the RequesterID of the originating UIOMRd. The data payload may be forwarded from the NVLink response into the UIORdCplD.

In some implementations of the method, the translating further comprises translating physical addresses between a first address space associated with the NVLink-based protocol and a second address space associated with the PCIe protocol. The address translation for UIO transactions may utilize the same address mapping tables or Link TLBs as standard PCIe translations. The first address space may include an NVLink-based network address space, and the second address space may include a PCIe memory address space. The address translation may be applied in both directions.

In some implementations of the method, the PCIe UIO TLPs carry a data payload not exceeding 64 Double Words (DWs), wherein the PCIe UIO TLPs are associated with a UIO Virtual Channel, and wherein the NVLink-based PDUs carry data associated with an artificial intelligence (AI) model comprising at least one of: a large language model (LLM), a mixture-of-experts (MoE) model, or a multi-modal model. The 64 DW ceiling (256 bytes) may correspond to a maximum payload size supported by the NVLink-based protocol. UIO TLPs may only be transmitted on Virtual Channels configured for UIO. The first UIO Virtual Channel may be VC2, and a second UIO Virtual Channel, if supported, may be VC4. LLMs may generate token sequences using autoregressive decoding, MoE models may route tokens to specialized expert sub-networks, and multi-modal models may fuse representations across text, image, and video inputs.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

In some implementations, translations between NVLink-based traffic and PCIe UIO TLPs may be implemented as a system comprising interfaces and a computer. The system may support PCIe UIO transactions that enable multi-path routing and out-of-order completions, providing performance benefits for fabric-based deployments. The system may be deployed in environments where NVLink-connected accelerators/GPUs need to access PCIe UIO-capable resources, or where PCIe UIO-capable entities need to access resources accessible via the NVLink fabric.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe UIO Transaction Layer Packets (TLPs) communicated via the second interface. The system may be deployed in environments where NVLink-connected entities need to access PCIe UIO-capable resources, or vice versa. The computer may translate between NVLink-based PDUs and PCIe UIO TLPs, including UIOMRd, UIOMWr, and UIORdCplD. The system may support bidirectional translation: in one direction the computer translates NVLink-based traffic to PCIe UIO TLPs, and in the opposite direction the computer translates PCIe UIO TLPs to NVLink-based traffic. The second interface may operate in Flit Mode, as UIO TLPs are defined for Flit Mode. The system may be implemented in various form factors, including semiconductor devices, active cables, chiplets, and switches.

In some implementations of the system, at least one physical address within a PCIe memory address space is not mapped to an NVLink address, and wherein the first entity comprises a GPU, a CPU, or an accelerator, and the second entity comprises a PCIe host or a PCIe device. The partial address space exposure may allow the system to selectively map only certain PCIe memory regions to the NVLink domain. The first entity may be a GPU, a CPU, or an accelerator connected via NVLink. The second entity may be a PCIe host, such as a CPU comprising a Root Complex, or a PCIe device, such as an NVMe SSD or a network interface card.

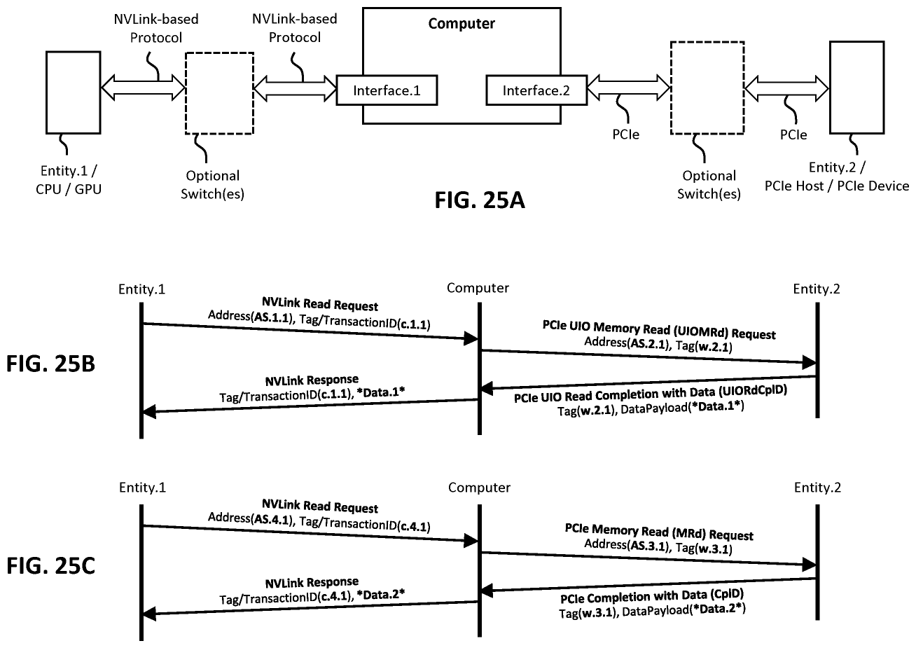

FIG. 25A illustrates an example of a system comprising a computer, which may be referred to as a semiconductor device, coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a PCIe-based protocol with a second entity (Entity.2), which may be a PCIe host or a PCIe device. The first interface may communicate bidirectionally with the first entity using the NVLink-based protocol. The second interface may communicate bidirectionally with the second entity using PCIe. The computer may be implemented in an IC package having high-speed differential I/O balls positioned according to a ball grid array (BGA) layout defined by a retimer specification, such as the PCIe 5.0, 6.0, or 7.0 Retimer Supplemental Features and Standard BGA Footprint Specification. The computer may translate between NVLink-based traffic communicated via the first interface and PCIe traffic communicated via the second interface, including translating physical addresses between a first address space associated with the NVLink-based protocol and a second address space associated with the PCIe protocol. Optional switch(es) may be positioned between the first interface and the first entity. Similarly, optional switch(es) may be positioned between the second interface and the second entity. The system may support bidirectional translation, wherein the computer may translate NVLink-based traffic to PCIe traffic in one direction, and may translate PCIe traffic to NVLink-based traffic in the opposite direction.

FIG. 25B illustrates an example of a TFD demonstrating translations, in one direction, between NVLink-based requests, such as NVLink read requests, received from a first entity (Entity.1), which may be a CPU or a GPU, and PCIe UIO TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address Address(AS.1.1), such as a GPU physical address or an NVLink-based network address, and Tag/TransactionID(c.1.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe UIO Memory Read (UIOMRd) request comprising Address(AS.2.1) and Tag(w.2.1), and may send the PCIe UIOMRd to the second entity. Upon receiving a completion from the second entity, which may include a PCIe UIO Read Completion with Data (UIORdCplD) comprising Tag(w.2.1) and DataPayload(*Data.1*), the computer may translate the PCIe UIORdCplD to an NVLink response comprising Tag/TransactionID(c.1.1) and *Data.1*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe UIO memory read requests in response to receiving an NVLink request from the first entity, such as when splitting an NVLink request for a large block of data to smaller PCIe UIO memory read requests, or when prefetching data from the second entity. The computer may translate NVLink-based traffic to PCIe UIO traffic in one direction, and/or may translate PCIe UIO traffic to NVLink-based traffic in the opposite direction.

FIG. 25C illustrates an example of a TFD demonstrating translations, in one direction, between NVLink-based requests, such as NVLink read requests, received from a first entity (Entity.1), which may be a CPU or a GPU, and PCIe TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.4.1), and Tag/TransactionID(c.4.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe request, such as a PCIe Memory Read (MRd) request comprising a physical address, such as an HPA Address(AS.3.1), and Tag(w.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to an NVLink response comprising Tag/TransactionID(c.4.1) and *Data.2*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe memory read requests in response to receiving an NVLink request from the first entity, such as when splitting an NVLink request for a large block of data to smaller PCIe memory read requests, or when prefetching data from the second entity. The computer may translate NVLink-based traffic to PCIe traffic in one direction, and/or may translate PCIe traffic to NVLink-based traffic in the opposite direction.

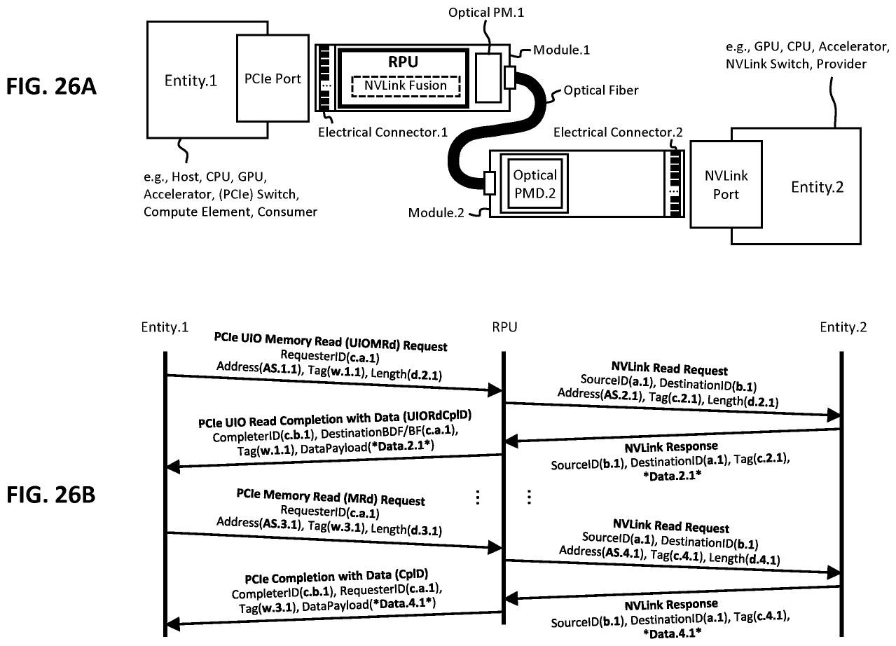

FIG. 26A illustrates an example of a cable comprising an RPU that translates between PCIe-based traffic and NVLink-based traffic. A first entity (Entity.1), which may be a host, a CPU, a GPU, an accelerator, a PCIe switch, or a compute element, and which may be referred to as a consumer, is coupled to a PCIe Port. The PCIe Port is coupled via a first electrical connector (Electrical Connector.1) to a first module (Module.1) within the cable. Module.1 may include an RPU, wherein the RPU may include an NVLink Fusion chiplet shown as an optional component, and an optical physical medium dependent (Optical PMD.1). The RPU within Module.1 may translate between PCIe-based traffic received from the first entity via the PCIe Port and NVLink-based traffic for transmission over the cable, and may translate between NVLink-based traffic received over the cable and PCIe-based traffic sent to the first entity. The cable may further include an optical fiber coupling Module.1 to a second module (Module.2), wherein the optical fiber carries NVLink-based traffic between the modules. Module.2 may include an optical physical medium dependent (Optical PMD.2). Module.2 is coupled via a second electrical connector (Electrical Connector.2) to an NVLink Port of a second entity (Entity.2), which may be a GPU, a CPU, an accelerator, or an NVLink switch, and which may be referred to as a provider. Placing the RPU in Module.1, closer to the PCIe Port, facilitates the translation from PCIe signaling to NVLink signaling at the entry point of the cable, such that the optical fiber carries NVLink-based traffic rather than PCIe-based traffic. NVLink may incorporate electrical signaling characteristics that are compatible with longer-reach interconnects, and may utilize a signaling rate higher than PCIe, and may therefore require fewer lanes for the same bandwidth. Consequently, placing the RPU closer to the PCIe Port may allow for reducing the number of optical fibers or optical wavelengths, which may simplify the cable design and reduce cost. In other examples, the RPU may reside in Module.2 instead of Module.1.

FIG. 26B illustrates an example of a TFD demonstrating translations, by an RPU, between PCIe-based requests received from a first entity (Entity.1) and NVLink-based requests sent to a second entity (Entity.2). The TFD illustrates two exemplary transactions, separated by a vertical ellipsis, demonstrating both PCIe UIO and standard PCIe paths. In a first exemplary transaction, the first entity may send a PCIe UIO Memory Read (UIOMRd) request comprising RequesterID(c.a.1), Address(AS.1.1), Tag(w.1.1), and Length(d.2.1). The RPU may translate the PCIe UIOMRd to an NVLink read request comprising SourceID(b.1), DestinationID(a.1), Address(AS.2.1), Tag(c.2.1), and Length(d.2.1), and may send the NVLink read request to the second entity. Upon receiving an NVLink response from the second entity comprising SourceID(b.1), DestinationID(a.1), Tag(c.2.1), and *Data.2.1*, the RPU may translate the NVLink response to a PCIe UIO Read Completion with Data (UIORdCplD) comprising CompleterID(c.b.1), DestinationBDF/BF(c.a.1), Tag(w.1.1), and DataPayload(*Data.2.1*), and may send the PCIe UIORdCplD to the first entity. The DestinationBDF/BF field in the UIORdCplD may correspond to the RequesterID of the originating UIOMRd, facilitating routing of the completion back to the requester.

In a second exemplary transaction, the first entity may send a PCIe Memory Read (MRd) request comprising RequesterID(c.a.1), Address(AS.3.1), Tag(w.3.1), and Length(d.3.1). The RPU may translate the PCIe MRd to an NVLink read request comprising SourceID(a.1), DestinationID(b.1), Address(AS.4.1), Tag(c.4.1), and Length(d.4.1), and may send the NVLink read request to the second entity. Upon receiving an NVLink response from the second entity comprising SourceID(b.1), DestinationID(a.1), Tag(c.4.1), and *Data.4.1*, the RPU may translate the NVLink response to a PCIe Completion with Data (CplD) comprising CompleterID(c.b.1), RequesterID(c.a.1), Tag(w.3.1), and DataPayload(*Data.4.1*), and may send the PCIe CplD to the first entity. In both transactions, the RPU may generate NVLink SourceID and DestinationID values when translating from PCIe requests, and may generate PCIe CompleterID values when translating NVLink responses to PCIe completions. The RPU may maintain state information, such as pending transaction tables, to correlate PCIe Tags with NVLink Tags and to associate completions with their corresponding requests. The RPU may translate physical addresses between the PCIe address space and the NVLink address space.

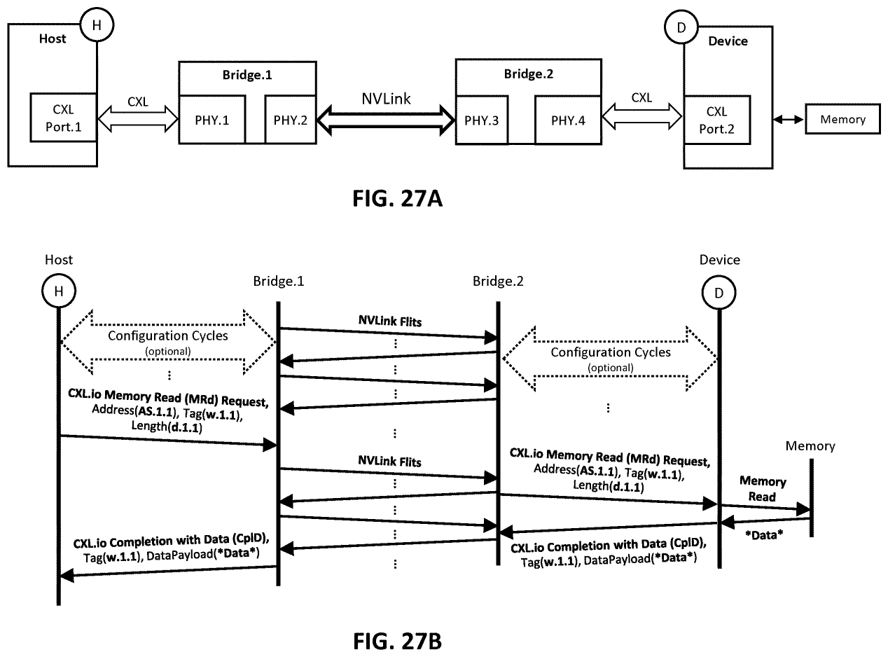

FIG. 27A illustrates an example of a system wherein a host comprising a first CXL port is coupled to Bridge.1 via a first PHY (PHY.1), which may be implemented as a Flex Bus PHY, a UCIe PHY, or an NVLink-C1C PHY. Bridge. 1 communicates with Bridge. 2 via a second PHY (PHY.2) which may be based on IEEE 802.3 PMA and may include an NVLink PHY instead of a UALink PHY. Bridge.2 is coupled via a fourth PHY (PHY.4) to a device comprising a second CXL port. Using NVLink PHY for inter-bridge communication demonstrates the flexibility of the bridge architecture to support different high-speed interconnect protocols while maintaining CXL protocol compatibility at the host and device interfaces.

FIG. 27B illustrates an example of a TFD depicting tunneling of CXL.io transactions between a host and a device through bridge.1 and bridge.2, utilizing physical layers based on IEEE 802.3 PMA. The TFD shows CXL.io Memory Read (MRd) request transmitted from the host through bridge.1, which translates or encapsulates the request for transmission to bridge.2 over NVLink flits, wherein bridge.2 performs the applicable translations to forward the request as a CXL.io transaction to the device ‘D’, with the corresponding CXL.io Completion with Data (CplD) response following the reverse path from the device through bridge.2 and bridge.1 back to the host ‘H’.

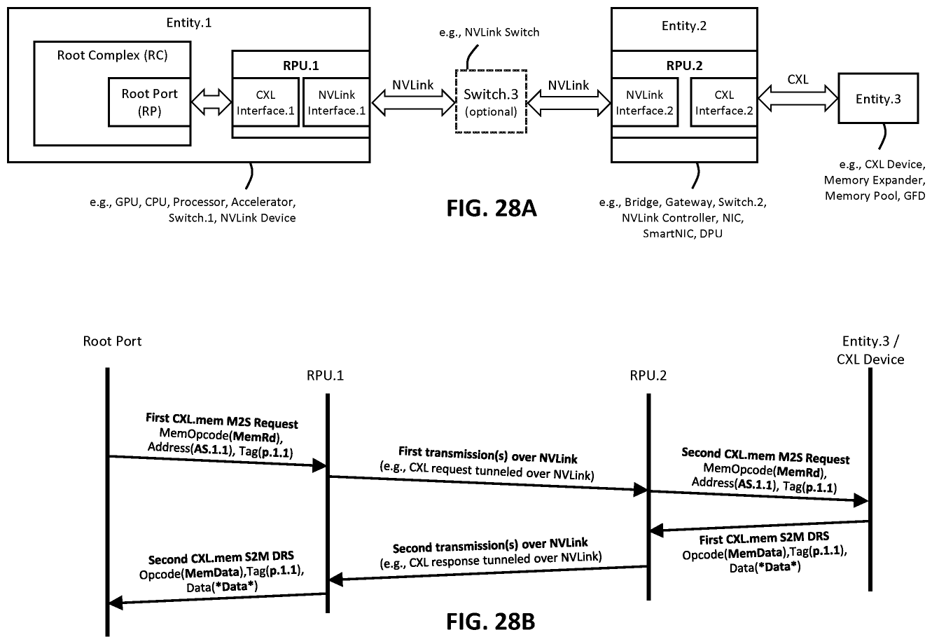

FIG. 28A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first CXL interface (CXL Interface.1) and a first NVLink Interface (NVLink Interface.1). The system may further include an optional third switch (Switch.3), such as an NVLink switch, and a second entity (Entity.2), such as a bridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second CXL interface (CXL Interface.2) and a second NVLink Interface (NVLink Interface.2). The system further includes a third entity (Entity.3), such as a CXL device, a memory expander, a memory pool, or a GFD. The first and second RPUs may enable the first entity to communicate with the third entity according to a CXL-based protocol, via the second entity and optionally via the third switch, such as by translating between CXL-based PDUs (such as TLPs, requests, messages, or flits) and transmissions comprising data indicative of CXL PDUs, such as transmissions comprising data indicative of CXL opcodes and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the CXL-based PDUs and the transmissions utilizing NVLink PDUs may enable CXL over NVLink, such as via CXL tunneling over NVLink, e.g., tunneling of CXL.mem requests and responses over NVLink, tunneling of CXL.io TLPs over NVLink, tunneling of CXL-based PDUs over NVLink, or tunneling of CXL transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch comprising the first NVLink interface, the second entity may be a second switch comprising the second NVLink interface, and the CXL traffic between the first and second switches may be tunneled over NVLink. Optionally, the first and second switches may be coupled by the third switch, which may be an NVLink switch. In other examples, the first entity may be a first switch comprising the first CXL interface (CLX Interface.1), the second entity may be a second switch comprising the second CXL Interface (CXL Interface.2), and the CXL traffic between the RP and the third entity (e.g., a CXL device) may be tunneled over NVLink via the second switch and optionally via the third switch, which may be an NVLink switch.

FIG. 28B illustrates an example of a TFD demonstrating a CXL communication between a first entity (Entity.1), such as a processor comprising a root port (RP), and a third entity (Entity.3), such as a CXL device, wherein the CXL communication may be tunneled over NVLink. The first entity may initiate a read from the third entity, such as by sending a first CXL.mem M2S request comprising MemOpcode(MemRd), Address(AS.1.1), and Tag(p.1.1) via the RP. The first RPU (RPU.1), which may reside in the first entity, may receive the first CXL.mem M2S request and translate it to first transmission(s) comprising data indicative of CXL PDU, such as transmission(s) comprising data indicative of CXL opcodes and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first CXL.mem M2S request to the first transmission(s) in a manner that enables reconstruction of the first CXL.mem M2S request at the second RPU with minimal (or no) modifications, effectively tunneling the first CXL.mem M2S request over NVLink. For example, the first RPU may encapsulate the first CXL.mem M2S request into an NVLink request, such as an NVLink write request, and send the NVLink request to the second RPU, wherein the CXL request may be extracted from the NVLink request such as by decapsulation. Additionally or alternatively, the first RPU may encapsulate a CXL flit comprising the first CXL.mem M2S request into an NVLink request, such as an NVLink write request, and send the NVLink request to the second RPU, wherein the CXL flit comprising the first CXL.mem M2S request may be extracted from the NVLink request such as by decapsulation. The second RPU may receive the first transmission(s) and translate it to a second CXL.mem M2S request comprising MemOpcode(MemRd), Address(AS.1.1), and Tag(p.1.1), and send the second CXL.mem M2S request to the third entity. In some examples, the first CXL.mem M2S request and the second CXL.mem M2S request may be identical, whereas in other examples the second RPU may construct the second CXL.mem M2S request based on the first CXL.mem M2S request with variations such as utilizing a different opcode (e.g., MemRdData instead of MemRd), utilizing a different Tag namespace, e.g., Tag(q.2.1) instead of Tag (p.1.1), or utilizing address translations, e.g., Address(AS.2.1) instead of Address(AS.1.1).

The third entity may respond to the second CXL.mem M2S request by sending a first CXL.mem S2M DRS comprising Opcode(MemData), Tag(p.1.1), and Data(*Data*) to the second RPU, wherein the second RPU may translate the first CXL.mem S2M DRS to second transmission(s) comprising data indicative of CXL PDU, and send the second transmission(s) to the first RPU. The first RPU may further receive the second transmission(s) and translate it to a second CXL.mem S2M DRS comprising Opcode(MemData), Tag(p.1.1), and Data(*Data*), and send the second CXL.mem S2M DRS to the RP. In some examples, the first CXL.mem S2M DRS and the second CXL.mem S2M DRS may be identical, whereas in other examples the first RPU may construct the second CXL.mem S2M DRS based on the first CXL.mem S2M DRS with variations, such as updating fields, e.g., Device Load (DevLoad), MetaField, MetaValue, TRP, Opcode, or reserved fields. Additionally or alternatively, the first RPU may alter the structure of the second CXL.mem S2M DRS compared to the original first CXL.mem S2M DRS, such as by adding a trailer.

In some examples, the second CXL.mem M2S request may be different from the first CXL.mem M2S request due to differences in protocol revisions, such as when the first RPU communicates with the RP according to CXL 1.1, whereas the second RPU communicates with the third entity according to CXL 3.2, or such as when message format conversion is required between HBR and PBR formats, e.g., when the second RPU utilizes PBR mode or PBR messages, whereas, for example, the RP is associated with an HBR host. Similarly, the second CXL.mem S2M DRS may be different from the first CXL.mem S2M DRS due to differences in protocol revisions, or such as when message format conversion is required between HBR and PBR formats. In some examples, the first RPU and the second RPU may be coupled by a switch, such as a UALink switch.

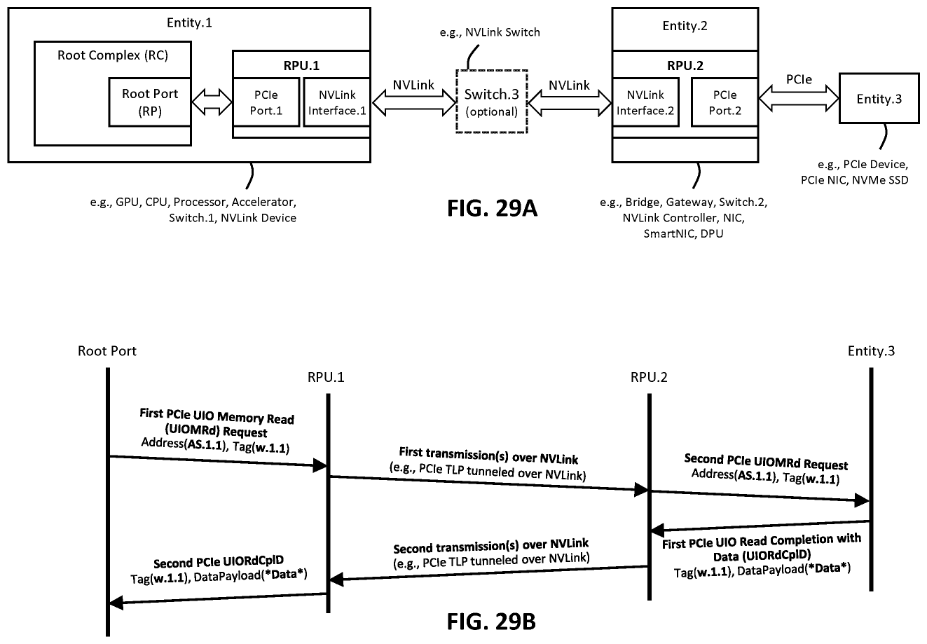

FIG. 29A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first PCIe port (PCIe Port.1) and a first NVLink Interface (NVLink Interface.1). The system may further include an optional third switch (Switch.3), such as a NVLink switch, and a second entity (Entity.2), such as a bridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second PCIe port (PCIe Port.2) and a second NVLink Interface (NVLink Interface.2). The system further includes a third entity (Entity.3), such as a PCIe device, a PCIe NIC, or an NVMe SSD. The first and second RPUs may enable the first entity to communicate with the third entity according to a PCIe-based protocol, via the second entity and optionally via the third switch, such as by translating between PCIe-based PDUs (such as PCIe TLPs, requests, messages, or flits) and transmissions comprising data indicative of PCIe PDUs, such as transmissions comprising data indicative of PCIe TLP types and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the PCIe-based PDUs and the transmissions utilizing NVLink PDUs may enable PCIe over NVLink, such as via PCIe tunneling over NVLink, e.g., tunneling of PCIe requests and completions over NVLink, tunneling of PCIe TLPs over NVLink, tunneling of PCIe-based PDUs over NVLink, or tunneling of PCIe transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch, such as a first PCIe switch comprising the first NVLink interface, the second entity may be a second switch, such as a second PCIe switch comprising the second NVLink interface, wherein the PCIe traffic between the first PCIe switch and the second PCIe switch may be tunneled over NVLink, and wherein the first PCIe switch and the second PCIe switch may be coupled by the third switch, that may be an NVLink switch. In other examples, the first entity may be a first switch, such as a first NVLink switch comprising the first PCIe Port (PCIe Port.1), the second entity may be a second switch, such as a second NVLink switch comprising the second PCIe Port (PCIe Port.2), wherein the PCIe traffic between the RP and the third entity (e.g., a PCIe device) may be tunneled over NVLink via the second NVLink switch and optionally via the third switch, such as a third NVLink switch.

FIG. 29B illustrates an example of a TFD demonstrating PCIe communication between a first entity (Entity.1), such as a processor comprising a root port (RP), and a third entity (Entity.3), such as a PCIe device, wherein the PCIe communication may be tunneled over NVLink. The first entity may initiate a read from the third entity, such as by sending a first PCIe UIO Memory Read (UIOMRd) request comprising Address(AS.1.1) and Tag(w.1.1) via the RP. The first RPU (RPU.1), which may reside in the first entity, may receive the first PCIe UIOMRd and translate it to first transmission(s) comprising data indicative of PCIe PDU, such as transmission(s) comprising data indicative of TLP types and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first PCIe UIOMRd to the first transmission(s) in a manner that enables reconstruction of the first PCIe UIOMRd at the second RPU with minimal (or no) modifications, effectively tunneling the first PCIe UIOMRd over NVLink. For example, the first RPU may encapsulate the first PCIe UIOMRd into an NVLink request, such as an NVLink write request, and send the NVLink request to the second RPU, wherein the PCIe request may be extracted from the NVLink request such as by decapsulation. Additionally or alternatively, the first RPU may encapsulate a PCIe flit comprising the first PCIe UIOMRd into an NVLink request, such as an NVLink write request, and send the NVLink request to the second RPU, wherein the PCIe flit comprising the first PCIe UIOMRd may be extracted from the NVLink request such as by decapsulation.

The second RPU may receive the first transmission(s) and translate it to a second PCIe UIOMRd comprising Address(AS.1.1) and Tag(w.1.1), and send the second PCIe UIOMRd to the third entity. In some examples, the first PCIe UIOMRd and the second PCIe UIOMRd may be identical, whereas in other examples, the second RPU may construct the second PCIe UIOMRd based on the first PCIe UIOMRd with variations such as utilizing a different TLP type (e.g., MRd instead of UIOMRd), utilizing a different Tag namespace, e.g., Tag(q.2.1) instead of Tag (w.1.1), or utilizing address translations, e.g., Address(AS.2.1) instead of Address(AS.1.1). The third entity may respond to the second PCIe UIOMRd by sending a first PCIe UIO Read Completion with Data (UIORdCplD) comprising Tag(w.1.1) and DataPayload(*Data*) to the second RPU, wherein the second RPU may translate the first PCIe UIORdCplD to second transmission(s) comprising data indicative of PCIe PDU, and send the second transmission(s) to the first RPU. The first RPU may further receive the second transmission(s) and translate it to a second PCIe UIORdCplD comprising Tag(w.1.1) and DataPayload(*Data*), and send the second PCIe UIORdCplD to the RP.

In some examples, the first PCIe UIORdCplD and the second PCIe UIORdCplD may be identical, whereas other examples, the first RPU may construct the second PCIe UIORdCplD based on the first PCIe UIORdCplD with variations, such as updating fields, e.g., reserved fields or fields treated as reserved, such as CDL that may represent CXL device load for QoS telemetry, where this field may be treated as reserved for use cases not covered by CXL. Additionally or alternatively, the first RPU may alter the structure of the second PCIe UIORdCplD compared to the original first PCIe UIORdCplD, such as by adding a TLP trailer, such as for supporting Transaction Layer end-to-end 32-bit CRC (ECRC) that may cover the path between the second RPU and the RP.

In some examples, the second PCIe UIOMRd may be different from the first PCIe UIOMRd due to differences in protocol revisions, such as when the first RPU communicates with the RP according to a first PCIe specification revision, whereas the second RPU communicates with the third entity according to a second PCIe specification revision (that may be different than the first PCIe specification revision), or such as when translation is required between Flit Mode (FM) and Non-Flit Mode (NFM) TLP formats. Similarly, the second PCIe UIORdCplD may be different from the first PCIe UIORdCplD due to differences in protocol revisions, or such as when translation is required between FM and NFM TLP formats. In some examples, the first RPU and the second RPU may be coupled by a switch, such as an NVLink switch.

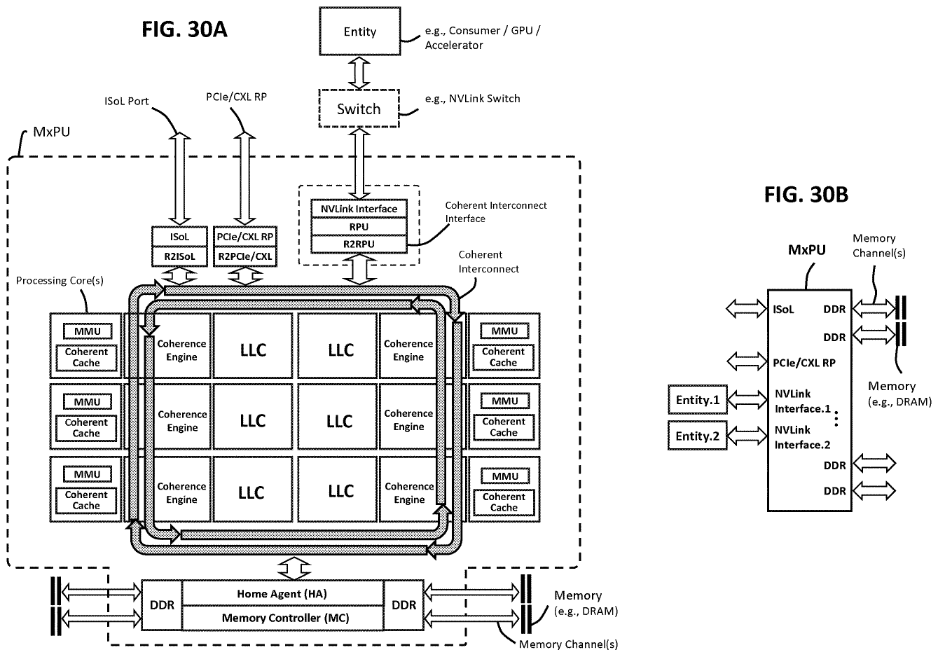

FIG. 30A illustrates an example of a processor (such as an MxPU that may be derived from an established processor design) comprising processing cores, last level cache (LLC), and a coherent interconnect utilizing a topology structure of a ring. Alternatively, the coherent interconnect may utilize other topology structures such as a mesh, a crossbar, or a custom topology. The processor may include an NVLink interface, and an ISoL port, such as a port utilizing ARM CHI C1C, NVIDIA NVLink-C1C, Intel UPI, or AMD Infinity Fabric. The processor may further include a PCIe/CXL root port (PCIe/CXL RP), and may be coupled to memory, such as DRAM, optionally via a memory controller and memory channels. The NVLink interface may communicate with an entity, such as a GPU or a CPU, optionally via a switch, according to an NVLink-based protocol, wherein an RPU may perform physical address translations that may enable the entity to access the memory via the NVLink interface. The illustrated RPU is coupled to the on-chip ring interconnect via a coherent interconnect interface, such as a Ring-to-RPU (R2RPU). Alternatively, the RPU may be coupled to the on-chip ring interconnect essentially directly. Similarly, the illustrated ISoL port is coupled to the on-chip ring interconnect via a coherent interconnect interface, such as a Ring-to-ISoL (R2ISoL), and the PCIe/CXL RP is coupled to the on-chip ring interconnect via a coherent interconnect interface, such as a Ring-to-PCIe/CXL (R2PCIe/CXL). The processor may be implemented as a monolithic die, as chiplets within an IC package, such as by utilizing separate compute die(s) and I/O die(s), or as components on a board.

FIG. 30B illustrates an example of a processor (such as an MxPU) comprising NVLink interfaces, DDR channels, at least one optional PCIe/CXL RP, and at least one optional ISoL. The NVLink interfaces may not utilize the same physical address space, may be coupled to entities, optionally via a switch, and may communicate with the entity according to one or more NVLink-based protocols.

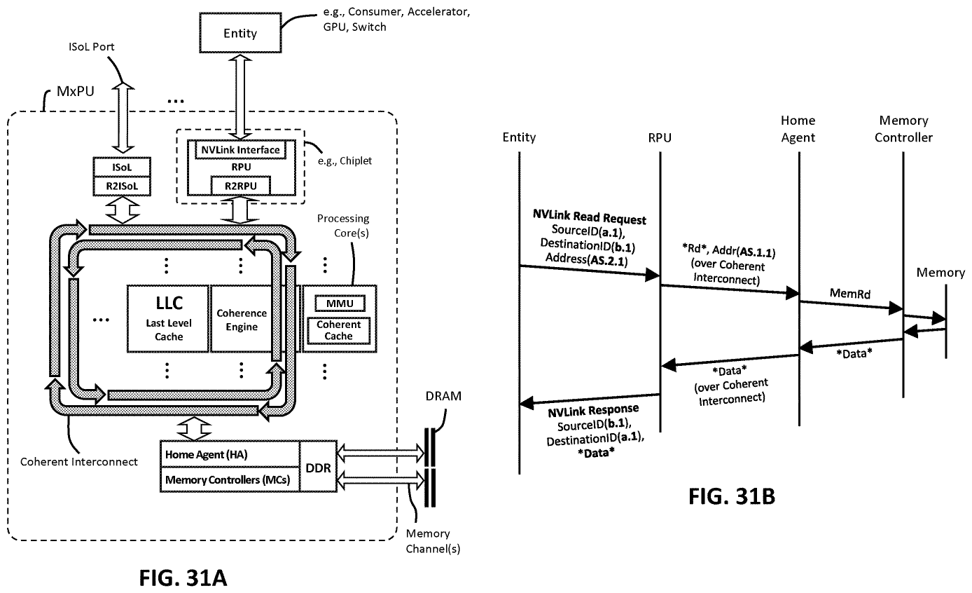

FIG. 31A illustrates an example of a processor (such as an MxPU) comprising processing cores, caches, and a coherent interconnect utilizing a topology structure of a ring. Alternatively, the coherent interconnect may utilize other topology structures such as a mesh, a crossbar, or a custom topology. The processor may further include an ISoL port such as ARM CHI C2C, NVIDIA NVLink-C2C, or Intel UPI, and memory controllers coupled via memory channels to memory, such as DRAM. The processor may include an NVLink interface that may communicate with an entity such as a GPU or an accelerator, according to an NVLink-based protocol, wherein an RPU may perform physical address translations to enable the entity to access the memory. The illustrated RPU is coupled to the coherent interconnect via a Ring-to-RPU (R2RPU) interconnect interface. Alternatively, the RPU may be coupled to the on-chip ring interconnect essentially directly. In some examples, the RPU, the NVLink interface, and the R2RPU may reside on a chiplet, such as an NVLink chiplet or NVLink Fusion, and coupled to the coherent interconnect via a chip-to-chip (C2C) interface. Similarly, the illustrated ISoL port may be coupled to the on-chip ring interconnect via a Ring-to-ISoL (R2ISoL) interconnect interface. The processor may be implemented as a monolithic die that includes the RPU and the NVLink interface, as silicon dies or chiplets within an IC package, such as by utilizing separate compute die(s) and I/O die(s), or as components on a board.

FIG. 31B illustrates an example of a TFD demonstrating an NVLink read request received from an entity, such as a GPU or an accelerator, wherein the RPU may translate a physical address (AS.2.1) carried in the NVLink request, to a physical address (AS.1.1) utilized for accessing the memory. The NVLink request may carry ID-based fields, such as source ID and destination ID, which may be utilized by NVLink switches for routing the request. In some examples, the NVLink request may further include a Tag that may be utilized to identify a transaction and match it with a corresponding NVLink response, and may further include a Length field that may specify the length of the data transfer requested. In some examples, the RPU may translate an NVLink request to multiple read transactions of the protocol utilized by the coherent interconnect, such as in order to fulfill the length of the data transfer specified in the NVLink request. The RPU may perform further translations, such as protocol translations from an NVLink-based protocol to a protocol utilized by the processor's coherent interconnect, and may further send the optionally translated request to a home agent (also known as home node), and/or to a memory controller, requesting the read of address (AS.1.1). In some examples, the requested data may be provided by a processor cache, such as by an LLC, instead of being provided by the memory. The data may then return over the processor's coherent interconnect to the RPU, wherein the RPU provides an NVLink response to the requesting entity. In some examples, the NVLink response may include a Tag that may identify the transaction and may enable matching the NVLink response with a corresponding NVLink request.

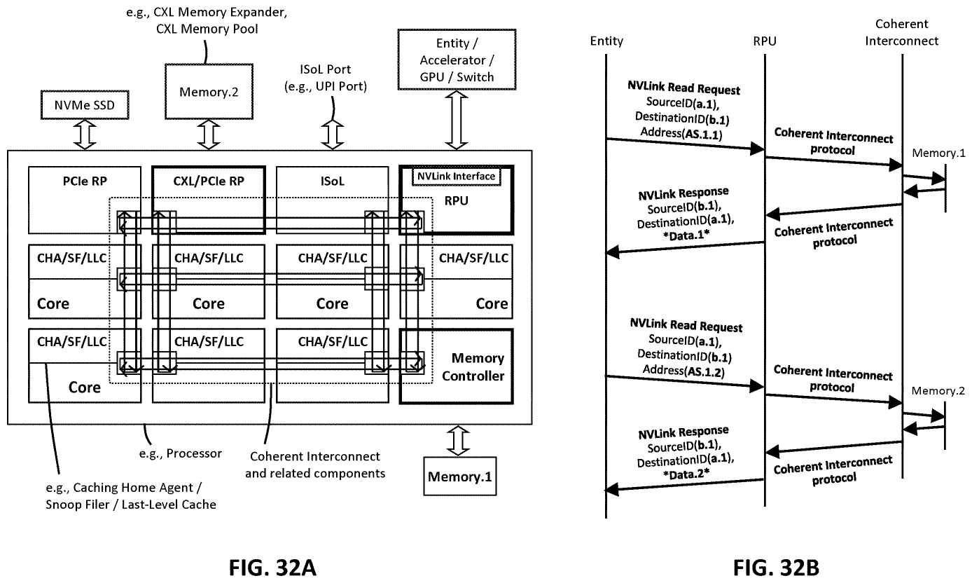

FIG. 32A illustrates an example of a system comprising a processor, including a coherent interconnect, capable of enabling an external entity to access memory resources mapped to the address space utilized by the coherent interconnect. Optionally, the processor may include an MxPU derived from an established processor design that may include processing cores, caching/home agent (CHA), snoop filter (SF), and last-level cache (LLC), optionally implemented as slices distributed across tiles on the coherent interconnect mesh. The processor may further include an ISoL port (such as a port utilizing Intel Coherent Processor Interconnect Protocol (ICPIP), or ARM CHI C1C), a PCIe RP that may be coupled to an NVMe SSD, a CXL/PCIe RP, and/or a memory controller that may be coupled to a first memory, such as DRAM. The processor may be coupled to a second memory, such as a CXL memory expander or a CXL memory pool, and may further include an RPU that includes or coupled to an NVLink interface that may communicate with an entity, such as an accelerator, according to an NVLink-based protocol, wherein the RPU may perform physical address translations to enable the entity to access the first memory (Memory.1) and/or the second memory (Memory.2). The illustrated RPU may be coupled to the coherent interconnect, and may translate between the NVLink-based protocol and a protocol utilized by the coherent interconnect. The processor may be implemented as a monolithic die, as chiplets within an IC package, such as by utilizing separate compute die(s) and I/O die(s), or as components on a board, and may utilize a mesh-based coherent interconnect, or in other examples may utilize a ring, a crossbar, or other types of coherent interconnects. In other examples, the NVLink interface may reside on a separate chiplet, such as an NVLink Fusion, and may be coupled to the coherent interconnect via a UCIe interface or a proprietary chip-to-chip or die-to-die interface.

FIG. 32B illustrates an example of a TFD demonstrating two NVLink requests, such as NVLink read requests, received from an entity (such as an accelerator, GPU, or a switch) and forwarded to different memories mapped to an address space utilized by the coherent interconnect. The RPU may perform physical address translations to enable the entity to access the processor's memories. The processor may have multiple memory resources, such as DRAM coupled to a memory controller of the processor, and/or memory expanders that may be coupled to a CXL RP of the processor. The RPU may further translate from NVLink-based traffic to traffic conforming to a protocol utilized by the coherent interconnect, and may send the optionally translated traffic to the coherent interconnect, requesting a read from memory. In some examples, the requested data may be provided by a processor cache, such as by an LLC, instead of by the memory. The data may then return over the coherent interconnect to the RPU, wherein the RPU provides an NVLink response to the requesting entity. The TFD illustrates two exemplary transactions carrying different physical addresses mapped to different memory resources. The first exemplary transaction includes an NVLink request comprising physical address (AS.1.1), which the RPU translates and forwards via the coherent interconnect protocol to Memory.1, resulting in the retrieval of *Data.1* that is returned to the entity with the first NVLink response. The second exemplary transaction includes an NVLink request comprising physical address (AS.1.2), which the RPU translates and forwards via the coherent interconnect protocol to Memory.2, resulting in the retrieval of *Data.2* that is returned to the entity with the second NVLink response. The physical addresses (AS.1.1) and (AS.1.2) may refer to different memory regions within the address space utilized by the coherent interconnect, enabling the entity to access memory resources based on the RPU's translation capabilities.

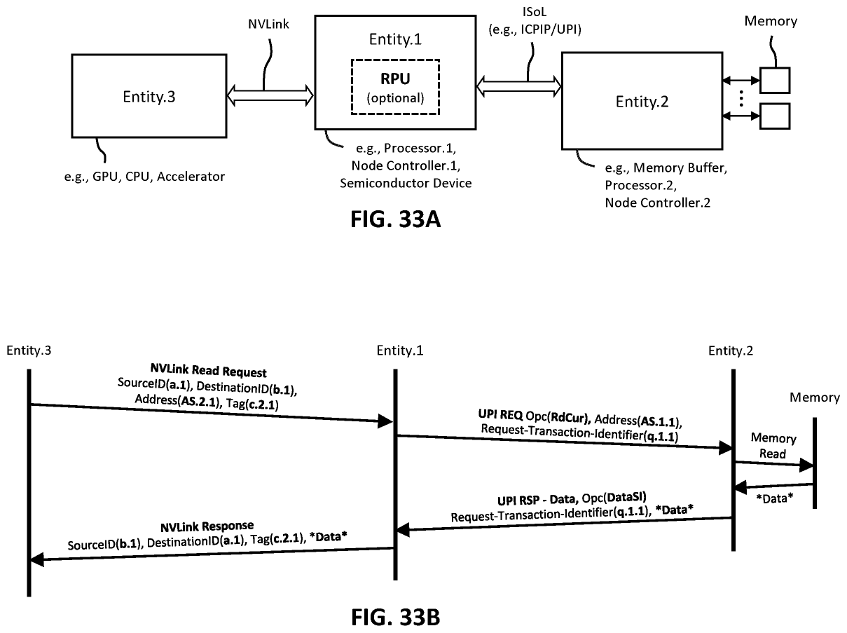

FIG. 33A illustrates an example of a system comprising a first entity (Entity.1), such as a first processor (Processor.1), a first node controller (Node Controller.1), or a semiconductor device, which may include an RPU. The first entity may be coupled to a third entity (Entity.3), which may be an accelerator, a GPU, a CPU, or an NVLink switch, wherein the first entity may communicate with the third entity according to an NVLink-based protocol, such as a protocol utilizing an NVLink interconnect. The first entity may be further coupled to a second entity (Entity.2), which may be a second processor (Processor.2), a memory buffer, or a second node controller (Node Controller.2), wherein the second entity may be coupled to memory, and wherein the first entity may communicate with the second entity according to an ISoL protocol, such as ARM CHI C1C, a protocol utilizing an NVIDIA NVLink-C1C interconnect, or Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC).

The first entity, optionally via the RPU, may translate between messages conforming to the NVLink-based protocol and messages conforming to the ISoL protocol, such as ICPIP, enabling the third entity to access resources coupled to the first entity (Entity.1), such as the memory that may be coupled to the second entity. In some examples, messages conforming to the NVLink-based protocol may be associated with a first address space, such as an NVLink-based address space, an NVLink-based network address space, or a GPU address space; and messages conforming to the ISoL protocol, such as ICPIP (e.g., Intel UPI), may be associated with a second address space, such as a System Physical Address (SPA) space or a Host Physical Address (HPA) space; wherein the first entity, optionally via the RPU, may perform address translations between addresses within the first and second address spaces, respectively, such as between addresses within the NVLink-based address space and addresses within the SPA space or the HPA space. In other examples, messages conforming to the NVLink-based protocol and messages conforming to the ISoL protocol, such as ICPIP (e.g., Intel UPI), may be associated with the same physical address space, such as with a global address space, a partitioned global address space (PGAS), a pod address space, a virtual pod address space, or a fabric address space; wherein the first entity, optionally via the RPU, may perform address translations between addresses within the same address spaces.

The first entity, optionally via the RPU, may perform further translations, such as protocol translations, opcode translations, command translations, TLP translations, or field translations (e.g. cross-field translations), such as between request types of NVLink requests and opcodes in requests conforming to the ISoL Protocol (e.g., Intel UPI RdCur opcode). The first entity, optionally via the RPU, may further translate between values of fields carried in PDUs of the NVLink-based protocol and in PDUs of the ISoL Protocol, e.g., translate traffic class (TC) and/or Tags, wherein the first entity, optionally via the RPU, may maintain tracking between Tags associated with the NVLink-based protocol and Tags associated with the ISoL protocol, such as in order to associate responses with their corresponding requests, within the same domain and/or between different domains.

FIG. 33B illustrates an example of a TFD demonstrating translations performed by a first entity (Entity.1), such as a first processor (Processor.1), a first node controller (Node Controller.1), or a semiconductor device, optionally via an RPU, between NVLink-based traffic and ISoL traffic, such as ICPIP traffic. The NVLink-based traffic may be utilized for communicating with a third entity (Entity.3), such as an accelerator, and the ISoL traffic may be utilized for communicating with a second entity (Entity.2), such as a second processor (Processor.2), or a second node controller (Node Controller.2). The second entity may be coupled to a memory, such as DRAM, which may be mapped to a physical address space (PAS) utilized by the first entity. The third entity may initiate an NVLink request, such as an NVLink read request, comprising SourceID(a.1), DestinationID(b.1), Address(AS.2.1), and Tag(c.2.1), wherein SourceID(a.1) may identify the source entity in the NVLink interconnect, such as the source GPU, wherein DestinationID(b.1) may identify the destination entity in the NVLink interconnect, such as the destination GPU, and wherein the NVLink interconnect may utilized ID-based routing when forwarding the NVLink request. The first entity, optionally via the RPU, may translate the NVLink request to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests. The first entity may send the UPI request (REQ) to the second entity.

Upon receiving a response from the second entity, that may include a UPI data response (“RSP-Data” message class, which may also be denoted by “RSP4-Data”) comprising Opc(DataSI), Request-Transaction-Identifier(q.1.1), and *Data*, the first entity, optionally via the RPU, may translate the UPI response (RSP-Data) to an NVLink response comprising SourceID(b.1), DestinationID(a.1), Tag(c.2.1), and *Data*. In some examples, the requested data may be provided by a processor cache instead of by the memory, such as wherein the requested data may be provided by an LLC that may be included in the first entity, or by an LLC that may be included in the second entity. In other examples, the first entity (Entity.1), optionally via the RPU, may translate the NVLink request to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO. The first entity, optionally via the RPU, may perform further translations, such as protocol translations, opcode translations, command translations, or translations between protocol data units (PDUs) of the NVLink-based traffic and PDUs of the ISoL traffic (e.g., Intel UPI), such as traffic class (TC) translations, cross-field translations, or Tag translations. The first entity, optionally via the RPU, may maintain tracking between Tags in the NVLink-based domain and Tags in the ISoL domain, such as in order to associate responses with their corresponding requests, within the same domain and/or between different domains.

In computing environments where a host, such as a CPU, accesses memory resources on a device, such as an accelerator, the device may expose memory regions to the host via CXL. Different memory regions may have different coherency requirements and may be backed by different types of memory. For example, a first memory region may be backed by local memory coupled to the device, such as HBM and/or High-Bandwidth Flash (HBF), and may benefit from device coherency where the device participates in cache coherency with the host. A second memory region may be backed by memory accessible via a UALink network, such as memory residing on remote accelerators, and may not require device coherency participation. The CXL specification defines different HDM types and device type flows that correspond to different coherency models, and a device may expose concurrent HDM regions utilizing different device type flows. An RPU or translation logic within the device may translate between CXL protocol messages received from the host and UPLI messages for accessing memory in the UALink domain, while maintaining the appropriate coherency semantics for each memory region.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an Ultra Accelerator Link (UALink)-based protocol; and translating, by the device, between a protocol based on CXL and UALink Protocol Level Interface (UPLI) for at least one of the first memory region or the second memory region. The method may be implemented in hardware, firmware, software, or combinations thereof, and may be performed by various types of devices, such as an accelerator, an RPU, a semiconductor device, or a chiplet within an IC package. The first and second CXL device type flows may correspond to any combination of CXL Type-2 and Type-3 device flows, and may further include CXL Type-1 device flows in some examples. The device may expose additional memory regions beyond the first and second memory regions, each utilizing different or the same CXL device type flows. Translations between the protocol based on CXL and UPLI may include translations of opcodes, addresses, Tags, and additional fields, and may further include address translations between different address spaces such as a Host Physical Address (HPA) space and a Network Physical Address (NPA) space. The first memory may include memory coupled to the device, such as HBM, HBF, DRAM, or GDDR, while the second memory may include memory accessible via a UALink switch, a UALink network, or remote accelerators within a UALink domain. The elements may communicate through one or more intermediary components, such as a switch, a retimer, or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to utilize both CXL.mem and CXL.cache protocols for the HDM-D region, allowing the device to maintain cached copies of data and participate in coherency negotiations with the host. The CXL Type-3 device flow may utilize CXL.mem without CXL.cache for the HDM-H region, where the host manages coherency without device cache participation.

In some implementations, the method further comprises receiving, from the host, a CXL.mem Master-to-Subordinate (M2S) request comprising MemRd* and an address targeting the first memory region, wherein the CXL.mem M2S request further comprises a SnpType field, a MetaField field, and a MetaValue field; translating the CXL.mem M2S request to a UPLI request; receiving a UPLI response comprising data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. The SnpType, MetaField, and MetaValue fields in the CXL.mem M2S request may indicate the cacheline state intent of the host, such as requesting a shared copy (SnpData) or an exclusive copy (SnpInv). The device may utilize these fields to determine the appropriate coherency response. The device coherency engine (DCOH) may select Cmp-S when the device retains a cached copy of the data, or Cmp-E when the device relinquishes its cached copy. The device may translate the CXL.mem M2S request to a UPLI request to fetch the data from the UALink domain before responding.

In some implementations of the method, the device comprises a cache; and wherein the device stores the data from the UPLI response in the cache and sends the CXL.mem S2M NDR comprising Cmp-S indicating that the device retains a cached copy of the cacheline at the address. By caching the fetched data and responding with Cmp-S, the device may enable subsequent accesses to the same cacheline to be served from its local cache without requiring another UPLI transaction. A device with cache, or a device that controls or utilizes a cache, may include a cache memory, a cache controller, or cache allocation and eviction logic.

In some implementations of the method, the UPLI request comprises a ReqSrcPhysAccID field, a ReqDstPhysAccID field, a ReqTag field, a ReqAddr field, and a ReqCmd field comprising a read command; and further comprising translating a Tag of the CXL.mem M2S request to the ReqTag of the UPLI request. The ReqSrcPhysAccID and ReqDstPhysAccID fields may carry identifiers utilized by the UALink network for routing the UPLI request. The Tag translation may involve maintaining a bidirectional mapping between CXL.mem Tag values and UPLI ReqTag values, enabling proper correlation of UPLI responses with their corresponding CXL.mem requests.

In some implementations, the method further comprises receiving, from the host, a CXL.mem Master-to-Subordinate (M2S) request comprising MemRd* and an address targeting the second memory region; translating the CXL.mem M2S request to a UPLI request; receiving a UPLI response comprising data; and sending to the host a CXL.mem Subordinate-to-Master Data Response (S2M DRS) comprising MemData and the data. For the second memory region, the device may operate as a passthrough translator that fetches data from the UALink domain and returns it to the host without maintaining cached copies or participating in coherency negotiations. The CXL.mem S2M DRS may carry MemData without an accompanying S2M NDR indicating Cmp-S or Cmp-E, because the device does not track cache state for this memory region.

In some implementations of the method, the UPLI response further comprises a RdRspDataError field indicating a data error; and further comprising translating the RdRspDataError field to a Poison field of the CXL.mem S2M DRS sent to the host. The RdRspDataError field in the UPLI response may serve as a per-beat data poison indicator. The translation of error indications across protocol boundaries may enable the host to detect data corruption that originated in the UALink domain and to take appropriate recovery actions.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region. RdOwn may acquire exclusive ownership, RdShared may acquire a shared copy, RdCurr may request a non-cacheable current value, and RdAny may accept any coherency state.

In some implementations of the method, the first memory comprises at least one of High Bandwidth Memory (HBM) or High-Bandwidth Flash (HBF) coupled to the device, the second memory comprises memory accessible via a UALink switch or a UALink network, and the device comprises an accelerator. The accelerator may be a GPU, a TPU, or other processing unit with HBM and/or HBF that may benefit from device coherency for its local memory. The UALink switch or fabric may couple the accelerator to remote accelerators, and the second memory may reside on the remote accelerators or on other memory resources within the UALink domain.

In some implementations, the method further comprises translating, by the device, between a first address associated with a first address space utilized by the host and a second address associated with a second address space utilized by the UALink-based protocol; wherein the first address space comprises a Host Physical Address (HPA) space, and the second address space comprises a Network Physical Address (NPA) space or a System Physical Address (SPA) space. The address translation may be implemented utilizing lookup tables, page tables, base-and-offset calculations, or programmable translation functions. The HPA space may represent the host's view of the memory, while the NPA or SPA space may represent the address used by the UALink network for routing and accessing memory resources.

In some implementations of the method, at least one of the first memory region or the second memory region comprises a Host-managed Device Memory with Back-Invalidate (HDM-DB) region; and wherein the device sends a CXL.mem Subordinate-to-Master Back-Invalidate Snoop (S2M BISnp) to the host, and the host responds with a CXL.mem Master-to-Subordinate Back-Invalidate Response (M2S BIRsp). The HDM-DB region may enable the device to snoop the host's cache when the device needs to modify or evict cached data. The S2M BISnp may carry opcodes such as BISnpInv, BISnpData, or BISnpCur, and the M2S BIRsp may carry opcodes such as BIRspI, BIRspS, or BIRspE indicating the resulting host cache state. HDM-DB may be utilized with either CXL Type-2 or CXL Type-3 device flows.

In some implementations, the method further comprises receiving, from the host, a CXL.mem Master-to-Subordinate Request with Data (M2S RwD) comprising MemWr* and write data; translating the CXL.mem M2S RwD to a UPLI request comprising a write command and the write data; and sending a CXL.mem Subordinate-to-Master No Data Response (S2M NDR) to the host. The write command in the UPLI request may include Write or WriteFull commands. The device may send the S2M NDR before or after the UPLI write completes, depending on ordering requirements and system configuration.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

In computing systems where a host accesses memory resources on a device coupled via CXL, the device may expose memory regions with different coherency characteristics to the host. A first memory region associated with local memory, such as HBM, may be exposed via a CXL device type flow that supports device coherency, enabling the host and device to maintain coherent cached copies of data. A second memory region associated with memory accessible via a UALink port may be exposed via a different CXL device type flow that does not require device coherency participation. The device may include an RPU or translation logic configured to translate between CXL protocol messages and UPLI messages for memory access operations targeting the UALink-accessible memory. A UALink switch may couple the device to one or more remote accelerators whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an Ultra Accelerator Link (UALink) port of the device; and wherein the device is configured to translate between a protocol based on CXL and UALink Protocol Level Interface (UPLI) for requests targeting at least one of the first memory region or the second memory region. The system may enable a host to access both local and remote memory resources on the device through a CXL link, with differentiated coherency semantics for different memory regions. The device may include an RPU, translation logic, or a combination of hardware and firmware that performs the translations between CXL and UPLI. The device may configure the boundaries between the first and second memory regions dynamically or statically, for example utilizing HDM decoder registers or programmable address range registers.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region. In some examples, the assignment of HDM types to memory regions may be configurable at system initialization or runtime.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to UPLI requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state of the cacheline at the device. For the second memory region, the device may translate the request to UPLI, fetch the data from the UALink domain, and return the data.

In some implementations of the system, the host communicates with the device via CXL.mem and CXL.cache for the first memory region, and the host communicates with the device via CXL.mem without CXL.cache for the second memory region. The use of CXL.cache for the first memory region may enable the device to initiate coherency transactions and respond to host snoops, supporting scenarios where the device and host may both cache data from the first memory region. The absence of CXL.cache for the second memory region may simplify the memory access path for remote memory.

In some implementations of the system, the device comprises an accelerator comprising a resource provisioning unit (RPU), and the first memory comprises at least one of High Bandwidth Memory (HBM) or High-Bandwidth Flash (HBF) coupled to the accelerator; and further comprising a UALink switch coupling the UALink port of the device to one or more remote accelerators, wherein the second memory is accessible via the UALink switch. The RPU may be implemented as an IP block embedded within the accelerator, or as a chiplet within an IC package containing the accelerator. The UALink switch may route UPLI traffic based on destination accelerator identifiers carried in the UPLI requests. The one or more remote accelerators may each have their own HBM, HBF, or other memory that collectively forms the second memory accessible from the device.

In computing environments where a host, such as a CPU, accesses memory resources on a device coupled via CXL, the device may expose memory regions to the host with different connectivity. A first memory region may be backed by local memory coupled to the device, while a second memory region may be backed by memory accessible via an NVLink fabric, such as memory residing on GPUs or other NVLink-connected devices. NVLink provides high-bandwidth communication between GPUs and accelerators, and may support distributed memory models where devices access memory via other devices. The device may translate between CXL protocol messages received from the host and NVLink messages for accessing memory in the NVLink domain, while exposing different CXL device type flows for different memory regions to provide appropriate coherency semantics. NVLink messages may carry fields such as source and destination identifiers for routing, addresses for memory location, transaction tags for response correlation, length fields for transfer size, and data payloads.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an NVLink-based protocol; and translating, by the device, between a protocol based on CXL and the NVLink-based protocol for at least one of the first memory region or the second memory region. The method may be implemented in hardware, firmware, software, or combinations thereof, and may be performed by various types of devices, such as an accelerator, an RPU, a semiconductor device, an active cable, or a chiplet within an IC package. The first and second CXL device type flows may correspond to any combination of CXL Type-2 and Type-3 device flows. Translations between CXL and NVLink may include translations of opcodes, addresses, transaction identifiers, and additional fields. NVLink messages may carry functional fields corresponding to source identifiers, destination identifiers, addresses, transaction tags, transfer lengths, and data payloads; the specific field names may vary across NVLink versions or implementations, and the translation may accommodate such variations. The first memory may include memory coupled to the device, such as HBM and/or HBF, while the second memory may include memory accessible via GPUs or other NVLink-connected devices. The device may be positioned in an active cable, in a module coupled to a CXL port, or within a computing platform, and may provide a bridge between the CXL domain and the NVLink domain. The elements may communicate through one or more intermediary components, such as an NVLink switch or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to maintain cached copies of data from the first memory and to participate in coherency negotiations with the host via CXL.cache. The CXL Type-3 device flow for the HDM-H region may enable simpler passthrough access to NVLink-accessible memory without device coherency overhead.

In some implementations, the method further comprises receiving, from the host, a CXL.mem Master-to-Subordinate (M2S) request comprising MemRd* and a first address targeting the second memory region; translating the CXL.mem M2S request to an NVLink read request comprising a SourceID, a DestinationID, a second address, a Tag, and a Length; receiving an NVLink read response comprising *Data*; and sending to the host a CXL.mem Subordinate-to-Master Data Response (S2M DRS) comprising MemData and data from the NVLink read response. The SourceID may identify the device or RPU that originated the NVLink read request, while the DestinationID may identify the target entity, such as a GPU, in the NVLink fabric. The second address may be an NVLink network address that may be utilized to route the NVLink read request to its destination, and may go through additional address translation phases facilitated by one or more Link TLBs in the NVLink domain. The Tag may be a transaction identifier maintained by the device for correlating the NVLink read response with the original CXL.mem M2S request. The Length may indicate the requested transfer size. The *Data* in the NVLink read response may represent data carried in one or more response packets. Different NVLink versions or implementations may use different naming conventions for these functional fields; for example, a source identifier may alternatively be referred to as a requester identifier, a source node identifier, or a similar designation, and a destination identifier may alternatively be referred to as a target identifier, a destination node identifier, or a similar designation.

In some implementations, the method further comprises receiving, from the host, a CXL.mem Master-to-Subordinate (M2S) request comprising MemRd* and an address targeting the first memory region; accessing the first memory to obtain data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. For the first memory region, the device may access local memory, such as HBM and/or HBF, without performing protocol translation to NVLink. The device may respond with Cmp-S or Cmp-E based on the device's caching policy and the host's requested coherency state as indicated by SnpType and MetaValue fields in the M2S request.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region, such as when the device needs to read or modify data that the host may have cached.

In some implementations, the method further comprises translating, by the device, between a first address associated with a Host Physical Address (HPA) space utilized by the host and a second address associated with an NVLink network address space utilized by the NVLink-based protocol. The address translation may be implemented utilizing lookup tables, page tables, base-and-offset calculations, or programmable translation functions. The NVLink network address may be utilized to route NVLink transactions to specific GPUs or memory resources within the NVLink fabric.

In some implementations of the method, a non-transitory computer-readable medium comprising instructions which, when executed by a processor, cause the processor to perform the method.

In computing systems where a host accesses memory resources on a device coupled via CXL, the device may expose memory regions with different connectivity and coherency models. A first memory region may be backed by local memory coupled to the device, and may be exposed via a CXL device type flow that supports device coherency. A second memory region may be backed by memory accessible via an NVLink port, such as memory residing on GPUs or other NVLink-connected devices, and may be exposed via a different CXL device type flow. The device may include an RPU or translation logic configured to translate between CXL protocol messages and NVLink messages for memory access operations targeting the NVLink-accessible memory. An NVLink switch, such as NVSwitch, may couple the device to one or more GPUs whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an NVLink port of the device; and wherein the device is configured to translate between a protocol based on CXL and an NVLink-based protocol for requests targeting at least one of the first memory region or the second memory region. The system may enable a host to access both local and NVLink-domain memory resources on the device through a CXL link, with differentiated coherency semantics for different memory regions. The device may include an RPU, translation logic, or a combination of hardware and firmware that translate between CXL and the NVLink-based protocol. The device may be an accelerator, an RPU, a bridge device, or a component within an active cable positioned between the CXL domain and the NVLink domain. The device may configure the boundaries between the first and second memory regions dynamically or statically, for example utilizing HDM decoder registers or programmable address range registers. The system may be deployed in datacenter environments where CXL-enabled CPUs participate with NVLink GPUs in inference or training of AI models.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to NVLink read requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state maintained by the device. For the second memory region, the device may translate the request to an NVLink read request, receive data from the NVLink domain, and return the data to the host.

In some implementations of the system, the device comprises an accelerator or a resource provisioning unit (RPU), and the first memory comprises at least one of High Bandwidth Memory (HBM) or High-Bandwidth Flash (HBF) coupled to the device; and further comprising an NVLink switch coupling the NVLink port of the device to one or more GPUs, wherein the second memory is accessible via the NVLink switch. The NVLink switch may be an NVSwitch or similar switch device that provides high-bandwidth routing between the device and GPUs within an NVLink fabric. The one or more GPUs may each have their own HBM, HBF, or other memory that collectively forms the second memory accessible from the device via the NVLink port.

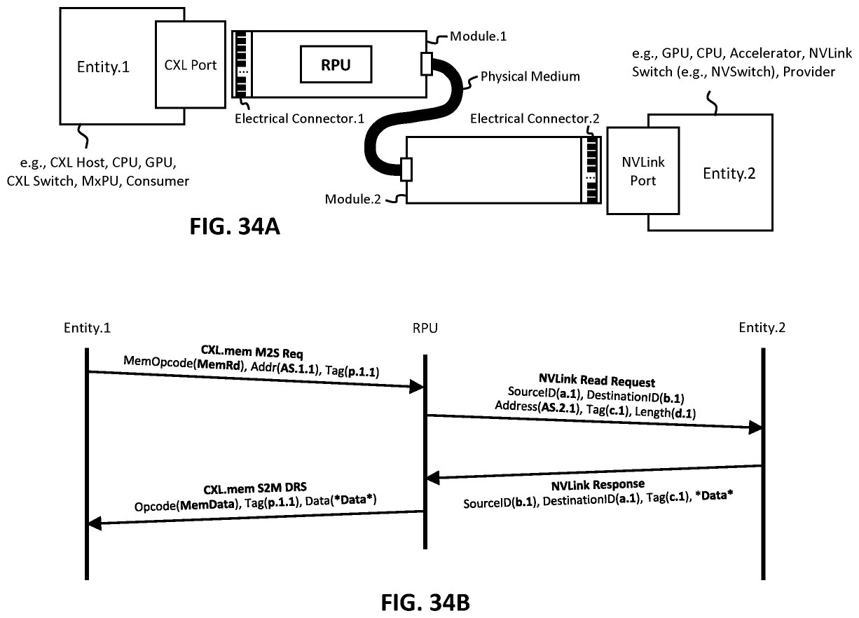

FIG. 34A illustrates an example of a system comprising an active cable that includes an RPU. The cable comprises a first pluggable module (Module.1) and a second pluggable module (Module.2) coupled by a Physical Medium. Module.1 includes the RPU and is coupled via a first electrical connector (Electrical Connector.1) to a CXL Port of a first entity (Entity.1). Module.2 is coupled via a second electrical connector (Electrical Connector.2) to an NVLink Port of a second entity (Entity.2). Entity.1 may be a CXL Host, CPU, GPU, CXL Switch, MxPU, or Consumer. Entity.2 may be a GPU, CPU, Accelerator, NVLink Switch (e.g., NVSwitch), or Provider. The RPU may be placed in various locations as a function of the requirements. In one example, the RPU is placed in Module.1 closer to the CXL Port of Entity.1, since CXL, which runs over PCIe electricals, is designed as a shorter-reach interface utilized for connecting devices to CPUs within a compute platform. Some versions of NVLink incorporate electrical signaling characteristics compatible with Ethernet and/or InfiniBand connectivity, designed for longer-reach interconnects that fit rack-level deployments and beyond. Placing the RPU closer to the CXL port may improve signal integrity. Additionally, NVLink typically utilizes a signaling rate higher than CXL, and consequently NVLink may require fewer lanes than CXL for the same bandwidth, which may allow for reducing the amount of copper wires or optical fibers in the Physical Medium.

FIG. 34B illustrates an example of a TFD demonstrating an RPU that translates between CXL.mem requests and NVLink requests. The TFD shows three entities: Entity.1/Consumer on the left, the RPU in the center, and Entity.2/Provider on the right. Entity.1 may send a CXL.mem M2S Req comprising MemOpcode(MemRd), Addr(AS.1.1), and Tag(p.1.1) to the RPU. Address (AS.1.1) may be an HPA of a Host, such as a CXL-enabled CPU coupled to the RPU. The RPU may translate the CXL.mem M2S Req to an NVLink Request Read comprising SourceID(a.1), DestinationID(b.1), Address(AS.2.1), Tag(c.1), and Length(d.1). Address (AS.2.1) may be an NVLink Network Address utilized to route the NVLink request to its destination on the NVLink fabric. In the response direction, Entity.2 may send an NVLink Response comprising SourceID(b.1), DestinationID(a.1), Tag(c.1), and *Data* to the RPU. The RPU may translate the NVLink Response to a CXL.mem S2M DRS comprising Opcode(MemData), Tag(p.1.1), and Data(*Data*), and may send the CXL.mem S2M DRS to Entity.1. The RPU may map the Tag from the NVLink response back to the original CXL.mem Tag (p.1.1) to enable proper transaction completion at Entity.1. In some examples, the NVLink Network Address may go through additional address translation phases, which may be facilitated by one or more Link TLBs residing on the transaction path. For example, in a GPU, a Link TLB may translate an NVLink Network Address to a GPU Physical Address that may reference memory resources integrated in or adjacent to the destination GPU. The RPU may perform another address translation to translate the HPA utilized by CXL.mem to the NVLink Network Address before the NVLink request is sent. Moreover, NVLink provides a distributed memory model where GPUs may access memory via other GPUs. This example provides a generic CXL.mem bridge/gateway for other, possibly non-NVLink compute elements, such as CPUs, to access memory residing on the NVLink Fabric, for example, where x86 GP-CPUs participate with NVLink GPUs in inference or training of AI models.

In various implementations, an apparatus comprising: processing cores coupled via an interconnect to memory controllers coupled to memory channels capable of supporting memory having a capacity of at least 64GB; wherein the interconnect utilizes a protocol based on Coherent Hub Interface (CHI-based protocol); first and second resource provisioning units (RPUs) comprising first and second NVLink interfaces and first and second CHI interfaces; wherein the first and second NVLink interfaces utilize differential pairs and are capable of communicating according to NVLink-based protocol with first and second entities external to the apparatus, respectively; and wherein the first and second RPUs are configured to translate between messages conforming to the NVLink-based protocol and messages conforming to the CHI-based protocol to enable the first and second entities to access in parallel the memory via the respective first and second NVLink interfaces and the interconnect. Sentences in the form of “access the memory” encompass accessing at least a portion of the memory, where the portion may range from a minimal addressable unit to the entire memory capacity, indicating open-ended claim language.

In some implementations of the apparatus, the first entity comprises a graphics processing unit (GPU) configured to: access dynamic random-access memory (DRAM) coupled to the memory channels via the first NVLink interface and the first RPU, and receive memory access requests from the processing cores targeting GPU-attached memory; wherein the first RPU is further configured to translate CHI-based requests to NVLink-based requests. The bidirectional communication may enable the GPU to function as both an initiator of memory transactions to system DRAM and a target for processor-initiated accesses to GPU-attached memory such as HBM. The RPU may maintain transaction context for both directions, managing protocol differences in flow control, credit management, and response generation between the NVLink and CHI-based domains.

In some implementations of the apparatus, the interconnect is a coherent interconnect, the GPU comprises on-package high-bandwidth memory (HBM), and the first RPU translates CHI-based write-back traffic targeting the HBM to NVLink-based traffic.

In some implementations of the apparatus, the interconnect is a coherent interconnect, the first RPU is further configured to maintain translations from first physical addresses associated with the first NVLink interface to physical addresses associated with the coherent interconnect, and the second RPU is further configured to maintain separate translations from second physical addresses associated with the second NVLink interface to the physical addresses associated with the coherent interconnect.

In some implementations of the apparatus, the interconnect comprises first and second interconnect components, the first RPU is coupled to the first interconnect component, and the second RPU is coupled to the second interconnect component, whereby the apparatus provides distributed bandwidth for the first and second entities to access resources.

In some implementations of the apparatus, a path between at least one of the first or second RPUs and at least one memory controller and/or processing core comprises one interconnect component. In some implementations, the RPU and at least one memory controller may be coupled to the same interconnect component, providing a low-latency communication path between the NVLink interface and memory attached to the xPU.

In some implementations of the apparatus, each of the first and second RPUs exposes registers accessible utilizing memory-mapped I/O (MMIO) operations via an Advanced Microcontroller Bus Architecture (AMBA) Advanced Peripheral Bus (APB) interface, enabling detection of RPU presence, NVLink-interface status, and translation capabilities.

In some implementations of the apparatus, each of the first and second RPUs is configured to: translate physical addresses associated with the respective NVLink-based protocol to physical addresses associated with the CHI-based protocol, and translate NVLink command encodings to corresponding CHI opcodes.

In some implementations of the apparatus, at least one of the first or second RPUs comprises a gateway utilizing a streaming interface protocol based on Advanced Microcontroller Bus Architecture (AMBA) Credited eXtensible Stream (CXS); and wherein the first and second entities are accelerators, from which at least one comprises a graphics processing unit (GPU).

In some implementations of the apparatus, each of the first and second RPUs comprises a request node that does not include a hardware-coherent cache and is configured to communicate with the interconnect according to the CHI-based protocol; and wherein the first and second entities are accelerators, from which at least one comprises a graphics processing unit (GPU).

In some implementations of the apparatus, at least one of the request nodes comprises an I/O-coherent request node (RN-I) or an I/O-coherent Request Node with Distributed Virtual Memory support (RN-D).

In some implementations of the apparatus, the interconnect comprises at least one crosspoint comprising at least four mesh ports and at least two device ports, wherein at least one of the first or second RPUs is coupled to one of the at least two device ports; and wherein the first and second entities are accelerators, from which at least one comprises a graphics processing unit (GPU).

In some implementations of the apparatus, each of the first and second NVLink interfaces supports virtual channels, and the respective RPUs map the virtual channels to corresponding quality-of-service fields of the CHI-based protocol.

In some implementations of the apparatus, the mapping between NVLink virtual channels and CHI quality-of-service fields is programmable via the MMIO registers exposed by the RPUs.

In some implementations of the apparatus, the memory comprises dynamic random-access memory (DRAM) having a capacity of at least 256 GB; wherein the first and second entities are accelerators, from which at least one comprises a graphics processing unit (GPU); and wherein the first and second entities can access in parallel different regions of the DRAM.

In some implementations, the apparatus further comprises a third NVLink interface coupled via a third RPU to the interconnect, enabling a third entity to access resources via the third NVLink interface and the interconnect, while maintaining I/O-coherency without cache coherency participation. The implementation may be scaled to support multiple NVLink-coupled entities, with their own translation paths through the I/O-coherent or non-coherent nodes, enabling high-bandwidth parallel access to system memory resources while the CHI-based protocol maintains appropriate ordering and coherency at the I/O level without requiring the NVLink entities to participate in cache coherency protocols.

In some implementations of the apparatus, each of the first and second RPUs maintains a link translation look-aside buffer that translates NVLink network addresses, including destination identifiers, into physical addresses employed by the interconnect.

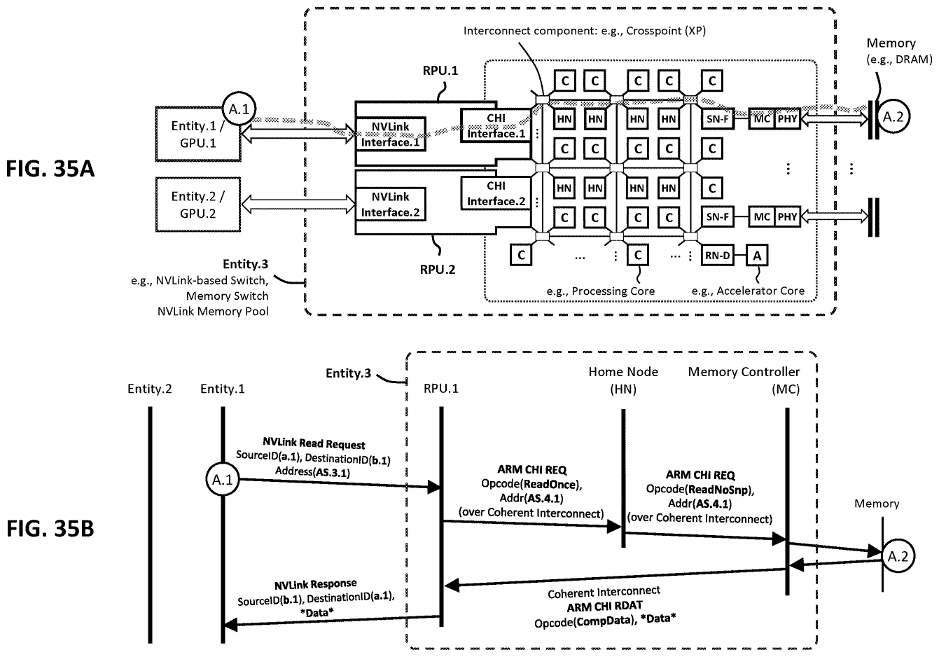

FIG. 35A illustrates an example of a memory switch configured to provide memory to entities coupled to it. Entity.1 is coupled to the memory switch wherein the entity may utilize the memory coupled to the coherent interconnect. The memory switch may function as an NVLink-based switch or an NVLink memory pool, providing switching capabilities between entities while also enabling access to memory resources.

FIG. 35B illustrates an example of a TFD demonstrating an NVLink request from Entity.1 to access memory. RPU.1 receives an NVLink request carrying a read request comprising an address, and translates it to an ARM CHI request comprising ReadOnce, potentially with a different address due to address translation. The request flows through the coherent interconnect to a home node (HN), which may translate it to a ReadNoSnp transaction destined to a memory controller (MC). The MC retrieves the data from memory and may return the data to RPU.1 without routing through the HN, or alternatively may send the data through the HN to RPU.1. Then RPU.1 generates the NVLink response with the data to Entity.1.

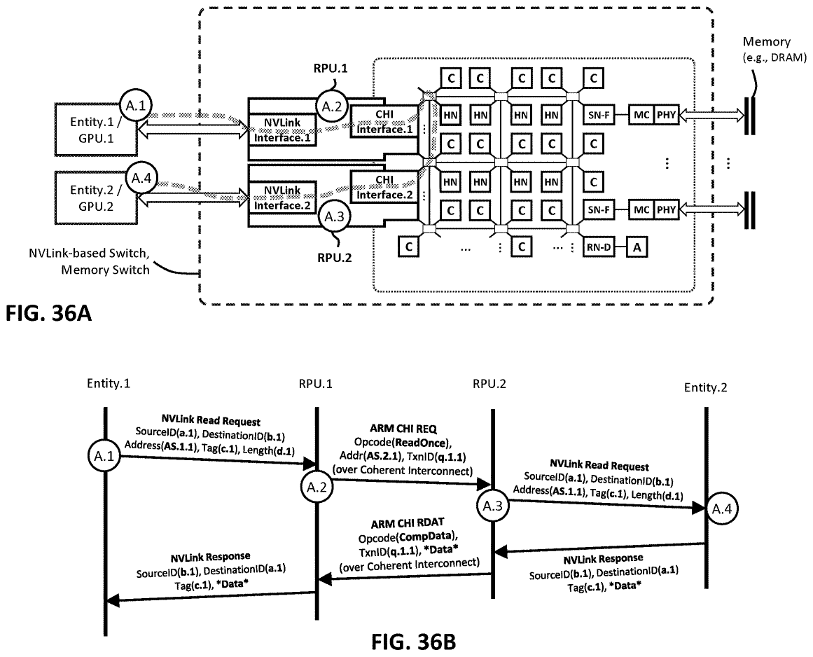

FIG. 36A illustrates an example of a system that implements an NVLink-based switch, or an NVLink Memory Switch, utilizing a CHI-based interconnect. The switch is coupled to two entities marked in the figure as Entity.1/GPU.1 and Entity.2/GPU.2. The switch may include processing cores, accelerator cores such as security accelerators, and memory controllers, coupled to the CHI-based interconnect. The switch utilizes translations, performed by each of the RPUs, between NVLink-based interfaces and the switch interconnect. The first RPU may enable Entity.1/GPU.1 to access, via the first NVLink interface and the switch interconnect (which may be a coherent interconnect), resources mapped to the address space utilized by the switch interconnect, such as memory resources of the switch. Correspondingly, the second RPU may enable Entity.2/GPU.2 to access, via the second NVLink interface and the switch interconnect, resources mapped to the address space utilized by the switch interconnect, such as memory resources of the switch. The first RPU may map resources of Entity.1/GPU.1, such as memory resources, to the physical address space associated with the switch interconnect, and may further enable Entity.2/GPU.2 to access resources mapped to the address space utilized by the switch interconnect, so that Entity.2/GPU.2 is able to access memory resources of Entity.1/GPU.1, via the second NVLink interface, the switch interconnect, and the first NVLink interface. Correspondingly, the second RPU may map resources of Entity.2/GPU.2, such as memory resources, to the physical address space associated with the switch interconnect, and may further enable Entity.1/GPU.1 to access resources mapped to the address space utilized by the switch interconnect, so that Entity.1/GPU.1 is able to access memory resources of Entity.2/GPU.2, via the first NVLink interface, the switch interconnect, and the second NVLink interface.

FIG. 36B illustrates an example of a TFD demonstrating NVLink switching operation between entities through a switch interconnect. Entity.1/GPU.1 issues a first NVLink request comprising source ID, destination ID and an address (AS.1.1). The first NVLink request is switched through the switch interconnect wherein a first RPU (RPU.1) translates it to an ARM CHI request comprising ReadOnce. The example demonstrates a switching operation wherein the switch typically does not change the message or the PDU, similar to how an Ethernet switch typically does not change an Ethernet frame. The first NVLink request is translated to an ARM CHI request that is translated to a second NVLink request, resulting in a switching operation of an NVLink request that passes from Entity.1 /GPU.1 to Entity.2/GPU.2 through the first RPU, the switch interconnect, and a second RPU (RPU.2). The first RPU converts the first NVLink request to an ARM CHI request carrying ReadOnce, possibly utilizing user-defined fields within the switch interconnect protocol to pass fields of the first NVLink request such as NVLink source ID, destination ID, Tags, and length, to the second RPU, wherein the ARM CHI request is translated to the second NVLink request that is sent to Entity.2/GPU.2. ARM CHI may include fields such as RSVDC that may be utilized as user-defined fields for passing transaction-related information such as fields from the first NVLink request of Entity.1/GPU.1 to the second NVLink request sent to Entity.2/GPU.2. Some of the fields of the NVLink traffic received from Entity.1/GPU.1 may be translated, whereas some of the fields may be truncated or compressed to fit within the available user-defined field widths. The second RPU translates the ReadOnce ARM CHI request to the second NVLink request, and translates the first NVLink response to an ARM CHI RDAT. The first RPU on the receiving side may translate the ARM CHI response (ARM CHI RDAT) with CompData and data back to a second NVLink response. The ARM CHI RDAT may also utilize user-defined fields for passing information to the other side, while the data itself may be passed natively through the ARM CHI RDAT data field.

In various implementations, an apparatus comprising: processing cores coupled via a coherent interconnect to memory controllers, wherein the coherent interconnect is based on Coherent Hub Interface (CHI) protocol (CHI-based protocol), and the memory controllers are coupled to memory channels capable of supporting memory having a capacity of at least 64 GB; interconnect gateway coupled to the coherent interconnect, or a Fully Coherent Request Node (RN-F) comprising a hardware-coherent cache and a Fully Coherent Home Node (HN-F) comprising a Point of Coherence (PoC) coupled to the coherent interconnect; an NVLink Chip-to-Chip (NVLink-C2C) interface configured to communicate according to NVLink-C2C coherent protocol with an entity external to the apparatus; and an NVLink-C2C to CHI adapter configured to translate between messages conforming to the NVLink-C2C coherent protocol and messages conforming to the CHI-based protocol, wherein the adapter couples the NVLink-C2C interface to the CCGs or the RN-F and HN-F to enable bidirectional coherent memory access between the entity and the processing cores. The following are two examples according to which the apparatus enables full cache-coherent communication between entities using NVLink-C2C protocol and the CHI-based system. In the first example, RN-F and HN-F nodes provide coherent connectivity, wherein the RN-F node may generate transactions defined by the CHI-based protocol and support snoop transactions, while the HN-F node manages coherency by snooping required RN-F nodes and serving as both the Point of Coherence and Point of Serialization. In the second example, CCGs provide integrated coherent gateway functionality that internally implements RN-F and HN-F capabilities. The adapter may perform coherency-preserving translations that enable the external entity to read from the apparatus's DRAM through the coherent request path while the processing cores may read from the entity's memory through the coherent home path, maintaining full cache coherency across both directions of communication.

In some implementations of the apparatus, the entity comprises a graphics processing unit (GPU), and wherein: the GPU accesses dynamic random-access memory (DRAM) coupled to the memory channels through the NVLink-C2C interface, the adapter, and the coherent interconnect; and the processing cores access memory attached to the GPU through the coherent interconnect, the adapter, and the NVLink-C2C interface. The bidirectional coherent access may enable the GPU to read from the processor's DRAM while maintaining cache coherency utilizing the coherent request functionality, and simultaneously allows the processor cores to access GPU-attached memory such as High Bandwidth Memory (HBM) or High-Bandwidth Flash (HBF) through the coherent home functionality, creating a coherent memory space across heterogeneous processing elements.

In some implementations of the apparatus, the NVLink-C2C interface comprises an NVLink Fusion chiplet coupled to the adapter via a physical layer (PHY), wherein the PHY is a UCIe PHY configured for chiplet-to-chiplet communication. The NVLink Fusion chiplet may provide a modular other implementation of NVLink-C2C protocol processing, with the UCIe PHY offering a standardized chiplet interconnect that enables integration of NVLink-C2C coherent capabilities into processors that may not have native NVLink support.

In some implementations of the apparatus, the adapter comprises a CHI C2C die-to-die adapter with UCIe streaming, configured to bridge between the UCIe PHY domain and the CHI-based domain while maintaining coherency. The ARM CHI C2C die-to-die adapter may implement streaming optimizations for UCIe transfers while performing the applicable translations between NVLink-C2C and CHI, managing credit flow, transaction ordering, and coherency state transitions required for maintaining cache coherency across the die boundary.

In some implementations of the apparatus, the apparatus comprises the RN-F and HN-F coupled to the coherent interconnect, and the adapter couples the NVLink-C2C interface to the RN-F and HN-F; and wherein the apparatus further comprises additional CCGs coupled to the coherent interconnect, and a Compute Express Link (CXL) device coupled to the additional CCGs, configured to communicate with a second entity based on a CXL protocol, wherein the CXL device and the NVLink-C2C interface share access to the memory channels through their respective coherent nodes. Optionally, this configuration provides dedicated coherent paths for different protocols, with the NVLink-C2C interface utilizing discrete RN-F and HN-F nodes while the CXL device utilizes CCGs that internally implement their own coherent functionality, enabling optimizations of protocol paths while sharing access to memory resources.

In some implementations of the apparatus, the CXL device is configured to route CXL.mem and/or CXL.cache transactions through the additional CCGs via a CXS interface; the apparatus further comprises an I/O-coherent Request Node with Distributed Virtual Memory support (RN-D) coupled to the coherent interconnect; and the CXL device is further configured to route CXL.io transactions through the RN-D via an AXI interface. The separation of CXL protocol types may leverage the additional CCGs' coherency management capabilities for CXL.mem and/or CXL.cache transactions while utilizing the simpler RN-D path for CXL.io transactions, with the CXS interface providing an optimized bridge protocol for coherent transactions and the AXI interface handling I/O transactions similar to PCIe.

In some implementations of the apparatus, the CXL device comprises a Global Fabric-Attached Memory (G-FAM) Device (GFD) configured to support only CXL.mem transactions through the additional CCGs. The GFD may allow the CXL transactions to be processed through the coherent path provided by the additional CCGs, which is suitable for memory pooling applications wherein I/O functionality is not required.

In some implementations of the apparatus, the second entity communicates with the CXL device via a physical layer based on IEEE 802.3 physical medium attachment (PMA) coupled to a resource provisioning unit (RPU) that includes the CXL device. The physical layer based on IEEE 802.3 PMA may enable the CXL device to receive CXL protocol messages encapsulated within a carrier protocol, extending the reach of CXL communications beyond traditional PCIe-based physical layers while the NVLink-C2C interface provides high-bandwidth coherent connectivity for tightly-coupled accelerators.

In some implementations of the apparatus, the apparatus comprises the CCGs coupled to the coherent interconnect, and the adapter couples the NVLink-C2C interface to the CCGs; and wherein the apparatus further comprises a Compute Express Link (CXL) device coupled to additional CCGs, wherein the additional CCGs provide shared coherent infrastructure for both the NVLink-C2C interface and the CXL device. Optionally, this configuration leverages the CCGs as unified coherent gateways that handle both NVLink-C2C and CXL protocols, with the CCGs internally implementing the coherent request and home functionality required for coherent transactions, potentially simplifying the system architecture by consolidating coherent protocol handling within shared CCG blocks.

In some implementations of the apparatus, the processing cores are part of a custom CPU comprising an integrated NVLink-C2C interface; and wherein the entity comprises an NVIDIA Blackwell GPU, an accelerator processing unit, or a second custom CPU with an NVLink-C2C interface. The custom CPU design may incorporate native NVLink-C2C support to enable direct coherent communication with NVIDIA GPUs or other NVLink-C2C capable devices, eliminating the need for protocol bridges in GPU-accelerated computing systems while maintaining full cache coherency between the CPU and accelerator domains.

In some implementations of the apparatus, the interconnect gateway comprises at least one of Coherent Multichip Link (CML) or Cache Coherent Interconnect for Accelerators (CCIX) Gateway (CXG) that utilizes a streaming interface protocol; and wherein the gateway is configured to utilize a 32-bit cyclic-redundancy check (CRC-32) to protect transactions conforming to the streaming interface protocol.

In various implementations, a system comprising: a processor comprising processing cores coupled via a coherent interconnect to memory controllers, wherein the coherent interconnect is based on Coherent Hub Interface (CHI) protocol (CHI-based protocol), and the memory controllers are coupled to memory channels coupled to memory having a capacity of at least 64 GB; a first graphics processing unit (GPU) coupled to the coherent interconnect via a first interface path comprising a first NVLink interface and a first adapter; a second GPU coupled to the coherent interconnect via a second interface path comprising a second NVLink interface and a second adapter; and wherein the first adapter and the second adapter are configured to translate between messages conforming to NVLink-based protocol and messages conforming to the CHI-based protocol, enabling the first GPU and the second GPU to communicate with each other through the coherent interconnect while the first and second GPUs have access to the memory via the coherent interconnect. The system may enable GPU-to-GPU communication through the processor's coherent interconnect rather than through direct GPU-to-GPU links or NVSwitch, providing a flexible communication architecture wherein GPUs may exchange data while sharing access to the processor's memory resources. The adapters translate between the NVLink domains and the CHI domain, managing differences in transaction formats, flow control, and addressing. The coherent interconnect serves as a common communication fabric that routes transactions between the GPUs while also handling memory access requests from the GPUs and the processor cores, potentially enabling new computational models wherein GPUs collaborate utilizing shared memory spaces managed by the processor.

Optionally, this implementation may route GPU-to-GPU communications through a processor's coherent interconnect, potentially offering several technical advantages, such as leveraging existing processor interconnect infrastructure without requiring additional dedicated GPU switching hardware, enabling GPUs to communicate while simultaneously accessing processor-attached memory through the same interconnect, and/or allowing heterogeneous accelerators using different protocols to participate in the same communication fabric. This implementation may also facilitate integration scenarios wherein the number or configuration of GPUs is not known at processor design time, as the coherent interconnect may dynamically route communications between whatever GPUs are coupled. Furthermore, by translating GPU protocols to the processor's native coherent protocol, the system may apply the processor's existing quality-of-service, security, and routing mechanisms to GPU traffic, potentially simplifying system-level traffic management. The translations performed by the adapters may enable memory architectures wherein GPUs, CPUs, and other accelerators share common view(s) of memory resources.

In some implementations of the system, the first NVLink interface and the second NVLink interface are NVLink interfaces configured for I/O-coherent communication; the first adapter couples the first NVLink interface to an I/O-coherent Request Node with Distributed Virtual Memory support (RN-D) and a I/O-coherent Home Node (HN-I); and wherein the second adapter couples the second NVLink interface to a second RN-D and a second HN-I. The I/O-coherent NVLink configuration may utilize I/O-Coherent nodes that do not maintain hardware cache coherency, suitable for GPU workloads that manage their own memory consistency, with the RN-D nodes handling DVM transactions and the HN-I nodes managing IO ordering for GPU-initiated operations.

In some implementations of the system, the first NVLink interface and the second NVLink interface are NVLink-C2C interfaces configured for coherent communication; the first adapter couples the first NVLink-C2C interface to a Fully Coherent Request Node (RN-F) and a Fully Coherent Home Node (HN-F); and the second adapter couples the second NVLink-C2C interface to a second RN-F and a second HN-F, enabling cache-coherent GPU-to-GPU communication through the coherent interconnect. The coherent NVLink-C2C configuration may enable the GPUs to participate in the processor's cache coherency protocol, with the RN-F nodes supporting snoop transactions and the HN-F nodes managing coherency as Points of Coherence, allowing GPUs to maintain cache-coherent views of shared data structures during communication.

In some implementations of the system, the first interface path further comprises a first NVLink Fusion chiplet coupled to the first adapter via a first physical layer (PHY); the second interface path further comprises a second NVLink Fusion chiplet coupled to the second adapter via a second PHY; and the first and second PHYs are selected from a UCIe PHY, an NVLink-C2C PHY, or a custom PHY. The NVLink Fusion chiplets may provide modular NVLink-based protocol processing capabilities that can be integrated into systems without native NVLink support, with the PHY selection enabling different physical layer implementations based on packaging technology and bandwidth requirements.

In some implementations, the system further comprises a third accelerator coupled to the coherent interconnect via a third interface path; wherein the third accelerator is selected from a custom accelerator, an xPU, or a third GPU; and wherein the third interface path comprises a Compute Express Link (CXL) device coupled to CXL/CCIX Gateways (CCGs), enabling the third accelerator to communicate with the first GPU and the second GPU through the coherent interconnect. This mixed configuration demonstrates the flexibility of the coherent interconnect to support heterogeneous accelerators using different protocols, with CXL-attached accelerators communicating with NVLink-attached GPUs based on appropriate translations at their respective adapter/gateway interfaces.

In some implementations of the system, the first GPU reads data from the memory through the first adapter and the coherent interconnect while the second GPU reads the same data from the memory; and the first GPU writes results to the memory that are subsequently read by the second GPU, implementing a producer-consumer pattern utilizing the processor's memory. The shared memory access patterns may enable collaborative computing models wherein GPUs coordinate utilizing processor memory rather than utilizing direct GPU memory transfers, potentially simplifying programming models and enabling dynamic work distribution among GPUs.

In some implementations of the system, the first adapter comprises a CHI C2C die-to-die adapter configured to translate between the first NVLink Fusion chiplet's domain and the CHI-based domain; and the second adapter comprises a second CHI C2C die-to-die adapter configured to translate between the second NVLink Fusion chiplet's domain and the CHI-based domain. The ARM CHI C2C die-to-die adapters may provide the translations while managing inter-die communication requirements including credit flow, transaction ordering, and optional support for UCIe streaming when coupled with UCIe PHYs.

In some implementations of the system, the first GPU is an NVIDIA Blackwell GPU with High Bandwidth Memory (HBM); the second GPU is a different GPU architecture; and the coherent interconnect enables the asymmetric GPUs to exchange data despite differences in their native memory architectures and protocol implementations. The support for asymmetric GPU configurations may enable systems to combine GPUs with different capabilities, memory hierarchies, or vendor implementations, with the coherent interconnect and adapters abstracting protocol differences to enable interoperability.

In some implementations of the system, the first adapter translates GPU physical addresses within a first GPU physical address space to CHI physical addresses within the coherent interconnect's physical address space; the second adapter translates GPU physical addresses within a second GPU physical address space to CHI physical addresses; and the processor maintains address mappings that enable the first GPU to access memory regions allocated to the second GPU through the coherent interconnect. The multi-level address translation may enable the GPUs to maintain their own physical address spaces while the processor's coherent interconnect provides a unified addressing scheme for routing transactions, with the processor potentially implementing memory protection and isolation between GPU physical address spaces.

In some implementations, the system further comprises additional GPUs coupled to the coherent interconnect via additional interface paths, the additional interface paths comprise NVLink interfaces and adapters; wherein the GPUs communicate with each other through the coherent interconnect in a fully-connected logical topology without requiring a dedicated GPU switch. The scalable architecture may support arbitrary numbers of GPUs limited by the coherent interconnect's capacity rather than by the dedicated GPU switching hardware, with the GPUs able to communicate with each other through the processor's routing infrastructure.

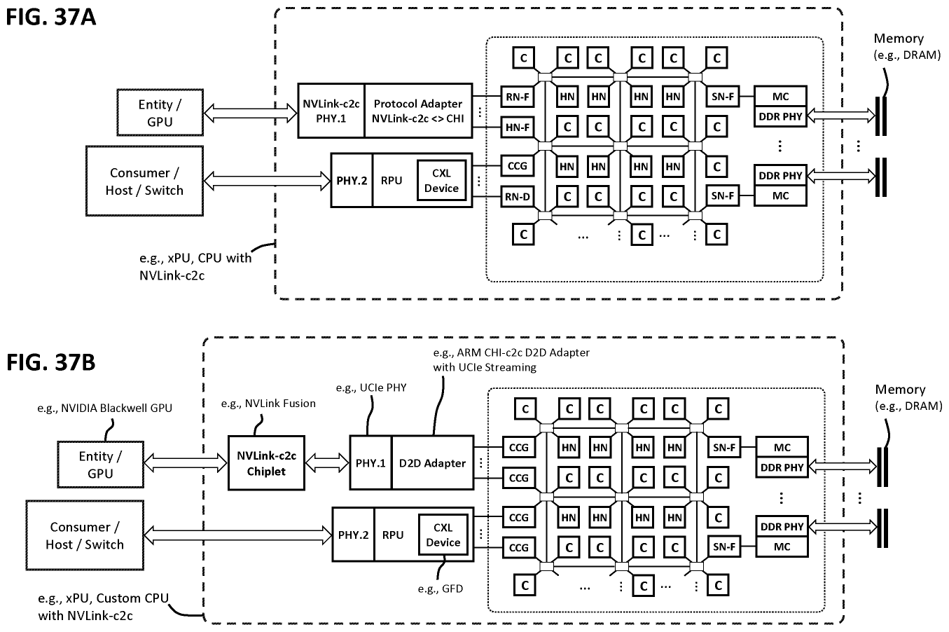

FIG. 37A illustrates an example of a system comprising a processor incorporating protocol interfaces integrating an RPU with a CXL device. The RPU includes or is coupled to a CXL device that is coupled to both (i) a CCG node for handling coherent CXL.mem and/or CXL.cache transactions, and (ii) an RN-D node for handling non-coherent CXL.io transactions. The system may couple the RPU to the CCG over a CXS interface, providing a path for coherent communications. The connection of NVLink-C2C interfaces to fully coherent request nodes (RN-F) and fully coherent home nodes (HN-F) may be included within a gateway node structure, enabling bidirectional coherent access wherein a GPU may read from the processor's DRAM through the RN-F node and the processor cores may read from the GPU's HBM through the HN-F node.

FIG. 37B illustrates an example of a system including a CPU, which may be a custom CPU design, incorporating NVLink-C2C capabilities and optionally including an NVLink-C2C chiplet, such as NVLink Fusion. The system integrates a Global Fabric-Attached Memory (G-FAM) Device (GFD) that operates as a specialized CXL device. The GFD may support only CXL.mem transactions, allowing it to service external requests through CCG nodes that are optimized for handling CXL.mem traffic, thereby simplifying the design by eliminating the need for separate CXL.io handling paths typically managed by RN-D or RN-I nodes.

Some implementations of the following method relate to processing pipelines, such as in a Fabric Processing Unit (FPU), for extracting and reconstructing CXL PDUs from carrier protocol communications received over a physical layer based on IEEE 802.3 PMA, possibly via software-defined methods, such as via protocol processing firmware executed on an FPU. A carrier protocol may refer to a protocol that transports or encapsulates other protocol data for transmission across a network or fabric, such as Ethernet, Ultra Ethernet Transport (UET), Ethernet for Scale-Up Networking (ESUN), Scale Up Ethernet (SUE), NVLink, or UALink. A passenger protocol may refer to a protocol whose data is encapsulated within the carrier protocol for transport, such as CXL.mem, CXL.cache, or CXL.io. A carrier protocol PDU refers to a protocol data unit of the carrier protocol, and a CXL PDU refers to a protocol data unit of a CXL sub-protocol. The CXL PDU may represent data indicative of a CXL message or a subset thereof, and may include fields that have been formatted, reduced, or otherwise adapted for transport within the carrier protocol PDU.

Modern datacenter architectures may benefit from transporting CXL traffic over network fabrics that utilize IEEE 802.3-based physical layers, enabling memory disaggregation, composable infrastructure, and remote memory access across rack-scale and cluster-scale deployments. When CXL PDUs are encapsulated within carrier protocol PDUs, the carrier protocol may utilize different field formats, may omit fields that are not required for transport, or may encode CXL information in carrier-specific representations. A processing pipeline within an RPU or similar processing unit may receive carrier protocol PDUs, extract encapsulated CXL information, translate fields between carrier and CXL formats, and reconstruct complete CXL PDUs that conform to the CXL specification for delivery to CXL devices or hosts. The pipeline may include stages for physical coding sublayer (PCS) processing, parsing, validity checking, stream extraction, access control, field translation, stream editing, address translation, and protocol translation, wherein different stages may be utilized depending on the carrier protocol type, the passenger protocol type, and the system configuration.

In various implementations, a method comprising: receiving, via a physical layer based on IEEE 802.3 physical medium attachment (PMA), a transmission comprising a protocol data unit (PDU) of a carrier protocol (carrier protocol PDU) encapsulating data indicative of a Compute Express Link (CXL) PDU; parsing the carrier protocol PDU to identify a passenger protocol type; extracting, from the carrier protocol PDU, fields of the CXL PDU; translating at least one extracted field from a format associated with the carrier protocol PDU to a field conforming to a CXL specification; and reconstructing an output CXL PDU comprising the translated field and at least one additional field not present in the carrier protocol PDU. The processing pipeline may be implemented as hardware, firmware, software, or combination thereof, within an FPU, an RPU, or a similar processing unit that is coupled to the physical layer based on IEEE 802.3 PMA. The physical layer may receive transmissions from external entities such as hosts, accelerators, switches, or memory devices that communicate CXL traffic encapsulated within carrier protocol PDUs. The parsing stage may examine protocol-specific patterns or markers in the data stream to identify both the carrier protocol type and the type of CXL sub-protocol (such as CXL.mem, CXL.cache, or CXL.io) encapsulated within. The extraction stage may identify and extract fields of interest from the carrier protocol PDU, including data indicative of CXL opcodes, physical addresses, transaction identifiers, and other protocol-specific fields. The translation stage may convert one or more extracted fields from a representation or encoding utilized by the carrier protocol into a representation that conforms to the CXL specification, such as translating a carrier-specific command encoding into a CXL opcode. The reconstruction stage may assemble a complete CXL PDU by combining translated fields with additional fields that were not included in the carrier protocol PDU, such as reserved fields, validity indicators, or metadata fields that may be omitted from the carrier PDU to conserve bandwidth but are utilized by CXL devices for proper parsing and processing of the CXL request.

In some implementations of the method, the at least one additional field is reconstructed based on at least one of a configuration or a default value, and wherein the method further comprises validating access permissions based on at least one of a physical address or an opcode extracted from the CXL PDU, and blocking the output CXL PDU from further processing when the access permissions are not satisfied. The reconstruction of fields not present in the carrier protocol PDU may utilize configuration parameters stored in registers or memory of the RPU, or may utilize default values defined by the CXL specification or by system policy. For example, a Valid field may be reconstructed as valid based on the presence of a well-formed carrier protocol PDU, while Reserved (RSVD) fields may be reconstructed utilizing configured default values such as zero. The access control validation may be performed by an Access Control List (ACL) module within the processing pipeline that evaluates extracted CXL fields against access policies. The ACL module may examine physical addresses to determine whether the requesting entity is permitted to access the targeted memory region, and may examine opcodes to determine whether the requested operation type is permitted. When access permissions are not satisfied, the pipeline may discard the CXL PDU, generate an error response, or log the access violation. This access control may operate at the CXL protocol level rather than at the carrier protocol level, enabling fine-grained memory access control that is specific to the CXL address space and operation types.

In some implementations, the method further comprises translating a physical address extracted from the CXL PDU from a first physical address space to a second physical address space. The address translation may be performed by an Address Translator stage within the processing pipeline, downstream of the field extraction and translation stages. The first physical address space may correspond to a Host Physical Address (HPA) space utilized by the external entity that originated the CXL request, while the second physical address space may correspond to an HPA space utilized by a local host or a Device Physical Address (DPA) space utilized by a local CXL device. The translation may be implemented utilizing lookup tables, page tables, hash tables, base-and-offset calculations, or programmable translation functions. The address translation may enable entities utilizing different address spaces to communicate via CXL over the carrier protocol fabric, without requiring the entities to share a common address space or address mapping.

In some implementations, the method further comprises translating the output CXL PDU from a first CXL channel to a second CXL channel, wherein the first CXL channel and the second CXL channel are different CXL sub-protocols. The protocol translation may be performed by a Protocol Translator stage within the processing pipeline, downstream of the stream editing and address translation stages. The first CXL channel may be CXL.mem and the second CXL channel may be CXL.cache, or vice versa, depending on the system configuration and the types of entities involved. For example, the Protocol Translator may translate a CXL.mem M2S request message into a CXL.cache H2D request message when the receiving entity is a CXL host that issues snoop requests to a local CXL device. Conversely, the Protocol Translator may translate a CXL.cache H2D request message into a CXL.mem M2S request message when the receiving entity is a memory device that processes memory access requests. The cross-channel translation may enable heterogeneous CXL deployments where different entities utilize different CXL sub-protocols while communicating through a common carrier protocol fabric.

In some implementations of the method, the carrier protocol comprises at least one of Ethernet, Ultra Ethernet Transport (UET), Ethernet for Scale-Up Networking (ESUN), Scale Up Ethernet (SUE), NVLink, or UALink, and wherein the physical layer based on IEEE 802.3 PMA operates at a lane rate of at least 100 Gbps. Different carrier protocols may utilize the IEEE 802.3 PMA in different ways while maintaining compatibility with the PMA interface specifications. Ethernet may utilize standard Ethernet framing with MAC-layer processing, while UET, ESUN, and SUE may utilize optimized framing adapted for high-performance computing and artificial intelligence workloads. UALink may utilize the IEEE 802.3 PMA as its physical layer while employing UALink-specific data link and transport layer protocols. The lane rate of at least 100 Gbps may correspond to IEEE 802.3 PMA specifications such as 100 GBASE or higher rates, enabling sufficient bandwidth for CXL memory traffic that may involve high-frequency, low-latency transactions. Higher lane rates, such as 200 Gbps or 400 Gbps per lane, may further increase the available bandwidth for encapsulated CXL traffic.

In some implementations, the method further comprises receiving a CXL response PDU, removing at least one field from the CXL response PDU, encapsulating remaining fields of the CXL response PDU within a second carrier protocol PDU, and transmitting the second carrier protocol PDU via the physical layer based on IEEE 802.3 PMA. The return path may operate as a reverse pipeline that processes CXL responses generated by local CXL devices or hosts for transmission to remote entities via the carrier protocol fabric. The removal of fields from the CXL response PDU may reduce bandwidth consumption by omitting fields that can be reconstructed at the receiving end, such as Valid fields, Reserved fields, or metadata fields that carry default or derivable values. The encapsulation may include generating carrier protocol headers and trailers appropriate for the carrier protocol type being utilized. The return path processing may mirror the inbound processing pipeline stages in reverse order, with the Stream Editor stripping unnecessary fields, the Field Translator converting CXL-specific field representations into carrier-specific formats, and the PCS performing encoding operations such as 64 B/66 B encoding, scrambling, and FEC encoding for transmission via the IEEE 802.3 PMA.

In some implementations of the method, the CXL PDU comprises a CXL.mem Master-to-Subordinate (M2S) PDU, the extracted fields comprise a MemOpcode field and an Address field, and the at least one additional field not present in the carrier protocol PDU comprises at least one of a Valid field, a Reserved (RSVD) field, a MetaField field, a SnpType field, or a Traffic Class (TC) field. The CXL.mem M2S PDU may refer to a Master-to-Subordinate message from either the M2S Req channel, which carries requests without data such as reads and invalidations, or the M2S RwD channel, which carries requests with data such as writes. Both channel types may include a MemOpcode field and an Address field as the primary extracted fields, along with other fields such as Valid, MetaField, SnpType, Tag, TC, and RSVD. When the carrier protocol PDU encapsulates CXL.mem information, the MemOpcode and Address fields may be included because they carry the operation type and target address that are needed for routing and processing. Other fields, such as Valid, RSVD, MetaField, SnpType, and TC, may be omitted from the carrier protocol PDU when their values can be reconstructed. The Valid field may be reconstructed based on the presence of a well-formed carrier protocol PDU. The RSVD field may be reconstructed utilizing a default value of zero. The MetaField, SnpType, and TC fields may be reconstructed based on RPU configuration parameters, system policies, or context derived from the MemOpcode and other extracted fields. The Tag field, which provides a transaction identifier for response correlation, may also be extracted from the carrier protocol PDU.

In some implementations of the method, the translating comprises translating a command field of the carrier protocol PDU to the MemOpcode field conforming to the CXL specification, the MemOpcode field comprising at least one of MemRd, MemRdData, MemWr, MemWrPtl, or MemInv. The carrier protocol may encode memory operation types utilizing a carrier-specific command field that differs in format, bit width, or encoding from the CXL MemOpcode field. The Field Translator may map carrier-specific command encodings to CXL MemOpcode values such as MemRd for memory read operations, MemRdData for memory read operations with specific metadata handling, MemWr for full cacheline write operations, MemWrPtl for partial cacheline write operations, or MemInv for invalidation operations. The mapping may be configurable, enabling the same processing pipeline to support different carrier protocols that utilize different command encoding schemes.

In some implementations of the method, the CXL PDU comprises a CXL.cache Host-to-Device (H2D) request PDU, the extracted fields comprise an Opcode field, an Address field, and a Unique Queue ID (UQID) field, and the at least one additional field not present in the carrier protocol PDU comprises at least one of a Valid field or a Reserved (RSVD) field. The CXL.cache H2D request PDU may include fields as defined by the CXL specification, including Valid, Opcode, Address, UQID, and RSVD fields. The Opcode field may carry H2D request opcodes such as SnpData, SnpInv, or SnpCur that indicate the type of snoop operation. The Address field may carry the physical address of the cacheline targeted by the snoop operation. The UQID field may identify the host entry that originated the request, enabling response routing. The Valid and RSVD fields may be omitted from the carrier protocol PDU because their values can be reconstructed: the Valid field based on PDU presence, and the RSVD field utilizing default values. Different flit modes defined by the CXL specification (such as 68 B flit, 256 B flit, or PBR flit) may include different sets of additional fields such as CacheID, SPID, and DPID, which may also be subject to extraction or reconstruction depending on the flit mode negotiated for the target CXL link.

In some implementations of the method, the CXL PDU comprises a CXL.cache Device-to-Host (D2H) request PDU, the extracted fields comprise an Opcode field, a command queue identifier (CQID) field, and an Address field, and the at least one additional field not present in the carrier protocol PDU comprises at least one of a Valid field, a NonTemporal (NT) field, or a Reserved (RSVD) field. The CXL.cache D2H request PDU may include fields as defined by the CXL specification, including Valid, Opcode, CQID, NT, Address, and RSVD fields. The D2H request direction carries requests from a device toward a host, with D2H request opcodes such as RdShared, RdOwn, RdCurr, RdOwnNoData, CLFlush, or other D2H request opcodes. The CQID field may identify the device tracker entry associated with the request. The NT (NonTemporal) field may provide a caching hint indicating that the requested data is not expected to be reused in the near term, allowing the host to avoid caching the data in a preferred cache position or to treat it as non-cacheable. The RSVD field in D2H requests may be larger than in H2D requests, and the NT field may carry a default value that can be reconstructed based on system configuration. The field set for D2H requests differs from H2D requests in both the transaction identifier (CQID versus UQID) and the available fields (NT versus CacheID in certain flit modes), which may result in different extraction and reconstruction behavior for each direction.

In some implementations of the method, the CXL PDU comprises a CXL.io Transaction Layer Packet (TLP), the extracted fields comprise a Type field, an Address field, and a Tag field, and the translating comprises translating a command field of the carrier protocol PDU to a Fmt/Type field of the CXL.io TLP. CXL.io utilizes TLPs based on the PCIe Transaction Layer specification. The TLP header may include fields such as Fmt/Type (which encodes the packet format and transaction type), TC (Traffic Class), Attr (Attributes), EP (Error Poisoned), Length, Requester ID, Tag, and Address, among others. The Fmt and Type fields together determine the TLP type, such as Memory Read (MRd), Memory Write (MWr), Completion with Data (CplD), or Configuration Read/Write. The carrier protocol may encode the CXL.io transaction type utilizing a carrier-specific command field that differs from the PCIe Fmt/Type encoding. The Field Translator may map carrier-specific commands to appropriate Fmt/Type values. In flit mode, the Fmt field may be absorbed into the Type field, and the translation may accommodate both flit mode and non-flit mode TLP header formats. The Tag and Address fields may be extracted from the carrier protocol PDU for routing and transaction tracking, while other TLP header fields such as TC, Attr, and EP may be omitted from the carrier PDU and reconstructed utilizing default values or configuration parameters.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a transmission comprising a protocol data unit (PDU) of a carrier protocol (carrier protocol PDU) encapsulating data indicative of a Compute Express Link (CXL) PDU; and a processing unit coupled to the physical layer, the processing unit configured to: parse the carrier protocol PDU to identify a passenger protocol type; extract, from the carrier protocol PDU, fields of the CXL PDU; translate at least one extracted field from a format associated with the carrier protocol PDU to a field conforming to a CXL specification; and reconstruct an output CXL PDU comprising the translated field and at least one additional field not present in the carrier protocol PDU. The apparatus may be implemented as an integrated circuit, an SoC, an FPGA, a SmartNIC, a data processing unit (DPU), a Fabric Processing Unit (FPU), or any other suitable hardware platform that includes a physical layer based on IEEE 802.3 PMA and a processing unit capable of performing the described operations. The processing unit may include dedicated hardware logic, a programmable processor, or a combination thereof. The processing unit may implement the pipeline stages, including parsing, extraction, translation, and reconstruction, as hardware pipeline stages that process carrier protocol PDUs at line rate, or as software-driven stages that provide configurability and flexibility. The apparatus may include physical layers based on IEEE 802.3 PMA for communicating with external entities, and may include processing units or pipeline instances for parallel processing of carrier protocol PDUs.

Some implementations of the following method further relate to bandwidth-optimized transport of CXL protocol data over carrier protocols utilizing a physical layer based on IEEE 802.3 PMA. When CXL PDUs are transported over carrier protocol fabrics, the bandwidth available for encapsulated CXL traffic may be constrained by the carrier protocol overhead, the physical layer data rate, and the number of concurrent transactions. Bandwidth optimization may be achieved by encapsulating a subset of the CXL PDU fields within the carrier protocol PDU, omitting fields that can be reconstructed at the receiving end. Different levels of field inclusion may be utilized depending on available bandwidth, quality-of-service requirements, and/or system configuration.

For example, a CXL.mem M2S request may include fields such as Valid, MemOpcode, MetaField, SnpType, Address, Tag, TC, and RSVD. A complete format may include all fields, while a reduced format may omit the Valid and RSVD fields, and an essential format may include the MemOpcode, Address, and Tag fields. The omitted fields may be reconstructed by the receiving processing unit based on configuration parameters, default values, or context derived from the received fields. Similar bandwidth optimization may be applied to CXL.cache and CXL.io PDUs by identifying fields that can be omitted and reconstructed.

In various implementations, a method comprising: receiving, via a physical layer based on IEEE 802.3 physical medium attachment (PMA), a protocol data unit (PDU) of a carrier protocol (carrier protocol PDU) encapsulating a subset of fields of a Compute Express Link (CXL) PDU, the subset excluding at least one field defined by a CXL specification for the CXL PDU; extracting the subset of fields from the carrier protocol PDU; reconstructing the at least one excluded field; and generating a CXL request comprising the extracted subset of fields and the at least one reconstructed field. The method may enable bandwidth-efficient transport of CXL traffic over carrier protocol fabrics by transmitting those CXL PDU fields that cannot be derived or reconstructed at the receiving end. The sender may analyze the CXL PDU and determine which fields carry information that is not derivable from other fields or from system configuration, and may include those fields in the carrier protocol PDU. The receiver may extract the included fields, reconstruct the excluded fields, and assemble a complete CXL request that conforms to the CXL specification. The bandwidth savings may be proportional to the number and size of excluded fields, and may vary depending on the CXL sub-protocol, the message type, and the level of field inclusion selected. For CXL.mem M2S requests, the savings may range from omitting a few bits (Valid and RSVD) to omitting several fields (MetaField, SnpType, TC, Valid, RSVD), depending on the selected format level.

In some implementations of the method, the at least one excluded field is reconstructed based on at least one of a configuration, a default value, or context derived from the subset of fields. Different reconstruction methods may be utilized for different excluded fields depending on the nature of the field and the information available. Configuration-based reconstruction may utilize values stored in registers or memory of the processing unit, such as system-wide settings for Traffic Class or metadata policies. Default-value reconstruction may utilize values defined by the CXL specification or by system convention, such as zero for Reserved fields or a valid indication for the Valid field when the carrier protocol PDU is well-formed. Context-based reconstruction may derive field values from other extracted fields, such as inferring a SnpType value from the MemOpcode when certain operation types imply specific snoop behaviors. The reconstruction method for each excluded field may be independently configurable, enabling the system to adapt to different deployment scenarios and CXL specification revisions.

In some implementations, the method further comprises receiving a CXL response, excluding at least one field of the CXL response defined by the CXL specification, and transmitting, via the physical layer based on IEEE 802.3 PMA, a carrier protocol PDU encapsulating a subset of fields of the CXL response excluding the at least one excluded field of the CXL response. The bandwidth optimization may be applied symmetrically on both the request and response paths. CXL responses, such as S2M No-Data Response (NDR) messages or S2M Data Response (DRS) messages for CXL.mem, or D2H response and D2H Data messages for CXL.cache, may also include fields that can be omitted for transport. The processing unit may analyze the CXL response, identify fields that can be reconstructed by the remote receiving entity, exclude those fields, and encapsulate the remaining fields within a carrier protocol PDU for transmission. The level of field reduction on the response path may be the same as or different from the level utilized on the request path, depending on the specific response message type and the fields available for reconstruction.

In some implementations, the method further comprises receiving the carrier protocol PDU by a remote processing unit, extracting the subset of fields of the CXL response, and reconstructing the at least one excluded field of the CXL response. The remote processing unit may receive the carrier protocol PDU transmitted by the local processing unit, extract the encapsulated subset of fields of the CXL response, and reconstruct the at least one excluded field. The remote processing unit may utilize its own configuration parameters, default values, or context to reconstruct excluded response fields. The remote processing unit may be implemented within an RPU, a SmartNIC, a DPU, or any other suitable entity coupled to a physical layer based on IEEE 802.3 PMA. The configuration parameters utilized by the remote processing unit for reconstruction may be synchronized with those utilized by the local processing unit for field exclusion, either through out-of-band configuration protocols or through negotiation during connection establishment.

In some implementations of the method, the CXL PDU comprises a CXL.mem Master-to-Subordinate (M2S) request, the subset of fields comprises MemOpcode, MetaField, SnpType, Address, Tag, and TC fields, and the at least one excluded field comprises a Valid field and a Reserved (RSVD) field. The reduced format for CXL.mem M2S requests may retain the fields that carry operational semantics (MemOpcode for the operation type, MetaField and SnpType for coherency behavior, Address for the target location, Tag for transaction tracking, and TC for traffic classification) while omitting the Valid field and the Reserved field. The Valid field may be reconstructed based on the presence of a well-formed carrier protocol PDU, since the receipt of a properly framed and validated carrier protocol PDU implies that the encapsulated CXL information is valid. The Reserved field may be reconstructed utilizing a default value of zero, as reserved fields are defined by the CXL specification to be cleared by the sender and ignored by the receiver.

In some implementations of the method, the CXL PDU comprises a CXL.mem M2S request, the subset of fields comprises MemOpcode, Address, and Tag fields, and the at least one excluded field comprises a Valid field, a MetaField field, a SnpType field, a TC field, and a Reserved (RSVD) field. In one example, the essential format may include the minimum fields for basic CXL.mem operation: MemOpcode to specify the memory operation, Address to identify the target physical address, and Tag to enable transaction tracking and response correlation. The excluded fields (Valid, MetaField, SnpType, TC, and RSVD) may be reconstructed utilizing default values or configuration parameters. The MetaField may be reconstructed as No-Op when the system configuration does not utilize metadata operations, the SnpType may be reconstructed based on the MemOpcode (such as defaulting to No-Op or to a configured snoop type), and the TC may be reconstructed utilizing a configured traffic class priority. The essential format may provide the greatest bandwidth savings and may be suitable for deployments where the carrier protocol bandwidth is constrained or where the additional fields carry predictable values.

In some implementations of the method, the CXL PDU comprises a CXL.cache Host-to-Device (H2D) request, the subset of fields comprises an Opcode field, an Address field, and a UQID field, and the at least one excluded field comprises at least one of a Valid field or a Reserved (RSVD) field. The CXL.cache H2D request may include Opcode, Address, UQID, Valid, and RSVD fields in the 68 B flit format. The Opcode field may carry snoop opcodes such as SnpData, SnpInv, or SnpCur. The Address field carries the cacheline address targeted by the snoop. The UQID identifies the host entry originating the request. The Valid and RSVD fields may be omitted from the carrier protocol PDU and reconstructed. In 256 B flit or PBR flit formats, additional fields such as CacheID, SPID, and DPID may also be subject to field reduction and reconstruction, and the set of excluded fields may vary based on the negotiated flit mode.

In some implementations of the method, the CXL PDU comprises a CXL.cache Device-to-Host (D2H) request, the subset of fields comprises an Opcode field, a command queue identifier (CQID) field, and an Address field, and the at least one excluded field comprises at least one of a Valid field, a NonTemporal (NT) field, or a Reserved (RSVD) field. The CXL.cache D2H request may include Opcode, CQID, NT, Address, Valid, and RSVD fields. The D2H request carries device-initiated requests toward a host, with opcodes such as RdShared, RdOwn, RdCurr, RdOwnNoData, or CLFlush. The CQID identifies the device tracker entry for response routing. The NT field provides a caching hint indicating that the requested data is not expected to be reused in the near term, allowing the host to avoid caching the data in a preferred cache position or to treat it as non-cacheable, and may carry a default value in many configurations. The RSVD field in D2H requests may include a larger number of reserved bits compared to H2D requests, making it a suitable candidate for exclusion. The reconstruction of the NT field may utilize a configured default caching policy, while the RSVD field may be reconstructed as zero.

In some implementations of the method, the CXL PDU comprises a CXL.io Transaction Layer Packet (TLP), the subset of fields comprises a Fmt/Type field, an Address field, a Requester ID field, and a Tag field, and the at least one excluded field comprises at least one of a Traffic Class (TC) field, an Attributes (Attr) field, or a reserved field. CXL.io TLP headers may include fields such as Fmt/Type, TC, Attr, EP, Length, Requester ID, Tag, and Address, among others. The Fmt/Type fields (or the combined Type field in flit mode) determine the transaction type and packet format. The Address and Tag fields are retained for routing and transaction tracking. The Requester ID identifies the originating function. The TC field, which indicates the traffic class for quality-of-service handling, may be reconstructed utilizing a configured default traffic class. The Attr field, which includes attributes such as relaxed ordering and no-snoop hints, may be reconstructed from configuration. Reserved fields and other padding may be reconstructed utilizing zero values. The bandwidth savings from excluding these fields may be proportional to the TLP header size, which varies depending on whether the TLP utilizes 32-bit or 64-bit addressing and whether flit mode or non-flit mode is in use.

In some implementations, the method further comprises selecting between a first format comprising a first subset of fields and a second format comprising a second subset of fields based on at least one of available bandwidth, quality-of-service parameters, or a configuration setting. The processing unit may dynamically select between different field inclusion levels based on runtime conditions or system configuration. When the carrier protocol fabric has sufficient bandwidth, a complete or reduced format with more fields may be selected to minimize reconstruction overhead and maximize protocol compliance fidelity. When bandwidth is constrained, an essential format with fewer fields may be selected to maximize the number of CXL transactions that can be transported within the available bandwidth. Quality-of-service parameters may influence the selection, such as utilizing a complete format for high-priority traffic classes and a reduced format for lower-priority traffic. The selection may be performed on a per-connection basis, a per-transaction basis, or a per-time-interval basis, and may be negotiated between the sender and receiver during connection establishment or renegotiated during operation in response to changing network conditions.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a protocol data unit (PDU) of a carrier protocol (carrier protocol PDU) encapsulating a subset of fields of a Compute Express Link (CXL) PDU, the subset excluding at least one field defined by a CXL specification for the CXL PDU; and a processing unit configured to extract the subset of fields from the carrier protocol PDU, reconstruct the at least one excluded field, and generate a CXL request comprising the extracted subset of fields and the at least one reconstructed field. The apparatus may be implemented as an RPU, a SmartNIC, a DPU, a network interface, a switch, an active cable, or any other suitable device that receives carrier protocol PDUs via a physical layer based on IEEE 802.3 PMA and processes encapsulated CXL traffic. The processing unit may include hardware logic, a programmable processor, or a combination thereof, configured to perform the extraction, reconstruction, and CXL request generation operations. The apparatus may support multiple levels of field inclusion and may be configurable to select between different levels based on system requirements. The apparatus may further include a CXL device or CXL port coupled to the processing unit for delivering the generated CXL requests to the CXL fabric.

In some implementations of the apparatus, the processing unit is configured to reconstruct the at least one excluded field based on at least one of a configuration, a default value, or context derived from the subset of fields. The processing unit may maintain configuration registers or memory structures that store reconstruction parameters for each field type and each CXL sub-protocol. The configuration parameters may be programmed during system initialization, updated during operation via management interfaces, or negotiated with remote entities during connection establishment. Default values may be defined by the CXL specification version targeted by the system, enabling automatic reconstruction without explicit configuration for fields that have specification-defined default behaviors.

In some implementations of the apparatus, the processing unit is further configured to receive a CXL response, exclude at least one field of the CXL response defined by the CXL specification, and transmit, via the physical layer based on IEEE 802.3 PMA, a carrier protocol PDU encapsulating a subset of fields of the CXL response excluding the at least one excluded field of the CXL response. The apparatus may support bidirectional bandwidth optimization by applying field reduction to both request and response directions. The processing unit may analyze outgoing CXL responses to identify fields that can be excluded for transport while maintaining the ability for the remote entity to reconstruct the complete response. The response field exclusion may be coordinated with the remote entity to facilitate proper reconstruction at the receiving end.

In some implementations of the apparatus, the processing unit is further configured to select between a first format comprising a first subset of fields and a second format comprising a second subset of fields based on at least one of available bandwidth, quality-of-service parameters, or a configuration setting. The apparatus may monitor bandwidth utilization on the carrier protocol fabric and dynamically adjust the field inclusion level to optimize performance. When bandwidth utilization is low, the apparatus may select a format with more fields to minimize reconstruction overhead. When bandwidth utilization is high or approaching congestion thresholds, the apparatus may select a format with fewer fields to reduce per-transaction bandwidth consumption and maintain throughput. The quality-of-service parameters may include priority levels, latency targets, or throughput guarantees that influence the selection of field inclusion formats for different traffic classes or transaction types.

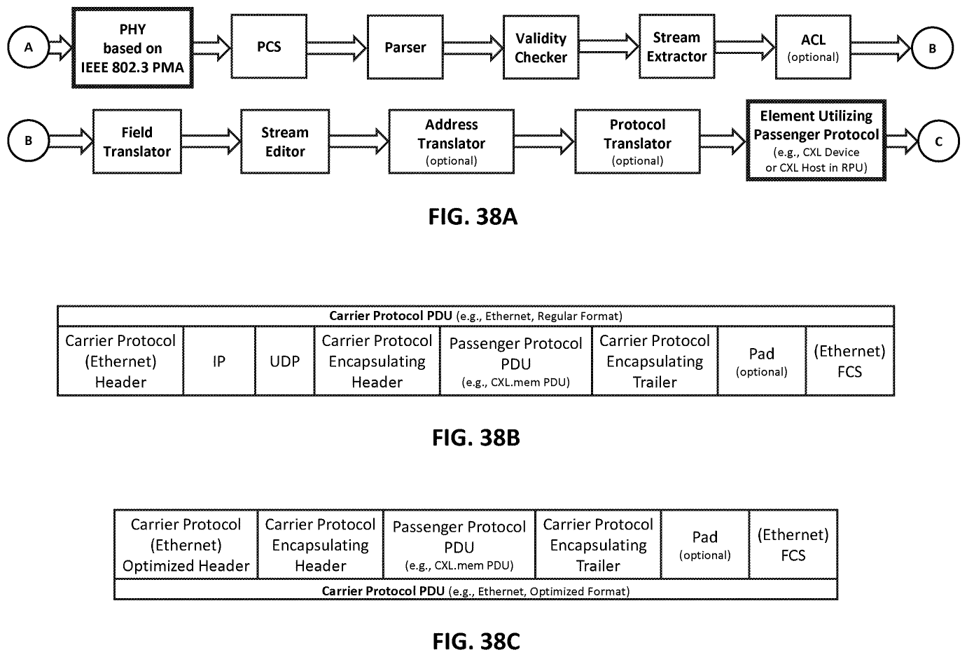

FIG. 38A illustrates an example of a processing pipeline for extracting passenger protocol messages from carrier protocol communications received over a physical layer based on IEEE 802.3 Physical Medium Attachment (PMA). The pipeline may process various carrier protocols that utilize a PMA based on IEEE 802.3, such as certain versions of Ethernet, ESUN, SUE, UALink, or NVLink, to extract encapsulated passenger protocol messages such as CXL.mem, CXL.cache, or CXL.io messages. The figure describes a transmission received by a PMA that is based on IEEE 802.3, which forwards a data stream of the carrier protocol to a Physical Coding Sublayer (PCS). The PCS may include protocol-specific processing operations that may vary based on the carrier protocol being utilized. For Ethernet examples, the PCS may perform operations such as 64 B/66 B block decoding, block framing, block synchronization, descrambling, lane deskewing, and/or forward error correction (FEC) decoding. For UALink or NVLink examples, the PCS may additionally or alternatively perform other operations specific to those protocols while maintaining compatibility with the IEEE 802.3 PMA interface.

The PCS forwards processed data to a Parser. The data may take the form of a partially-delineated stream wherein protocol boundaries have been identified but detailed field parsing has not yet been performed. The Parser may analyze the received data to identify protocol structures and extract protocol-specific information. The Parser may perform analysis operations including identification of the carrier protocol type by examining protocol-specific patterns or markers in the data stream, identification of the passenger protocol type that is encapsulated within the carrier protocol, delineation of Protocol Data Units (PDUs) of the carrier protocol (Carrier PDU) according to the specific framing rules of the identified carrier protocol (such as Ethernet framing, frame-boundary delimitation, and frame synchronization which may involve operations similar to those performed by an Ethernet MAC), and identification of locations of interest within the carrier protocol PDU such as headers, addresses, identifiers, payload sections, and other fields that may be required by subsequent stages of the processing pipeline. The Parser may add metadata fields to the processed data, such as metadata identifying protocol types and data patterns.

The Parser forwards to a Validity Checker a structured data with location information, such as an array of offsets to locations of interest in the Carrier PDU. The Validity Checker performs validation operations on the received data structure, such as validation of data stream format conformance and carrier PDU validity checks including cyclic redundancy checks (CRC) or other error detection logic specific to the carrier protocol. The Validity Checker forwards validated data structures to a Stream Extractor.

The Stream Extractor processes the validated data structures to extract passenger protocol information, such as extracting fields of interest from the Carrier PDU including data indicative of passenger protocol opcodes and physical addresses within a second physical address space utilized by the requesting entity. The Stream Extractor may identify and extract various passenger protocol fields required for message processing, regardless of the specific passenger protocol type. The Stream Extractor forwards its output to an optional Access Control List (ACL) module that may validate access permissions based on the extracted fields. The ACL feeds validated data to a Field Translator that performs field-level transformations between carrier and passenger protocol formats, such as translating fields of interest from the Carrier PDU (e.g., a command field) to fields conforming to the Passenger Protocol specifications (e.g., a CXL opcode field required for constructing a CXL request).

The Field Translator feeds transformed field data to a Stream Editor that reconstructs complete passenger protocol messages. The Stream Editor may perform several operations including reconstruction and formatting of translated fields into a PDU structure compliant with a valid Passenger Protocol PDU (Passenger PDU), such as CXL, insertion of mandatory or optional Passenger Protocol fields that may not be included in the Carrier PDU such as reserved fields of a CXL message that may be omitted from the Carrier PDU but are necessary for an element utilizing passenger protocol, such as a CXL device, to properly parse the request wherein values of omitted fields may be reconstructed based on RPU configurations and/or configurable default values, and removal of intermediate data and metadata that was collected and generated in the processing pipeline but is not part of a compliant Passenger PDU, such as a CXL request.

When no address translation or protocol translation is required, the Stream Editor forwards the Passenger PDU to an element utilizing passenger protocol, such as a CXL device within an RPU. When address translation and/or protocol translation is required, the Stream Editor forwards the Passenger PDU, such as a CXL.mem M2S Req message carrying a physical address within a second HPA space, to an optional Address Translator. The Address Translator translates physical addresses between different physical address spaces, such as translating from a second HPA space to a first HPA space, and forwards the result to an optional Protocol Translator. The Protocol Translator may perform protocol-specific translations, such as translating from a CXL.mem M2S Req message to a CXL.cache D2H Req message. The translated Passenger PDU is then forwarded to the appropriate protocol device, such as forwarding a CXL.cache D2H Req message carrying the physical address within the first HPA space to an element utilizing passenger protocol, such as a CXL host.

FIG. 38B illustrates an example of a packet structure that may be suitable for Layer 3 (L3) switching operations. L3 switching typically refers to packet forwarding based on network layer information, typically using IP addresses or similar network-layer identifiers to make routing decisions across different network segments or subnets. The illustrated packet structure shows a carrier protocol PDU in a regular format that may be processed by standard networking equipment while carrying an encapsulated passenger protocol PDU. The packet structure includes a Carrier Protocol Header, shown as an Ethernet header, which may contain standard Ethernet fields such as destination MAC address, source MAC address, and EtherType or length fields. Following the Ethernet header, the packet includes an IP header that may contain network layer routing information including source and destination IP addresses, protocol identifiers, and other IP-specific fields required for L3 routing decisions. A UDP header follows the IP header and may contain transport layer information including source and destination port numbers that may be used to identify specific services or applications. The packet includes a Carrier Protocol Encapsulating Header that may carry metadata specific to the encapsulation scheme. This header may include a PDU Version (Ver) field that indicates the version or format of the protocol PDU structure, enabling the Parser to correctly interpret the packet structure. A Source Node ID (SourceNodeID) field may identify the originating node in a format specific to the overlay network or fabric topology. A Destination Node ID (DestinationNodeID) field may identify the target node for routing within the overlay network. A Segmentation ID (SegmentID) field may be used for infrastructure virtualization, such as to provide isolation between different tenants or logical networks in multi-tenant environments. A PDU Sequence Number (PSN) field may provide ordering information for reliable delivery or reassembly of segmented messages. A Passenger Protocol (PassengerProt) field may identify the type of passenger protocol encapsulated within the PDU, such as CXL.io, CXL.cache, or CXL.mem, enabling the Parser to apply appropriate processing rules. The Passenger Protocol PDU section may contain the actual passenger protocol message, such as a CXL.mem PDU, that is being transported across the network. The Passenger Protocol PDU section may include the fields required by the passenger protocol specification, or a subset of the fields that enable reconstruction of the message, as further discussed below.

The packet further includes a Carrier Protocol Encapsulating Trailer that may carry additional metadata and integrity information. This trailer may include an Encapsulating CRC (E-CRC) field that provides error detection for the encapsulated portion of the packet, potentially offering stronger integrity protection than the standard Ethernet FCS. A Data Poisoning (Poison) field may be used to mark data that is known to be corrupted, allowing protocols such as CXL or UPI to propagate error indications across the network. A Reported Load (ReportedLoad) field may communicate congestion or load information from the source device, possibly augmented with congestion information from intermediate components along the path, such as CXL DevLoad indicators, enabling network-aware load balancing or congestion management. The packet structure may further include an optional Pad field that may be used to meet minimum frame size requirements of the carrier protocol, and may conclude with an Ethernet Frame Check Sequence (FCS) that provides error detection for the entire Ethernet frame according to Ethernet specifications.

FIG. 38C illustrates an example of a packet structure that may be suitable for Layer 2 (L2) switching operations. L2 switching typically refers to packet forwarding based on data link layer information, typically using MAC addresses to make forwarding decisions within a network segment or broadcast domain. The Carrier Protocol Optimized Header may contain condensed addressing or routing information suitable for L2 forwarding decisions. The Carrier Protocol Encapsulating Header, Passenger Protocol PDU, and Carrier Protocol Encapsulating Trailer may contain similar fields and serve similar functions as described for the L3 packet structure in FIG. 38B, adapted for the L2 switching context. The packet structure maintains the optional Pad field and Ethernet FCS for compatibility with the frame requirements as defined by the Ethernet specification.

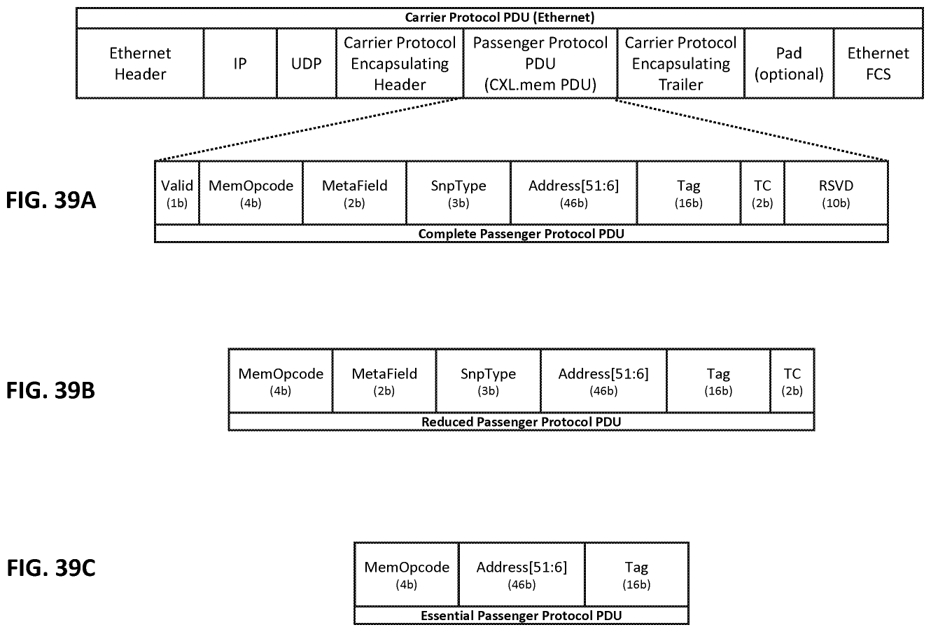

FIG. 39A to FIG. 39C illustrate three examples of variations for the Passenger Protocol PDU that may be encapsulated within the Carrier Protocol PDU illustrated in FIG. 38B. These variations illustrate different levels of field inclusion that may be utilized to optimize bandwidth utilization while maintaining the ability to reconstruct complete passenger protocol messages. The lower part of FIG. 39A illustrates a complete Passenger Protocol PDU for a CXL.mem message conforming to Revision 1.1 of the CXL Specification. The complete PDU includes the fields required by CXL.mem: a Valid field (1 bit) that indicates whether the message contains valid data, a MemOpcode field (4 bits) that specifies the memory operation type, a MetaField field (2 bits) that contains metadata about the transaction, a SnpType field (3 bits) that indicates the snoop type for cache coherency operations, an Address field (46 bits) that carries the physical address for the operation, a Tag field (16 bits) that provides a unique identifier for tracking the transaction, a TC field (2 bits) that may indicate traffic class or priority information, and a Reserved (RSVD) field (10 bits) that is reserved for future use or protocol compliance. This complete format may be utilized when full protocol compliance is required or when the carrier protocol has sufficient bandwidth to accommodate the fields.

FIG. 39B illustrates an example of a reduced Passenger Protocol PDU, wherein some of the fields that can be reconstructed are omitted from the Carrier PDU to reduce bandwidth requirements. The reduced PDU retains the MemOpcode field (4 bits), MetaField field (2 bits), SnpType field (3 bits), Address field (46 bits), Tag field (16 bits), and TC field (2 bits). The reconstructed fields, which are not included in the Carrier PDU but are required for a CXL device for parsing the CXL request, may be reconstructed by the Stream Editor of the RPU. For FIG. 39B, the fields to be reconstructed are the one bit Valid field and the 10 bits Reserved (RSVD) field. The Valid field may be reconstructed based on the presence of a well-formed PDU, while the RSVD field may be reconstructed using configured default values.

FIG. 39C illustrates an example of an essential Passenger Protocol PDU, which may include essentially the minimum fields required for basic operation of the passenger protocol. The essential PDU comprises the MemOpcode field (4 bits) that specifies the operation to be performed, the Address field (46 bits) that identifies the physical address, and the Tag field (16 bits) that enables transaction tracking and response correlation. The fields omitted from the essential PDU, including Valid, MetaField, SnpType, TC, and RSVD fields, may be reconstructed by the Stream Editor using protocol-specific default values or configuration parameters.

In various implementations, a system comprising: a processor comprising a coherent interconnect; the processor is coupled to memory having a capacity of at least 64 GB; wherein the processor is configured to utilize physical addresses within a Host Physical Address (HPA) space to access the memory, and to execute an operating system (OS) that utilizes a virtual address space; a memory management unit (MMU) configured to enable access to the memory based on mapping addresses within the virtual address space to physical addresses within the HPA space; a resource provisioning unit (RPU) comprising a Compute Express Link (CXL) device configured to communicate with an entity according to a protocol based on CXL; and wherein the RPU is further coupled to the coherent interconnect and configured to perform host-to-host physical address translations, whereby the host-to-host physical address translations enable the entity to access the memory via the CXL device. The OS may utilize the MMU for virtual to physical address mapping to access the memory, wherein the MMU translates OS-level virtual addresses to physical addresses within the HPA space. Processes, applications and user programs executing under the control of the OS may utilize the MMU to access the memory utilizing virtual addresses while the MMU enforces memory protection and isolation between different processes or applications. Device drivers operating within the OS kernel space may utilize the MMU for accessing memory-mapped device registers and for managing DMA buffers. When the processor supports virtualization, hypervisors may utilize the MMU to manage memory mappings for virtual machines (VMs), wherein hypervisors and/or guest OSs may further utilize the MMU to manage memory mappings for processes within the VMs, optionally supporting nested virtualization that may include multiple levels of address translations. In some examples, an MMU may translate from addresses within a physical address space, such as a Guest Physical Address (GPA) space, to addresses within another physical address space, such as an HPA space. Infrastructure code or firmware running on hidden cores may utilize the MMU for accessing memory regions allocated for infrastructure tasks such as memory telemetry collection or memory pool management operations. And hardware components such as DMA engines within the system may utilize the MMU or IOMMU functionality to perform address translations when moving data between different memory regions.

The processor, MMU, and RPU may be implemented as a semiconductor device that combines processing capabilities with memory pooling functionality. The processor may be a multi-core processor based on x86, ARM, RISC-V, or other instruction set architectures, and may include various levels of cache hierarchy. The HPA space utilized by the processor is the physical address space the processor utilizes to access the memory. The RPU may be implemented as dedicated hardware logic, firmware running on dedicated cores, or a combination thereof, and may maintain translation tables or use programmable mappings to convert between different HPA spaces used by external entities and the local HPA space of the processor.

Optionally, the messages received by the RPU, such as the messages conforming to the CXL protocol, may include additional messages that do not carry HPA, and such messages may be processed by the RPU without performing host-to-host physical address translations. Additionally or alternatively, the RPU may further process additional messages that carry virtual addresses instead of host physical addresses, and the messages carrying host physical addresses may coexist with other types of messages that may be processed differently by the RPU, such that the description of messages carrying host physical addresses does not limit the presence or processing of other types of messages that may be communicated with the entity and through the processor. Furthermore, the RPU may apply different processing methods to different types of messages according to their content and/or requirements, which may include forwarding messages without modification, modifying message contents without performing address translations, or performing other types of translations or modifications that may differ from the above described host-to-host physical address translations.

In some implementations of the system, the entity utilizes a second HPA space, and the host-to-host physical address translations translate physical addresses within the second HPA space to physical addresses within the HPA space. The second HPA space utilized by the entity may have a different size, layout, or addressing scheme compared to the HPA space utilized by the processor. The host-to-host physical address translations may include offset calculations, range remapping, or lookup table operations to convert addresses between the two HPA spaces. The RPU may support configurable translation windows that define which portions of the entity's HPA space are mapped to the processor's HPA space, and may implement protection logic to prevent unauthorized access to memory regions outside the allocated ranges.

In some implementations, the system further comprises a CXL root port configured to communicate with a CXL memory expander that utilizes a Device Physical Address (DPA) space; and wherein at least one of the operating system, system firmware, or the memory expander is configured to map between physical addresses within the HPA space and physical addresses within the DPA space, which enable the entity to utilize the memory and/or the CXL memory expander. The CXL memory expander may be a CXL type-3 device that provides additional memory capacity to the system. The DPA space of the memory expander represents the device-local physical addresses used internally by the expander. The OS or system firmware may maintain mapping tables that associate HPA ranges with DPA ranges of the memory expander, enabling transparent access to the expanded memory. Additionally or alternatively, HPA to DPA mapping may further be maintained by the memory expander, such as via internal firmware, software, or hardware of the expander.

In some implementations of the system, the RPU further comprises a second CXL device configured to communicate with a second entity utilizing a second protocol based on CXL, whereby the second entity utilizes a third HPA space; and wherein the RPU is further configured to translate physical addresses within the third HPA space to physical addresses within the HPA space, which enable the second entity to utilize the CXL memory expander. The system may support multiple entities accessing the CXL memory expander utilizing coordinated address translations. Different entities may have their own portions of the memory expander's capacity utilizing separate HDM regions or virtual CXL devices exposed by the RPU. Additionally or alternatively, the memory expander may expose multiple HDM regions, or may expose multiple logical devices (LDs), which may be mapped via RPU translations to multiple entities. The RPU may maintain separate translation contexts for separate entities, ensuring that memory accesses from different entities are properly isolated while still allowing shared access to designated memory regions when configured for multi-entity sharing. The system may implement Quality-of-Service (QoS) mechanisms to fairly allocate memory expander bandwidth among multiple entities.

In some implementations of the system, the RPU further comprises a second CXL device configured to communicate with a second entity utilizing a second protocol based on CXL, whereby the second entity utilizes a third HPA space, and the RPU is further configured to translate physical addresses within the third HPA space to physical addresses within the HPA space, which enable the second entity to utilize the memory. When supporting multiple entities accessing the memory (e.g., DRAM), the system may implement memory partitioning schemes to allocate specific memory regions to different entities. The RPU may enforce access controls to enable entities to access only their respective allocated memory regions. The system may support dynamic reallocation of memory between entities based on workload demands or administrative policies, and may implement memory tiering and migration capabilities to move data between different entities'allocated regions such as when workload access patterns change or reconfiguration occurs.

In some implementations of the system, the entity comprises a host coupled to the processor via at least one of a CXL root port or a CXL switch, and the second protocol based on CXL is different from the protocol based on CXL. Supporting different CXL protocols for different entities may enable heterogeneous system configurations wherein entities with varying capabilities can utilize or share the memory pool. For example, one entity may use CXL.mem for simple memory expansion while another entity uses CXL.cache for cache-coherent shared memory. The RPU may maintain protocol-specific state machines and translation logic for different supported protocol combinations, enabling interoperability between entities using different CXL protocol subsets.

In some implementations of the system, the processor comprises a modified processing unit (MxPU), the memory comprises dynamic random-access memory (DRAM), and the RPU enables the entity to utilize DRAM having a capacity of at least 256 GB of the DRAM. The MxPU may be derived from an established CPU or GPU design with modifications to support CXL device functionality and host-to-host address translations. The large DRAM capacity (≥256 GB) may be achieved through multiple memory channels supporting high-capacity DRAM modules. The MxPU may implement memory compression, deduplication, or other techniques to effectively increase the usable memory capacity exposed to entities beyond the physical DRAM capacity.

In some implementations of the system, the memory comprises dynamic random-access memory (DRAM) that is coupled via memory channels to the processor, and the CXL device comprises a Global Fabric-Attached Memory (G-FAM) Device (GFD). The memory channels may include channels transmitting in parallel to increase memory bandwidth and reduce latency. The memory channels may support one or more DRAM modules, such as DIMMs or RDIMMs, and may implement various memory technologies including DDR4, DDR5, LPDDR4, LPDDR5, or future memory standards. The memory channels may include memory controllers integrated within the processor or implemented as separate components within the system, and may support features such as ECC, memory interleaving, and channel bonding for improved performance and reliability.

In some implementations of the system, the protocol based on CXL utilizes CXL.mem, and the CXL device exposes at least one Host-managed Device Memory (HDM) address region to the entity. When operating according to CXL.mem, the CXL device (such as CXL EP) may expose one or more HDM regions that appear as memory-mapped regions to the coupled entity. The HDM regions may be configured with specific address ranges, access permissions, and memory attributes through HDM decoders. The entity may access these HDM regions using standard memory load/store operations, which are translated by the entity's CXL root port into CXL.mem transactions. The system may support HDM regions with different characteristics, such as volatile memory regions backed by the memory and persistent memory regions backed by storage-class memory.

In some implementations of the system, the protocol based on CXL utilized CXL.io, and the host-to-host physical address translation translates from physical addresses carried in CXL.io UIOMRd Transaction Layer Packets (TLPs) received from the entity to physical addresses within the HPA space. When operating according to CXL.io, the system may process various types of TLPs including memory read/write TLPs, configuration TLPs, and message TLPs. The UIOMRd TLPs may carry physical addresses within the entity's physical address space that require translation to the local HPA space. The RPU may intercept these TLPs, extract the physical addresses, perform the applicable translations, and generate corresponding transactions in the local HPA space. The system may also support other CXL.io transaction types such as UIOMWr for memory writes and may implement flow control and credit management according to CXL specifications.

In some implementations of the system, the processor comprises cores, from which at least one is a hidden core; and wherein the RPU is further configured to utilize the hidden core for internal tasks, wherein the internal tasks comprise at least one of internal firmware processing, CXL Fabric Manager (FM) API processing, processing in memory (PIM), near-memory processing, or housekeeping tasks. The RPU may utilize at least one hidden core for internal tasks, which may include processing internal firmware, handling CXL Fabric Manager (FM) API processing, processing in memory (PIM), near-memory processing, and/or performing housekeeping tasks. By utilizing hidden cores to these specific functions, the processor may improve its performance and enable efficient operation without overburdening non-hidden cores that may be allocated to running user workloads. Additionally, utilizing the hidden core(s) for the RPU tasks can allow a CPU vendor to differentiate the processor from other CPUs while maintaining compatibility with existing/established designs, applications, and software code base that was developed for established CPUs.

In some implementations of the system, the hidden core is isolated from user access and visibility, providing user-infrastructure isolation. The processor's hidden core(s) may be isolated from user access and visibility, providing user-infrastructure isolation. This isolation ensures that the user cannot affect the execution of code on the hidden cores, enhancing the security and reliability of the system. By separating the visible user-controlled cores from the hidden vendor-controlled cores, the processor can effectively protect critical infrastructure functions from undesired interference or tampering by potentially malicious user code.

In some implementations of the system, the processor comprises cores, from which at least one is hidden and is utilized for collection of memory telemetry. At least one of the processor's hidden core(s) may be utilized to collect memory telemetry. By running memory telemetry on the hidden core(s), the system can effectively monitor and manage memory resources, such as memory resources in a memory pool, without burdening the user-accessible cores, which allows for efficient resource utilization and prevents memory management tasks from interfering with user code execution.

In some implementations of the system, the processor comprises cores, from which at least one is a hidden core utilized for secure key storage and management for encrypting and decrypting data transmitted according to the protocol based on CXL, leveraging user-infrastructure isolation provided by the hidden core. At least one of the processor's hidden core(s) may be utilized to secure key storage and management, specifically for encrypting and decrypting data transmitted according to the protocol based on CXL. By leveraging the user-infrastructure isolation provided by the hidden core(s), the system prevents sensitive cryptographic keys used for securing data transmitted according to the protocol based on CXL from being accessible to user code. This isolation enhances the security of the data transmitted between the processor and the entity, protecting it from potential compromise by malicious user code. The hidden core(s) may perform the cryptographic operations on the data themselves, improving confidentiality, integrity, and/or replay protection. Alternatively, the hidden core(s) may utilize hardware-accelerated cryptographic engine(s) for performing at least part of the cryptographic operations on the data, while the hidden core(s) remain responsible for the management of the secure keys and for controlling the processing flows of the data. In this approach, the cryptographic accelerator may handle the data processing while the hidden core(s) handle the control, following a Control/Data Plane separation. Furthermore, the infrastructure code running on the hidden core(s) may participate in enabling support for confidential computing over memory exposed/provisioned by the RPU via the CXL device of the system.

In some implementations, the system further comprises a hardware-accelerated cryptographic engine, wherein the hidden core is configured to utilize the hardware-accelerated cryptographic engine for performing at least part of the cryptographic operations on the data transmitted according to the protocol based on CXL. The system may include one or more hardware-accelerated cryptographic engines that can be utilized by the hidden core(s) for performing at least part of the cryptographic operations on the data transmitted according to the protocol based on CXL. The hidden core(s) are responsible for managing the secure keys and controlling the processing flows of the data, while the cryptographic engine(s) handle the actual data processing. This approach features control/data plane separation, wherein the hidden core(s) act as the control plane, and the cryptographic engines serve as the data plane. By offloading the computationally intensive cryptographic operations to hardware accelerators, the system may achieve higher performance and efficiency in securing the data transmitted according to the protocol based on CXL.

In some implementations of the system, the hidden core enables support for confidential computing over memory exposed by the RPU via the CXL device; whereby confidential computing performs computation within a secure isolated environment to protect data in use. The hidden core(s) of the processor may support confidential computing over memory exposed/provisioned by the RPU via the CXL device. Confidential computing is a security paradigm that aims to protect data in use by performing computation within a secure, isolated environment, such as a Trusted Execution Environment (TEE). In Confidential computing, data remains encrypted and confidential even during processing, protecting sensitive information from unauthorized access, modification, or disclosure. This may be achieved utilizing a combination of hardware-based security features, such as encrypted memory regions and secure enclaves, and optional software-based logic that enforce access controls and data isolation. By enabling computation on encrypted data without exposing the plaintext contents, confidential computing provides a higher level of security and privacy compared to traditional computing models that only protect data at rest and in transit. The infrastructure code running on the hidden core(s) participates in setting up and managing the secure environment required for confidential computing, including provisioning encrypted memory regions, managing encryption keys, and keeping sensitive data protected from unauthorized access. By leveraging the user-infrastructure isolation provided by the hidden core(s), the system can create a trusted execution environment for confidential computing, enabling secure processing of sensitive data within the memory exposed by the RPU utilizing the protocol based on CXL.

In some implementations of the system, the processor comprises cores, from which at least one core is a hidden core; and wherein the RPU is further configured to utilize the hidden core for error handling and/or correction tasks within a memory pool comprising the memory, enhancing data integrity and reliability. The error handling and correction tasks performed by hidden cores may include detecting and correcting single-bit and multi-bit errors, managing spare memory regions for replacing faulty memory locations, and maintaining error logs for system analysis. The hidden cores may implement scrubbing routines (e.g., patrol scrub) that periodically read and correct memory contents to prevent error accumulation. The system may support various error correction codes and advanced ECC schemes suitable for large-scale memory pools.

In some implementations of the system, the error handling and/or correction tasks further comprise predictive failure analysis (PFA) operations, configured to predict and handle imminent failure of memory components within the memory pool, thereby preempting potential data loss and system downtime. The error handling and correction tasks may include predictive failure analysis operations designed to anticipate and address imminent failures of memory components within the memory pool. By implementing the PFA, the system may proactively identify potential faults before they manifest into actual failures, enabling timely interventions that mitigate the risk of data loss and system downtime. The PFA may not only enhance the reliability and data integrity of the memory system but also improve overall system resilience in high-performance computing architectures.

In some implementations of the system, the memory comprises dynamic random-access memory (DRAM), and the processor comprises cores, from which at least one core is a hidden core; and wherein the RPU is further configured to utilize the hidden core for controlling or managing memory access scheduling within a memory pool comprising the DRAM, to improve memory utilization and throughput. Memory access scheduling controlled or managed by hidden cores, such as via utilizing a hardware-based memory controller or a memory access scheduler managed by hidden cores, may optimize memory bandwidth utilization by reordering memory requests based on factors such as request priority, memory bank availability, and access patterns. The hidden cores may implement and apply scheduling algorithms that consider Quality-of-Service (QoS) requirements, minimize memory access conflicts, and maximize row buffer hit rates. The scheduling may also account for thermal constraints and power management goals while maintaining fair access for the memory pool clients.

In some implementations of the system, the processor comprises cores, from which at least one core is a hidden core; and wherein the RPU is further configured to utilize the hidden core for managing security protocols within a memory pool comprising the memory, including data encryption and/or access controls. Security protocol management by hidden cores may include encryption algorithms for data at rest and in transit, managing security keys and certificates, and enforcing access control policies. The hidden cores may support various security standards such as CXL Integrity and Data Encryption (IDE) for protecting data transmitted over CXL links. The memory pool may include secure enclaves or trusted execution environments to protect sensitive data and cryptographic operations from unauthorized access.

In some implementations of the system, the processor comprises cores, from which at least one core is a hidden core; and wherein the RPU is further configured to utilize the hidden core for configuration management tasks within a memory pool comprising the memory, including dynamic allocation and deallocation of memory resources. In further examples, one or more of the hidden cores of the processor may be utilized for advanced infrastructure management tasks within a memory pool based on the processor and the memory. These tasks may include one or more of: (i) error handling and correction, which enhances data integrity and reliability by promptly addressing memory errors, (ii) memory access scheduling, which improve the allocation and utilization of memory resources based on current demand and operational priorities, (iii) security management, which secures the memory pool by implementing robust encryption and access controls to safeguard data, and/or (iv) configuration management, which dynamically adjusts memory settings to adapt to varying workload requirements. One or more of these tasks may be employed to maintain the overall efficiency, security, and/or performance of the system, such as in environments requiring high-speed, high-integrity memory operations, thereby enhancing the system's capabilities and distinguishing it from architectures based on conventional CPU/GPU (where CPU/GPU refers to CPU and/or GPU).

In some implementations of the system, the processor comprises cores, from which at least one core is a hidden core; and wherein the RPU is further configured to utilize the hidden core for memory tiering tasks. Memory tiering tasks performed by hidden cores may include classifying memory regions into different performance tiers based on their underlying technology characteristics. The hidden cores may monitor access patterns to different memory regions, such as via utilizing hardware-based telemetry collectors and analyzers, and dynamically adjust tier assignments to optimize overall system performance. The system may support various memory technologies and/or speeds in different tiers, such as high-bandwidth DRAM (e.g., MRDIMMs) in tier 1, ordinary DRAM (e.g., RDIMMs) in tier 2, and persistent memory or storage-class memory (SCM) in lower tiers.

In some implementations of the system, the memory tiering tasks further comprise migration of data between memory tiers based on hotness level of the data, thereby increasing performance of memory accesses from the entity to hot data. The hidden core(s) of the processor may enable support for memory tiering, wherein memory regions or subsets of memory regions exposed to entities, may be mapped to memory resources based on parameters such as the hotness of the data in these memory regions, e.g., the frequency at which the data is used. In some implementations, the hidden core(s) may utilize memory telemetry to map hot data to higher-performance memory tiers, whereas colder data may be mapped to slower memory such as Flash memory coupled to the processor. In other implementations, the hidden core(s) may utilize memory mapping based on priority or Service-Level Agreement (SLA) associated with the data, e.g., in cases wherein the system is configured to prioritize particular workloads, virtual machines, users, or tenants, that utilize the data. Yet in other implementations, the hidden core(s) may migrate data between memory tiers, such as migrating hot data from a lower-performance memory tier to a higher-performance memory tier.

In some implementations, the system further comprises a direct Memory Access (DMA) engine, wherein the hidden core is configured to utilize the DMA engine for migrating data between memory tiers. The hidden core(s) of the processor may utilize a DMA engine for data migration between memory tiers, offloading the data movement task from the hidden core(s) to a dedicated engine, thereby providing faster migration of data and freeing the hidden core(s) to perform additional tasks.

In various examples, hidden cores are isolated from the user's access and visibility, while visible cores are available for user utilization. This isolation may be achieved utilizing different techniques, such as utilizing Type 1 hypervisors, Type 2 hypervisors, hardware partitioning, software partitioning, asymmetric multiprocessing (AMP), firmware configuration, CPU microcode updates, custom CPUs, security extensions, and/or a combination thereof.

In a first example, a Type 1 hypervisor may be utilized to create hidden and visible cores. A Type 1 hypervisor, such as VMware ESXi or Microsoft Hyper-V, runs on the hardware and manages virtual machines (VMs). The hypervisor can allocate specific processing cores to VMs using techniques such as CPU affinity or core pinning. For instance, certain cores may be designated as hidden and assigned to a VM that is not accessible or visible to the user. These hidden cores may run system management tasks or specialized applications such as CXL memory management or memory pool operations, while the visible cores are allocated to user-accessible VMs running general-purpose operating systems (GPOS). The hypervisor prevents the user from direct access to the hidden cores, maintaining isolation.

In a second example, a Type 2 hypervisor may be utilized to achieve similar isolation. A Type 2 hypervisor, such as VMware Workstation or Oracle VirtualBox, runs on a host OS and supports guest OSes, wherein the host OS manages the visible cores accessible to the user. The Type 2 hypervisor can then create additional VMs using hidden cores, which run separate OSes or specialized tasks. The overhead of the Type 2 hypervisor is higher compared to a Type 1 hypervisor, but it may provide additional flexibility in managing user-visible and hidden cores.

In a third example, hardware partitioning, also known as hardware-assisted virtualization in some systems, may be utilized to divide processing cores to isolated partitions at the hardware level, wherein the isolated partitions run different operating systems. It may be used in various scenarios wherein isolation between partitions is required, including high-reliability and safety-critical systems. For instance, one partition with hidden cores may run an RTOS or embedded OS for critical system functions, while another partition with visible cores runs a GPOS for user applications. Hardware partitioning enables isolation, as the partitions are managed by the hardware, preventing user access to the hidden cores.

In a fourth example, software partitioning, such as the Jailhouse hypervisor, may be utilized to create isolated partitions while offering lower overhead compared to full virtualization. This approach allocates specific cores to different partitions, wherein hidden cores may run dedicated tasks or specialized applications. For example, Jailhouse can configure certain cores to run an RTOS or bare-metal applications, isolating them from user access; and visible cores can run a GPOS that is available for user applications.

In a fifth example, Asymmetric Multiprocessing (AMP) may be utilized to run different OSes on different cores without a hypervisor. In this configuration, certain cores may run an RTOS or embedded OS, while other cores may run a GPOS. Communication between the operating systems may be achieved utilizing shared memory or inter-process communication logic. For instance, Linux may run on the visible cores for user applications, while an RTOS may run on the hidden cores for real-time tasks. AMP provides a straightforward method to isolate hidden cores from user access while leveraging the specific strengths of different operating systems.

In a sixth example, firmware configuration may be utilized to achieve hidden and visible cores. By accessing the Basic Input/Output System (BIOS) or the Unified Extensible Firmware Interface (UEFI) settings, certain CPU cores can be disabled, making them invisible to the OS. While this method can prevent the OS from utilizing the disabled cores, it is noted that depending on the example, these cores may still be accessible utilizing other means, such as hardware debugging interfaces, and these changes may not be persistent (e.g., rebooting the system could reset the BIOS/UEFI settings, making the hidden cores visible again). Therefore, depending on the specific requirements, additional measures may be necessary to provide complete isolation of the hidden cores.

In a seventh example, CPU microcode updates provided by the hardware vendor may be employed. These updates can include specific instructions to disable or hide cores at the microcode level, preventing their detection or usage by the operating system. This method provides a secure way to manage core visibility, as the updates are controlled by the CPU manufacturer.

In an eighth example, custom CPU designed by hardware vendors can be utilized, which include technologies and mechanisms that enable core partitioning and management of core visibility. For example, Intel's Resource Director Technology (RDT) allows for the partitioning of CPU resources, while ARM's Big. LITTLE architecture enables heterogeneous multi-processing, wherein different types of cores can be used for different purposes. These vendor-specific examples provide control over core allocation and maintain certain cores hidden from the user.

In a ninth example, security extensions such as Intel's Trusted Execution Technology (TXT) or ARM's TrustZone may be used. These technologies create secure execution environments that isolate specific cores for security-sensitive operations. The hidden cores may only be accessible within the secure environment, protecting them from user interference and enabling secure execution of critical tasks.

In various implementations, a method comprising: accessing memory coupled to a processor utilizing physical addresses within a Host Physical Address (HPA) space; wherein the processor comprises a coherent interconnect; mapping addresses within a virtual address space to physical addresses within the HPA space; whereby the addresses within the virtual address space are utilized by an operating system (OS) of an apparatus comprising the processor; communicating, by a Compute Express Link (CXL) device of a resource provisioning unit (RPU), with an entity coupled to the apparatus according to a protocol based on CXL; wherein the RPU is coupled to the coherent interconnect; and performing, by the RPU, host-to-host physical address translations which enable the entity to access the memory via the CXL device.

In some implementations of the method, the entity comprises a second host that utilizes a second HPA space, and the host-to-host physical address translations are translating physical addresses within the second HPA space to physical addresses within the HPA space.

In some implementations, the method further comprises communicating, via a CXL root port, with a CXL memory expander that utilizes a Device Physical Address (DPA) space; and wherein at least one of the operating system or system firmware is mapping between physical addresses within the HPA space and physical addresses within the DPA space, whereby the mapping enables the second host to utilize the memory and/or the CXL memory expander.

In various implementations, an apparatus comprising: a processor comprising a coherent interconnect; the processor is coupled to memory having a capacity of at least 64GB; wherein the processor is configured to utilize physical addresses within a first Host Physical Address (HPA) space to access the memory, and to execute an operating system (OS) that utilizes a virtual address space; a memory management unit (MMU) configured to enable access to the memory, based on mapping addresses within the virtual address space to physical addresses within the first HPA space; a resource provisioning unit (RPU), coupled to a Compute Express Link (CXL) device configured to exchange messages conforming to a protocol based on CXL which utilizes a second HPA space; and wherein the RPU is further coupled to the coherent interconnect and configured to translate physical addresses within the second HPA space to physical addresses within the first HPA space.

In various implementations, a system designed to function as a Multi-Headed Device (MHD), comprising: a processor comprising a coherent interconnect; the processor is coupled to dynamic random-access memory (DRAM) having a capacity of at least 32 GB; wherein the processor is configured to utilize physical addresses within a Host Physical Address (HPA) space to access the DRAM, and to execute an operating system (OS) that utilizes a virtual address space; a memory management unit (MMU) configured to enable access to the DRAM, based on mapping addresses within the virtual address space to physical addresses within the HPA space; first and second Compute Express Link (CXL) endpoints configured to communicate with hosts coupled to the system according to a protocol based on CXL; and a resource provisioning unit (RPU) configured to perform host-to-host physical address translations which enable the hosts to access the DRAM utilizing messages conforming to the protocol based on CXL.

The CXL Specification revision 3.2 defines a Multi-Headed Device (MHD) in section 2.5 as a CXL type-3 device with CXL ports, referred to as heads. The CXL specification currently defines two types of MHDs that are distinguished by how they present themselves on each head: (i) a MH-SLD, which presents Single Logical Devices (SLDs) on the heads, and has a 1:1 mapping between heads and LDs, and (ii) a MH-MLD, which may present Multi-Logical Devices (MLDs) on any of their heads, wherein a head in a Multi-Headed Device has at least one and no more than 16 Logical Devices mapped.

In some implementations of the system, the DRAM is coupled via at least four memory channels to the processor; wherein the DRAM has a memory capacity exceeding 128 GB, 256 GB, 512 GB, or 1 TB; and wherein the DRAM comprises mainstream DRAM modules exhibiting an average unit price per gigabyte that does not exceed three times an average unit price per gigabyte of a lowest-cost DRAM module technology in volume production for servers in data centers.

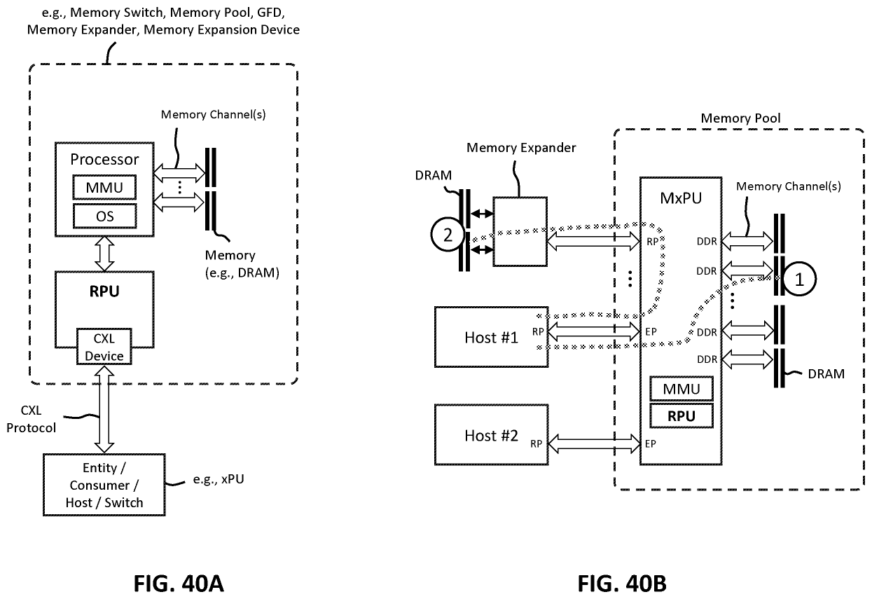

FIG. 40A illustrates an example of a system comprising a memory switch, a memory pool, a Global Fabric-Attached Memory (GFAM) Device (GFD), a memory expander (ME), or a memory expansion device, which comprise a processor, memory (such as DRAM), and an RPU coupled to an entity such as a host. The processor may include processing cores and cache hierarchies that utilize a first HPA space for accessing system resources. The memory may be coupled to the processor via memory channels, such as DDR4 or DDR5 channels, providing high-bandwidth memory access. The RPU may include, or be coupled to, a CXL device (such as a CXL EP), and may be integrated within the same semiconductor device as the processor or implemented as a separate component. The RPU may perform physical address translations between the entity's HPA space and the processor's physical address space. The entity may be coupled to the memory pool via the CXL device that supports one or more CXL protocols, enabling the entity to access the memory based on the address translations performed by the RPU.

FIG. 40B illustrates an example of a system comprising a memory pool coupled to hosts and to a memory expander, wherein the memory pool is based on a processor (such as an MxPU) comprising an RPU and CXL devices. The memory pool may include memory tiers, such as a first memory tier (denoted as “1”) comprising DRAM coupled via memory channels to the MxPU, and a second memory tier (denoted as “2”) comprising DRAM associated with the memory expander. The MxPU may include a CXL RP for coupling to the memory expander, enabling the memory pool to extend its capacity beyond the directly attached DRAM. Multiple hosts may be coupled to the memory pool via separate CXL devices (such as CXL EPs) within the MxPU, wherein the hosts utilize their respective HPA spaces. The RPU within the MxPU may perform different host-to-host physical address translations for the different coupled hosts, enabling concurrent access to both memory tiers while maintaining isolation between different hosts'physical address spaces.

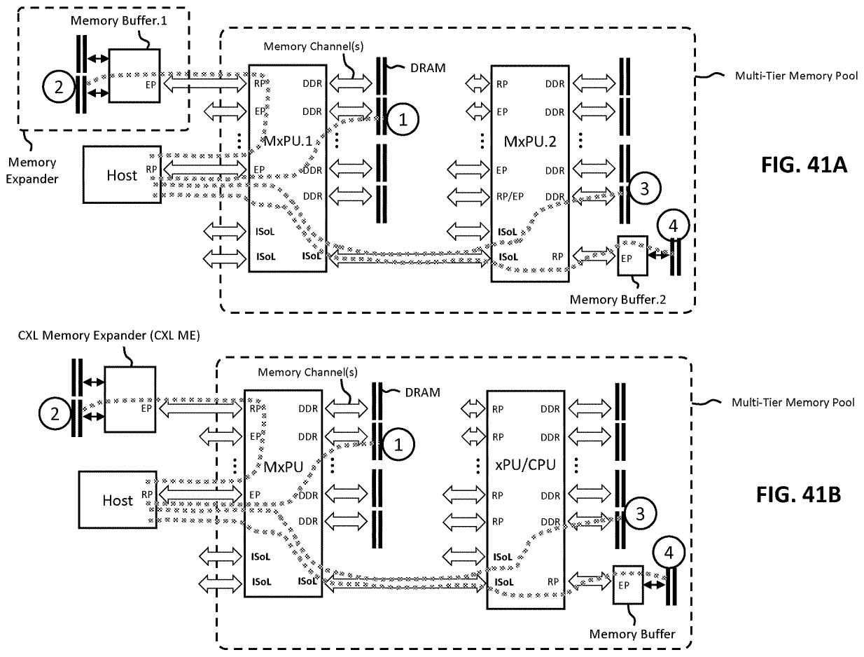

FIG. 41A illustrates an example of a system comprising a memory pool comprising two or more MxPUs. The memory pool may utilize a chipset-based architecture wherein a collection of electronic components such as MxPUs, xPUs, CPUs, and memory buffers, works together on a platform for realizing a memory pool functionality. The memory pool may include memory tiers, such as a first memory tier (denoted as “1”) comprising DRAM coupled via memory channels to the first MxPU, a second memory tier (denoted as “2”) comprising DRAM associated with the memory expander coupled to the first MxPU, a third memory tier (denoted as “3”) comprising DRAM coupled via memory channels to the second MxPU, and a fourth memory tier (denoted as “4”) coupled to the memory buffer that is coupled to the second MxPU. The MxPUs may be interconnected via an ISoL, such as UPI, Infinity Fabric, or CHI C2C, enabling coherent communication between the MxPUs. Each MxPU may include its own RPU for performing host-to-host physical address translations and CXL devices (such as CXL EPs) for coupling to external hosts, allowing at least some of the external hosts to access the distributed memory resources across memory tiers. The memory buffers may provide additional memory capacity and may include buffer control logic for managing data flow between different memory tiers.

FIG. 41B illustrates an example of a system comprising a memory pool comprising at least one MxPU and at least one xPU (that may be a CPU). The memory pool may utilize a chipset-based architecture. The memory pool may include memory tiers, such as a first memory tier (denoted as “1”) comprising DRAM coupled to the MxPU, a second memory tier (denoted as “2”) comprising DRAM associated with the memory expander coupled to the MxPU, a third memory tier (denoted as “3”) comprising DRAM coupled to the xPU/CPU, and a fourth memory tier (denoted as “4”) coupled to the memory buffer. The MxPU may include CXL devices (such as CXL EPs) and serve as the primary interface for external hosts to access the memory pool via protocols based on CXL, while the xPU/CPU may provide additional processing capabilities and memory resources. The RPU within the MxPU may coordinate address translations to enable external hosts to access memory resources across the tiers, including memory attached to the xPU/CPU. This example may optimize cost and performance by combining specialized MxPUs for memory pooling with established xPUs/CPUs for processing tasks and additional memory capacity.

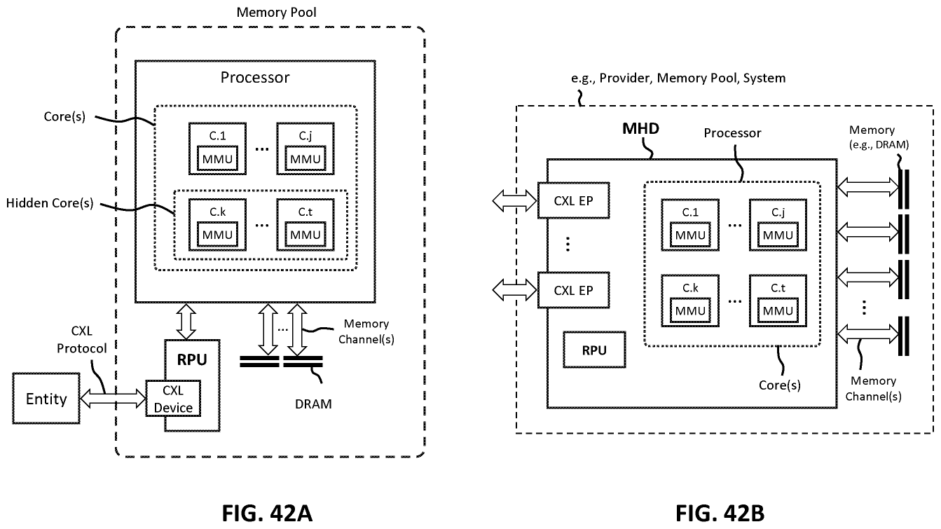

FIG. 42A illustrates an example of a system comprising a memory pool comprising a processor, DRAM, and an RPU. The RPU may include or be coupled to a CXL device. The RPU performs host-to-host physical address translations that enable an entity, external to the memory pool, to access the DRAM coupled to the processor. The processor may include cores, wherein some of the cores may be hidden from the user and may serve for executing infrastructure tasks related to operations, administration and management (OAM) of the memory pool.

FIG. 42B illustrates an example of a system comprising a memory pool comprising a CXL Multi Headed Device (MHD), such as Multi-Headed Single Logical Device (MH-SLD) or Multi-Headed Multi-Logical Device (MH-MLD), comprising a processor coupled to DRAM. The processor includes one or more processing cores wherein each processing core may include an MMU. The MHD further comprises CXL endpoints, wherein at least some of the endpoints may be associated with logical devices such as SLDs or MLDs, and an RPU configured to perform host-to-host physical address translations that enable entities external to the MHD to access the DRAM. Optionally, some of the illustrated blocks may be omitted, combined, or implemented as discrete chiplets, IP blocks, or firmware-assisted logic. The number and type of cores is implementation-dependent and may include general-purpose CPUs, vector engines, AI accelerators, or heterogeneous combinations thereof. In alternative or additional examples, one or more cores execute processing-in-memory (PIM) operations, for example, reductions, searches, or machine-learning kernels, against data resident in the DRAM, thereby reducing link bandwidth consumption. By virtue of the address-translation logic in the RPU, the MHD can expose the DRAM as a shared or partitionable pool that is accessible by entities via the CXL endpoints, which enables memory pooling, memory sharing, multi-tenant isolation, and/or dynamic capacity provisioning within a CXL-based system.

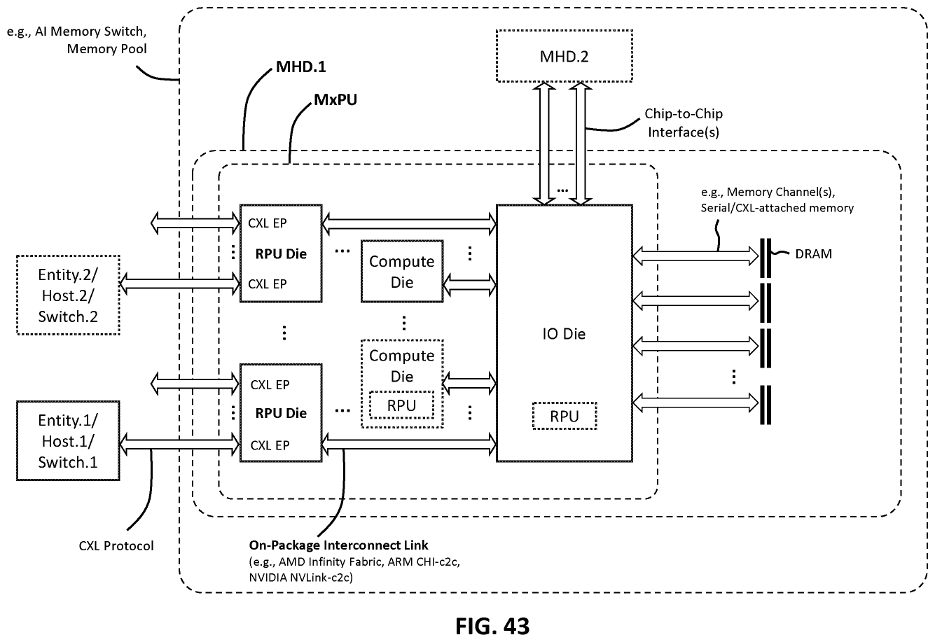

FIG. 43 illustrates an example of a system comprising an AI memory switch or a memory pool, comprising a CXL Multi Headed Device (MHD) coupled to two external entities. The memory pool may include additional MHDs coupled to additional entities. The memory pool may utilize a chipset-based architecture wherein a collection of electronic components such as MxPUs, xPUs, CPUs, and memory buffers, works together on a platform for realizing a memory pool functionality. The MHD comprises an MxPU coupled to DRAM, wherein the DRAM may be internal to the MHD, such as mounted on a PCB alongside the MxPU, possibly within an MHD enclosure, or the DRAM may be external to the MHD, such as in pluggable memory modules (e.g., EDSFF). The MxPU may be derived from an established processor design, such as a CPU design that utilizes a combination of at least one compute die and at least one I/O die that may communicate with each other utilizing an on-package interconnect such as AMD Infinity Fabric, ARM CHI C2C, or NVIDIA NVLink-C2C. An RPU, optionally implemented in a separate die/chiplet, or embedded into an I/O die and/or into a compute die, performs host-to-host physical address translations that enable entities coupled to the memory pool via the CXL endpoints to access the DRAM coupled to the MxPU. The MxPU may include one or multiple chip-to-chip interfaces, such as ISoL, that may provide interconnection of multiple MxPU instances in various topologies to create a larger logical MHD, a distributed MHD, or a memory pool that may serve additional external entities and provide larger memory capacities. The chip-to-chip interface may utilize the same communication protocol utilized by the on-package interconnect links, such as AMD Infinity Fabric, ARM CHI C2C, or NVIDIA NVLink-C2C. Processing cores in the MxPU, optionally hidden cores utilized for infrastructure tasks, may provide Processing In Memory (PIM) services to data residing in the DRAM.

Coherent Hub Interface (CHI) employs a role-based node classification system. Non-limiting examples of CHI node types may include the following. Request Nodes (RN) may generate transactions, including reads and writes, to the interconnect. For example, a Fully Coherent Request Node (RN-F) may include a hardware-coherent cache and may support snoop transactions. An I/O-Coherent Request Node with Distributed Virtual Memory (DVM) support (RN-D) may not include a hardware-coherent cache but may receive DVM transactions and generate a subset of transactions defined by the protocol. An I/O-Coherent Request Node (RN-I) may not include a hardware-coherent cache and may not receive DVM transactions, generating a subset of transactions defined by the protocol without requiring snoop functionality. Home Nodes (HN) may be located within the interconnect and may receive transactions from Request Nodes. For example, a Fully Coherent Home Node (HN-F) may include a Point of Coherence (PoC) that manages coherency by snooping the required RN-Fs, consolidating the snoop responses for a transaction, and sending a single response to the requesting Request Node. HN-F nodes are expected to be the Point of Serialization (PoS) for memory requests, and may include a snoop filter or directory and an integrated interconnect cache. An I/O-coherent Home Node (HN-I) may process a limited subset of request types and may serve as the PoS for IO requests targeting the IO subsystem. Subordinate Nodes (SN) may receive requests from Home Nodes and return responses. For example, a Subordinate Node (SN-F) may be used for normal memory and may be capable of processing non-snoopable read, write, and atomic requests, including Cache Maintenance Operation (CMO) requests. Other CHI implementations may define additional or different node types and classifications.

References herein to ARM CHI component types, such as RN-F, HN-F, HN-I, RN-I, RN-D, SN-F, CCG, CXG, and XP, are intended to encompass the functionality associated with these designations as defined in the ARM AMBA CHI Architecture Specifications and related ARM documentations, including present and future revisions that may refine, rename, or extend these designations.

In some examples utilizing ARM-based coherent mesh architectures, crosspoints (XP) may function as routing nodes that direct traffic between different components of the system. For example, crosspoints may route packets both horizontally and vertically within a mesh structure based on identifiers within protocol messages. Nodes within the mesh may maintain registers accessible through memory-mapped I/O (MMIO) operations, such as via ARM's Advanced Microcontroller Bus Architecture (AMBA) Advanced Peripheral Bus (APB). These registers may contain configuration information and operational parameters that allow system firmware, system software, or diagnostic tools to determine the presence and configuration of specific nodes and blocks within the architecture. Other coherent interconnect architectures may utilize different routing topologies and register access mechanisms.

In some examples, systems integrating CXL with ARM CHI interconnects may utilize specialized interfaces and gateways to manage the translation and routing of different protocol types. For example, a CXL/CCIX Gateway (CCG) may incorporate Request Node (RN) functionality, Home Node (HN) functionality, and link interface logic, managing conversion between CXL-based protocols and CHI-based protocols. The CCG may be coupled to the CHI interconnect via a CXS interface, which may provide a pathway for coherent transactions that is less complex to implement than a full CHI interface. CXL.mem and CXL.cache transactions, being coherent in nature, may be routed through the CCG via the CXS interface. CXL.io transactions, being non-coherent, may be routed through alternative paths, such as via an AXI interface coupled to RN-D or HN-I nodes within the CHI interconnect. For example, CXL.mem and CXL.cache traffic may be routed via a CXS interface to CCG nodes, while CXL.io traffic may be routed via an AXI interface to RN-D and HN-I nodes, allowing different paths to be optimized for their specific protocol characteristics. Other architectures may utilize different interfaces, gateways, or routing approaches for integrating CXL with coherent interconnects.

Non-limiting examples of transaction flows within CHI-based systems with CXL integration may follow the sequences described below. In one example, a requester, which may be a CCG block coupled to CXL Device logic or a CXL Device coupled to a mesh crosspoint, may issue an allocating read request to a Home Node (HN). The initial request may utilize various opcodes such as ReadClean, ReadNotSharedDirty, ReadShared, ReadUnique, ReadPreferUnique, or MakeReadUnique. The Home Node may process these transactions and may employ different response approaches based on system configuration and optimization goals. In one example, the Home Node may utilize combined responses from subordinate nodes, wherein the Home Node sends a downstream read request, such as ReadNoSnp, to a Subordinate node such as a Memory Controller. The Subordinate node may then return a combined response along with the requested data to the original requester using CompData, bypassing the need for the data to flow back through the Home Node. Using CompData may reduce message count and may decrease transaction latency by eliminating one hop in the data return path. The selection between different response approaches may be made by the Home Node based on factors such as current system load, transaction type, or design complexity considerations. In some examples, CCG blocks may be used for coupling RPUs and CXL Devices to mesh interconnects, providing a standardized interface for CXL integration. In other examples, RPUs may expose CHI interfaces capable of connecting to XP crosspoints within the mesh, wherein these RPUs may perform address translations as part of the transaction processing flow.

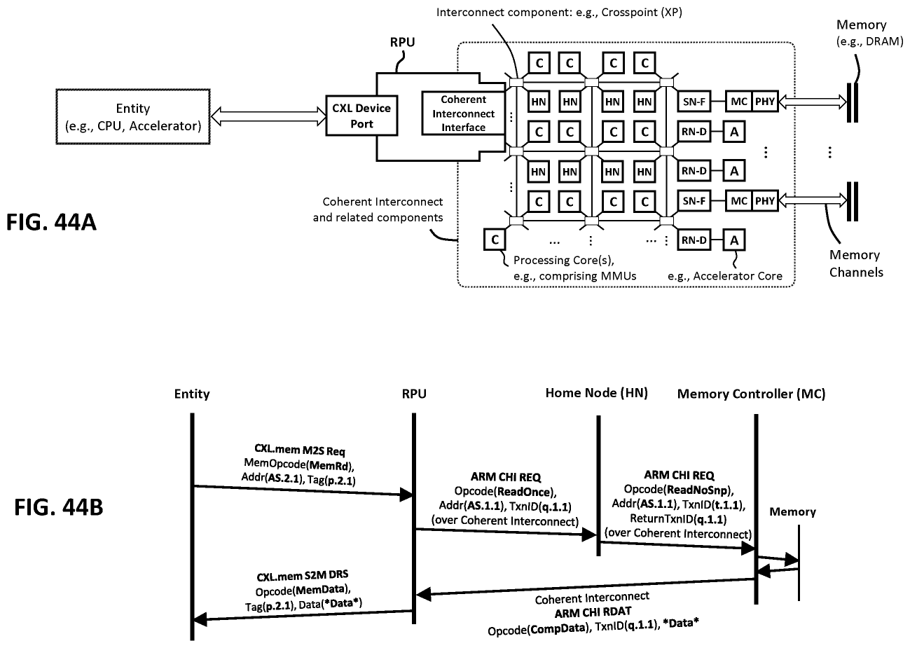

FIG. 44A illustrates an example of a system where an entity, such as a CPU or accelerator, communicates via a CXL device port that is coupled to or included in an RPU. The RPU may further include a Coherent Interconnect Interface that may utilize a protocol based on ARM CHI. The Coherent Interconnect Interface couples the RPU to an interconnect component, such as a crosspoint (XP), within a coherent interconnect. The Coherent Interconnect Interface performs the applicable conversions between a CXL-based domain and a coherent interconnect domain, such as between CXL.mem and ARM CHI, enabling the entity to access the memory (such as DRAM) and other resources coupled to the coherent interconnect. The coherent interconnect may be implemented as a mesh topology connecting various components including processing cores, home nodes (HN), memory controllers (MC), and accelerator cores.

FIG. 44B illustrates an example of a TFD showing address translations between CXL.mem and ARM CHI. An entity, such as a CPU, initiates a CXL.mem M2S request, such as M2S Req comprising a physical address (AS.2.1), MemRd, Addr(AS.2.1), and Tag(p.2.1). The RPU translates the M2S Req to a CHI request, such as ARM CHI REQ carrying ReadOnce, a translated physical address (AS.1.1), and TxnID(q.1.1). The transaction flows through the coherent interconnect to a home node (HN), which may process the request and send the processed request to a memory controller (MC). The HN may translate the received ARM CHI REQ to an ARM CHI REQ carrying ReadNoSnp, Addr(AS.1.1), TxnID(t.1.1), and ReturnTxnID(q.1.1). The memory controller retrieves the data from the memory (such as DRAM) and sends the data to the RPU, such as utilizing ARM CHI RDAT, through the coherent interconnect. For example, the memory controller may utilize ARM CHI RDAT with CompData and TxnID(q.1.1) for sending the data. The wildcard notation *Data* indicates that the data may be encoded, encrypted, or otherwise processed as needed for the transmission. Alternatively, the response and read data paths may be implemented according to other designs, such as wherein the MC may send the data to the HN that sends it to the RPU, or the HN sends a response to the RPU while the MC sends the data to the RPU. The RPU then translates the ARM CHI response back to the CXL.mem domain for delivery to the requesting entity. For example, the RPU may translate the ARM CHI RDAT to CXL.mem S2M DRS comprising MemData, Tag(p.2.1), and the *Data*.

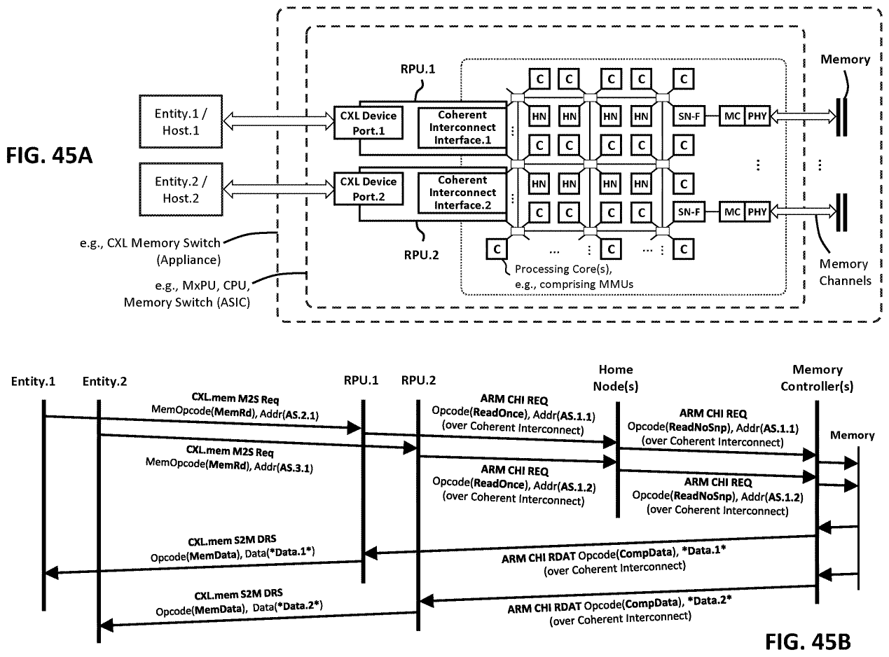

FIG. 45A illustrates an example of a system comprising a CXL memory switch appliance comprising an MxPU, CPU, or a memory switch ASIC, which is coupled to first and second entities denoted as Entity.1/Host.1 and Entity.2/Host.2. The MxPU includes processing cores and memory controllers coupled to a coherent interconnect that in one example utilizes a CHI-based protocol. The MxPU utilizes translations, performed by the RPUs, between CXL-based ports and the MxPU's coherent interconnect. The first RPU (RPU.1) may enable Entity.1/Host.1 to access, via the first CXL device port and the MxPU's coherent interconnect, resources mapped to a physical address space utilized by the MxPU's coherent interconnect, such as memory (e.g., DRAM) resources of the MxPU. Correspondingly, the second RPU (RPU.2) may enable Entity.2/Host.2 to access, via the second CXL device port and the MxPU's coherent interconnect, resources mapped to the physical address space utilized by the MxPU's coherent interconnect, such as the memory resources of the MxPU.

FIG. 45B illustrates an example of a TFD depicting a multi-host memory access scenario wherein two entities access memory through a shared coherent interconnect infrastructure. Entity.1/Host.1 initiates a CXL.mem M2S request comprising MemOpcode(MemRd) and Addr(AS.2.1) from a second physical address space, which RPU.1 translates to ARM CHI REQ carrying Opcode(ReadOnce) and Addr(AS.1.1) from the coherent interconnect's first physical address space. Concurrently or sequentially, Entity.2/Host.2 may initiate a CXL.mem M2S request comprising MemOpcode(MemRd) and Addr(AS.3.1) from a third physical address space, which RPU.2 translates to ARM CHI REQ carrying Opcode(ReadOnce) and Addr(AS.1.2) from the coherent interconnect's first physical address space. Both transactions flow through the coherent interconnect to one or more home nodes, which send respective ARM CHI REQ messages to one or more memory controllers, for example with Opcode(ReadNoSnp) and the addresses Addr(AS.1.1) and Addr(AS.1.2), respectively. The memory controller(s) retrieve the requested data from memory and send ARM CHI RDAT messages with Opcode(CompData) carrying *Data.1* and *Data.2*, representing the data retrieved from the addresses AS.1.1 and AS.1.2, respectively. RPU.1 translates the first response to CXL.mem S2M DRS with Opcode(MemData) and Data(*Data.1*) and sends it to Entity.1/Host.1. RPU.2 translates the second response to CXL.mem S2M DRS with Opcode(MemData) and Data(*Data.2*) and sends it to Entity.2/Host.2. The illustrated example demonstrates how hosts may share access to the same memory resources based on RPUs that perform physical address translations. Additionally or alternatively, the illustrated example may be viewed as two separate transactions that utilize the same processor's coherent interconnect to access the memory, wherein the entities maintain their respective physical address space that are translated to the physical address space utilized by the coherent interconnect.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other examples may co-locate the home node function with a specific memory controller, utilizing a unified mapping scheme that selects both a home node and a memory controller.

In various implementations, an apparatus comprising: processing cores coupled via a coherent interconnect to: a interconnect gateway, an I/O-Coherent node, and memory controllers; wherein the coherent interconnect is based on Coherent Hub Interface (CHI) protocol (CHI-based protocol), the processing cores are configured to respond to snoop requests that utilize physical addresses within a first physical address space, and the memory controllers are coupled to memory channels capable of supporting memory having a capacity of at least 64 GB; and a resource provisioning unit (RPU) configured to: receive transmissions comprising data indicative of Compute Express Link (CXL) messages; wherein the CXL messages comprise CXL.mem messages and/or CXL.cache messages, and at least some of the second CXL.mem and/or CXL.cache messages carry physical addresses within a second physical address space; translate the physical addresses within the second physical address space to physical addresses within a first physical address space; generate first CXL.mem and/or CXL.cache messages based on the second CXL.mem and/or CXL.cache messages and the physical addresses within the first physical address space; and forward the first CXL.mem and/or CXL.cache messages to the interconnect gateway.

In some implementations of the apparatus, the interconnect gateway comprises a Compute Express Link (CXL)/Cache-Coherent Interconnect for Accelerators (CCIX) Gateway (CCG), and the I/O-Coherent node comprises an I/O-Coherent Request Node with DVM support (RN-D) and/or an I/O-Coherent Request Node (RN-I).

In some implementations of the apparatus, the RPU forwards the first CXL.mem and/or CXL.cache messages to the CCG via a CXS interface; and wherein the apparatus is further configured to translate the first CXL.mem and/or CXL.cache messages to CHI-based messages for transmission over the coherent interconnect. The CXS interface may provide an intermediate protocol layer between CXL and CHI, with the CCG performing the final protocol conversion to CHI while managing coherency requirements for the translated messages.

In some implementations of the apparatus, the apparatus operates as a Global Fabric-Attached Memory (G-FAM) Device (GFD); the RPU receives CXL.mem messages in the transmissions; and the received CXL.mem messages are forwarded to the CCG after address translation.

In some implementations of the apparatus, the CCG and the I/O-Coherent node are mapped to an internal protocol bus with configuration registers; the configuration registers are accessible utilizing memory-mapped I/O (MMIO) operations; and the configuration registers enable discovery of address translation capabilities and configuration of address translation parameters. The MMIO-accessible configuration registers may allow system software to discover the presence of address translation functionality, configure address translation tables or parameters, and monitor translation statistics or error conditions through standardized register interfaces.

In some implementations of the apparatus, the data is further indicative of second CXL.io messages, and the RPU is further configured to: translate the second CXL.io messages to first CXL.io messages, and forward the first CXL.io messages to the I/O-Coherent node.

In some implementations of the apparatus, the RPU forwards the first CXL.io messages to the I/O-Coherent node via an AXI interface, and wherein the I/O-Coherent node comprises an RN-D that translates the first CXL.io messages to CHI-based messages for non-coherent operations. The AXI interface may leverage its PCIe-like characteristics to handle CXL.io messages, which maintain PCIe compatibility, while the RN-D provides appropriate translation to CHI for I/O operations without cache coherency overhead.

In some implementations of the apparatus, the transmissions are received via a physical layer based on IEEE 802.3 physical medium attachment (PMA); and wherein the data indicative of CXL messages is encapsulated within a carrier protocol transmitted over the physical layer based on IEEE 802.3 PMA. The use of IEEE 802.3 PMA may enable CXL messages to be transported over longer distances using established physical layer technology, with the carrier protocol providing encapsulation while enabling transmission over Ethernet-compatible physical infrastructure.

In some implementations of the apparatus, the carrier protocol is based on Ethernet or based on IEEE 802.3, and wherein the data indicative of CXL messages is encapsulated within Ethernet frames or IEEE 802.3 frames, respectively.

In some implementations of the apparatus, the carrier protocol is based on Ultra Ethernet Transport (UET) protocol; and wherein the data indicative of CXL messages is encapsulated within Link Layer Retry eligible frames (LLR-eligible frames).

In some implementations of the apparatus, the carrier protocol is based on Scale Up Ethernet (SUE); and wherein the data indicative of CXL messages is encapsulated within an SUE-based Protocol Data Unit (PDU). Examples of SUE-based PDU may include SUE PDU, SUE Lite PDU, or PDUs based on future revisions of SUE.

In some implementations of the apparatus, the RPU is further configured to: translate the first CXL.mem and/or CXL.cache messages to CHI-based messages after generating the first CXL.mem and/or CXL.cache messages; and forward the CHI-based messages to the interconnect gateway. The two-stage process may first perform address translation while maintaining CXL-based format, then convert to CHI-based format for transmission over the coherent interconnect, enabling modular processing wherein address translation logic can be separated from protocol conversion logic.

In some implementations of the apparatus, the second CXL.mem and/or CXL.cache messages comprise source Tags from an originating entity; the RPU maintains a Tag mapping table that associates the source Tags with local Tags; and the first CXL.mem and/or CXL.cache messages comprise the local Tags, enabling the RPU to correlate responses with original requests. The Tag mapping may enable the RPU to manage transaction tracking across the address translation boundary, so that responses can be properly routed back to the originating entity even though the transactions use different physical address spaces and potentially different Tag namespaces.

In some implementations of the apparatus, the RPU is further configured to: receive transmissions from entities that utilize different physical address spaces, maintain separate address translation contexts for the entities, and generate the first CXL.mem and/or CXL.cache messages with appropriate address translations based on the originating entity. The multi-entity support may enable the RPU to serve as a consolidation point for CXL devices or hosts associated with different physical address space views, while providing unified access to the system's memory resources utilizing appropriate per-entity address translations.

In some implementations of the apparatus, the RPU enforces memory access permissions during address translation, comprising: validating that addresses within the second physical address space are within permitted ranges for the originating entity; and generating error responses for attempts to access addresses outside permitted ranges. The address translation process may incorporate security and isolation mechanisms that prevent entities from accessing memory regions allocated to other entities or system-reserved areas, implementing hardware-enforced memory protection at the protocol translation boundary.

In some implementations of the apparatus, the RPU is further configured to: receive CHI-based protocol responses from the coherent interconnect via the interconnect gateway; translate physical addresses within the CHI-based protocol responses from the first physical address space to the second physical address space; generate CXL response messages based on the CHI-based protocol responses and the translated addresses; and transmit the CXL response messages to the originating entity. The bidirectional address translation enables the response messages to carry addresses that are meaningful to the originating entity, maintaining address space consistency throughout the complete transaction lifecycle from request to response.

In some implementations of the apparatus, the interconnect gateway comprises CXL/CCIX Gateway (CCG) that utilizes a streaming interface protocol, wherein the CCG comprises a link agent that supports the streaming interface protocol, providing flit packing and unpacking, end-to-end data integrity, and a flit-retry mechanism for reliability, availability and serviceability (RAS) containment when data corruption is detected.

In some implementations of the apparatus, the interconnect gateway comprises at least one of Coherent Multichip Link (CML) or Cache Coherent Interconnect for Accelerators (CCIX) Gateway (CXG) that utilizes a streaming interface protocol, and wherein the interconnect gateway is configured to utilize a 32-bit cyclic-redundancy check (CRC-32) to protect transactions conforming to the streaming interface protocol.

Some implementations of the following apparatus relate to processor architectures that incorporate interconnects with CXL protocol interfaces coupled through interconnect components and RPUs for enabling CXL communication with external entities via a physical layer based on IEEE 802.3 PMA. The interconnect within the processor may be implemented as a mesh interconnect that routes messages among processing cores, cache controllers, home agents, memory controllers, and interface agents through crosspoints or similar routing elements. Interconnect components, such as ARM CCG, may bridge CXL protocol domains with CHI protocol domains on the interconnect, enabling CXL devices coupled to RPUs to exchange coherent and non-coherent traffic with agents on the interconnect. The CXL device may be implemented in at least one of the RPU or the interconnect component, and may serve as the CXL endpoint logic that enables CXL transactions between the external entities and the interconnect. The RPU and the interconnect component may together perform the translation between CXL transactions associated with data communicated with external entities via the physical layer based on IEEE 802.3 PMA, and interconnect transactions communicated via the interconnect. The translation may include extracting CXL information from carrier protocol PDUs, reconstructing CXL transactions, performing address and Tag translations, translating CXL transactions to interconnect transactions, and encapsulating CXL responses for transmission back to external entities.

In various implementations, an apparatus comprising: a processor comprising processing cores coupled via an interconnect; an interconnect component coupled to the interconnect; a resource provisioning unit (RPU) coupled to the interconnect component; a physical layer based on IEEE 802.3 physical medium attachment (PMA), coupled to the RPU, configured to communicate with an external entity; a Compute Express Link (CXL) device implemented in at least one of the RPU or the interconnect component; and wherein at least one of the RPU or the interconnect component is configured to translate between CXL transactions and interconnect transactions; wherein the CXL transactions are associated with data communicated with the external entity via the physical layer based on IEEE 802.3 PMA, and the interconnect transactions are communicated via the interconnect. The processor may be implemented as a SoC, a multi-chip module, or a chiplet-based design incorporating processing cores, an interconnect, and various interface agents. The interconnect may provide a scalable on-chip fabric that routes transactions among agents based on packet identifiers, node addresses, or other routing information. The interconnect component may translate between CXL transactions (such as CXL.mem M2S and S2M transactions, CXL.cache H2D and D2H transactions) and interconnect transactions (such as CHI Read, Write, Snoop, and Data transactions) for communication with agents on the interconnect. The CXL device, implemented in at least one of the RPU or the interconnect component, may present CXL endpoint functionality, implementing the CXL protocol logic for one or more CXL sub-protocols. The RPU and the interconnect component may together perform carrier-to-CXL and CXL-to-interconnect protocol translations, enabling external entities connected via the IEEE 802.3 PMA to exchange CXL traffic with the processor's interconnect-coupled agents. Multiple interconnect components may be utilized to provide ports or to handle different CXL sub-protocols.

In the context of coherent interconnects, an interconnect component may refer to various types of devices, blocks, or functional entities that participate in, terminate, bridge, gateway, aggregate, or otherwise interface with a coherent or non-coherent fabric. Non-limiting examples of interconnect components may include router modules, request nodes, home nodes, subordinate nodes, gateways, bridges, and domain bridges. For example, in certain revisions of ARM-based coherent mesh architectures, such as the ARM Neoverse and CoreLink CMN families, interconnect components may include: crosspoint (XP) router blocks; Request Nodes, such as Fully Coherent Request Node (RN-F), I/O-coherent Request Node (RN-I), or I/O-coherent Request Node with Distributed Virtual Memory support (RN-D); Home Nodes, such as Fully Coherent Home Node (HN-F) or I/O-coherent Home Node (HN-I); Gateways, such as CXL/CCIX Gateway (CCG) blocks used with Coherent Multichip Link (CML) or external CXL attachment, or CCIX Gateway (CXG) bridging between CHI and CXS interfaces; and Bridges, such as AMBA 5 CHI to ACE5-Lite bridge (SBSX), AMBA Domain Bridge (ADB), CHI Domain Bridge (CDB), or CXS Domain Bridge (CXSDB). Other revisions of ARM architectures or other coherent interconnect architectures may define different interconnect component types, classifications, or naming conventions.

In some implementations of the apparatus, the interconnect component comprises an ARM CXL/CCIX Gateway (CCG). The CCG may translate between CXL and CHI protocol domains. The CCG may be coupled to the interconnect via one or more ports at a crosspoint.

In some implementations of the apparatus, the interconnect comprises a mesh interconnect, the mesh interconnect comprising crosspoints (XPs) configured to route interconnect transactions between the processing cores, the interconnect component, and memory controllers based on packet identifiers. The crosspoints may function as routing elements at intersections within the mesh topology, examining fields within packets to determine the appropriate output port and routing path. Packet identifiers may include target node identifiers, address-based routing information, or other fields defined by the interconnect protocol for mesh routing. The crosspoints may connect to processing cores, LLC slices, home agents, memory controllers, interconnect components, RN-D nodes, SN-F nodes, and other agents on the mesh interconnect.

In some implementations, the apparatus further comprises an I/O-coherent Request Node with Distributed Virtual Memory support (RN-D) coupled to the interconnect, the RN-D configured to handle CXL.io or non-coherent traffic between the CXL device and the processing cores. The RN-D may handle CXL.io configuration reads and writes, memory-mapped I/O (MMIO) access, and other non-coherent transactions. The RN-D may support Distributed Virtual Memory (DVM) operations, which may enable synchronization of virtual memory management operations across the interconnect.

In some implementations, the apparatus further comprises Subordinate Node (SN-F) nodes coupled to memory controllers, the memory controllers coupled to DRAM via DDR PHY and memory channels. The SN-F nodes may serve as subordinate agents on the interconnect that interface between the interconnect protocol domain and the memory controllers. The SN-F nodes may include snoop filter functionality for tracking cacheline state and location across the interconnect. The memory controllers may access DRAM through DDR PHY interfaces and memory channels, supporting memory technologies such as DDR4, DDR5, LPDDR5, or HBM. When a CXL.mem request from an external entity is translated through the RPU, the request may be routed through the interconnect to a home node, which may in turn access the SN-F node and memory controller to read from or write to DRAM.

In some implementations of the apparatus, the interconnect component comprises a CXL Streaming (CXS) interface and a Coherent Multichip Link (CML) gateway or a Cache Coherent Interconnect for Accelerators (CCIX) Gateway (CXG) that utilizes the CXS interface. Utilizing the CXS interface may enable modular design where different CXL device configurations can be paired with different interconnect component implementations. The CXS interface may support flow control, credit management, and virtual channels for different CXL sub-protocols. The CML gateway or CXG may utilize the CXS interface as the streaming interface protocol for exchanging CXL transactions between the CXL device and the interconnect. The CML gateway may provide coherent multichip link functionality that extends the coherent interconnect across chip boundaries, while the CXG may provide CCIX-based gateway functionality that bridges between CXL and CHI protocol domains with CCIX compatibility. Optionally, a 32-bit cyclic-redundancy check (CRC-32) may be applied to transactions conforming to the CXS interface to detect bit errors, which may be beneficial when the CXS interface spans die-to-die boundaries within a multi-chip module or chiplet-based design where signal integrity conditions may differ from on-die interconnects.

In some implementations of the apparatus, the interconnect component is configured to initiate a CHI allocating ReadShared request to a Home Node in response to a CXL.mem request, wherein the Home Node is coupled to a memory controller. When the RPU receives a CXL.mem read request from an external entity via the physical layer based on IEEE 802.3 PMA and translates it into a CXL transaction, the interconnect component may translate the CXL.mem request into a CHI allocating ReadShared request directed to the Home Node responsible for the targeted address.

In some implementations of the apparatus, the Home Node is configured to send a ReadNoSnp request to the memory controller, and the memory controller is configured to return data to the interconnect component using a CompData response. The combined response optimization may reduce transaction latency by enabling the memory controller to send response data directly to the interconnect component as the requester, rather than routing the data back through the Home Node.

In some implementations of the apparatus, the CXL device comprises a Global Fabric-Attached Memory Device (GFD) supporting CXL.mem transactions, and the interconnect component is optimized for handling CXL.mem traffic. The GFD may operate as a specialized CXL device that supports CXL.mem transactions without supporting CXL.io or CXL.cache sub-protocols. By limiting the supported sub-protocols to CXL.mem, the GFD and the associated interconnect component may be optimized specifically for memory access operations, simplifying the design by eliminating the need for separate CXL.io handling paths that would otherwise be managed by RN-D or RN-I nodes. This simplified architecture may be suitable for processors or accelerators designed for servicing external memory requests through fabric-attached memory pooling, where CXL.io configuration and enumeration may be handled through alternative mechanisms or may not be utilized.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol may include Ethernet, Ultra Ethernet Transport (UET), Ethernet for Scale-Up Networking (ESUN), Scale Up Ethernet (SUE), UALink, NVLink, or other protocols that utilize the IEEE 802.3 PMA for data transmission. The carrier protocol PDUs may encapsulate CXL information within carrier protocol headers and trailers, including encapsulating headers with fields such as source and destination node identifiers, segmentation identifiers, PDU sequence numbers, and passenger protocol identifiers. The RPU may extract the encapsulated CXL PDUs by parsing the carrier protocol headers, identifying the passenger protocol type, extracting CXL fields from the carrier protocol payload, translating field formats between carrier and CXL representations, and reconstructing complete CXL PDUs conforming to the CXL specification. The extracted and reconstructed CXL transactions may then be communicated to the interconnect component for translation to interconnect transactions.

In some implementations of the apparatus, the external entity comprises at least one of a GPU, an accelerator, or a switch, and the apparatus is configured to enable the external entity to access memory coupled to memory controllers of the processor via the RPU and the interconnect component. External entities such as GPUs, accelerators (including AI/ML accelerators, FPGAs, and data processing units), or switches may communicate with the processor through a carrier protocol fabric via the physical layer based on IEEE 802.3 PMA. The RPU and the interconnect component may translate carrier protocol PDUs from these external entities into interconnect transactions that traverse the interconnect to home nodes and memory controllers, which access DRAM to service the requests. This path may enable external entities to read from or write to the processor's memory for purposes such as shared memory access in heterogeneous computing environments, memory pooling across a fabric, or remote direct memory access (RDMA) operations.

In various implementations, a method comprising: receiving, via a physical layer based on IEEE 802.3 physical medium attachment (PMA), data from an external entity; translating, utilizing a Compute Express Link (CXL) device implemented in at least one of a resource provisioning unit (RPU) or an interconnect component coupled to an interconnect of a processor, between CXL transactions and interconnect transactions communicated via the interconnect; and wherein the processor comprises processing cores coupled via the interconnect, and the CXL transactions are associated with the data received from the external entity via the physical layer based on IEEE 802.3 PMA. The receiving of data may include receiving carrier protocol PDUs from the external entity via the physical layer based on IEEE 802.3 PMA. The translating may include extracting CXL information from the received data, reconstructing CXL transactions conforming to the CXL specification, and translating the CXL transactions into interconnect transactions for routing through the interconnect. The CXL device, implemented in at least one of the RPU or the interconnect component, may provide the CXL protocol endpoint functionality utilized during the translation.

In some implementations of the method, the data comprises protocol data units (PDUs) of a carrier protocol encapsulating CXL PDUs, and the translating comprises extracting CXL PDUs from the carrier protocol PDUs and reconstructing CXL transactions from the extracted CXL PDUs. The carrier protocol PDUs may include headers and trailers specific to the carrier protocol (such as Ethernet, UET, ESUN, or SUE), encapsulating headers with routing and identification metadata, and a payload containing CXL PDU fields. The extraction may involve parsing the carrier protocol structure, identifying the CXL sub-protocol type from a passenger protocol identifier, extracting CXL fields such as opcodes, addresses, and transaction identifiers, and translating field formats where the carrier protocol utilizes different encodings than the CXL specification. Reconstruction may include assembling the extracted and translated fields into complete CXL transactions and inserting any fields that were omitted from the carrier protocol PDU for bandwidth optimization, utilizing configuration parameters or default values for the omitted fields.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

Some implementations of the following apparatus further relate to processor architectures where a CXL root port couples to an interconnect for exchanging CXL traffic with external entities via an RPU and a physical layer based on IEEE 802.3 PMA. A root port may provide root complex functionality and may couple to the interconnect through different nodes depending on the types of CXL traffic to be supported. In one configuration, the root port may couple to a fully coherent request node (RN-F) and a fully coherent home node (HN-F), enabling bidirectional coherent access where external entities access the processor's memory and the processor's cores access resources coupled to external entities. In another configuration, the root port may couple to a CXL/CCIX Gateway (CCG) and an RN-D node, providing coherent CXL.mem handling through the CCG and non-coherent CXL.io handling through the RN-D node.

In various implementations, an apparatus comprising: a processor comprising processing cores coupled via an interconnect; a Compute Express Link (CXL) root port coupled to the interconnect; a resource provisioning unit (RPU) coupled to the CXL root port; a physical layer based on IEEE 802.3 physical medium attachment (PMA), coupled to the RPU, configured to communicate with an external entity; and wherein at least one of the RPU or the CXL root port is configured to translate between CXL transactions and interconnect transactions; wherein the CXL transactions are associated with data communicated with the external entity via the physical layer based on IEEE 802.3 PMA, and the interconnect transactions are communicated via the interconnect. The CXL root port may provide root complex functionality for CXL devices and endpoints coupled to or accessed through the RPU and the IEEE 802.3 PMA. The root port may be coupled to the interconnect through one or more intermediate nodes that translate between CXL protocol transactions and interconnect protocol transactions for communication with agents on the interconnect. The specific node configuration through which the root port is coupled to the interconnect may vary depending on the types of CXL traffic to be supported and the coherency requirements of the deployment. The RPU and the CXL root port may together translate between CXL transactions associated with data from external entities (received as carrier protocol PDUs via the IEEE 802.3 PMA) and interconnect transactions communicated via the interconnect.

In some implementations of the apparatus, the CXL root port is coupled to a fully coherent request node (RN-F) and a fully coherent home node (HN-F) on the interconnect. The RN-F and HN-F may be included within a gateway or bridge node structure coupled between the root port and the interconnect. The RN-F may act as a fully coherent request node that participates in the interconnect coherency protocol, enabling it to issue fully coherent requests (such as ReadShared, ReadUnique, or MakeUnique) on behalf of external entities whose CXL traffic arrives through the RPU and root port. The HN-F may act as a fully coherent home node that manages a portion of the address space, enabling the processor's cores to issue coherent requests to resources accessible through the external entity. Together, the RN-F and HN-F may enable bidirectional coherent communication between the processor and external entities through the CXL root port path.

In some implementations of the apparatus, the RN-F enables the external entity to access memory coupled to memory controllers of the processor via the physical layer based on IEEE 802.3 PMA, the RPU, the CXL root port, and the RN-F. When the external entity, such as a GPU or a storage device, transmits a read or write request encapsulated within a carrier protocol PDU, the RPU may extract the CXL request, translate it into a CXL transaction, and deliver it via the root port to the RN-F node on the interconnect. The RN-F may issue a corresponding interconnect request (such as a ReadShared or WriteBack) to the Home Node responsible for the targeted address, which may access the memory controller and DRAM to service the request. The response data may traverse back through the interconnect to the RN-F, the root port, the RPU, and the physical layer for delivery to the external entity. This path may enable external entities to access the processor's DRAM with full cache coherency, meaning that if the targeted cacheline is present in any of the processor's caches, the coherency protocol may handle the applicable snoops and state transitions.

In some implementations of the apparatus, the HN-F enables the processing cores to access a resource coupled to the external entity via the interconnect, the CXL root port, the RPU, and the physical layer based on IEEE 802.3 PMA. The HN-F may serve as a home node proxy for an address range that maps to resources coupled to the external entity, such as HBM coupled to a GPU, storage buffers coupled to a storage device, or memory-mapped registers of a remote accelerator. When a processing core issues a coherent read or write to an address within this range, the request may be routed through the interconnect to the HN-F, which may translate the interconnect request into a CXL transaction delivered through the root port to the RPU. The RPU may encapsulate the CXL transaction within a carrier protocol PDU and transmit it via the physical layer to the external entity for servicing. The response from the external entity may traverse the reverse path back to the processing core. This outbound path may enable the processor's cores to access external resources with coherency, without requiring the cores to be aware that the resource is accessible via a carrier protocol fabric.

In some implementations of the apparatus, the CXL root port is coupled to the interconnect via a CXL/CCIX Gateway (CCG) and an I/O-coherent Request Node with Distributed Virtual Memory support (RN-D). In this configuration, the CXL root port may couple to the interconnect through a CCG for handling coherent traffic, and through an RN-D node for handling non-coherent traffic. The CCG may translate CXL.mem and CXL.cache transactions arriving through the root port into interconnect transactions for communication with agents on the interconnect. The RN-D node may handle CXL.io or PCIe traffic that does not require full cache coherency but may participate in DVM operations. This configuration may provide a different balance of functionality compared to the RN-F/HN-F configuration, potentially offering advantages for workloads that primarily utilize CXL.mem for memory access combined with CXL.io for device configuration and management.

In some implementations of the apparatus, the CCG is optimized for handling CXL.mem traffic. The CCG in this configuration may be optimized specifically for CXL.mem transactions, potentially simplifying the translation logic by focusing on memory read, memory write, and related memory operations without the overhead of supporting CXL.cache coherency operations through the root port path. The optimization may reduce the logic area, power consumption, and latency of the CXL-to-interconnect translation for CXL.mem traffic. When CXL.cache operations are not expected through the root port path (for example, when cache coherency is managed through a separate path or is not utilized), the CCG may omit or disable the CXL.cache translation logic, further simplifying the design.

In some implementations of the apparatus, the RN-D is configured to handle CXL.io or PCIe traffic communicated via the CXL root port. The RN-D may receive CXL.io or PCIe transactions from the root port and communicate them to the interconnect for routing to the appropriate agents. CXL.io traffic may include configuration reads and writes for device enumeration and management, MMIO access for device control, and other non-coherent transactions defined by the CXL.io (PCIe-based) protocol. The RN-D may support DVM operations that enable synchronization of virtual memory management across the interconnect. The separation of CXL.mem traffic (handled by the CCG) and CXL.io traffic (handled by the RN-D) through the same root port may enable the root port to support the full range of CXL sub-protocols while utilizing specialized nodes for each traffic type.

In some implementations, the apparatus further comprises Subordinate Nodes (SN-F) coupled to memory controllers, the memory controllers coupled to DRAM via DDR PHY and memory channels. The memory subsystem in the root port architecture may be similar to that in the CXL device architecture, with SN-F nodes serving as subordinate agents that interface between the interconnect protocol domain and the memory controllers. CXL traffic arriving through the root port path may ultimately be serviced by the memory controllers accessing DRAM through the DDR PHY and memory channels, after traversal through the interconnect and home node processing.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol PDUs may include Ethernet, UET, ESUN, SUE, or other carrier protocol frames carrying encapsulated CXL information within headers, payloads, and trailers. The RPU may parse the carrier protocol structure, extract CXL fields, translate between carrier and CXL field formats, and deliver reconstructed CXL transactions to the root port for communication with the interconnect.

In some implementations of the apparatus, the external entity comprises at least one of a GPU, an accelerator, or a switch, and the apparatus is configured to enable the external entity to access memory coupled to memory controllers of the processor via the RPU, the CXL root port, and the interconnect. External entities communicating through a carrier protocol fabric may access the processor's memory through the root port path, with the RPU and the CXL root port translating carrier protocol PDUs into interconnect transactions routed to home nodes and memory controllers. The type of external entity may influence the traffic patterns and CXL sub-protocols utilized: GPUs may generate high-bandwidth CXL.mem read and write requests for shared memory access, accelerators may combine CXL.mem access with CXL.io for device control, and switches may aggregate and route CXL traffic from downstream entities. The root port path may provide advantages for certain entity types that benefit from root complex enumeration and management capabilities.

In some implementations of the apparatus, the interconnect comprises a mesh interconnect, the mesh interconnect comprising crosspoints (XPs) configured to route interconnect transactions between the processing cores, the CXL root port, and memory controllers based on packet identifiers. The crosspoints in the root port architecture may route interconnect transactions between agents including the processing cores, the nodes through which the root port couples to the interconnect (such as RN-F, HN-F, CCG, or RN-D nodes), home agents, SN-F nodes, memory controllers, and other agents. The routing based on packet identifiers may enable the crosspoints to direct transactions along the mesh topology from source to destination without centralized routing control. The crosspoints may support virtual channels, quality-of-service levels, and flow control mechanisms defined by the interconnect protocol.

In various implementations, a method comprising: receiving, via a physical layer based on IEEE 802.3 physical medium attachment (PMA), data from an external entity; translating, by at least one of a resource provisioning unit (RPU) or a Compute Express Link (CXL) root port coupled to an interconnect of a processor, between CXL transactions and interconnect transactions; wherein the processor comprises processing cores coupled via the interconnect, the CXL transactions are associated with the data received from the external entity via the physical layer based on IEEE 802.3 PMA, and the interconnect transactions are communicated via the interconnect. The receiving of data may include receiving carrier protocol PDUs from external entities such as GPUs, accelerators, or switches. The translating may include extracting CXL information from the received data, reconstructing CXL transactions, and translating the CXL transactions into interconnect transactions for routing to agents on the interconnect through the root port and its coupled nodes.

In some implementations of the method, the CXL root port is coupled to a fully coherent request node (RN-F) and a fully coherent home node (HN-F) on the interconnect, the RN-F enabling the external entity to access memory coupled to memory controllers of the processor, and the HN-F enabling the processing cores to access a resource coupled to the external entity. The bidirectional coherent access method may enable external entities to read from or write to the processor's memory through the RN-F path, and may enable the processor's cores to read from or write to resources coupled to external entities through the HN-F path. The inbound path through the RN-F may involve the RPU extracting and translating incoming data into CXL transactions, which the root port delivers to the RN-F for issuance as interconnect requests. The outbound path through the HN-F may involve the processing cores issuing coherent requests that the HN-F translates into CXL transactions delivered through the root port and RPU for transmission to the external entity via the physical layer. Both paths may operate simultaneously, enabling full-duplex coherent communication between the processor and external entities.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

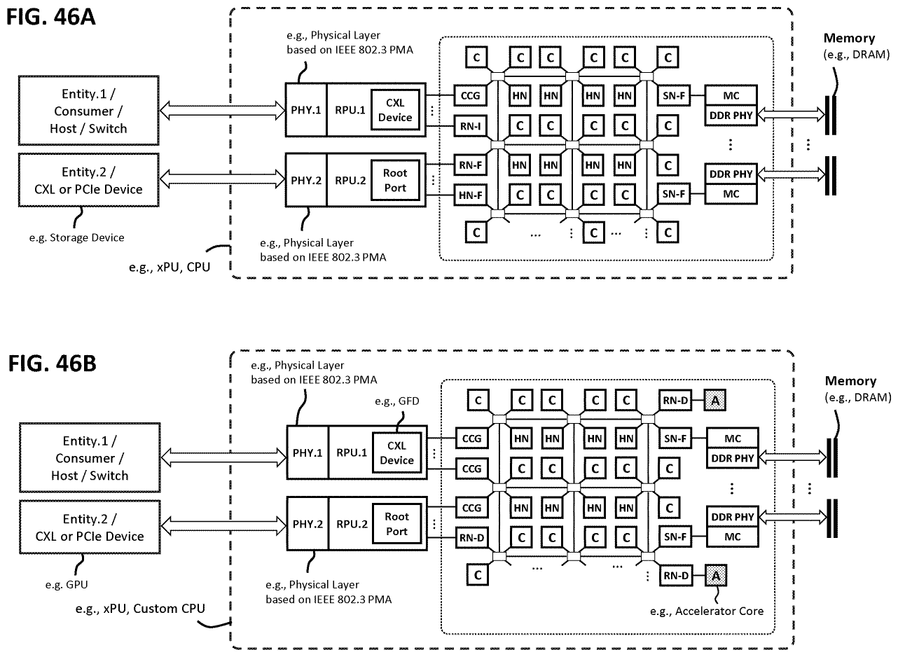

FIG. 46A illustrates an example of a system comprising a processor comprising interfaces that may utilize a physical layer based on IEEE 802.3 PMA. A first RPU includes or is coupled to a CXL device that is coupled to both a CCG node for handling coherent CXL.mem and/or CXL.cache transactions and an RN-D node for handling non-coherent CXL.io transactions, where the CXL device may be implemented in at least one of the RPU or the CCG. The system may couple the first RPU to the CCG over a CXS interface, providing a path for coherent communications. A second RPU includes or is coupled to a root port that is coupled to both a fully coherent request node (RN-F) and a fully coherent home node (HN-F) that may be included within a gateway or a bridge node structure, enabling bidirectional coherent access wherein an external entity, such as a GPU or a storage device, may read from the processor's DRAM through the RN-F node, and in the opposite direction, the processor cores may read from the GPU's HBM or from buffers in the storage device through the HN-F node.

FIG. 46B illustrates an example of a system comprising an xPU or a CPU, which may be a custom CPU design, incorporating accelerator cores and interfaces that may utilize a physical layer based on IEEE 802.3 PMA. A Global Fabric-Attached Memory Device (GFD), utilized by a first RPU, may operate as a specialized CXL device that supports only CXL.mem transactions, allowing the GFD to service external requests through CCGs that are optimized for handling CXL.mem traffic, thereby simplifying the design by eliminating the need for separate CXL.io handling paths typically managed by RN-D or RN-I nodes. The system further includes an optional second RPU that includes or is coupled to a root port, coupled to the interconnect via a CCG and an I/O-Coherent Request Node with DVM support (RN-D), wherein the RN-D may handle CXL.io or PCIe traffic.

It is noted that a line in the drawings may denote more than one port, interface, or link. For example, a single line connecting a CCG to an XP may represent two ports, such as one port for a Request Agent (RA) proxy and another port for a Home Agent (HA) proxy.

### Terminology

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4 ), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### General COnsiderations

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or eschange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method comprising:
receiving, by a computer from a first entity via a first interface that communicates according to an NVLink-based protocol, an NVLink-based request comprising a first physical address associated with a first address space;
translating, by the computer, the first physical address to a second physical address associated with a second address space;
generating, by the computer, a CXL.mem Master-to-Subordinate (M2S) request comprising a read-class memory opcode and the second physical address, wherein CXL denotes Compute Express Link;
sending, by the computer via a second interface, the CXL.mem M2S request to a second entity;
receiving, by the computer from the second entity, a CXL.mem Subordinate-to-Master Data Response with Status (S2M DRS) comprising data; and
sending, by the computer to the first entity, an NVLink-based response comprising the data.

2. The method of claim 1, wherein the NVLink-based request is associated with a data payload size exceeding a maximum CXL.mem data payload size, and wherein the generating of the CXL.mem M2S request comprises generating CXL.mem M2S requests corresponding to the NVLink-based request.

3. The method of claim 2, further comprising accumulating data from CXL.mem S2M DRS responses corresponding to the CXL.mem M2S requests before sending the NVLink-based response to the first entity.

4. The method of claim 1, further comprising maintaining, by the computer, a mapping between a first Tag associated with the NVLink-based request and a second Tag associated with the CXL.mem M2S request, and utilizing the mapping to associate the CXL.mem S2M DRS with the NVLink-based request.

5. The method of claim 1, further comprising: generating, by the computer, a second CXL.mem M2S request comprising a MemSpecRd opcode and a third physical address; and sending the second CXL.mem M2S request to the second entity.

6. The method of claim 1, wherein the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool.

7. The method of claim 1, wherein the CXL.mem S2M DRS further comprises a Poison indication, and the NVLink-based response further comprises an error indication translated from the Poison indication.

8. The method of claim 1, further comprising: receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface;
receiving, from the second entity, a CXL.mem Subordinate-to-Master No Data Response (S2M NDR); and sending an NVLink-based write response to the first entity.

9. A non-transitory computer-readable medium comprising instructions which, when executed by a processor, cause the processor to perform the method of claim 1.

10. One or more integrated circuits configured to perform the method of claim 1, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

11. An active cable comprising first and second pluggable modules coupled by a physical medium; wherein the active cable further comprises hardware circuitry, integrated into the active cable, configured to perform the method of claim 1.

12. A system comprising:
a first interface configured to communicate according to an NVLink-based protocol with a first entity;
a second interface configured to communicate according to Compute Express Link (CXL) with a second entity; and
a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface.

13. The system of claim 12, wherein the computer is packaged in an integrated circuit (IC) package comprising input/output (I/O) connection points arranged according to a retimer ball grid array (BGA) specification.

14. The system of claim 12, further comprising at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools.

15. The system of claim 12, wherein the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY.

16. The system of claim 12, wherein the NVLink-based protocol and CXL are associated with a same physical address space, the same physical address space comprising a global address space, a pod address space, or a fabric address space.

17. A method comprising:
receiving, by a computer from a first entity via a first interface that communicates according to Compute Express Link (CXL), a CXL.mem Master-to-Subordinate (M2S) request comprising a read-class memory opcode and a first physical address associated with a first address space;
translating, by the computer, the first physical address to a second physical address associated with a second address space;
generating, by the computer, an NVLink-based request comprising the second physical address;
sending, by the computer via a second interface that communicates according to an NVLink-based protocol, the NVLink-based request to a second entity;
receiving, by the computer from the second entity, an NVLink-based response comprising data; and
generating, by the computer, a CXL.mem Subordinate-to-Master Data Response with Status (S2M DRS) comprising the data, and sending the CXL.mem S2M DRS to the first entity.

18. The method of claim 17, further comprising maintaining, by the computer, a mapping between a first Tag associated with the CXL.mem M2S request and a second Tag associated with the NVLink-based request, and utilizing the mapping to associate the NVLink-based response with the CXL.mem M2S request.

19. The method of claim 17, wherein the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface.

20. The method of claim 17, wherein the first entity comprises a CXL host or a CPU, and the second entity comprises a GPU, an NVLink switch, or an accelerator; and wherein the NVLink-based response comprises data retrieved from a memory accessible via the second entity on an NVLink fabric.

21. The method of claim 17, further comprising: receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity.

22. The method of claim 17, further comprising: receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and
generating a CXL.mem Subordinate-to-Master No Data Response (S2M NDR), and sending the CXL.mem S2M NDR to the first entity.

23. A non-transitory computer-readable medium comprising instructions which, when executed by a processor, cause the processor to perform the method of claim 17.

24. One or more integrated circuits configured to perform the method of claim 17, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

25. An active cable comprising first and second pluggable modules coupled by a physical medium; wherein the active cable further comprises hardware circuitry, integrated into the active cable, configured to perform the method of claim 17.

26. A system comprising:
a first interface configured to communicate according to Compute Express Link (CXL) with a first entity;
a second interface configured to communicate according to an NVLink-based protocol with a second entity; and
a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface.

27. The system of claim 26, further comprising an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface.

28. The system of claim 26, wherein the second interface utilizes fewer lanes than the first interface, and wherein the NVLink-based protocol operates at a higher per-lane signaling rate than CXL, such that the second interface achieves a bandwidth comparable to the first interface utilizing the fewer lanes.

29. The system of claim 26, wherein the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments.

30. The system of claim 26, wherein the computer is included in an NVLink switch, the NVLink switch coupled to NVLink entities via the second interface; and wherein the computer translates CXL.mem M2S requests from the first entity to NVLink-based requests directed to at least one of the NVLink entities.
